SEQUENCE LISTING (8 sequences)

SEQ ID NO: 1 - DNA, 12 bp, Artificial Sequence
  Description of Artificial Sequence Synthetic oligonucleotide
aggtcgccgccc

SEQ ID NO: 2 - DNA, 12 bp, Artificial Sequence
  Description of Artificial Sequence Synthetic oligonucleotide
gggcggcgacct

SEQ ID NO: 3 - DNA, 24 bp, Artificial Sequence
  Description of Artificial Sequence Synthetic primer
cacaagggctactggttgccgatt

SEQ ID NO: 4 - DNA, 30 bp, Artificial Sequence
  Description of Artificial Sequence Synthetic primer
agcttcccaacgtgatcgcctttctcccat

SEQ ID NO: 5 - DNA, 68 bp, Artificial Sequence
  Description of Artificial Sequence Synthetic primer
cggcatcaggccatggattacaaagatgacgacgataaggctgaagcaatgtctaataaaaaacagtc

SEQ ID NO: 6 - DNA, 32 bp, Artificial Sequence
  Description of Artificial Sequence Synthetic primer
tttatagctcttccgcacttagatgtaagctg

SEQ ID NO: 7 - DNA, 73 bp, Artificial Sequence
  Description of Artificial Sequence Synthetic oligonucleotide
gtcagggtcatagtttgcagagggggttttgcagccaaagttgcagtagtcattatacccctcgaactagacg

SEQ ID NO: 8 - DNA, 41 bp, Artificial Sequence
  Description of Artificial Sequence Synthetic oligonucleotide
cgtgtagttcgaggggtataatgactactgcaactttggct

(19) United States
(12) Patent Application Publication
(10) Pub. No.: US 2008/0274905 A1
(43) Pub. Date: Nov. 6, 2008

(54) MICROFLUIDIC CELLS WITH PARALLEL ARRAYS OF INDIVIDUAL DNA MOLECULES

(75) Inventor: Eric C. Greene, New York, NY (US)

Correspondence Address: WilmerHale/Columbia University, 399 PARK AVENUE, NEW YORK, NY, 10022, US

(73) Assignee: THE TRUSTEES OF COLUMBIA UNIVERSITY IN THE CITY OF NEW YORK, New York, NY (US)

(21) Appl. No.: 12/058,095

(22) Filed: Mar. 28, 2008

Related U.S. Application Data
(63) Continuation-in-part of application No. PCT/US2006/038131, filed on Sep. 29, 2006.
(60) Provisional application No. 60/722,733, filed on Sep. 30, 2005.

(51) Int. Cl. C40B 20/04; C40B 40/08; C40B 60/12; C40B 30/04

(52) U.S. Cl. 506/4; 506/17; 506/39; 506/9

(57) ABSTRACT

Nucleic acid arrays and methods of using nucleic acid arrays are disclosed.

This application is a continuation-in-part of International Application No. PCT/US2006/38131 filed on Sep. 29, 2006, which claims the benefit of priority of U.S. Ser. No. 60/722,733 filed on Sep. 30, 2005, the contents of which are hereby incorporated in their entirety.

This invention was made with government support under PA-03-058 and GM074739 awarded by the National Institutes of Health. The government has certain rights in the invention.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

### BACKGROUND

Recent years have witnessed a dramatic increase in the use of technologies that allow the detailed interrogation of individual biological macromolecules in aqueous environments under near-native conditions. This increase can be attributed to the development and availability of highly sensitive experimental tools, such as atomic force microscopy (AFM), laser and magnetic tweezers, and fluorescence-based optical detection, all of which have all been used to study biological phenomena such as protein folding and unfolding, DNA dynamics, and protein-nucleic acid interactions.

### SUMMARY

The invention is based, in part, on the discovery that nucleic acid molecules can be disposed on a substrate and positionally aligned to allow analysis of individual nucleic acid molecules. Accordingly, in one aspect, the invention features an array that includes a substrate and nucleic acid molecules attached to the substrate. The nucleic acid molecules can be attached to the substrate by means of a linkage, e.g., a linkage between cognate binding proteins, e.g., neutravidin and biotin, or an antibody and antigen (e.g., anti-digoxigenin antibody and digoxigenin); or a crosslinking linkage, e.g., disulfide linkage or coupling between primary amines using gluteraldehyde. In some embodiments, the nucleic acid molecules are attached at one end. In some embodiments, the nucleic acid molecules are attached at both ends.

The array further includes a coating material, e.g., lipids, e.g., a lipid layer, e.g., a lipid bilayer, deposited onto the substrate. In one embodiment, the lipids are zwitterionic lipids. In one embodiment, polyethylene glycol (PEG) is added to the lipid bilayer. For example, 1%, 2%, 3%, 4%, 5%, 6%, 7%, 8%, 9%, 10%, 12% (w/w) or more of PEG can be included in the lipid bilayer.

The substrate can be, e.g., glass, fused silica (SiO₂), quartz, borosilicate glass, polydimethylsiloxane, polymerized Langmuir Blodgett film, functionalized glass, Si, Ge, GaAs, GaP, SiO₂, SiN₄, modified silicon, or a polymer (e.g., (poly)tetrafluoroethylene, (poly)vinylidenedifluoride, polystyrene, or polycarbonate). Preferably, the substrate is fused silica. The substrate can be, e.g., a disc, square, rectangle, sphere or circle. The substrate can be a suitable to be used in the methods described herein. In one embodiment, the substrate is a slide used for fluorescent microscopy.

The nucleic acid molecules can be, e.g., single stranded DNA, double stranded DNA, or RNA. The nucleic acid molecules can be about 10, 20, 30, 40, 50, 100, 150, 200, 500, 1000, 2000, 5000, 10000, 50000, 100000, 200000, or more nucleotides in length. The number of nucleic acid molecules that can be attached to the substrate can be determined by the size of the substrate and by the design of the array. In some embodiments, about 50, 100, 250, 500, 1000, 2000, 5000 or more nucleic acid molecules are attached to the substrate.

The nucleic acid molecules can be coupled to a label, e.g., a fluorescent label, e.g., YOYO1, or other fluorescent label described herein, or to a quantum dot.

In another aspect, the invention features an array that includes a substrate, a lipid bilayer disposed on the substrate, and nucleic acid molecules attached to the lipid bilayer by a linkage. In one embodiment, a polypeptide, e.g., neutravidin, is linked to the lipid head groups and a cognate polypeptide, e.g., biotin, is linked to the nucleic acid molecules. The nucleic acid molecules are attached to the lipid bilayer by a linkage between the neutravidin and the biotin. In some embodiments, the nucleic acid molecules are attached at one end. In some embodiments, the nucleic acid molecules are attached at both ends.

In one embodiment, the substrate further includes a diffusion barrier, e.g., a a mechanical, chemical or protein barrier, that prevents lipid diffusion. A mechanical barrier can be, e.g., a scratch or etch on the substrate. Protein barriers include, e.g., fibronectin. Protein barriers can be deposited onto a substrate, e.g., a substrate described herein, in well-defined patterns. Protein barriers can have a thickness of, e.g., 2, 3, 4, 5, 6, 7, 8, 9, 10, 15, 20 or more 1 m thick. In one embodiment, the barrier materials comprising a chemical barrier can comprise metals, such as chromium, aluminum, gold, titanium, platinum, osmium, or nickel. In another embodiment, the barrier materials can comprise metal oxides, such as aluminum oxide, titanium oxide, etc.

In another aspect, the invention features an array that includes a substrate, a diffusion barrier described herein, a lipid bilayer disposed on the substrate, and nucleic acid molecules attached to the diffusion barrier by a linkage. In one embodiment, the diffusion barrier is coupled to a protein, e.g., biotin. A cognate protein, e.g., neutravidin, is then bound directly to the biotinylated diffusion barriers, and biotinylated nucleic acid molecules are attached to the diffusion barriers by binding to the cognate protein, e.g., neutravidin. In some embodiments, the nucleic acid molecules are attached at one end. In some embodiments, the nucleic acid molecules are attached at both ends.

In another aspect, the invention features a cell, e.g., a flowcell, e.g., a microfluidic flowcell, that includes an array described herein. The flowcell can be configured to allow a fluid to interact with the lipid bilayer, e.g., to flow over the lipid bilayer. In some embodiments, a substrate described herein further includes two openings, e.g., an inlet port and an outlet port. The cell, e.g., flowcell, includes the substrate, and a cover, e.g., a glass cover, e.g., a glass coverslip, adhesively attached at its perimeter to the substrate, creating a chamber between the substrate and the cover. The inlet port and the outlet port open into the chamber, allowing the application of a hydrodynamic force into the chamber and over the lipid bilayer deposited on the substrate. For example, a buffer can be forced through the inlet port into the chamber such that the buffer flows over the lipid bilayer and exits the chamber through the outlet port.

In one embodiment, the nucleic acid molecules of the array are positioned into a desired orientation by application of the hydrodynamic force to the flowcell. For example, upon application of a hydrodynamic force to the flowcell, e.g., introduction of a buffer as described herein, the nucleic acid molecules are aligned in the direction of the hydrodynamic force. In embodiments in which the nucleic acid molecules are attached at one end, the hydrodynamic force results in the extension of the nonattached ends of the nucleic acid molecules in the direction of the flow of the hydrodynamic force. In embodiments in which the nucleic acid molecules are attached to the lipid heads of the lipid bilayer, the nucleic acid molecules will flow in the direction of the hydrodynamic force until the lipid head encounters a diffusion barrier, resulting in the extension of the nucleic acid molecule at a desired position in a desired orientation.

In another aspect, the invention features a method for visualizing individual nucleic acid molecules. The method includes attaching nucleic acid molecules (coupled to a fluorescent label) to a substrate, to a lipid bilayer, or to a diffusion barrier, as described herein, to form an array. The array is then included in a flowcell, and the nucleic acid molecules are aligned in a desired orientation, as described herein. The arrays are then excited with a light source, e.g., a laser, at the excitation wavelength of the particular fluorescent label and the resulting fluorescence at the emission wavelength is detected. Detection of the fluorescence signal utilizes a microscope, e.g., a fluorescent microscope. In another embodiment, excitation and detection is mediated by Total Internal Reflection Fluorescence Microscopy (TIRFM), as described herein.

In another aspect, the invention features methods for analyzing the interactions between a nucleic acid and a polypeptide. The method includes, e.g., providing an array within a flowcell as described herein. The nucleic acid molecules can be aligned in a desired orientation by application of a hydrodynamic force, and the nucleic acid molecules can be visualized as described herein. A target polypeptide is then added to the flowcell, e.g., by being added to the buffer that mediates the hydrodynamic force across the array. In one embodiment, the target polypeptide is coupled to a fluorescent label that is different than the fluorescent label coupled to the nucleic acid molecule. The localization of the target polypeptide to the nucleic acid molecule can be visualized, and such localization is indicative of interaction between the target polypeptide and the nucleic acid molecule.

In one embodiment, the signals from the array are collected serially over time, allowing the movement of the target polypeptides on the nucleic acid molecules to be determined.

In one embodiment, the length of the nucleic acid molecules is determined before and after the addition of the polypeptide, wherein if the polypeptide causes the nucleic acid molecule to change length, e.g., shorten or lengthen, this indicates that the polypeptide causes a structural change in the nucleic acid molecule.

In another aspect, the invention features methods for identifying a nucleic acid sequence, e.g., a mutation in a nucleic acid sequence, that disrupts an interaction between a nucleic acid molecule and a polypeptide. The method includes providing a first array within a first flowcell as described herein. The first array contains a first population of identical nucleic acid molecules that are coupled to a first fluorescent label. The method also includes providing a second array within a second flowcell as described herein. The second array contains a second population of identical nucleic acid molecules that are coupled to a first fluorescent label. In another embodiment, the nucleotide sequence of the second population of nucleic acid molecules differs from the nucleotide sequence of the first population of nucleic acid molecules by at least one nucleotide. A polypeptide is then added to the flowcells, e.g., by being added to the buffer that mediates the hydrodynamic force across the arrays. In an embodiment of the invention, the polypeptide is coupled to a second fluorescent label, e.g., one that is different from the fluorescent label coupled to the nucleic acid molecules. The localization of the polypeptide to the nucleic acid molecules on the arrays can be visualized, and the localization of the polypeptide to the nucleic acid molecules of the first array, but not of the second array, is indicative that the nucleic acid molecules of the second array contain a nucleic acid sequence, e.g., a mutation, that disrupts the interaction between the nucleic acid molecules of the first array and the polypeptide.

In another aspect, the invention features methods for identifying an agent that disrupts the interaction of a polypeptide and a nucleic acid. The method includes, e.g., providing an array within a flowcell as described herein. The nucleic acid molecules (coupled to a first fluorescent label) can be aligned in a desired orientation by application of a hydrodynamic force, and the nucleic acid molecules can be visualized as described herein. A polypeptide is then added to the flowcell, e.g., by being added to the buffer that mediates the hydrodynamic force across the array. In another embodiment, the polypeptide is coupled to a fluorescent label that is different than the fluorescent label coupled to the nucleic acid molecule. In another embodiment, the polypeptide is a polypeptide that is known to bind to the nucleic acid molecules. The localization of the polypeptide to the nucleic acid molecule can be visualized. A candidate agent, e.g., a compound or drug, is then added to the flowcell, e.g., by being added to the buffer and whether the localization of the polypeptide can be visualized. An agent that causes loss of localization of the polypeptide anywhere along the length of the nucleic acid molecule is indicative of an agent that disrupts the interaction between the nucleic acid molecule and the polypeptide.

In another aspect, the invention features methods for sequencing a nucleic acid molecule. The method includes, e.g., providing a single stranded nucleic acid molecule, e.g., a single stranded DNA molecule. The single stranded nucleic acid molecule is mixed with DNA polymerase and a mix of fluorescently labeled nucleotide analogs, e.g., fluorescently labeled dNTPs. In another embodiment, each dNTP, e.g., DATP, dCTP, dGTP and dTTP, is coupled to a different fluorescent label. The mixture is reacted under conditions that allow the addition of the nucleotide analogs to the single stranded nucleotide molecules. The reacted nucleic acid molecules are then added to an array as described herein. The nucleic acid molecules can be aligned in a desired orientation by application of a hydrodynamic force, and the nucleic acid molecules can be visualized as described herein.

In one embodiment, the nucleic acid molecules are identical, and the sequence can be determined by parallel lines of color representing particular nucleotides across the array. In one embodiment, the nucleic acid molecules are different.

In another aspect, the invention features methods for high-throughput physical mapping of single DNA molecules, for example using restriction enzymes, hybridization with fluorescent proteins, or fluorescence in situ hybridization.

In another aspect, the invention features a plurality of microfluidic flowcells described herein arranged in parallel. The plurality of flowcells can be used in parallel in any method described herein.

In another aspect, the invention features a diagnostic method that uses the arrays described herein for detecting a mutation in a nucleic acid. Detection can be achieved in a variety of ways including but not limited either through sequencing of the nucleic acids, or hybridization methods.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting. Other features and advantages of the invention will be apparent from the following detailed description, and from the claims.

### BRIEF DESCRIPTION OF THE FIGURES

FIG. 1 is a schematic of an overview of a Total Internal Reflection Fluorescence Microscope (TIRFM).

FIG. 2A is a schematic illustration of the strategy for preparing surfaces with immobilized neutravidin surrounded by a fluid lipid bilayer. FIG. 2B is a graph of FRAP measurements of lipid bilayers in the presence (circles) and absence (squares) of neutravidin.

FIG. 3A is a TIRFM image of YOYO1-stained λ-DNA molecules immobilized by a single end to a lipid bilayer-coated surface in the absence of buffer flow. FIG. 3B is a TIRFM image of YOYO1-stained λ-DNA molecules immobilized by a single end to a lipid bilayer-coated surface when buffer is flowing. A cartoon illustration of a DNA molecule and its response to hydrodynamic force are shown at the right. The scale bar corresponds to 10 μm.

FIG. 4A is a TIRFM image of six λ-DNA molecules tethered by both extremities to the bilayer-coated surface (arrow heads highlight the ends of one molecule), in the absence of buffer flow. Three bright fluorescent spots (highlighted with white arrow heads) correspond to DNA molecules that are tethered by a single end. FIG. 4B are TIRFM images before and after photo-induced cleavage of a double-tethered DNA molecule in the absence of buffer flow. The ends of the DNA are indicated with white arrowheads.

FIG. 5A is a schematic for preparing arrays of surface-tethered DNA molecules. FIG. 5B is a collection of TIRFM images of the assembly of parallel arrays of DNA molecules. A 10-μm scale-bar and time points are indicated.

FIGS. 6A-6D are TIRFM images of arrays containing different amounts of biotinylated λ-DNA, either in the absence of buffer flow (left panels) or in the presence of buffer flow at rate of 0.2 ml/min (right panels).

FIG. 7 is a collection of TIRFM images of arrays containing lipid-tethered DNA molecules following termination of buffer flow. A 10-μm scale-bar and time points are indicated.

FIG. 8A is a series of TIRFM images of a DNA array containing tethered λ-DNA taken at flow rates of 0.05, 0.1, 0.2, 0.5 and 1.0 ml/min, as indicated. When corrected for the dimensions of the sample chamber (0.45×0.0025 cm, W×H), these values correlate to flow velocities of 0.75, 1.5, 3, 7.5, and 15 cm/sec. FIG. 8B is a graph of the relative mean extension [symbol] plotted as a function of flow rate. The experimental data points are shown as open circles with corresponding standard deviations. The solid line is a fit of the data points to an equation describing the WLC model for DNA (inset), and was used to estimate the force experienced by the tethered DNA molecules within the sample chamber. F is force (in pN), k_{B} is Boltzmann's constant, T is temperature (295 K), and Lₚ is the persistence length of the DNA (≈50 nm).

FIG. 9A is a schematic of a microcontact stamp. FIG. 9B is a schematic of a process for using microcontact printing to define DNA array architecture.

FIGS. 10A-10F are schematics of different various designed arrays.

FIG. 11A is a TIRFM image of DNA molecules biotinylated at one end and labeled with a single Cy3 fluorophore at the other end. FIG. 11B is a schematic of a two-layer stamp. FIG. 11C is a schematic of a defined nanoarray.

FIG. 12A is a coomassie-stained gel of fluorescently tagged human Rad51 and mutant proteins (left panel) and a fluorescence image of the same gel (right panel).

FIG. 12B is an ethidium bromide stained gel of unlabeled wt or fluorescently tagged Rad51. FIG. 12C is a graph of ATPase assays with wt Rad51, unlabeled A11C Rad51, and the fluorescently tagged version of A11C Rad51.

FIG. 13A is a schematic of the TIRFM design used to visualize fluorescent Rad51 on single molecules of dsDNA. FIG. 13B is a series of images of Rad51 on a tethered λ DNA molecule. The DNA is oriented vertically in the center of each frame. The numbers at the bottom of each frame show elapsed time; arrows indicate the direction of flow and highlight the movement of Rad51; and the tethered (T) and free (F) ends of the DNA molecule are indicated.

FIG. 14A is a schematic of tethered DNA molecules and their response to changes in hydrodynamic force. FIG. 14B is a TIRFM image of tethered YOYO1-stained DNA molecules assembled into an aligned array using a combination of hydrodynamic force and microscale barriers to lipid diffusion. The free (F) and tethered (T) ends of the DNA molecules are indicated. FIG. 14C is a TIRFM image of a DNA array bound by fluorescent Rad51. Each image represents a single 100-millisecond frame taken from a real time video and the scale bar is 10 μm.

FIG. 15A is schematic of a λ-DNA molecule tethered by both ends to a fused silica surface coated with a supported lipid bilayer, followed by injection of Rad51 and ATP into the sample chamber and the flushing of unbound protein and ATP from the sample chamber. FIG. 15B is a series of TIRFM images of Rad51 on dsDNA in the absence of flow force and ATP. Individual Rad51 complexes on the DNA are highlighted with arrowheads.

FIG. 16A is a graph of the y-displacement of three typical Rad51 complexes bound to ds DNA molecules monitored over a period of 124 seconds. Measurements were made with double-tethered DNA in the absence of buffer flow. FIG. 16B is a graph of the x-displacement for the three diffusing protein complexes. FIG. 16C is a graph of the MSD (mean squared displacement) for these three complexes plotted as a function of time interval for a period up to 12 seconds. The open circles represent the calculated data points and the solid lines represent linear fits to the data points. FIG. 16D is a graph of the total distance versus time for the same three Rad51 complexes. Each trace represents the total distance traversed by a single Rad51 complex during the indicated time interval.

FIG. 17A is a histogram of diffusion coefficients measured for 47 different freely diffusing Rad51 complexes sliding on dsDNA. FIG. 17B is a histogram of step sizes measured for the diffusing complexes.

FIG. 18A is a schematic of the design of dsDNA and ssDNA substrates. FIG. 18B is a schematic of a side view and FIG. 18C is a schematic of a top view of resulting recombination products and their response to buffer flow.

FIG. 19A is an outline of a predicted outcome for a random collision mechanism. FIG. 19B is a schematic of YOYO1 stained λ-DNA and Alexa 647 labeled presynaptic filaments. FIG. 19C is a representation of a merged TIRFM image.

FIG. 20A is an outline of a predicted outcome for a sliding mechanism. FIG. 20B is a schematic of YOYO1 stained λ-DNA and Alexa 647 labeled presynaptic filaments. FIG. 20C is a representation of a merged TIRFM image.

FIG. 21A is an outline of a predicted outcome for an intersegmental transfer mechanism. FIG. 21B is a schematic of YOYO1 stained λ-DNA and Alexa 647 labeled presynaptic filaments. FIG. 21C is a representation of a merged TIRFM image.

FIG. 22 is a schematic of a DNA substrate for intramolecular recombination.

FIG. 23 is a flow diagram of homology search experiments.

FIG. 24 is a schematic distinguishing alignment and strand invasion.

FIG. 25 is a schematic of the influence of nucleosomes on homologous recombination.

FIG. 26A is a schematic (upper panel) of an individual DNA molecule and the change in length (ΔL) that is predicted upon assembly of a Rad51 filament. “T” indicates tethered and “F” free end of the DNA molecule. The lower panels are images of DNA curtains before and after the injection of human Rad51. FIG. 26B is a series of images following the extension of one DNA molecule as Rad51 assembles into a filament. Each image was obtained at 3 sec intervals. FIG. 26C is a graph of length for a population of individual DNA molecules during the assembly of Rad51 filaments plotted as a function of time. Squares and error bars indicate the mean length and standard deviation for the population of DNA molecules, and the solid line represents a sigmoidal fit to the data points.

FIG. 27A is a graph of rate of Rad51 filament assembly plotted as a function of Rad51 concentration. FIG. 27B is a graph of DNA length as a function of time at 25° C. and 37° C. FIG. 27C is a graph of DNA length as a function of time with 1 mM magnesium (squares) and 1 mM calcium (circles).

FIG. 28A is a graph of filament assembly rate plotted as a function of ATP concentration. FIG. 28B is a graph of DNA length plotted as a function of time in the presence of various nucleotide co-factors. FIG. 28C is a graph of Rad51 filament assembly rates in the presence of either ATP, ATPγS, AMP-PNP or ADP obtained from the data depicted in FIG. 28B. The inset is a dsDNA gel-shift assay with human Rad51 carried out in the presence of ATP (lane 2), ATPγS (lane 3), AMP-PNP (lane 4), ADP (lane 5). Rad51 was omitted from lane 1. FIG. 28D is a graph of DNA length plotted as a function of time for wild type 1 μM Rad51, 1 μM K133R Rad51 and 1 μM K133A Rad51. The inset is a gel of in vitro recombination reactions performed with oligonucleotide substrates and either wild-type Rad51, K133R, or K133A.

FIG. 29A is a graph of DNA length plotted as a function of time with various Rad51 mutants and wild type Rad51. FIG. 29B is a series of gels of products of gel shift assays carried out with either linearized φX174 dsDNA or φX174 virion ssDNA. Lane 1—control without protein; lane 2—2.5 μM protein; lane 3—5 μM protein; lane 4—10 μM; lane 5—12.5 μM. The final concentration of base pairs was 30 μM for all of the gel shift experiments, and all reactions contained 2 mM ATP. FIG. 29C is a gel of DNA products following in vitro recombination assays performed with 4 μM of each of the indicated Rad51 proteins.

FIG. 30A (upper panel) is a schematic illustration of DNA curtains assembled at the leading edge of a microscale diffusion barrier on the surface of a flow chamber that was coated with a fluid lipid bilayer. The lower panel depicts just one DNA molecule and its response to changes in buffer flow and its relative position within the evanescent field. FIG. 30B is an image of an actual DNA curtain stained with YOYO1 shown in the presence and absence of buffer flow. “T” and “F” indicate the tethered and free ends of the DNA molecules, respectively. The observed length of the DNA was ˜12.5 μm, yielding a mean extension [symbol] of 0.8, which corresponds to an applied force of ˜0.5 pN. FIG. 30C is an image of Rdh54 bound to the DNA curtain in the presence and absence of buffer flow. The protein was labeled with quantum dots and the DNA was not labeled. There are 264 individual complexes of Rdh54 in the field-of-view. FIG. 30D is a histogram of binding site distributions.

FIG. 31A is a kymogram of Rdh54 movement against buffer flow (upper panel) and with buffer flow (lower panel). FIG. 31B is a kymogram of a single translocating complex of Rdh54 (upper panel), along with the corresponding particle-tracking data superimposed on the image of the protein (middle panel), or shown independently as a graph of the movement (lower panel). Linear fits to the translocation data are also indicated along with the corresponding translocation rates. FIG. 31C is a pair of histograms generated from the analysis of 64 different translocating Rdh54 complexes showing the distribution of translocation rates (273 different rates) and total distance traveled during the 250-second intervals.

FIG. 32A (upper panels) are kymograms of wild-type Rdh54 before and after 1 mM ATP was injected into the sample chamber (arrow) with proteins moving either with or against flow, and the lower panel shows a graphical representation of the same data. FIG. 32B is an image of Rdh54 ATPase mutant K352R binding to a DNA curtain and a histogram of the binding site distribution. The lower panel is a kymogram of the Rdh54 K352R mutant bound to DNA in the presence of ATP. Particle-tracking data are superimposed on two of the Rdh54 complexes.

FIG. 33A is a series of traces of individual Rdh54 complexes that are representative of the various behaviors observed as they translocated on the DNA. FIG. 33B is a histogram of pause time distributions. For this analysis, only the events where translocation was resumed were scored as pauses. FIG. 33C are examples of kymograms depicting collisions between different complexes of Rdh54 bound to the same molecule of DNA.

FIG. 34A is a series of images of a DNA curtain bound by Rdh54 complexes that were labeled with a mixture of differently colored quantum dots. FIG. 34B is a series of kymograms generated from Rdh54 complexes that were labeled with the two different colored quantum dots.

FIG. 35A is a kymogram with an example of synchronous movement of different Rdh54 complexes bound to the same molecule of DNA. The upper panel is the image sequence and the lower panel has superimposed particle-tracking data. FIG. 35B is a pair of graphs detailing each looping event (5 total) and the release of each loop is indicated with an arrowhead. FIG. 35C is a histogram depicting the lengths of DNA loops generated by Rdh54. These data encompass 80 total looping events observed on 70 different molecules of DNA.

FIG. 36 is a schematic of a process for labeling fluorescent PCNA with a single Qdot.

FIG. 37 is a schematic of a process for measuring the 1D-diffusion of DNA sliding clamps.

FIG. 38 is a schematic of a process for visualizing the behavior of Msh2-Msh6 on DNA.

FIG. 39 is a schematic of a process for visualizing mismatch recognition by PCNA-Msh2-Msh6 complexes.

FIG. 40A is a TIRFM image of Cy3-PCNA loaded onto a DNA array composed of molecules with an ssDNA gap at their tethered ends. FIG. 40B is a series of images with an individual PCNA ring loading and sliding down a DNA molecule. FIG. 40C is an image of Qdot-labeled Msh2-Msh6 bound to dsDNA. Each fluorescent spot is a single Qdot bound to a DNA within an array.

FIG. 41 is a schematic of a process for sequencing identical DNA molecules.

FIG. 42 is a schematic of a process for sequencing different DNA molecules.

FIG. 43A is a schematic of a process for mapping DNA molecules with restriction enzymes. FIG. 43B is a schematic of a process for mapping DNA molecules with fluorescent DNA-binding proteins. FIG. 43C is a schematic of a process for mapping DNA molecules with FISH probes. FIG. 43D is a schematic of a process for mapping unknown protein binding sites on DNA molecules. FIG. 43E is a schematic and images of fluorescent Rad51 binding to λ-DNA.

FIG. 44A is a schematic of a side view of an array with a hypothetical DNA molecule engineered to contain binding sites for 26 hypothetical proteins. FIG. 44B is a top view of the array of FIG. 44A. FIG. 44C is a schematic of a process for screening drugs. FIG. 44D is a schematic of a process for screening proteins.

FIGS. 45A and 45B are designs for flowcells.

FIG. 46A is an outline of the PCR strategy for preparation of biotin and digoxigenin labeled DNA molecules. FIG. 46B is an illustration of the procedure for construction of DNA curtains on lipid coated fused silica surfaces. FIG. 46C is a schematic of the arrangement of DNA curtains on the surface of the sample chamber.

FIG. 47A is an illustration of the response of a tethered DNA molecule to changes in buffer flow and its corresponding location within the evanescent field. FIG. 47B are three images of a DNA curtain labeled with both YOYO1 and anti-DIG quantum dots. The tethered (T) and free (F) ends of the DNA molecules (23 kb) are indicated. The top panel shows the DNA curtain in the presence of buffer flow, the middle panel shows the DNA curtain immediately after stopping buffer flow, and the bottom panel shows the same region after buffer flow was resumed.

FIG. 48A is an image of a DNA curtain stained with YOYO1 and labeled with anti-DIG quantum dots before (upper panel) and after (lower panel) the addition of buffer containing 200 mM NaCl. FIG. 48B is a series of images (kymogram) extracted from a video showing the decrease in YOYO1 signal as 200 mM NaCl was injected into the sample chamber. This kymogram was generated by selecting a region-of-interest (ROI; 3×50 pixels, W×H) corresponding to one DNA molecule within the DNA curtain and plotting this ROI as a function of time over a 2-minute interval. All images represent single 100-millisecond exposures taken from videos collected at 8.3 frames per second.

FIG. 49 (top panel) is a kymogram of a quantum dot-labeled DNA end over time as Rad51 assembles and then disassembles from the DNA. The lower panel is a graph of DNA length changes during the assembly of the Rad51 nucleoprotein filaments. All points on the graph were acquired by using a single-particle tracking algorithm to determine the position of the end of the DNA as it changed over time.

FIG. 50 is a photographic image showing YOYO1 stained DNA assembled into DNA curtains at the nanoscale diffusion Cr barriers in the presence (left panel) and absence (right panel) for buffer flow.

FIG. 51 is a conceptual diagram of lipid tethered DNA molecules aligned at a diffusion barrier. FIG. 51A shows a diagram of the total internal reflection fluorescence microscope (TIRFM) used to image single molecules of DNA. For imaging by TIRFM the long DNA molecules (48 kb) used in these studies must be extended parallel to the surface of the sample chamber in order to remain confined within the evanescent field. FIGS. 51B-C depict the bilayer on the surface of a fused silica slide along with a barrier to lipid diffusion and the response of tethered DNA molecules to the application of a hydrodynamic force. The upper and lower panels in FIGS. 51B-C depict views from the side and above, respectively. In the absence of buffer flow (FIG. 51B), the DNA molecules are tethered to the surface, but are not confined within the evanescent field, nor are they aligned at the barrier. As depicted in FIG. 51C, when flow is applied, the DNA molecules are dragged through the bilayer until they encounter the diffusion barrier, at which point they will align with respect to one another and form a curtain of DNA molecules

FIG. 52 demonstrates patterned barriers on a fused silica surface. FIG. 52A shows a cartoon diagram of the patterns used to organize the DNA molecules into curtains. The important features of the design including the perpendicular barriers used as guide channels, the guide channel openings, and the parallel barriers (“curtain rods”) used to align the DNA molecules into curtains are indicated. An optical image at 10× magnification is shown in FIG. 52B of a single barrier set made of chromium deposited onto fused silica. FIG. 52C shows a composite fluorescence image of a barrier pattern collected at 100× magnification after deposition of a supported lipid bilayer containing 0.1% Rhodamine-DHPE (shown in red). The barriers themselves appear black because they are not covered by lipids. FIG. 52D shows an optical image of a fused silica surface with a 2×3 set of barrier patterns at 10× magnification. The upstream and downstream areas are indicated and the arrow shows the direction that buffer would be flowing relative to the barrier patterns

FIG. 53 depicts images of barrier height and width. FIG. 53A shows an AFM image of a 10.5×10.5 μm area of fused silica with a 31 nm tall chromium barrier on the surface. An SEM image of a typical chromium barrier viewed from above is shown in FIG. 53B. The scale bars in FIG. 53B are divided into 100 nm increments. For comparison FIGS. 53C-D show AFM and SEM images, respectively, of typical barriers made by manually etching the surface. Note that the width of the manually etched barriers is actually comparable to the actual length of the λ-DNA molecules. The scale bars in FIG. 53D are divided into 5 μm increments

FIG. 54 represents a series of photographic images of YOYO1-stained λ-DNA curtains shown assembled at the nano-scale diffusion barriers. FIG. 54A shows the DNA molecules imaged at 60× magnification after they have been aligned at the barriers. The direction of buffer flow is from top to bottom. There are approximately 805 DNA molecules in this single image (˜150, 185, 185, 155, and 130 molecules in the 1^{st}, 2^{nd}, 3^{rd}, 4^{th}, and 5^{th} tiers, respectively). FIG. 54B shows the response of the DNA molecules immediately after stopping buffer flow. This shows that the molecules rapidly retract away from the surface leaving only their tethered ends within the evanescent field. In FIG. 54C the DNA molecules have begun to diffuse away from the chromium barrier and panel DNA shows the same field of view immediately after buffer flow was resumed. In FIG. 54D, buffer flow was reapplied causing the DNA molecules to realign at the barriers. FIGS. 54E-G show a 2×3 series of barrier sets viewed at 10× magnification with buffer flow on, without buffer flow, and then after flow was resumed, respectively. Note that the uneven fluorescence signal in the 10× image is due to heterogeneity in the evanescent field, which arose when the illumination beam was expanded to cover the full field at the lower magnification

FIG. 55 depicts the physical mapping of a λ-DNA curtain. A curtain of λ-DNA tethered by the right ends of the molecules is shown before (FIG. 55A) and after (FIG. 55B) complete digestion with EcoRI, which yields a ˜21 kb tethered product. FIGS. 55C-D show λ-DNA tethered by the left ends before and after digestion with EcoRI, which is expected to yield a 3.5 kb tethered product. The images and histograms in FIG. 55E show the length distributions (measured from the barrier edge to the end of the DNA) of uncut λ-DNA (48,502 bp; 13.26 μm; red) tethered via the left end and following a series of successive digests with Nhe I (34,679 bp; Δ13,823 bp; 8.84 μm; gray), Xho I (33,498 bp; Δ1,181 bp; 7.80 μm; purple), EcoRI (21,226 bp; Δ12,272 bp; 4.94 μm; blue), Nco I (19,329 bp; Δ1,897 bp; 4.42 μm; green), Pvu I (11,936 bp; Δ7,393 bp; 2.34 μm; yellow), and Sph I (2,216 bp; Δ9,720 bp; ˜0.5 μm; orange), respectively; the distance in base pairs between the cut site and the left end of the DNA are shown in parentheses, as is the expected change in size (A; in base pairs) following each digest based on the known sequence of λ, along with the observed DNA fragment length. The SphI fragments were too short to measure or count accurately, so the total number observed was based on the number of uncut DNA molecules in the frame before restriction digest. Fragments outside the peak values were due to either laser induced double-stranded breaks of the YOYO1 stained DNA or uncut DNA molecules

### DETAILED DESCRIPTION

The present invention is based in part on the discovery that nucleic acid molecules can be disposed on a substrate and positionally aligned to allow analysis of individual nucleic acid molecules. In particular, the methods and compositions described herein include a substrate, coating material, e.g., a lipid bilayer, and nucleic acid molecules attached directly to the substrate, attached to the substrate via a linkage, or attached to the lipid layer via a linkage. The nucleic acids are capable of interacting with their specific targets while attached to the substrate, and by appropriate labeling of the nucleic acid molecules and the targets, the sites of the interactions between the targets and the nucleic acid molecules may be derived. Because the nucleic acid molecules are positionally defined, the sites of the interactions will define the specificity of each interaction. As a result, a map of the patterns of interactions with nucleic acid molecules on the substrate is convertible into information on specific interactions between nucleic acid molecules and targets.

### Preparation of Substrate

Essentially, any conceivable substrate may be employed in the compositions and methods described herein. The substrate may be biological, nonbiological, organic, inorganic, or a combination of any of these, existing, e.g., as particles, strands, precipitates, gels, sheets, tubing, spheres, containers, capillaries, pads, slices, films, plates, or slides. The substrate may have any convenient shape, such as, e.g., a disc, square, sphere or circle. The substrate and its surface can form a rigid support on which to carry out the reactions described herein. The substrate can be, e.g., a polymerized Langmuir Blodgett film, functionalized glass, Si, Ge, GaAs, GaP, SiO₂, SiN₄, modified silicon, or any one of a wide variety of gels or polymers such as (poly)tetrafluoroethylene, (poly)vinylidenedifluoride, polystyrene, polycarbonate, or combinations thereof. Other substrate materials will be readily apparent to those of skill in is the art upon review of this disclosure. In some embodiments, the substrate is a made of SiO₂ and is flat.

In some embodiments, the substrate is coated with a linker to which the nucleic acid molecules attach. Such linkers can be, e.g., chemical or protein linkers. For example, the substrate can be coated with a protein such as neutravidin or an antibody.

In some embodiments, the substrate includes a diffusion barrier, e.g., a mechanical, chemical or protein barrier. Diffusion barriers can be prepared by applying barrier materials onto the substrate prior to deposition of the lipid bilayer; the bilayer then forms around the barriers. A mechanical barrier can be, e.g., a scratch or etch on the substrate, which physically prevents lipid diffusion.

In the case of a chemical barrier, the chemical nature of the barrier, and not its surface topography, is the primary factor in preventing lipid diffusion [Q13]. Barrier materials can be made that are similar to the thickness of the bilayer itself (e.g., 6-8 nm), or thinner than the bilayer. Protein barriers can be deposited onto substrates, e.g., SiO₂ substrates, by a variety of methods. For example, protein barriers can be deposited in well-defined patterns by a process called microcontact printing [Q11, Q14]. Microcontact printing uses a PDMS (poly[dimethylsiloxane]) template as a stamp for generating specific patterns on substrates. PDMS stamps can transfer proteins to a SiO₂ substrate in patterns with features as small as 1 μm, and thicknesses on the order of 5-10 nm [Q11, Q14]. The PDMS stamps used for microcontact printing can be made, e.g., by soft-lithography as described in [reference 14]. Once made, the PDMS can be incubated with a solution of protein, dried, and then placed into contact with the substrate, e.g., SiO₂, resulting in transfer of the protein “ink” from the PDMS stamp to the substrate and yielding a pattern defined by the stamp design. For example, protein barriers can be made from fibronectin.

To the substrate is then attached a layer of a material. In one embodiment, the material is one that renders the substrate inert. For example, the material can be lipids, forming, e.g., a lipid bilayer. In another embodiment, the layer is made of zwitterionic lipids. A lipid bilayer can be deposited onto the substrate by applying liposomes to the substrate. Liposomes can be produced by known methods from, e.g., 1,2-dioleoyl-sn-glycero-3-phosphocholine (DOPC) or 0.5% biotin-phosphatidylethanolamine (biotein-PE) plus 99.5% DOPC (Avanti Polar Lipids, Alabaster, Ala.). In some embodiments, the lipid bilayer can include polyethylene glycol (PEG). For example, in embodiments where quantum dots are used to label nucleic acid molecules and/or polypeptides, PEG can be included in the lipid bilayer. PEG can also be included to make the surface of the bilayer inert to reagents added to the array.

### Tethering Nucleic Acid Molecules

As described herein, the nucleic acid molecules can be attached to the substrate, to the lipid bilayer, or to the diffusion barrier, to form an array. The nucleic acid molecules can be attached by a linkage either at one end of the nucleic acid molecule or at both ends. For example, when a protein is coated on the substrate prior to the deposition of the lipid bilayer, the nucleic acid molecule can be linked to a cognate protein that binds to the protein coated on the substrate. In one embodiment, the substrate is coated with neutravidin and the nucleic acid molecule linker is biotin. Linkers can be added to the nucleic acid molecules using standard molecular biology techniques known to those of ordinary skill in the art.

Alternatively, the nucleic acid molecule can be linked to the lipid bilayer. In one embodiment, the lipid bilayer is deposited onto the substrate and a protein, e.g., neutravidin, is linked to the lipid head groups. Biotinylated nucleic acid molecules are then introduced, linking the nucleic acid molecules to the lipid bilayer.

In other embodiments, the nucleic acid molecules can be linked to the diffusion barriers. In one embodiment, the diffusion barrier is a protein, e.g., biotinylated bovine serum albumin (BSA), deposited on the substrate. Neutravidin is then bound directly to the biotinylated BSA protein barriers, and biotinylated nucleic acid molecules are linked to the biotinylated BSA protein barriers.

Other known protein-cognate protein pairs can be used in the methods described herein. For example, antibodies, e.g., anti-digoxigenin antibodies, can be used as protein barriers and the cognate antigen, e.g., digoxigenin, linked to the nucleic acid molecule.

### Labeling Nucleic Acid Molecules and Polypeptides

In another embodiment, the attached nucleic acid molecules and/or the interacting nucleic acid molecules or polypeptides are visualized by detecting one or more labels attached to the nucleic acid molecules or polypeptides. The labels may be incorporated by any of a number of means well known to those of skill in the art. The nucleic acid molecules on the array can be coupled to a nonspecific label, e.g., a dye, e.g., a fluorescent dye, e.g., YOYO1 (Molecular Probe, Eugene, Oreg.), TOTO1, TO-PRO, acridine orange, DAPI and ethidium bromide, that labels the entire length of the nucleic acid molecule. The nucleic acid molecules can also be labeled with Quantum dots, as described herein.

In another embodiment, the nucleic acid molecules, e.g., the nucleic acid molecules on the array or target nucleic acid molecules, can be coupled to a label at defined locations using known methods. The label can be incorporated during an amplification step in the preparation of the sample nucleic acids. For example, polymerase chain reaction (PCR) with labeled primers or labeled nucleotides will provide a labeled amplification product. The nucleic acid molecule is amplified in the presence of labeled deoxynucleotide triphosphates (dNTPs).

Alternatively, a label may be added directly to the nucleic acid molecule or to an amplification product after an amplification is completed. Means of attaching labels to nucleic acids include, for example, nick translation or end-labeling (e.g. with a labeled RNA) by kinasing of the nucleic acid and subsequent attachment (ligation) of a nucleic acid linker joining the sample nucleic acid to a label (e.g., a fluorophore).

Detectable labels suitable for use in the methods and compositions described herein include any composition detectable by spectroscopic, photochemical, biochemical, immunochemical, electrical, optical or chemical means. Useful labels in include biotin for staining with labeled streptavidin conjugate, magnetic beads (e.g., Dynabeads™), fluorescent dyes (e.g., fluorescein, Texas red, rhodamine, green fluorescent protein, and the like, see, e.g., Molecular Probes, Eugene, Oreg.), radiolabels (e.g., ³H, ¹²⁵¹, ³⁵S, ¹⁴C, or ³²P), enzymes (e.g., horse radish peroxidase, alkaline phosphatase and others commonly used in an ELISA), and colorimetric labels such as colloidal gold (e.g., gold particles in the 40-80 nm diameter size range scatter green light with high efficiency) or colored glass or plastic (e.g., polystyrene, polypropylene, latex, etc.) beads. Patents teaching the use of such labels include U.S. Pat. Nos. 3,817,837; 3,850,752; 3,939,350; 3,996,345; 4,277,437; 4,275,149; and 4,366,241.

In some embodiments, fluorescent labels are used. The nucleic acid molecules can all be labeled with a single label, e.g., a single fluorescent label. Alternatively, different nucleic acid molecules have different labels. For example, one nucleic acid molecule can have a green fluorescent label and a second nucleic acid molecule can have a red fluorescent label.

Suitable chromogens which can be employed include those molecules and compounds that absorb light in a distinctive range of wavelengths so that a color can be observed or, alternatively, which emit light when irradiated with radiation of a particular wave length or wave length range, e.g., fluorescers.

A wide variety of suitable dyes are available, being primary chosen to provide an intense color with minimal absorption by their surroundings. Illustrative dye types include quinoline dyes, triarylmethane dyes, acridine dyes, alizarine dyes, phthaleins, insect dyes, azo dyes, anthraquinoid dyes, cyanine dyes, phenazathionium dyes, and phenazoxonium dyes.

A wide variety of fluorescers can be employed either by alone or, alternatively, in conjunction with quencher molecules. Fluorescers of interest fall into a variety of categories having certain primary functionalities. These primary functionalities include 1- and 2-aminonaphthalene, p,p′-diaminostilbenes, pyrenes, quaternary phenanthridine salts, 9-aminoacridines, p,p′-diaminobenzophenone imines, anthracenes. oxacarbocyanine, marocyanine, 3-aminoequilenin, perylene, bisbenzoxazole, bis-p-oxazolyl benzene, 1,2-benzophenazin, retinol, bis-3-aminopyridinium salts, hellebrigenin, tetracycline, sterophenol, benzimidzaolylphenylamine, 2-oxo-3-chromen, indole, xanthen, 7-hydroxycoumarin, phenoxazine, salicylate, strophanthidin, porphyrins, triarylmethanes and flavin. Individual fluorescent compounds that have functionalities for linking or that can be modified to incorporate such functionalities include, e.g., dansyl chloride; fluoresceins such as 3,6-dihydroxy-9-phenylxanthhydrol; rhodamineisothiocyanate; N-phenyl 1-amino-8-sulfonatonaphthalene; N-phenyl 2-amino-6-sulfonatonaphthalene: 4-acetamido-4-isothiocyanato-stilbene-2,2′-disulfonic acid; pyrene-3-sulfonic acid; 2-toluidinonaphthalene-6-sulfonate; N-phenyl, N-methyl 2-aminoaphthalene-6-sulfonate; ethidium bromide; stebrine; auromine-0,2-(9′-anthroyl)palmitate; dansyl phosphatidylethanolamine; N,N′-dioctadecyl oxacarbocyanine; N,N′-dihexyl oxacarbocyanine; merocyanine, 4(3′pyrenyl)butyrate; d-3-aminodesoxy-equilenin; 12-(9′anthroyl)stearate; 2-methylanthracene; 9-vinylanthracene; 2,2′(vinylene-p-phenylene)bisbenzoxazole; p-bis[2-(4-methyl-5-phenyl-oxazolyl)]benzene; 6-dimethylamino-1,2-benzophenazin; retinol; bis(3′-aminopyridinium) 1,10-decandiyl diiodide; sulfonaphthylhydrazone of hellibrienin; chlorotetracycline; N(7-dimethylamino-4-methyl-2-oxo-3-chromenyl)maleimide; N-[p-(2-benzimidazolyl)-phenyl]maleimide; N-(4-fluoranthyl)maleimide; bis(homovanillic acid); resazarin; 4-chloro-7-nitro-2,1,3-benzooxadiazole; merocyanine 540; resorufin; rose bengal; and 2,4-diphenyl-3 (2H)-furanone.

The label may be a “direct label”, i.e., a detectable label that is directly attached to or incorporated into the nucleic acid molecule. Alternatively, the label may be an “indirect label”, i.e., a label joined to the nucleic acid molecule after attachment to the substrate. The indirect label can be attached to a binding moiety that has been attached to the nucleic acid molecule prior to attachment to the substrate. For a detailed review of methods of labeling nucleic acids and detecting labeled hybridized nucleic acids see Laboratory Techniques in Biochemistry and Molecular Biology, Vol. 24: Hybridization With Nucleic Acid Probes, P. Tijssen, ed. Elsevier, N.Y., (1993)).

Polypeptides can be visualized by coupling them to, e.g., fluorescent labels described herein, using known methods. Alternatively, other labels, such as Quantum dots (Invitrogen) can be used, as described herein.

### Detecting Nucleic Acid Molecules and Polypeptides

As discussed above, the use of a fluorescent label is an embodiment of the invention. Standard procedures are used to determine the positions of the nucleic acid molecules and/or a target, e.g., a second nucleic acid molecule or a polypeptide. For example, the position of a nucleic acid molecule on an array described herein can be detected by the signal emitted by the label. In other examples, when a nucleic acid molecule on the array and a target nucleic acid molecule or polypeptide are labeled, the locations of both the nucleic acid molecules on the array and the target will exhibit significant signal. In addition to using a label, other methods may be used to scan the matrix to determine where an interaction, e.g., between a nucleic acid molecule on an array described herein and a target, takes place. The spectrum of interactions can, of course, be determined in a temporal manner by repeated scans of interactions that occur at each of a multiplicity of conditions. However, instead of testing each individual interaction separately, a multiplicity of interactions can be simultaneously determined on an array, e.g., an array described herein.

In certain embodiments, the array is excited with a light source at the excitation wavelength of the particular fluorescent label and the resulting fluorescence at the emission wavelength is detected. In certain embodiments, the excitation light source is a laser appropriate for the excitation of the fluorescent label.

Detection of the fluorescence signal can utilize a microscope, e.g., a fluorescent microscope. The microscope may be equipped with a phototransducer (e.g., a photomultiplier, a solid state array, or a ccd camera) attached to an automated data acquisition system to automatically record the fluorescence signal produced by the nucleic acid molecules and/or targets on the array. Such automated systems are known in the art. Use of laser illumination in conjunction with automated confocal microscopy for signal detection permits detection at a resolution of better than about 100 μm, better than about 50 μm, and better than about 25 μm.

The detection method can also incorporate some signal processing to determine whether the signal at a particular position on the array is a true positive or may be a spurious signal. For example, a signal from a region that has actual positive signal may tend to spread over and provide a positive signal in an adjacent region that actually should not have one. This may occur, e.g., where the scanning system is not properly discriminating with sufficiently high resolution in its pixel density to separate the two regions. Thus, the signal over the spatial region may be evaluated pixel by pixel to determine the locations and the actual extent of positive signal. A true positive signal should, in theory, show a uniform signal at each pixel location. Thus, processing by plotting number of pixels with actual signal intensity should have a clearly uniform signal intensity. Regions where the signal intensities show a fairly wide dispersion, may be particularly suspect and the scanning system may be programmed to more carefully scan those positions.

### Total Internal Reflection Fluorescence Microscopy

Total internal reflection fluorescence microscopy (TIRFM) is used to detect the nucleic acid molecules and polypeptides described herein. For TIRFM, a laser beam is directed through a microscope slide and reflected off the interface between the slide and a buffer containing the fluorescent sample. If the angle of incidence is greater than the critical angle [θ_{c}=sin⁻¹(n₂/n₁); where n1 and n2 are the refractive indexes of the slide and aqueous samples, respectively], then all of the incident light is reflected away from the interface. However, an illuminated area is present on the sample side of the slide. This is called the evanescent wave, and its intensity decays exponentially away from the surface [N2, N3]. For most applications the evanescent wave penetrates approximately 100 nm into the aqueous medium. This geometry reduces the background signal by several orders of magnitude compared to conventional fluorescence microscopy and readily allows the detection of single fluorescent molecules, because contaminants and bulk molecules in solution are not illuminated and do not contribute to the detected signal. [N3]. By using total internal reflection fluorescence microscopy to visualize the arrays described herein, it is possible to simultaneously monitor hundreds of aligned DNA molecules within a single field-of-view.

The methods described herein use microfluidic flowcells composed of substrates that are rendered inert by deposition of a lipid bilayer as described herein. By applying a hydrodynamic force to the arrays described herein, the attached nucleic acid molecules are aligned in a desired orientation that is optimal for detection by, e.g., TIRFM.

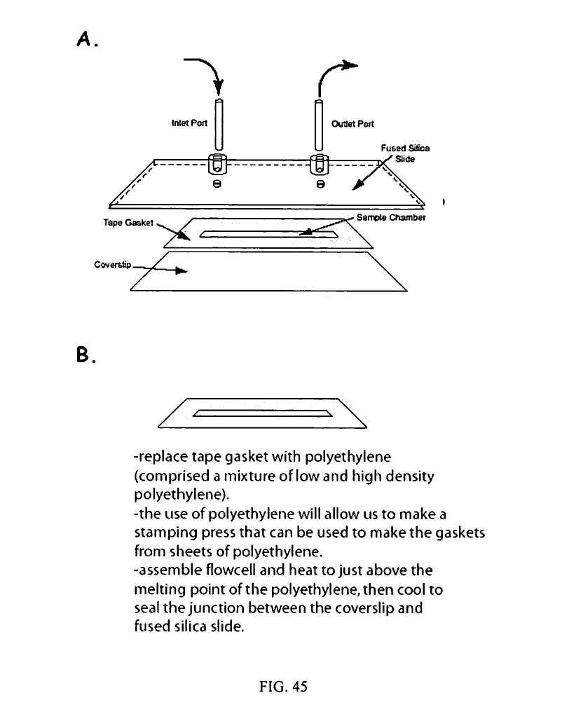

A microfluidic flowcell that can be used in the methods described herein is depicted in FIG. 45A. Generally, a substrate described herein is overlaid with a coverslip, e.g., a glass coverslip, to form a sample chamber, and the substrate contains an inlet port and an outlet port, through which a hydrodynamic force is applied. The hydrodynamic force can be mediated by, e.g., a buffer solution that flows over the lipid bilayer described herein. An exemplary microfluidic flowcell can be constructed from 76.2×25.4×1 mm (L×W×H) fused silica slides (ESCO Products, Oak Ridge, N.J.). Inlet and outlet holes can be drilled through the slides using, e.g., a diamond-coated bit (1.4 mm O.D.; Eurotool, Grandview, Mo.). A sample chamber can be prepared from a borosilicate glass coverslip (Fisher Scientific, USA) and, e.g., double-sided tape (˜25 μm thick, 3M, USA) or a polyethylene gasket. Inlet and outlet ports can be attached using preformed adhesive rings (Upchurch Scientific, Oak Harbor, Wash.), and cured at 120° C. under vacuum for 2 hours. The dimensions of the exemplary sample chamber are 3.5×0.45×0.0025 cm (L×W×H). The total volume of the exemplary flowcell is ˜4 μl. A syringe pump (Kd Scientific, Holliston, Mass.) is used to control buffer delivery to the sample chamber. This exemplary apparatus is not meant to be limiting, and one of skill in the art would appreciate modifications that could be made.

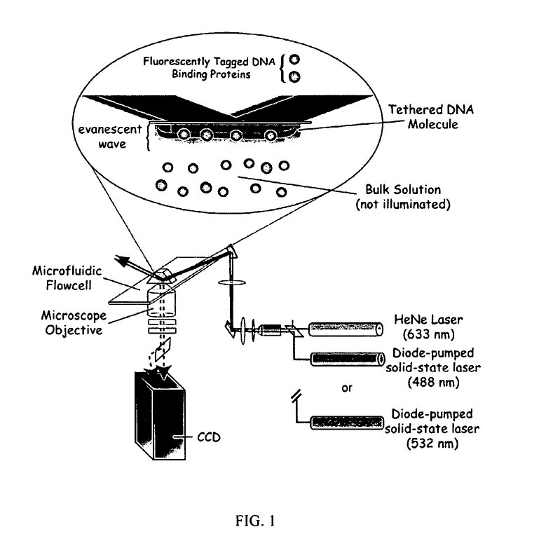

A total internal reflection fluorescence microscope is depicted in FIG. 1. An exemplary microscope is a modified Nikon TE2000U inverted microscope. [N10] A 488 nm laser (Coherent Inc., Santa Clara, Calif.) and a 532 nm laser (CrystaLaser, Reno, Nev.) were focused through a pinhole (10 μm) using an achromatic objective lens (25×; Melles Griot, Marlow Heights, Md.), then collimated with another achromatic lens (f=200 mm). The beam was directed to a focusing lens (f=500 mm) and passed through a custom-made fused silica prism (J.R. Cumberland, Inc) placed on top of the flowcell. Fluorescence images were collected through an objective lens (100× Plan Apo, NA 1.4, Nikon), passed through a notch filter (Semrock, Rochester, N.Y.), and captured with a back-thinned EMCCD (Cascade 512B, Photometrics, Tucson, Ariz.). Image acquisition and data analysis were performed with Metamorph software (Universal Imaging Corp., Downington, Pa.). All DNA length measurements were performed by calculating the difference in y-coordinates from the beginning to the end of the fluorescent molecules. Diffusion estimates for the lipid-tethered DNA substrates were performed by manually tracking the tethered ends of four different molecules, and diffusion coefficients were calculated using: D=MSD/4t; where MSD (the mean square displacement) is the square of the average step size measured over time interval t (0.124 sec) [N18].

### Methods for Visualizing Nucleic Acid Molecules and Polypeptides

The arrays described herein can be used to detect individual nucleic acid molecules, e.g., nucleic acid molecules coupled to a label. For example, an array can be constructed as part of a microfluidic flowcell described herein. The nucleic acid molecules, e.g., labeled nucleic acid molecules, can be attached to a substrate, to a lipid bilayer, or to a diffusion barrier, as described herein. Upon the application of hydrodynamic force, e.g., introduction of a buffer as described herein, the nucleic acid molecules are aligned in direction of the hydrodynamic force, with the nonattached ends of the nucleic acid molecules extending in the direction of the flow of the hydrodynamic force. Individual nucleic acid molecules on the array can be visualized before and/or after the application of the hydrodynamic force using, e.g., TIRFM as described herein.

In some embodiments, the interactions of nucleic acid molecules on the arrays with target polypeptides are determined. The nucleic acid molecules can be visualized before and/or after the application of a hydrodynamic force, as described herein. To visualize the interactions with target polypeptides, the polypeptides can be coupled to a label and introduced into the array, e.g., a microfluidic cell including the array, as a component of the buffer that mediates the hydrodynamic force. Individual nucleic acid molecules and individual target polypeptides can be visualized, e.g., by TIRFM as described herein, and interactions can be determined by colocalization of the signals from the nucleic acid molecules and the polypeptides. Such interactions can be further analyzed by collecting signals over a period of time. Such methods can be used to visualize, e.g., the movement of polypeptides along the length of individual nucleic acid molecules, as described herein.

### Methods for High-Throughput Screening of Compounds

The methods and compositions described herein can be used to screen for compounds, e.g., drug compounds, that affect, e.g., disrupt, the interactions between nucleic acid molecules and polypeptides. For example, an array can be constructed as part of a microfluidic flowcell described herein. The nucleic acid molecules, e.g., labeled nucleic acid molecules, can be attached to a substrate, to a lipid bilayer, or to a diffusion barrier, as described herein. To visualize the interactions with target polypeptides, the polypeptides can be coupled to a label and introduced into the array, e.g., a microfluidic cell including the array, as a component of the buffer that mediates the hydrodynamic force. In some embodiments, the polypeptides are known to interact with the nucleic acid molecules, and the interactions are visualized as described herein. For example, the polypeptides can be proteins involved in DNA replication, recombination and/or repair. Candidate compounds can then be added to the array, e.g., as a component of the buffer that mediates the hydrodynamic force, and the effect of the compound on the interactions between individual nucleic acid molecules and the polypeptides can be visualized. Compounds that disrupt the interactions can be visually identified. Such methods can be automated.

For example, the methods described herein can be used to screen for therapeutic compounds to treat cancer, e.g., cancer of the breast, prostate, lung, bronchus, colon, rectum, urinary bladder, kidney, pancreas, oral cavity, pharynx, ovary, skin, thyroid, stomach, brain, esophagus, liver, cervix, larynx, soft tissue, testis, small intestine, anus, anal canal, anorectum, vulva, ballbladder, bones, joints, hypopharynx, eye, nose, nasal cavity, ureter, gastrointestinal tract; non-Hodgkin lymphoma, Multiple Myeloma, Acute Myeloid Leukemia, Chronic Lymphocytic Leukemia, Hodgkin Lymphoma, Chronic Myeloid Leukemia and Acute Lymphocytic Leukemia.

### Methods for High-Throughput Sequencing of Nucleic Acid Molecules

The methods and compositions described herein can be used to sequence nucleic acid molecules. The arrays described herein can be constructed with identical nucleic acid molecules, e.g., single stranded DNA molecules, or with different nucleic acid molecules, e.g., single stranded DNA molecules. Before attaching the DNA molecules to the substrate, an oligonucleotide primer is annealed to the DNA molecules. Polymerase is then added along with the fluorescent dNTP mix. Such methods are known in the art. Fluorescent nucleotide analogs that do not terminate extension of the DNA strand are used. The DNA molecules are then attached to the substrate and the array is visualized as described herein. The color of the nucleotide incorporated into the growing chain reveals the sequence of the DNA molecules. If all of the DNA molecules within the array are identical, then the incorporation of the first nucleotide during polymerization will yield a fluorescent line extending horizontally across the array. Subsequent nucleotide addition will also yield horizontal lines and the color of each line will correspond the DNA sequence. When sequencing different DNA molecules, the differences in DNA sequences are revealed as the incorporation of different fluorescent nucleotides across the array, rather than the lines of identical color seen when sequencing identical DNA molecules. In some embodiments, these methods are automated.

### EXAMPLE 1

### Generation of Arrays and Visualization of Nucleic Acid Molecules

We have developed methods for immobilizing biotinylated λ-DNA substrates on surfaces that have been rendered inert through the deposition of a supported lipid bilayer. These techniques are widely applicable to single-molecule experiments designed to investigate many fundamental aspects of protein and nucleic acid biochemistry, and were specifically developed to be compatible with a broad range of biological systems. The first methods involve applying a very sparse coating of neutravidin (biotin-binding protein) onto the surface of a fused silica sample chamber, followed by assembly of the lipid bilayer. The bilayer surrounds the isolated molecules of neutravidin, which provide solid anchor points for biotinylated DNA, and the DNA molecules can then be anchored by either one or both extremities. The second method uses DNA substrates that are attached directly to single lipids within a fluid bilayer. We demonstrate that hydrodynamic force can be used to organize these mobile DNA molecules into arrays whose patterns are defined by the positions of user-applied micro-scale mechanical barriers to lipid diffusion. The ability to define ordered arrays of individual DNA molecules on an inert sample chamber surface will provide a powerful tool for single-molecule biochemical and biophysical experiments by allowing simultaneous detection of hundreds of physically aligned DNA molecules in a single TIRFM experiment.

### Materials and Methods

DNA. Biotinylated oligonucleotides were annealed to the 12-nucleotide overhang at either the right, left, or both ends of bacteriophage λ-DNA (48,502 bp; New England Biolabs, Ipswich, Mass.). The sequences of the oligonucleotides were as follows: 5′-pAGGTCGCCGCCC-TEG-Biotin (right end; SEQ ID NO: 1) and 5′-pGGGCGGCGACCT-TEG-Biotin (left end; SEQ ID NO: 2) (Operon, Huntsville, Ala.). The λ-DNA and the oligonucleotide were mixed at a molar ratio of 1:10, heated to 80° C., and slowly cooled to room temperature (RT). DNA ligase (New England Biolabs, Ipswich, Mass.) was then added, and the reactions were incubated at RT for 2 hours. For the DNA substrates that were biotinylated at both ends, an additional round of annealing and ligation was performed using a 50-fold molar excess of the second oligonucleotide. After the reactions were complete, the DNA ligase was inactivated by heating to 65° C. for 10 minutes, excess oligonucleotide was removed using a Sephacryl S-200 HR column (Amersham Biosciences, Uppsala, Sweden), and the purified DNA was stored at −20° C. in 150 mM NaCl, 10 mM Tris, pH 7.5 and 1 mM EDTA. Prior to use, the DNA was stained with YOYO-1 ((1,1′-(4,4,7,7-tetramethyl-4,7-diazaundecamethylene)-bis-4-[3-methyl-2,3-dihydro-(benzo-1,3-oxazole)-2-methyldene]-quinolinium tetraiodide; Molecular Probes, Eugene, Oreg.) at RT for 1 hour at dye/bp ratio of 1/100.

Flowcells. Microfluidic flowcells were constructed from 76.2×25.4×1 mm (L×W×H) fused silica slides (ESCO Products, Oak Ridge, N.J.). Inlet and outlet holes were drilled through the slides using a diamond-coated bit (1.4 mm O.D.; Eurotool, Grandview, Mo.). The slides were immersed in a 2% (v/v) Hellmanex solution (Hellma, Germany) for 30 minutes, thoroughly rinsed with Milli-Q H₂O, and dried in a vacuum oven for a minimum of 1 hour. A sample chamber was prepared from a borosilicate glass coverslip (Fisher Scientific, USA) and double-sided tape (˜25 μm thick, 3M, USA). Inlet and outlet ports were attached using preformed adhesive rings (Upchurch Scientific, Oak Harbor, Wash.), and cured at 120° C. under vacuum for 2 hours. The dimensions of the sample chambers were 3.5×0.45×0.0025 cm (L×W×H). The total volume of the flowcells was ˜4 μl. A syringe pump (Kd Scientific, Holliston, Mass.) was used to control buffer delivery to the sample chambers, as previously described^{L17}.

Lipids and Bilayers. Lipids were stored in chloroform at −20° C. The chloroform was evaporated prior to liposome preparation using a stream of nitrogen and dried further under vacuum onto the glass wall of a test tube for 2-12 hrs. Lipids were resuspended in buffer A, which contained 100 mM NaCl, 10 mM Tris (pH 8.0), at a concentration of 10 mg/ml, and extruded through a polycarbonate filter with 100 nm pores (Avanti Polar Lipids, Alabaster, Ala.). The resulting liposomes were stored at 4° C. under nitrogen and used within one week of preparation. Liposomes were prepared from either 1,2-dioleoyl-sn-glycero-3-phosphocholine (DOPC) or 0.5% biotin-phosphatidylethanolamine (biotin-PE) plus 99.5% DOPC (Avanti Polar Lipids, Alabaster, Ala.). Neutravidin (33 nM, Pierce Biotechnologies, Inc., Rockford, Ill.) was applied to the microfluidic sample chamber surface and incubated for 15 min, before rinsing with an additional 3 ml of buffer. DOPC liposomes (0.4 mg/ml) were then injected into the sample chamber and incubated for ≧1 hour, during which time the bilayer formed around the immobilized neutravidin. Excess liposomes were then removed by rinsing with buffer.

Diffusion Barriers. For experiments using diffusion barriers, the fused silica slides were mechanically etched using a diamond-tipped scribe (Eurotool, Grandview, Mo.) prior to assembly of the flowcell. DOPC liposomes (0.4 mg/ml) containing 0.5% biotinylated lipids were applied to the sample chamber surface for at least 1 hr. Excess liposomes were rinsed away using a buffer A, and the bilayer was incubated for an additional 1 hr. Buffer containing 40 mM Tris (pH 7.8), 1 mM DTT, 1 mM MgCl₂ and 0.2 mg/ml BSA (buffer B) was added to the flowcell and incubated for 30 minutes. Neutravidin (330 nM) suspended in buffer B was added to the flowcell and incubated for an additional 30 minutes. After rinsing, the biotinylated λ-DNA (16 μM) was added in buffer B and incubated for 30 minutes. Ascorbic acid (10 mM) was added to buffer B in the TIRFM experiments as an oxygen scavenger to minimize photo-damage of the DNA during illumination. All experiments were carried out at room temperature.

TIRFM. An overview of a Total Internal Reflection Fluorescence Microscope (TIRFM) is shown in FIG. 1. The TIRF microscope was a custom-design system built around a Nikon TE2000U inverted microscope^{L10}. A 488 nm laser (Coherent Inc., Santa Clara, Calif.) and a 532 nm laser (CrystaLaser, Reno, Nev.) were focused through a pinhole (10 μ□m) using an achromatic objective lens (25□×; Melles Griot, Marlow Heights, Md.), then collimated with another achromatic lens (f□=200 mm). The beam was directed to a focusing lens (f=500 mm) and passed through a custom-made fused silica prism (J.R. Cumberland, Inc) placed on top of the flowcell. Fluorescence images were collected through an objective lens (100□□× Plan Apo, NA 1.4, Nikon), passed through a notch filter (Semrock, Rochester, N.Y.), and captured with a back-thinned EMCCD (Cascade 512B, Photometrics, Tucson, Ariz.). Image acquisition and data analysis were performed with Metamorph software (Universal Imaging Corp., Downington, Pa.). All DNA length measurements were performed by calculating the difference in y-coordinates from the beginning to the end of the fluorescent molecules. Diffusion estimates for the lipid-tethered DNA substrates were performed by manually tracking the tethered ends of four different molecules, and diffusion coefficients were calculated using: D=MSD/4t; where MSD (the mean square displacement) is the square of the average step size measured over time interval t (0.124 sec)^{L18}.

FRAP. Fluorescence recovery after photobleaching (FRAP) measurements were performed to monitor the assembly and fluidity of the lipid bilayers. For FRAP, the bilayers were labeled with 0.05% (N-(6-tetramethylrhodaminethiocarbamoyl)-1,2-dihexadecanoyl-sn-glycero-3-phospho-ethanolamine (TRITC-DHPE; Molecular Probes, Eugene, Oreg.). The FRAP measurements were performed by bleaching the lipids with a 532 nm laser at a power of ˜9.0 mW (measured at the face of the prism) for 5 min. Bilayer fluidity was monitored by imaging the bleached region at 1-minute intervals for a total of 15 min. The average fluorescence intensity of an area of 522 μm² (151×135 pixels) located in the center of the evanescent field was then plotted as a function of time.

### Results and Discussion

Single-molecule studies using TIRFM require “bio-friendly” surfaces that prevent non-specific adsorption yet provide defined anchor positions for the molecules under investigation. Even a very small amount of nonspecific adsorption can prevent observation of individual biochemical reactions, and/or can perturb the biochemical behaviors of the molecules on the surface. Lipid bilayers offer a potential solution to this problem by presenting biological macromolecules with a microenvironment closely mimicking the interior of a cell^{L12}. However, fluid bilayers also present several complications for use in some types of experiments. For example, bacteriophage λ-DNA (48 kb, ˜16 μm) is often used in single-molecule studies of DNA dynamics and protein-nucleic acid interactions^{L4,L10,L19}. However, to visualize all points along the contour length of this relatively long DNA by TIRFM, it is necessary to confine the molecules near the surface, within the detection volume defined by the penetration depth of the evanescent field. One elegant solution to this problem is to tether polystyrene beads to the extremities of the DNA, use a dual-trap optical tweezer to capture each bead, and then suspend the captured DNA molecule above a rectangular pedestal on the surface^{L20}. Another, much simpler solution is to attach one end of the DNA substrates to a surface and use hydrodynamic force to keep tethered molecules extended parallel to the x-y plane of the sample chamber and confined within the evanescent field^{L10}. This approach offers the advantage of allowing simultaneous observation of multiple DNA molecules in a single experiment. In the absence of an externally applied force, DNA molecules that are tethered by only one end are not visible because an increase in their conformational entropy causes them to relax and diffuse out of the evanescent field^{L17}. When buffer flow is applied, the DNA molecules experience a decrease in conformational entropy and become extended parallel to the surface where they can be observed by TIRFM^{L10,L17}. The use of hydrodynamic force to extend the DNA requires that the molecule be anchored to a solid support. If the DNA substrates were tethered directly to a fluid bilayer, then the application of hydrodynamic force is expected to result in lateral displacement of the tethered λ-DNA, in which case they would move rapidly across the field-of-view. Therefore, to take advantage of the potential benefits of lipid bilayers in applications with large DNA substrates, methods must be developed for anchoring DNA molecules to the sample chamber surface under conditions that would prevent lateral movement of the tethered DNAs.

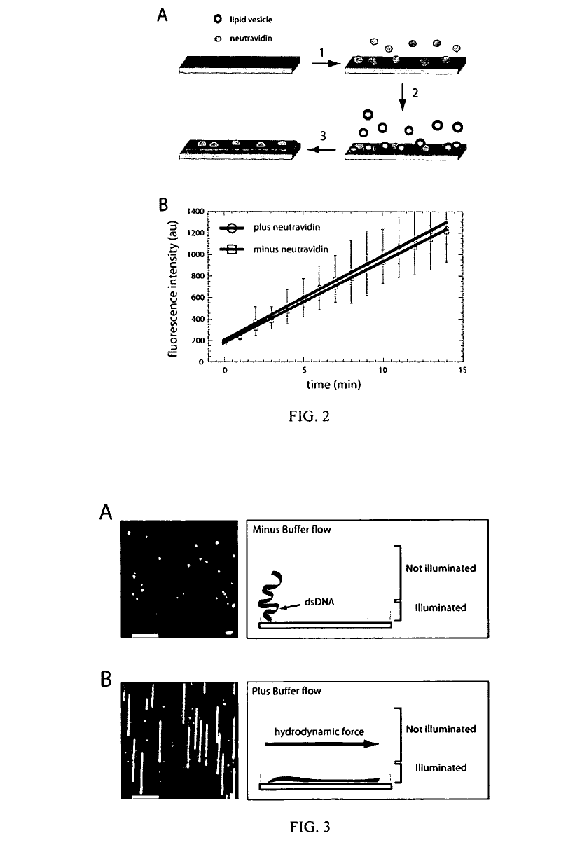

FIG. 2A outlines the strategy that allows DNA molecules to be immobilized on surfaces coated with a lipid bilayer. First, a very dilute solution of neutravidin (40 nM) was applied to the surface of a microfluidic sample chamber. Neutravidin is a tetravalent biotin-binding protein, and has been shown to adsorb to bare fused silica surfaces while retaining biotin-binding capability^{L10}. After a brief incubation, the unbound neutravidin was rinsed from the sample chamber and replaced with a solution of DOPC-liposomes (0.4 mg/ml). The liposomes spontaneously ruptured on the fused silica surface, filling in exposed regions between the isolated molecules of neutravidin. Bovine serum albumin (BSA) was then used to block any small regions of the surface that might have remained exposed after deposition of the bilayer^{L21}. The assembly and fluidity of these bilayers were monitored in a separate experiment using fluorescent TRITC-DHPE (0.05%) and fluorescence recovery after photobleaching (FRAP). These experiments showed that the adsorbed neutravidin did not hamper bilayer formation and that the lipids within the bilayer retained their normal fluidity (FIG. 2B).

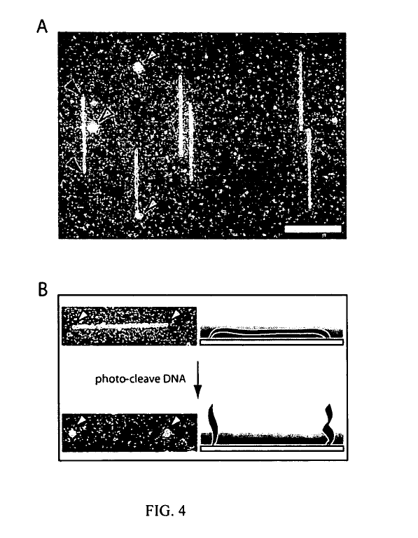

Biotinylated λ-DNA was then injected into the sample chamber, incubated for a brief period to allow binding to the surface, and the unbound molecules were flushed away. The YOYO1-stained λ-DNA was visualized with TIRFM, and as expected, the application of buffer flow was required to extend the DNA parallel to the surface (FIGS. 3A and 3B, left panel). When buffer flow was terminated, the DNA molecules diffused out of the evanescent field (although their tethered ends remained linked to the surface), at which point they could no longer be visualized along their contour lengths (FIG. 3A, top panels). Several lines of evidence indicated that the DNA molecules were tethered via a specific interaction with the immobilized neutravidin, and that they did not adhere nonspecifically to the surrounding lipid bilayer. If neutravidin was omitted or if the DNA was not biotinylated, then the molecules did not attach to the sample chamber surface; reiterative cycles of alternating hydrodynamic force could be used to repeatedly extend and relax the tethered DNA molecules; and the tethered DNA molecules remained on the surface for hours without moving away from their original locations. Taken together, these data demonstrate that the DNA molecules were tethered to the surface in the desired configuration.

As indicated above, continuous buffer flow was required to maintain the DNA molecules in an extended configuration that allowed observation along their entire contour lengths by TIRFM. If flow was terminated the molecules diffused out of the evanescent field, yet remained linked to the surface via the biotin-neutravidin interaction. One implication of this is that with experiments designed to probe protein-nucleic acid interactions, the proteins would also be subject to the hydrodynamic force required to extend the DNA molecules. In some instances, application of force may perturb the biochemical properties of the system under investigation, and could possibly lead to erroneous interpretations of the observed single-molecule behavior. An example of this would be the 1D-diffusion mechanism used by some site-specific DNA binding proteins to locate their targets; in this case, the application of a hydrodynamic force is expected to cause the proteins to move preferentially in the direction of buffer flow. Therefore, it was desirable to develop a method that allowed the molecules to be tethered by both extremities, such that the DNA remained confined within the evanescent field and suspended above the inert lipid bilayer even in the absence of flow force.

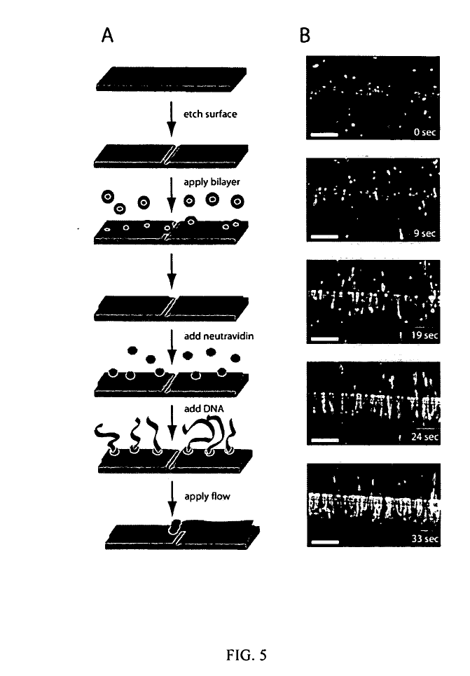

Previous techniques that have been used to tether extended DNA molecules to a surface include molecular combining^{L22,L23} and pH-dependent attachment of DNA extremities to a silica surface^{L24}. Molecular combining does confine the DNA molecules near a surface, however the molecules are extended by up to 50% relative to B-form DNA; they are also attached by multiple points along their contour length^{L22,L23,L25}. Either of these effects can be expected to alter the behaviors of proteins that interact with the DNA. With both afore mentioned methods, the DNA molecules are suspended above a highly hydrophobic surface, which is unlikely to be compatible with many DNA-binding proteins. To solve this problem, we developed a new method for tethering the λ-DNA substrates by both ends, in an extended configuration parallel to the sample chamber surface and suspended above the inert lipid bilayer. This strategy confines the molecules within the detection volume defined by the evanescent field and allows continual observation over their entire contour lengths. First, λ-DNA molecules biotinylated at either end were applied to a sample chamber surface containing immobilized molecules of neutravidin surrounded by a fluid lipid bilayer (as described above). Buffer flow was maintained during sample application such that when one biotinylated end of the DNA bound to the surface, the molecule was immediately extended to its full contour length by hydrodynamic force, whereupon the second end of the DNA could bind to the surface. As shown in FIG. 4A, this procedure yielded DNA molecules that remained extended parallel to the surface, even in the absence of flow force, and the majority of the molecules were aligned in the direction of the flow with which they were applied. The distance between the tethered ends appeared fairly uniform, and the molecules displayed a mean length [symbol] of 12.8±3.1 μm (n=52); yielding a relative mean extension [symbol] of ˜0.8 (where L is the total length of the DNA and taken to be 16 μm). Based on the worm-like chain model describing DNA polymer dynamics, this degree of extension corresponds to a tension of approximately 0.5 piconewtons (pN; see below)^{L24,L26,L27}.

Close inspection of real time videos showed that although the DNA ends were immobilized on the surface, the molecules themselves were subject to Brownian motion. This was revealed as entropically-driven transverse fluctuations of the DNA parallel to the x-y plane of the surface. Additionally, fluctuations in the z-direction, perpendicular to the surface, were apparent as changes in fluorescence signal intensity as the molecules vibrated within the exponentially decaying evanescent field. These observations are consistent with previous work, which has shown that the main features of their dynamic properties are not altered when DNA molecules were tethered by both ends to a solid support^{L24}, and also suggested that the molecules were only linked to the surface via their extremities. To further confirm that the DNA was in the desired configuration, the YOYO1-stained molecules were intentionally photo-cleaved by application of a high photon-flux in the absence of buffer flow (FIG. 4B). Cleavage of the DNA molecules in the absence of flow was expected to relieve the tension required to maintain them in an extended configuration, allowing the untethered portions of the molecules to diffuse away from the surface and only the biotinylated ends of the molecules would remain within the evanescent field. As predicted, when the molecules were cleaved, the two halves of the DNA rapidly diffused out of the evanescent field, leaving only the ends of the molecule visible (FIG. 4B). This verified that the DNA molecules were anchored only via their biotinylated extremities, and further demonstrated that there were no nonspecific interactions between the DNA and the lipid bilayer.

The methods described above utilized DNA molecules that were anchored to fixed attachment points embedded within the bilayer rather then being linked directly to the mobile lipids. This strategy was necessary to prevent the lateral movement of the DNA when buffer flow was applied to the sample chamber and allowed continuous observation of the same molecules over long periods of time. The importance of anchoring the DNA was further illustrated by preparing a surface in which the DNA molecules were linked to individual lipids within the bilayer. As expected, when flow was applied, the lipid-tethered DNA molecules moved rapidly across the field-of-view in the direction of the hydrodynamic force. FRAP measurements using DOPC bilayers containing 0.05% TRITC-DHPE indicated that the bilayer itself was not influenced by the application of buffer flow. This was expected because the shear flow rate decreases linearly towards the surface (i.e., the laminar flow boundary), therefore lipids within the bilayer should experience little net force, even at high flow velocities. This indicated that the lipids tethered to the ends of the DNA molecules were being dragged through the bilayer due to the force exerted on the attached DNA molecules, but that the bilayer itself was unperturbed.

Interestingly, previous studies have demonstrated that the diffusion of lipids can be restricted by the placement of various chemical or physical barriers on the surface underlying the supported bilayer^{L28,L29}. Therefore, as an alternative strategy for preventing the lateral displacement of the tethered DNA substrates, physical barriers to lipid diffusion to halt the movement of the molecules were used. If the DNA molecules were linked directly to a single lipid within the bilayer, then the application of a hydrodynamic force can be used to organize the tethered DNA molecules along the leading edge of diffusion barriers oriented perpendicular to the direction of buffer flow. Furthermore, this would allow the DNA molecules to be assembled into parallel arrays, the patterns of which would be defined by the design of the diffusion barriers.

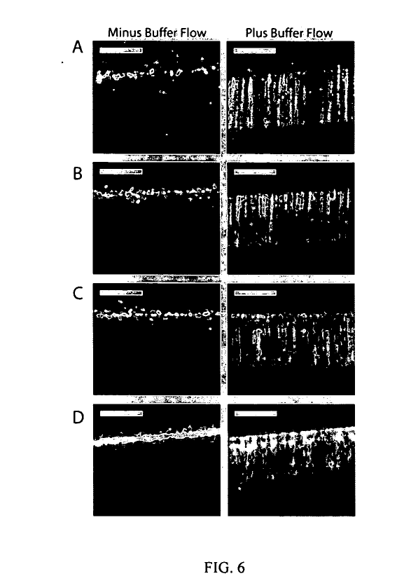

FIG. 5A illustrates the strategy used to assemble parallel arrays of DNA molecules using micro-scale mechanical barriers to lipid diffusion. First, the surface of a fused silica slide was mechanically etched using a diamond-tipped scribe, as previously described^{L29,L31}. In this case, the etched barriers were approximately 10 μm wide and were placed at ˜1 mm intervals along the surface of the sample chamber. These etched slides were used to prepare a flowcell, and DOPC liposomes containing 0.5% biotin-PE were then injected into the sample chamber (as described above). After deposition of the bilayer, excess liposomes were removed from the sample chamber by rinsing thoroughly with buffer, and the surface was further blocked by the addition of buffer containing BSA (0.2 mg/ml). Neutravidin (0.4 μM) was then added, and after a short incubation the sample chamber was rinsed with additional buffer to remove unbound protein. Biotinylated λ-DNA was then injected into the sample chamber and allowed a short period to bind the tetravalent neutravidin linked to the lipid head groups. Finally, buffer flow was applied to remove any unbound molecules and to organize the tethered DNA along the diffusion barriers.

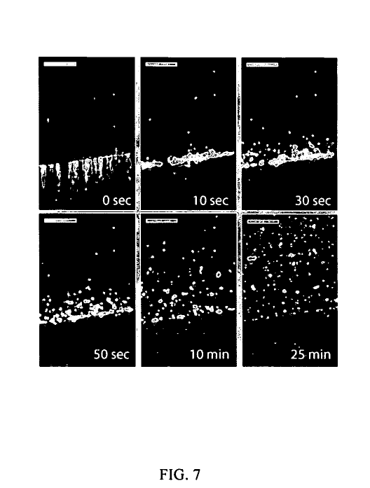

When flow was applied the DNA molecules moved in the direction of the hydrodynamic force and accumulated at the edges of the diffusion barriers. FIG. 5B illustrates the time-dependent accumulation of DNA molecules at the leading edge of a mechanical barrier. At the outset of the experiment, no buffer was flowing through the sample chamber and only the tethered ends of the molecules were visible. Buffer flow was then applied and a series of images were collected at the indicated intervals. When the DNA was tethered to the bilayer, application of buffer flow caused the molecules to align along the barrier, resulting in the assembly of a parallel DNA array. Importantly, the density of DNA molecules within the array could be easily controlled by either varying the lateral spacing between the individual diffusion barriers, or by applying different amounts of DNA to the surface (FIG. 6). This allowed control over the number of molecules within the array as well as the spatial resolution between the adjacent DNAs within the field-of-view.

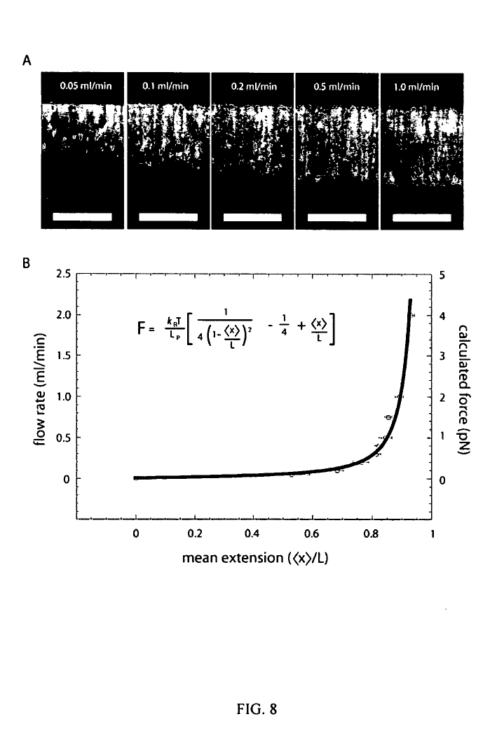

To determine if the DNA molecules aligned at the edge of a barrier were still free to move within the bilayer, an aligned array was assembled as described above, buffer flow was then terminated, and images collected at the indicated intervals. As shown in FIG. 7, in the absence of flow the molecules quickly diffused out of the evanescent field due to the increase in their conformational entropy, and although their tethered ends remained visible the molecules could no longer be examined along their contour lengths. This verified that the DNA molecules were only linked to the surface via the single biotin-neutravidin interaction. Over time, the DNA molecules began to move away from the edge of the barrier, and eventually became evenly distributed on the sample chamber surface. These molecules displayed a diffusion coefficient of 0.38±0.13 μm²/sec, which, as expected, was somewhat lower than the ˜1 μm²/sec diffusion coefficient reported for lipids within supported bilayers. Reapplication of flow force could be used to push the molecules back to the diffusion barrier. This confirmed that no part of the DNA irreversibly adhered to the surface, and that the behavior of the individual lipids and the fluidity of the lipid bilayer were not interrupted at the edge of the mechanical barriers.

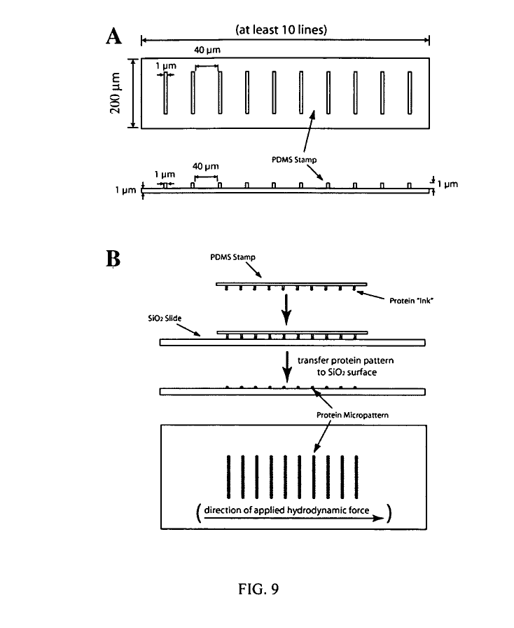

For the DNA arrays, buffer flow was required to both organize the DNA molecules along the diffusion barriers as well as to extend the molecules parallel to the surface so that they could be imaged by TIRFM. At low flow velocities, the DNA molecules displayed pronounced entropic fluctuations, which were particularly evident in the z-direction because of the exponential decay of the evanescent field, and these fluctuations reduced the overall extension of the DNA molecules. At higher flow rates, the amplitude of the fluctuations decreased, causing an increase in the mean extension of the DNA and the molecules themselves were confined closer to the surface (FIG. 8A). The degree of extension increased at higher flow rates because of the increased net hydrodynamic force acting on the molecules. The force/extension regimes of double-stranded DNA have been characterized by single-molecule methods designed to probe the mechanical properties of nucleic acids. These studies have shown that the dynamic behavior of DNA can be mathematically modeled as a worm-like chain (WLC), in which the polymer is treated as a flexible rod that curves smoothly as a result of thermal vibrations^{L26,L27}. To estimate the force experienced by the tethered molecules with an array, the relative mean extension [symbol] of the DNA was plotted as a function of flow velocity (FIG. 8B). These data were then fit to an expression describing the WLC behavior of DNA^{L26,L27}. As illustrated in FIG. 8B, the extension data were well represented by the WLC model for DNA, and using buffer flow we were able to exert forces ranging up to approximately 4 pN to the tethered DNA molecules within the microfluidic sample chamber. Unlike mechanical DNA-stretching experiments, where the applied force is evenly distributed along the entire molecule, tethered polymers in shear flow experience variable tension, which increases with distance from the free end of the DNA molecules. Finally, even at the highest flow rates tested, when the DNA substrates were experiencing at least 4 pN of force, the molecules were not pulled out of the bilayer. This demonstrates that the arrays were highly robust and can be used to explore the DNA dynamics and/or protein-acid interactions over long periods of time under a variety of flow force conditions, without loss of DNA molecules within the array.

### Forming Physical Barriers

Lipid bilayers only form on a few types of surfaces other than SiO₂, and materials that do not support bilayer formation can potentially be used as lipid diffusion barriers [R11]. Diffusion barriers can be prepared by applying barrier materials onto the surface prior to deposition of the lipid bilayer; the bilayer then forms around the barriers. The chemical nature of the barrier, and not its surface topography, is the primary factor in preventing lipid diffusion [R13]. Therefore, barrier materials can be made that are similar to the thickness of the bilayer itself (6-8 nm).

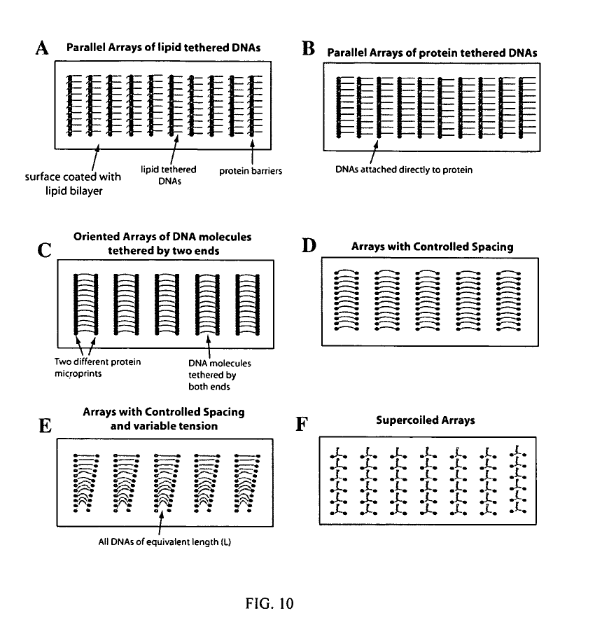

Proteins, in particular, have proven very effective as barrier materials, and can easily be deposited on SiO₂ surfaces in well-defined patterns by a process called microcontact printing [R11, R14]. Microcontact printing uses a PDMS (poly[dimethylsiloxane]) template as a stamp for generating patterns on surfaces (outlined in FIG. 9). PDMS stamps can be used to routinely transfer proteins to a SiO₂ surface in patterns with features as small as 1 μm, and thicknesses on the order of 5-10 nm [R11, R14]. Protein barriers do not interfere with the evanescent field and will allow even illumination of the DNA molecules.

The PDMS stamps used for microcontact printing are made by soft-lithography [R14]. This starts with construction of a master template, which can then be used repeatedly to cast replicas made of elastomeric silicone polymers. First, a thin film of SU-8 (photoresist) is spin-coated onto a silicon substrate. The coating is baked to remove all traces of solvent, leaving behind a flat film of photoresist. The sample is aligned with a photomask containing the desired template pattern, and irradiated with UV light (365 nm). This crosslinks the photoresist in the regions exposed to UV light, and the remaining uncrosslinked material is dissolved in solvent, leaving behind a pattern whose topology is defined by the photomask. Finally, this master template is coated with a thin (10 nm) layer of gold or fluorosilane to allow easy removal of the PDMS replicates. Once complete, the master is used repeatedly to make multiple, identical PDMS casts. Replicates are made by pouring liquid PDMS on top of the master, bubbles are removed in a vacuum chamber, and the polymer is cured by heating to 70° C. for 4 hours. After cooling, the flexible PDMS is peeled from the master. The PDMS is briefly oxidized in a plasma cleaner, incubated with a solution of protein, dried, and then placed into contact with the clean silica surface (i.e., the surface of our flowcell sample chamber). This results in transfer of the protein “ink” from the PDMS stamp to the SiO₂ surface, yielding a pattern defined by the stamp design.

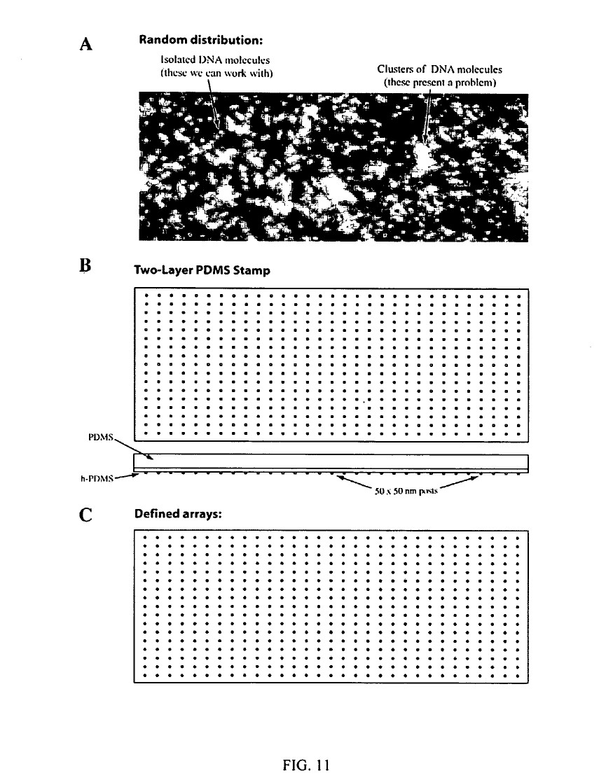

FIG. 9 shows the design of the PDMS stamp that is initially used, as well as the resulting protein print. Fibronectin is used as the “ink” for the micropattern, as this protein has been shown to work well as a lipid diffusion barrier, and is easy to deposit by microcontact printing [R10]. This approach is translated with the mechanically scratched surfaces directly into experiments with protein barriers by patterning lines of protein on the surface oriented perpendicular to the direction of buffer flow. FIG. 10A depicts predicted outcomes, based on preliminary experiments with scratched surfaces. Initially, the DNA molecules are tethered to the lipid bilayer and randomly oriented on the surface. A hydrodynamic force is then applied, causing the DNA molecules to move into positions defined by the presence of the protein barriers. Once aligned along the barriers, the DNAs extend parallel to the sample chamber surface and using TIRFM we readily detect the binding of fluorescent proteins to the DNA molecules. This design incorporates several new elements that offer distinct advantages over the mechanical barriers presented earlier. The protein barriers themselves are made relatively small (≦1 μm) relative to the total length of the DNA molecules we are working with (15 μm). Extension of the DNA molecules places them within the evanescent field and over the lipid bilayer, as opposed to the undefined surface of the mechanical scratch. This ensures that the evanescent field evenly illuminates the DNA molecules; eliminates the background scatter caused by the scratched surface; and keeps the protein-DNA complexes positioned over the inert lipid bilayer.

### Designer Arrays of Individual DNA Molecules

This approach allows the even alignment of DNA molecules on a surface coated by an inert lipid bilayer, enabling parallel analysis of many more individual DNA molecules in a single experiment than would otherwise be possible. This approach does not, however, permit user control over the lateral spacing between the individual DNA molecules. Therefore, molecules that are too close together are not optically resolved and this spacing problem limits the total number of DNA molecules that are simultaneously analyzed on these initial arrays. Additionally, reliance on hydrodynamic force to maintain the DNA molecules in an extended configuration parallel to the flowcell surface, within the evanescent wave, presents a potential difficulty for future biochemical experiments. Specifically, flow through our microfluidic sample chamber falls into a laminar regime; the flow rate is greatest near the center of the channel and decreases approaching the tethered molecules located at the surface [R14]. Thus, very high flow rates are necessary to maintain the DNAs in an extended conformation; it is also difficult to precisely control the delivery of reaction components to the DNA molecules [R2]. Delivery of high molecular weight reactants at relatively low concentrations (such as will required for many of our future biochemical experiments with the large nucleoprotein complexes involved in DNA recombination), is complicated by their tendency to remain in the areas of high flow (i.e., the center of the channel), rather than diffuse into the volume near the surface where they can interact with the tethered DNA molecules and be detected by TIRFM. To solve this problem, we developed a method for tethering linear DNA to a sample chamber surface in an extended conformation using Lambda DNA with biotin tags at each end. These DNA molecules remain extended even in the absence of buffer flow. However, because each end has an identical biotin tag, and because we are currently relying on random tethering to the surface, we cannot control the orientation of the DNAs or the distance between the two tethered ends. To overcome these problems we will develop the use of microcontact printing as a method for creating more elaborate surface arrays of DNA molecules.

DNA molecules are tethered directly to the protein barrier itself (FIG. 10B). First, protein patterns are made with biotinylated BSA. Neutravidin is then bound directly to the biotinylated BSA protein patterns to provide an attachment point for the DNA molecules. Directly attaching the DNA molecules to the protein barriers allows the retention of the beneficial properties of the inert lipid bilayer, while providing a solid anchor point for the individual DNA molecules. Alternative methods for tethering the DNAs to protein barriers can also be used. Antibodies, in particular, have proven useful as protein “ink” materials with SiO₂ surfaces and retain their biological properties even when adsorbed onto SiO₂ [R16]. Patterns made from anti-digoxigenin antibodies are used to attach Lambda DNA molecules labeled at one end by digoxigenin (a hapten that can readily be incorporated into synthetic oligonucleotides). Different tethering schemes are then combined into a single approach that allows the creation of parallel arrays of oriented DNA molecules tethered by two ends to the surface of the microfluidic flowcell (FIG. 10B). To do this, the first protein pattern (e.g., biotin-BSA) is printed, followed by printing a pattern with the second protein (e.g., anti-digoxigenin) (FIG. 10C). Arrays are assembled using DNA molecules with two different tags (for example, biotin at one end and digoxigenin at the other). Once the DNAs have attached by one or the other end, buffer flow is applied to extend the DNA molecules, allowing the opposite end to attach to the surface. These arrays consist of DNA molecules whose orientations are defined by the different tags present on each end, as well as the design of the dual-patterned microprints (FIG. 10C). Because both ends of the DNA molecules are tethered, the entire length of the DNA remain confined within the volume define by the evanescent field, even in the absence of buffer flow. A simple extension of these methods gives a solution the problem of lateral separation. Here, arrays are prepared of proteins on the sample chamber surface using a PDMS template comprised of uniformly spaced pillars, as opposed to the lines used in the earlier experiments. This allows construction of arrays with individual DNA molecules having defined orientations, wherein the tethered ends of each DNA molecule are separated from the neighboring DNA molecule by a distance defined by the dimensions of the PDMS stamp (FIG. 10D).

The force exerted on an extended DNA molecule can influence the biochemical behavior of proteins that interact with the DNA [R18]. Therefore, in some embodiments, methods of varying the tension on the DNA molecules in a predictable manner are used. For example, two different microcontact printed proteins are used, wherein the second protein print is not parallel to the first, but rather angled such that the DNAs linked between the two protein prints experience different degrees of extension depending on their position along the protein patterns (FIG. 10E). This type of array allows the use of TIRFM to investigate the effects of variable DNA tension on DNA-protein interactions. By invoking the mathematical calculations derived from the well-established statistical mechanical treatment of DNA as a wormlike chain (WLC) [R17, R18], TIRFM is used to measure the physical properties, such as tension and persistence length, of the DNA molecules (and the protein-DNA complexes) tethered by two ends. DNAs tethered by two ends vibrate due to Brownian motion; the frequency and amplitude of these vibrations are measured by TIRFM because their magnitude is on the order of 10's of nanometers (depending on the length of the DNA and the distance between the tethered ends), causing the emission intensity of fluorescently labeled DNAs to fluctuate as the molecules move in and out of the evanescent field. Therefore, the physical properties of any given DNA molecule within an array are calculated.

All of the DNA arrays described above are made with relaxed, linear DNA molecules. However, biologically relevant reactions may require supercoiled DNA molecules as substrates. Our microcontact printed arrays allows the creation of arrays of DNA molecules with defined degrees of supercoiling (FIG. 10F). The top and bottom stands at each end of the DNA molecules are linked to protein barriers on the surface. Connecting both strands to the surface will prevents the DNA molecules from freely rotating around the tethered bonds, and allows the introduction of supercoils in the tethered DNAs by injecting topoisomerases into the sample chamber [R19]. Initially, the barriers are spaced 5 μm apart, ⅓ the length of the Lambda DNA molecules. After attaching the DNA molecules to the surface, topoisomerase is added to the sample chamber to introduce negative supercoils into the DNA molecules on the surface. At the outset of the experiment, the DNAs fluctuate in and out of the evanescent field due to Brownian motion, but as the degree of supercoiling increases, the tension of the molecules increases, pulling the DNAs down into the evanescent field. The degree of supercoiling introduced into each molecule is limited only by the distance between the two tethered ends of the DNA (and by the biophysical limitations of the topoisomerases) [R19, R20]. Because the extent of supercoiling is limited by the user-defined distance between the DNA ends (i.e., the protein micropatterns) it is possible to custom-design arrays of individual DNAs with variable supercoiling. For example, combining the approaches depicted in FIGS. 10E and 10F creates DNA molecules with degrees of supercoiling that varied as a function of their position within the array.

### Nano-Patterned DNA Arrays

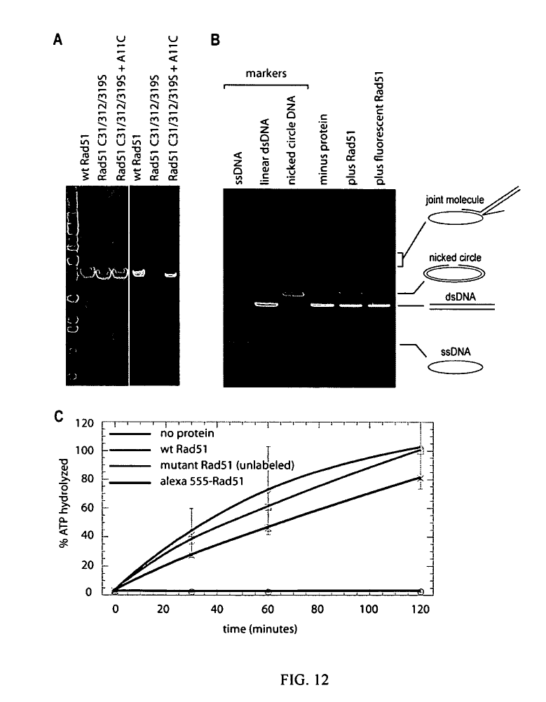

The work described in the previous sections utilize relatively long DNA molecules that can be bound by up to hundreds, or in some cases, even thousands of protein molecules. However, many TIRFM experiments for investigating protein-nucleic acid interactions are designed to look at much more detailed molecular events. In some instances, this requires obtaining information from single fluorophores. As the final extension of our microcontact printing experiments, we will develop methods for defining arrays of much smaller DNA molecules that maintain the beneficial aspects of the inert lipid bilayer and can be used in single-molecule biochemical experiments. FIG. 11A shows a single 100 milli-second frame of an experiment performed with 30-basepair DNA molecules. The DNA molecules are biotinylated at one end, and labeled with a single Cy3 fluorophore at the other end. Each spot on the image is the fluorescence emission from a single DNA molecule that is tethered to the sample chamber surface. FIG. 11A also illustrates that the molecules tethered to the surface are randomly distributed. Some of the individual DNAs are isolated, and the fluorescence signal emitted from these molecules can be analyzed. However, many of the molecules are clustered close together, and the fluorescence signals overlap. The random distribution requires that each individual molecule be manually identified and individually analyzed. This can be the rate-limiting step in TIRFM experiments. Both of these issues are eliminated by preparing defined arrays of individual molecules on the surface of our microfluidic flowcell.

Patterned arrays of attachments sites for small biotinylated DNA molecules surrounded by an inert lipid bilayer are prepared. Because the DNA molecules of interest are small, on the order of 30-300 basepairs (10-100 nm), minimizing the dimensions of the protein patterns stamped onto the fused silica surface is necessary so that the molecules themselves are encompassed by a lipid bilayer microenvironment. This requires manufacturing more delicate features in our PDMS stamps, but these features are limited in that they must not collapse onto the SiO₂ substrate during the stamping process or the pattern will be destroyed. To accomplish this, two-layer stamps that have a thick (3 mm) layer of flexible PDMS and a thin (30 μm) layer of stiffer h-PDMS are used (FIG. 11B) [R21]. These two-layer stamp designs have previously been used to create patterns with 30 nm features, sufficiently small to fulfill our current requirements [R21, R22]. These nano-patterned stamps are made by soft-lithography, and protein patterns are inked on the sample chamber surface as described above to generate defined arrays of individual, small DNA molecules in inert environments compatible with single-molecule TIRFM biochemical experiments (FIG. 11C). Because the position of each biochemical reaction within the array is known a priori, analysis of the data is accomplished through a computer algorithm designed to analyze only specific pixels within the acquired images. This eliminates the need for manual identification of the individual reactions and allows parallel processing of up to hundreds of individual biochemical reactions at a much greater rate.

The ability to define ordered arrays of individual DNA molecules on an inert sample chamber surface facilitates the throughput of single-molecule biochemical experiments, and the techniques described herein are applicable to experiments designed to investigate many fundamental aspects of protein and nucleic acid biochemistry at the single-molecule level. These new technologies allow user control over the physical properties of the DNA molecules under investigation, greatly expanding the potential applications of TIRFM.

### CONCLUSION

We have developed new methods for tethering long DNA molecules to surfaces rendered inert through the deposition of a lipid bilayer. We have also demonstrated that it is possible to prepare well-defined arrays of aligned DNA molecules by using hydrodynamic force to organize lipid-tethered DNAs along the edge of a micro-scale mechanical barrier to lipid diffusion. This approach will simplify the use of TIRFM for analyzing protein-nucleic acid interactions by allowing precise control over the arrangement of the surface-tethered DNA molecules. Each of these strategies serve as general methods for studying both DNA dynamics and protein-DNA interactions at the single-molecule level specifically because of the inert microenvironment provided by the zwitterionic lipid bilayer. In addition, the DNA array technology described herein allows parallel processing of hundreds or possibly thousands of individual reaction trajectories in a single TIRFM experiment, and data analysis is greatly facilitated because all of the individual molecules within the array are physically aligned with respect to one another. An important implication of this is that a hypothetical line drawn across the DNA, perpendicular to the direction of buffer flow, crosses the exact same nucleotide sequence on each individual molecule within the array. Similarly, application of a fluorescently labeled site-specific DNA-binding protein can yield a fluorescent band extending horizontally across the array demarking the position of the protein's binding site. Taken together, these benefits greatly improve the throughput capacity of single-molecule experiments.

### EXAMPLE 2

### Visualizing Long-Distance Lateral Diffusion of Human Rad51 on Double-Stranded DNA

Rad51 is the primary eukaryotic recombinase responsible for initiating DNA strand exchange during homologous recombination. Many molecular details of the reactions promoted by Rad51 and related recombinases remain unknown. Using fluorescently labeled protein and total internal reflection fluorescence microscopy (TIRFM), we directly visualized the behavior of individual Rad51 complexes on double-stranded DNA molecules (dsDNA) suspended in an extended configuration above an inert lipid bilayer. We show that rings of Rad51 can bind to and slide freely along the helical axis of dsDNA. Sliding is bi-directional, does not require ATP hydrolysis, and displays properties consistent with a one-dimensional random walk driven solely by thermal diffusion. The proteins move freely on the DNA for long periods of time, however, sliding terminates and the proteins become immobile upon encountering the free end of a linear DNA molecule. This study provides new insights into the behaviors of human Rad51, which may apply to other members of the RecA-like family of recombinases that can form ring-like structures.

The repair of double-stranded DNA breaks (DSBs) by homologous recombination is essential for maintaining genome integrity in most organisms (P1-P3). The importance of homologous recombination is highlighted by the finding that Rad51 null mutations are embryonic lethal in mice (P4). Furthermore, defects in this repair pathway are associated with a variety of human cancers (P5, P6). In eukaryotes, the broken ends of chromosomes are processed by 5′ to 3′ exonucleases to yield long single-stranded DNA (ssDNA) overhangs (P2, P3). Rad51, a DNA-dependent ATPase, assembles onto these overhangs, forming a nucleoprotein filament that is a key intermediate in homologous recombination (P1, P2, P7, P8). The primary functions of this filament are to locate homologous sequence that can be used as a template to repair the damaged DNA strand and to initiate strand exchange (P1, P7).

Numerous studies have shown that the structure and function of the complexes formed by Rad51 and the other RecA-like recombinases are conserved throughout evolution (P8, P9). Bacterial RecA, bacteriophage T4 UvsX protein, archaeal RadA, S. cerevisiae Rad51, and human Rad51 have highly conserved sequence elements, all form similar oligomeric structures, and each promotes pairing and exchange of homologous DNA strands (P1, P8, P10). In their active states, Rad51 and related recombinases form a helical filament on DNA that induces a 50% extension of the bound DNA molecule, untwists the duplex to ˜18.6 basepairs per turn, and a changes the helical pitch from ˜36 Å in B-form DNA to ˜95 Å (P8).

The extended nucleoprotein filament is correlated with DNA recombination activity; however, Rad51 and related recombinases also form octameric rings with a central pore large enough to accommodate a dsDNA molecule (P11-P16). These ring-like recombinase structures do not appear to be the form of the protein that is active during the strand exchange phase of homologous recombination. It has been suggested that these rings may function as DNA “pumps”, allowing the proteins to move along DNA (P12, P17). Here we have developed a TIRFM-based assay to investigate the behavior of single fluorescent Rad51 complexes bound to dsDNA. We show that the ring form of the human Rad51 can bind stably to dsDNA and diffuse long distances in one dimension along the helical axis. This provides new insights into the range of behaviors attributed to Rad51 and also presents a general approach that can be adapted to investigate the lateral movements of other protein molecules bound to DNA.

### Materials and Methods

### Fluorescent Protein

The E. coli expression construct pFB530 (P18) that encodes human Rad51 was a generous gift from Dr. M. Modesti (Erasmus University). To simplify cloning, an internal NdeI restriction site was removed using QuikChange™ mutagenesis (Stratagene). The Rad51 gene was amplified with a proofreading DNA polymerase (Invitrogen) and a set of primers that added an NdeI site to the N-terminus of the PCR product. The PCR fragment was digested with Nde I and BamH I, cloned into pET14b (Novagen) and sequenced to verify its identity. This new plasmid was renamed pET14b-hRad51 and was used for all subsequent steps. Human Rad51 has five cysteines: C31, 137, 144, 312, and 319. Cysteines 137 and 144 are buried in the protein interior structure (P14, P19). C31 and 319 are surface accessible, and C312 is partially accessible (P14, P19, P20). Covalent modification of the exposed cysteines in the wild-type protein results in the loss of this protein's ability to catalyze in vitro strand invasion and significantly diminishes its DNA binding activity. Based on the crystal structures, this inactivation is most likely due to disruption of the interfaces between adjacent monomers in the nucleoprotein filament (P21). Therefore C31, 312, and 319 were changed to serine, and reintroduced a normative cysteine into the protein at A11 to serve as a more favorable attachment point for fluorescent dyes.

Rad51 was expressed in E. coli (3 L culture), and the proteins were precipitated by the addition of 0.34 g/ml ammonium sulfate followed by centrifugation at 36K rpm for 1 hour. The protein pellet was dissolved into buffer containing 10% glycerol, 25 mM Tris (pH 8), 500 mM NaCl, 0.1% NP40, 1 mM PMSF, 50 mM imidazole, and 5 mM β-mercaptoethanol. The protein was loaded onto a 1 ml HiTrap Chelating column (Amersham Biosciences) and washed with 30 ml buffer. The column was flushed sequentially with buffer containing 0.1 mM TCEP (Tris[2-carboxyethyl]phosphine hydrochloride), followed by buffer lacking β-mercaptoethanol and containing 1 mM Alexa Fluor 555-maleimide (Molecular Probes) and incubated for 2 hours at 4° C. The unreacted dye was removed by rinsing extensively with buffer containing 5 mM β-mercaptoethanol and the fluorescently labeled Rad51 eluted with 500 mM imidazole. The fluorescent protein was dialyzed into storage buffer containing 20% glycerol, 25 mM Tris (pH 8), 500 mM NaCl, 1 mM EDTA, and 2 mM DTT.

### Ensemble Recombination Reaction Conditions

Conditions for the Rad51 reactions with virion substrates were adapted directly from Sigurdsson et al. (P10). A reaction mix was prepared containing 40 mM Tris (pH 7.8), 1 mM MgCl₂, 2 mM ATP, 1 mM DTT, and an ATP regenerating system comprised of 8 mM creatine phosphate and 28 μg/ml creatine kinase. Rad51 (7.5 μM) and 30 μM φX174 virion (concentration reported in μM nucleotide; New England Biolabs) were added, and the reaction was incubated for 5 minutes at 37° C. RPA was added to a final concentration of 2 μM and incubation continued for an additional 5 minutes at 37° C. This was followed by the addition of 1 M ammonium sulfate to a final concentration of 100 mM and a 1-minute incubation at 37° C. Finally, 30 μM of ApaL1-digested φX174 dsDNA and 4 mM spermidine were added and the reactions incubated for an additional 90 minutes at 37° C. The DNA products were deproteinized with the addition of 0.4% SDS and 2.0 mg/ml proteinase K, followed by a 30-minute incubation at 37° C. The deproteinized products were resolved on 0.8% agarose gels in 1×TAE and detected by staining with ethidium bromide.

### ATPase Assays

Reaction mixes were assembled on ice and contained 20 mM Tris (pH 7.5), 2 mM DTT, 0.5 mM ATP, 0.25 μM α³²P-ATP (800 Ci/mmol), 2 mM MgCl₂, 100 μg/ml BSA, and 120 μM φX174 virion (NEB). Rad51 was then added to a final concentration of 13.3 μM and reactions initiated by incubation at 37° C. (P22). 2 μL aliquots were removed at the indicated intervals, mixed with 5 μL of 0.5 M EDTA, and stored on ice until all time points were collected. Reaction products were resolved on 20×20 cm PEI-Cellulose F plates (EMD Chemicals, Inc.) in 0.4 M LiCl and 1 M formic acid. All quantitation was done using a phosphorimager and the reported data points represent the average of three separate experiments.

### Total Internal Reflection Fluorescence Microscopy

The TIRFM system was built around a Nikon TE2000U inverted microscope. Illumination was provided by a 75 mW, 532 nm diode-pumped solid-state laser (CrystaLaser), or a 200 mW, 488 nm laser (Sapphire, Coherent). The beams were passed through a spatial filter and beam expander (Thorlabs), and focused through the face of a fused silica prism (J.R. Cumberland Optics, Inc.) onto the microfluidic flowcell (see description below) to generate an evanescent wave within the sample chamber (P23). Images were collected through an object lens (100×, NA 1.4, oil immersion, Nikon), passed through a holographic notch filter (Kaiser Optical Systems, Inc.) to reject any scattered laser light, and detected with a back-illuminated EMCCD (Cascade 512B, Photometrics). The 532 nm laser was used to illuminate Alexa Fluor 555-Rad51 and the 488 nm laser was used to locate YOYO1 stained DNA (when necessary). Data acquisition and initial analysis were performed with a PC running Universal Imaging's Metamorph software. Sample application was controlled via a syringe-pump system. All TIRFM experiments were performed at room temperature (approximately 23° C.). Reaction buffers were passed through a 0.22 μm filter prior to use and contained 40 mM Tris (pH 7.8), 1 mM MgCl₂, 1 mM DTT, 2 mM ATP, and 200 μg/ml BSA.

### Surface Preparation and DNA Array Construction

All experiments were performed with microfluidic flowcells machined and assembled in house. The flowcell consists of a fused silica slide glass (ESCO Products, Inc.) with a pair of holes made by boring through the slide with a diamond-tipped drill bit (Eurotool). Inlet and outlet ports are made using Nanoports (Upchurch Scientific) and sample delivery was controlled by a syringe pump (Kd Scientific). The microfluidic chamber was constructed out of double-sided tape (3M) and a glass coverslip (Fisher).

The surface of the sample chamber was rendered inert through deposition of a supported lipid bilayer, and a detailed description and characterization of these bilayer-coated surfaces will be published elsewhere (P24). In brief, liposomes were made by extrusion of phosphatidylcholine (PC) through a polycarbonate membrane with 100 nm diameter pores (Avanti Polar Lipids). A dilute solution (16 nM) of neutravidin (Pierce) was applied to the bare SiO₂ surface in buffer containing 10 mM Tris (pH 8) and 100 mM NaCl. The chambers were rinsed with buffer, filled with liposomes and incubated for 1 hour at room temperature. The liposomes in the flowcell rupture and form a supported bilayer on the fused silica surface. FRAP (fluorescence recovery after photobleaching) measurements of bilayers prepared with rhodamine tagged lipids showed that the bilayers were able to form around the sparsely applied neutravidin and retained normal fluidity (P24).

Phage λ-DNA (with either one or both ends biotinylated) was applied to the freshly prepared surface after blocking with buffer that contained 200 μg/ml BSA. Unbound DNA was then removed from the sample chamber by washing extensively with buffer. The tethered state of each DNA molecule was experimentally verified by alternately starting and stopping buffer flow.

A detailed description of the DNA array construction will be presented elsewhere (P24). In brief, the diffusion barriers were made by manually etching the surface of the sample chamber with a diamond-tipped scribe (Eurotool) prior to assembly of the flowcell. DOPC liposomes (0.4 mg/ml) containing 0.5% biotinylated lipids were applied to the sample chamber surface for at least 1 hr. Excess liposomes were rinsed away using a buffer A, and the bilayer was incubated for an additional 1 hr. Buffer containing 40 mM Tris (pH 7.8), 1 mM DTT, 1 mM MgCl₂ and 0.2 mg/ml BSA (buffer B) was added to the flowcell and incubated for 30 minutes. Neutravidin (330 nM) suspended in buffer B was added to the flowcell and incubated for an additional 30 minutes. After rinsing, the biotinylated λ-DNA (16 μM) was added in buffer B and incubated for 30 minutes. Buffer flow was then applied to organize the DNA molecules along the diffusion barriers

### Single-Particle Tracking

Diffusion measurements were made using images collected at a rate of 8.3 frames/second for a period of 124 seconds. The images were imported into Igor Pro (WaveMetrics) as two-dimensional matrices. The data were then processed to determine the centroid position of the fluorescent particles using an algorithm that fit the images to a two-dimensional Gaussian function in conjunction with a region-of-interest mask. The movement of each particle in the y-direction (i.e., parallel to the long axis of the DNA molecules) was then analyzed to calculate the mean squared displacement (MSD) using:

$$M S D ( n Δ T ) = {\sum }_{i = 0}^{N} ( {Y}_{i + n} - {Y}_{i} ) / ( N + 1 )$$

for nΔT=12 seconds (˜10% of the total time) to minimize errors due to sampling size (25). Using the MDS information, the diffusion coefficient for each protein complex was calculated by:

D(t)=MSD(t)/2t

where D(t) is the diffusion coefficient for time interval t (0.12 seconds) (P26, P27). All calculations were restricted to diffusing proteins that were well-resolved from any neighboring complexes. Similar calculations were also used to measure the x-displacement of the diffusing proteins (i.e., perpendicular to the long axis of the DNA molecules).

To minimize errors in the particle tracking algorithm, only fluorescent complexes that displayed a signal-to-noise ratio greater than 4:1 were analyzed (P28). To estimate the precision of the particle tracking algorithm and the position measurements, the same procedure was performed on a series of protein complexes that were nonspecifically immobilized to the sample chamber surface. This yielded a standard deviation of +0.017 μm in the y-direction and ±0.018 μm in the x-direction.

### Results

### Construction and Characterization of Fluorescent Rad51

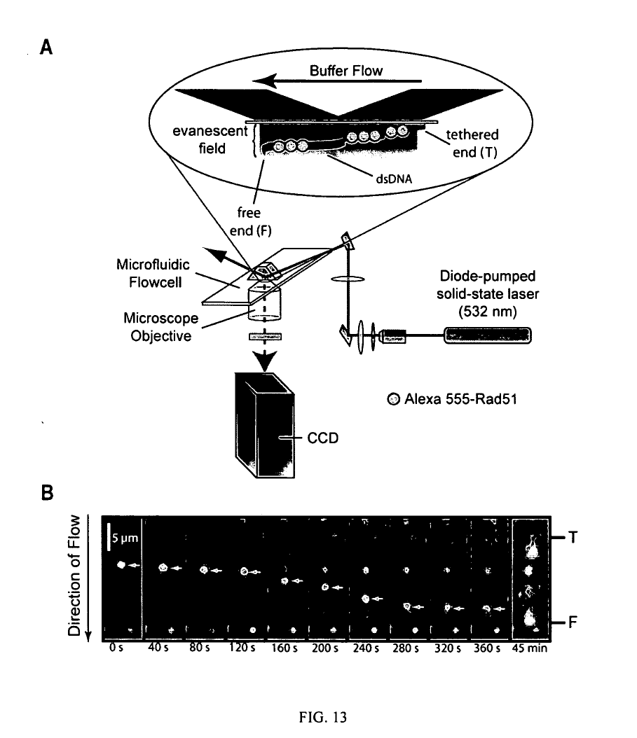

Single-molecule methods are an ideal approach for probing the dynamic behavior of individual macromolecular complexes (P29-P31). To study the interactions between human Rad51 and its DNA substrates using TIRFM, fluorescently tagged proteins that retained the properties of the wild-type protein in standard biochemical assays were first made. Construction of the fluorescent protein was facilitated by the availability of several crystal structures for the Rad51 monomer as well as the Rad51 filament (P14, P19, P21). Human Rad51 has five native cysteine residues: C31, 137, 144, 312, and 319. Of these five, C31, 312, and 319 are exposed on the surface whereas 137 and 144 are buried within the interior of the protein. Modification of the wild-type protein with thiol reactive fluorescent dyes decreased the biochemical activity of the protein in an ensemble assay for DNA recombination. Therefore, using these crystal structures as a guide we mutated the three surface accessible cysteine residues to serine and then introduced a normative cysteine near the N-terminus of the protein (A11C). This re-engineered protein (referred to as A11C Rad51) was tagged while bound to a Ni²⁺ affinity column using Alexa Fluor 555-maleimide (Molecular Probes). After labeling the unreacted dye washed away, and the labeled protein was then eluted from the column. FIG. 12A shows results from typical labeling protocols with the wild-type protein, the cysteine minus mutant, and the A11C version of Rad51. As illustrated in FIG. 12A, removal of the surface exposed cysteines eliminated fluorescent labeling with maleimide-fluorophore conjugates, and the addition of the A11C mutation to the cysteine minus mutant allowed site-specific labeling of the protein with the fluorescent dye.

The ensemble-level biochemical characterization of the fluorescent Rad51 was performed using an in vitro homologous recombination assay with plasmid-sized DNA substrates as described (P10). In brief, a circular single-stranded DNA substrate (φX174 virion) was mixed with the single-stranded binding protein RPA (replication protein A). Rad51 and ATP are then added to the reaction mixture and Rad51 forms a contiguous helical filament on the ssDNA molecules. After filament formation a linearized duplex DNA (φX174 RFII) that is complementary to the ssDNA was added to the mixture and the reactions then incubated at 37° C. Finally, the reaction products were deproteinized with proteinase K and resolved on an agarose gel. Recombination results in the formation of products that migrate as either nicked circles or joint molecules (P10). As shown in FIG. 12B, the fluorescently labeled version of human Rad51 exhibits recombination activity comparable to that of its unlabeled, wild-type counterpart. Similar results were obtained using oligonucleotide substrate. (P32).

Rad51 has a DNA-dependent ATPase activity (P8). To determine whether the fluorescent protein retained this activity, the different versions of Rad51 were incubated with ssDNA and α³²P-ATP, and the reaction products were resolved by thin-layer chromatography and quantitated by phosphor-imaging. As shown in FIG. 12C, wt Rad51, unlabeled mutant Rad51 and the fluorescently tagged version of Rad51 all displayed similar levels of ATPase activity. This indicated that neither the mutagenesis nor the fluorescent labeling had a drastic effect on the ability of the protein to hydrolyze ATP.

The biochemically active form of Rad51 and related recombinases is an extended helical filament bound to DNA (P8, P33). Cyro-electron microscopy was used to determine whether the fluorescently tagged version of Rad51 formed structures consistent with the known forms of the wild-type protein. First, fluorescent Rad51 was mixed with double-stranded, linearized φX174 in the presence of ATP. The reaction mixes were then applied to a carbon-coated grid, flash frozen in liquid ethane, and visualized with cryo-EM (P9). When the fluorescent Rad51 was bound to the DNA molecules it displayed a striated pattern characteristic of the helical filament form of the protein (P9, P33). In addition, the protein that was not bound to the DNA molecules was present as a ring-like structure, as previously reported (P16). Rad511 and several closely related proteins, are known to form ring-like structures under various reaction conditions and it is thought that these rings contain from 6-8 monomers of protein (P13-P15, P34, P35). Taken together, our data indicated that the fluorescent version of human Rad51 behaved similarly to the wt protein in all tested ensemble-level assays, and the Cryo-EM demonstrated that under normal reaction conditions the protein was capable of forming an extended helical filament.

### Single-Molecule Assay for Rad51 Binding to DNA

An often-unappreciated aspect of TIRFM is the need for an inert environment that eliminates nonspecific interactions between the biomolecules under investigation and the surface of the sample chamber. For the TIRFM experiments described below, the microfluidic sample chamber surface was prepared by deposition of a supported lipid bilayer onto a fused silica slide sparsely coated with neutravidin (P24). The bilayer formed on the surface and surrounded the immobilized molecules of neutravidin, which serve as fixed anchor points for the biotinylated λ-DNA, and provided an inert microenvironment mimicking the interior of the cell (P24, P36).

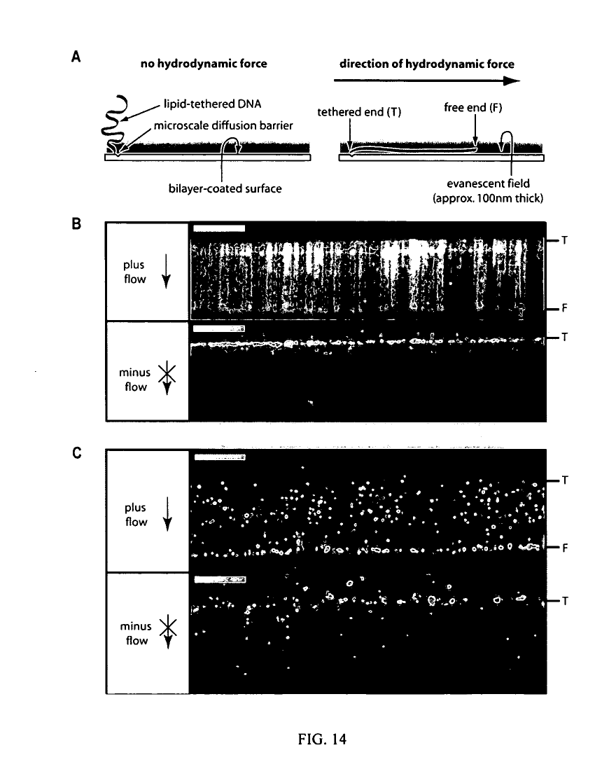

The TIRFM experimental design used to visualize fluorescent Rad51 on single molecules of dsDNA is illustrated in FIG. 13A. Here the λ-DNA was tethered to the surface by one end, and the application of a hydrodynamic force was used to maintain the molecules in an extended configuration, parallel to the sample chamber surface and within the evanescent field (P24, P37). This allowed continual visual inspection of fluorescent proteins bound to the DNA molecules at any point along their entire contour lengths. To initiate binding, 5 nM fluorescent Rad51 and 2 mM ATP were injected into the sample chamber and images collected at 40-second intervals for the duration of the experiment. At high concentrations of Rad51 (≧50 nM) the DNA becomes rapidly coated by the fluorescent protein. However, reactions performed at lower concentrations of Rad51 (5 nM) revealed small, individual complexes bound to the DNA. Contrary to our initial expectations, the fluorescent Rad51 complexes bound to the DNA were not stationary; rather they appeared to slide freely along the entire length of the tethered λ-DNA (FIG. 13B). The movement of Rad51 always occurred in the direction of flow, the velocity was proportional to the flow rate, and the direction of sliding was not influenced by which end (left or right) of the λ-DNA was immobilized to the surface. Similar sliding behavior was observed using Rad51 labeled at different positions on its surface, with GFP-tagged Rad51, and with the Alexa Fluor 555-labeled protein mixed with a 4-fold molar excess of unlabeled wild-type Rad51. Although a single example of Rad51 movement is presented, the same behavior has been observed for thousands of Rad51 complexes on hundreds of different double-stranded DNA molecules.

### Rad51 Stops Sliding and Binds Tightly to DNA Ends

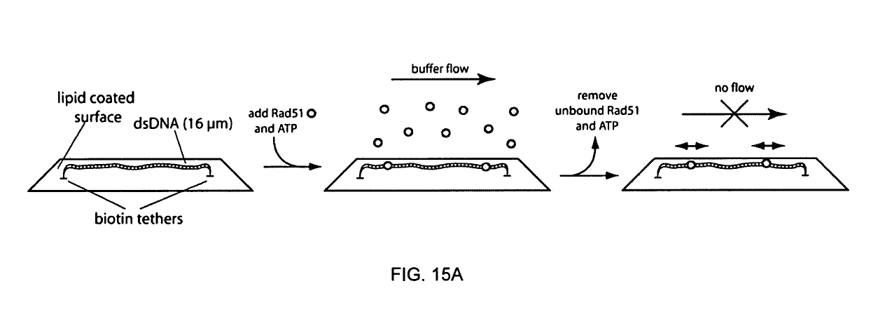

Surprisingly, the sliding proteins appeared to stop at the free end of the DNA molecules, where they remained tightly bound and accumulated over time (FIG. 13B). To further verify this we used a employed a new technology that allows high-throughput single-molecule analysis of DNA molecules and associated proteins (P24). In brief, the DNA molecules were tethered by one end directly to the fluid lipid bilayer that coats the fused silica surface. Hydrodynamic force was then used to organize the DNA molecules along the leading edge of a micro-scale barrier to lipid diffusion (P24). This yielded parallel arrays of DNA molecules aligned at defined positions on the surface of the sample chamber (FIGS. 14A and 14B).

The DNA molecules within the array are physically aligned with one another. Therefore, a hypothetical line drawn across the array perpendicular to the direction of buffer flow will cross the same site on each individual molecule. Similarly, application of a fluorescent sequence- or structure-specific DNA binding protein is predicted to yield a fluorescent line extending across the array at a position corresponding to the binding site for that particular protein. When fluorescent Rad51 (5 nM) was injected into the sample chamber with a DNA array, virtually all of the protein moved down the DNA molecules and accumulated at the free ends, which yielded a line of protein that extended across the array (FIG. 14C). Each fluorescent spot within the array corresponds to a single protein complex sliding down a DNA molecule and the accumulation of Rad51 at the free end of the DNA is evident as a fluorescent “line” of protein extending horizontally across the array. Sliding was observed on over 500 different molecules of DNA, and although there were occasional pauses, virtually all of the Rad51 on the DNA eventually moved to the ends of the molecules where they remained tightly bound. As expected, in the absence of flow, the DNA molecules and the DNA-bound proteins diffuse out of view, confirming that they did not nonspecifically adhere to the lipid bilayer. We verified that the free end of the λ-DNA was not linked to the surface by transiently stopping the flow of buffer. As expected, the DNA molecules (along with the bound fluorescent proteins) diffused out of the evanescent field, confirming that only the single biotinylated ends of the λ-DNA molecules were immobilized to the surface (FIG. 14C).

The free end of the tethered λ-DNA has a 12-base ssDNA overhang. To test whether the presence of this short ssDNA was sufficient to halt sliding of the protein, the DNA was digested with the restriction enzyme SnaB I. This removes 12 kb from the free end of the molecule, leaving behind a blunt DNA end. Removal of this 12 kb fragment (including the 12-base ssDNA overhang) did not prevent accumulation of the protein at the free end of the λ-DNA molecule, demonstrating that even the blunt end is sufficient to prevent Rad51 from sliding off of the linear dsDNA molecules.

### Lateral Movement of Rad51 on DNA in the Absence of Buffer Flow

To allow continual observation over the entire contour length of the λ-DNA with TIRFM, it was necessary to maintain a constant flow of buffer through the sample chamber; otherwise the DNA molecules experience an increase in conformational entropy and diffuse out of the evanescent field (P37). As indicated above, the fluorescent proteins always appeared to move in the direction of the flow force. Therefore, it was reasonable to presume that the observed movement of Rad51 was being driven by the hydrodynamic force necessary to maintain the λ-DNA in an extended conformation, parallel to the sample chamber surface. To determine if the movement of the protein could occur in the absence of buffer flow the λ-DNA was biotinylated at both ends, and then applied to the surface of the sample chamber under a constant, moderate flow force (P24). Under these conditions, one end of the DNA randomly binds to neutravidin immobilized on the surface, and the DNA is immediately extended by hydrodynamic force. Once fully extended, the second biotinylated end of the DNA molecule can bind to the immobilized neutravidin on the surface. The result of this is that DNA attaches to the surface in an extended configuration parallel to the sample chamber surface, and suspended above the supported bilayer such that only the ends of the molecule are anchored, ensuring that proteins have unobstructed access to the remainder of the DNA (P24). DNA molecules tethered to the surface using this approached were fairly uniform and displayed a mean length [symbol] of 12.8±3.1 μm (n=52); yielding a relative mean extension [symbol] of ˜0.8 (where L is the total length of the DNA and taken to be 16 μm), this degree of extension corresponds to a tension of approximately 0.5 piconewtons (P24). This amount of force is sufficient to maintain the DNA in an extended conformation, yet is insufficient to alter the B-form geometry of the DNA (P30). This dual-tethering scheme confines the λ-DNA molecules within the detection volume defined by the evanescent field and suspended above the inert lipid bilayer, even in the absence of an applied hydrodynamic force.

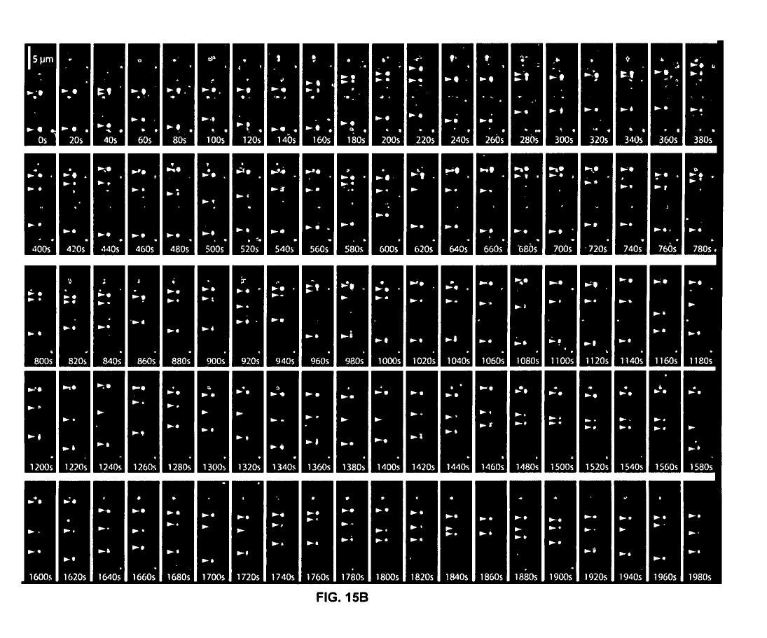

To determine if sliding occurred via a 1D-diffusion mechanism, fluorescent Rad51 and ATP were injected into a flowcell containing double-tethered λ-DNA (FIG. 15A). Reactions were incubated for a brief period, and the unbound protein was then flushed from the sample chamber by the application of buffer flow. Therefore, once data collection was initiated there was little or no free Rad51 remaining in the sample chamber of the microfluidic flowcell and removal of the unbound protein ensured that the fluorescent signals on the DNA were due only to protein molecules bound at the outset of the experiment. Flow was then terminated, and the fluorescent complexes were monitored in the absence of the perturbing hydrodynamic force by capturing images at 20-second intervals over a period of 33 minutes. As shown in FIG. 15B, the fluorescent Rad51 complexes (highlighted with arrowheads) appeared to move long distances on the λ-DNA even in the absence of the externally applied force. The movement in the absence of flow was bi-directional, and the movements of different complexes on a single DNA were completely uncorrelated, precluding the possibility that pump drift or convection currents played any significant role in the observed behavior. This strongly suggested that the observed movement of Rad51 on the DNA occurred via a one-dimensional random walk and was driven primarily by thermal diffusion.

In the example presented in FIG. 15B, there were three distinct complexes of Rad51 bound to the DNA, and the Rad51 in the center of the DNA displayed a decreased fluorescence signal relative to the two flanking complexes. This fortuitous difference in emission intensity allowed us to readily distinguish between the three different complexes, and we observed no evidence that the proteins could bypass one another as they moved back and forth along the DNA molecule, confirming that the protein molecules were tightly associated with the DNA as they moved along its helical axis. In addition, the apparent velocity was inversely related to the number of Rad51 complexes bound to the individual DNA molecules. This decrease in the apparent velocity was likely due to steric collisions between neighboring protein complexes on the DNA molecules. This is an expected outcome if the diffusing complexes were unable to freely pass by one another as they moved along the DNA because they would be limited to a single-file diffusion mechanism (P38). Furthermore, while separate complexes on the same DNA occasionally merged for brief periods of time, we saw no evidence suggesting persistent interactions between the adjacent Rad51 complexes bound to the same DNA molecule (FIG. 14B). Rad51 remained bound to the double-tethered λ-DNA for up to several hours (t_{1/2}≧2 hours), indicating that the complexes were extremely stable, even though they exhibited unrestricted lateral mobility along the helical axis. The tight binding of the complexes to the DNA and free lateral mobility strongly suggested that the fluorescent Rad51 protein was bound to the DNA as a ring and it was likely that the DNA passed through the center of the ring as proposed for DMC1 (P13, P35).

When ATP was omitted, no proteins were observed on the DNA, and ATP could not be substituted with ATPγS during the initial assembly stage of the experiment. However, the movement of Rad51 did not require ATP, once the proteins were loaded on the DNA, and similar sliding behavior was observed when ATP was completely flushed from the sample chamber, or when ATP was flushed from the sample chamber and replaced with ADP or ATPγS. The fact that the complexes continued to slide freely on the DNA in the absence of hydrolyzable ATP strongly supported the hypothesis that the observed movement occurred via a 1D-diffusion mechanism. To determine if ATP hydrolysis was required for loading the protein onto the DNA, fluorescent Rad51 was mixed with ADP and injected into the sample chamber containing tethered molecules of DNA. When ADP was the only nucleotide cofactor present in the reaction mixture Rad51 still bound to and diffused along the DNA. This demonstrates that while ATP or ADP were required for initial binding, ATP hydrolysis was not required for either binding of the protein to the DNA or the subsequent movement of the bound proteins.

### The Movement of Rad51 on DNA Occurs Via a 1D-Random Walk Mechanism

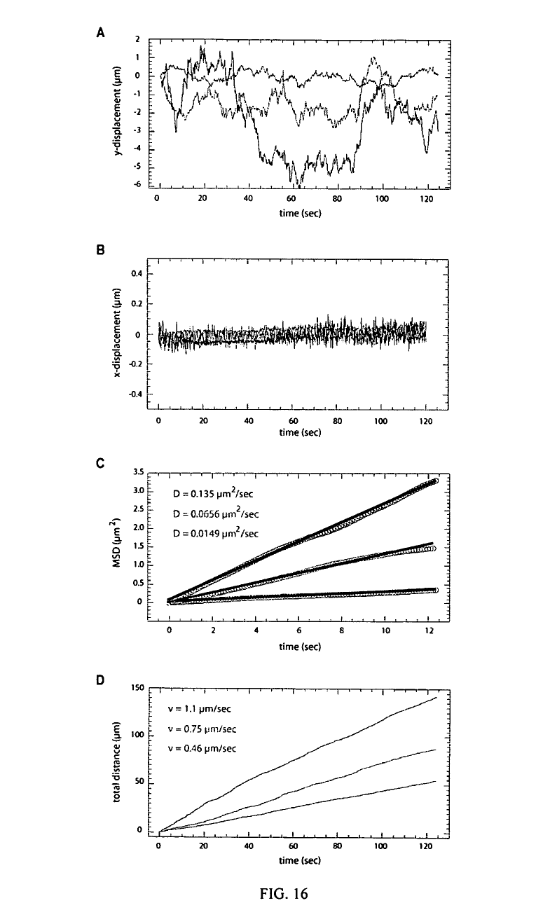

To further confirm that the lateral motion was purely diffusion based, the movement of the proteins was analyzed by single-particle tracking. For this, data collected at 8.3 frames per second were fit to two-dimensional Gaussian functions to locate the centroid position of the fluorescent proteins (P25). A graphical representation of this analysis for three typical Rad51 complexes is presented in FIG. 16. The sliding of Rad51 in the y-direction along the DNA (parallel to the helical axis) was characterized by a series of short distance oscillations, as predicted for a one-dimensional random walk, rather than long continuous movements and could span several microns (FIG. 16A). In contrast, movement of the fluorescent protein in the x-direction (perpendicular to the helical axis of the DNA) was highly restricted (FIG. 16B). We attribute this horizontal motion to a combination of noise in the measurements, and to entropically driven transverse fluctuations of the DNA molecules in the x-y plane relative to the sample chamber surface. Importantly, the amplitude of these fluctuations was at least an order of magnitude less than the movements observed in the y-direction, ruling out the possibility that the movement observed for Rad51 along the helical axis was due to motion of the DNA itself.

We further analyzed the lateral movement of Rad51 along the DNA by measuring the squared displacements (in the y-direction) between pairs of positions whose time interval ranged from 0.124 seconds (1 frame) to approximately 12 seconds (FIG. 16C). The arithmetic average of the square-displacements of the pairs separated by the same time interval was calculated and plotted versus the time interval (FIG. 16B). In most cases (47 out 50) the mean square displacement (MSD) plots yielded a linear curve, as expected for unbounded one-dimensional diffusion (P25, P26, P39). (The equation for one-dimensional diffusion is, MSD=2Dt, where D is the diffusion coefficient, and t is time (P27).) Unbounded diffusion implies that there was no significant steric constraint imposed on the proteins due to their close proximity to the lipid bilayer. In the three examples shown in FIG. 16, the complexes displayed an average 1D-diffusion coefficient of 0.042±0.054 μm²/sec. The cumulative apparent distance covered by the proteins was calculated as the running sum of the individual step sizes and ranged from ˜50-150 μm in a period of just 124 seconds (FIG. 16C). This corresponded to apparent velocities that ranged from 0.46 to 1.1 μm/sec (or 1.1-3.5 kilobases/sec). These movements allowed the proteins to scan back and forth across regions of the DNA spanning several micrometers over the 2-minute duration of the observation (FIGS. 16A and 16D). In FIG. 16D, the points on the graph represent the absolute value of the change in position; direction of movement is not implied. Although most of the protein complexes moved freely on the DNA, a small subset (3 out of 50) of the particles yielded concave curves, indicative of bounded diffusion (P25, P39). In these few cases it was possible that the movement of the proteins was restricted by either nonspecific interactions with the surface or by collisions with neighboring proteins (P38).

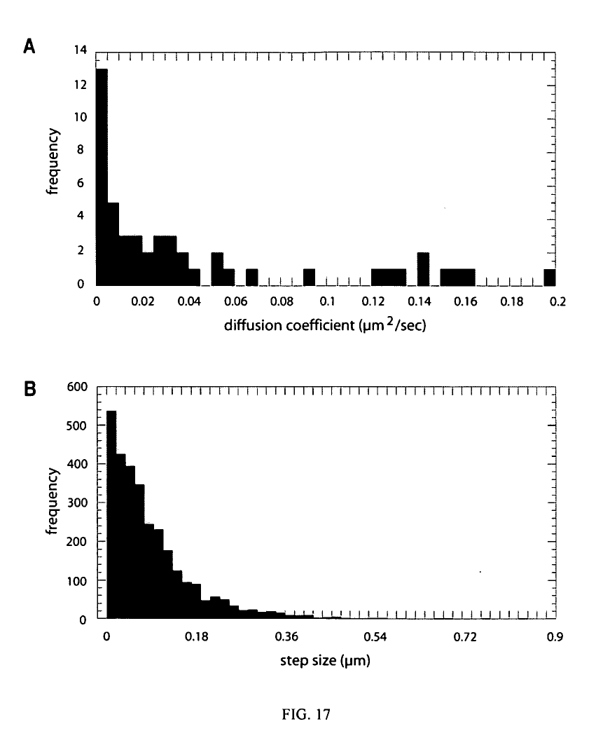

Analysis of 50 different protein complexes revealed and average step size of 0.095 μm (approximately 300-400 basepairs) and diffusion coefficients that ranged from 0.001 to 0.21 μm²/sec (n=50 different protein complexes on 38 different molecules of DNA, each monitored for 124 seconds, corresponding to 103 total minutes of diffusion; FIGS. 17A and 17B) (P27, P40). In addition, there appeared to be a rough correlation between the apparent size of the protein complexes (based on observed emission intensity) and their diffusion properties, with larger complexes appearing to travel more rapidly than smaller complexes. The wide variation in diffusion coefficients correlated to differences in emission intensities suggested that the protein complexes on the DNA did not display a uniform distribution of molecular weights, but rather they may have represented Rad51 complexes comprised of varying numbers of subunits (e.g., rings and stacks of rings).

### Discussion

### Direct Visual Detection of One-Dimensional Diffusion of Proteins on DNA

The one-dimension diffusion of proteins on DNA is a commonly invoked mechanism of facilitated target location (P41, P42). However, movement that involves passive diffusion is difficult to measure in bulk assays and often requires theoretical assumptions to interpret the behavior of the proteins under investigation (P41, P42). Single-molecule measurements of passive diffusion offer an attractive alternative to bulk measurements because they allow direct observation of the diffusing entities. Despite this potential, single-molecule approaches for measuring 1D-diffusion of proteins on DNA have been very limited (P40, P43). The use of TIRFM and single-particle tracking, along with long DNA substrates maintained in an extended conformation above a supported lipid bilayer, provides an experimental approach for probing the diffusion of proteins on DNA, which can be applied to virtually any protein that binds to DNA.

Using this approach we analyzed the movement of human Rad51 on DNA. Virtually all of the observed protein complexes diffused for long distances, yet remained tightly bound to the double-stranded DNA. Our data revealed large variations in the 1D-diffusion coefficients for human Rad51, ranging from 0.001 to 0.2 μm²/second. The broad distribution of diffusion coefficients likely reflects variations of the oligomeric state of the protein, suggesting the possibility that there may be stacks of Rad51 rings on the DNA. Although the hydrodynamic properties of Rad51 have not been characterized at the ensemble-level, the crystal structure of an octameric ring of full-length human Dmc1 (the meiosis specific homolog of Rad51) has been solved, and the hydrodynamic properties of these ring structures have been evaluated with analytical ultracentrifugation (P35). The Dmc1 protein ring has a frictional coefficient of 2.07×10⁻⁷ g/sec, corresponding to a diffusion coefficient of 19.3 μm²/second in solution, which is significantly higher than those measured for the DNA bound complexes observed in this study. Factors contributing to the lower diffusion coefficients obtained here include the confinement of the proteins to one-dimension, the possibility of transient interactions with the lipid bilayer surface, interactions between the positively charged inner surface of the protein ring and the negatively charged phosphate backbone, and/or steric interactions between the protein and the DNA.

### Recombinase Rings and Filaments

Several lines of experimental evidence indicate that the fluorescent Rad51 complexes observed moving on the DNA were in the ring-like conformation and encircled the DNA molecules. First, in the TIRFM experiments, even at higher concentrations of fluorescent Rad51, we do not see 50% extension of the DNA substrates, which is expected for the helical form of the nucleoprotein filament. We do, however, observe the expected 50% extension in experiments with fluorescently labeled DNA and unlabeled wt Rad51. Second, the diffusing complexes bound to the DNA were highly stable, often remaining bound for several hours, and we observed no evidence that proteins bound to the same DNA molecule were able to bypass one another as they moved back and forth along the DNA. Third, it is unlikely that the helical form of the protein could maintain the DNA in an extended and untwisted conformation yet still be capable of sliding freely along the helical axis. This strongly suggests that the fluorescent protein does not bind the λ-DNA as an extended filament under the experimental conditions used for these TIRFM experiments, but rather binds to the DNA in the ring conformation. This difference between the ensemble and single-molecule experiments is likely due to the cumulative effects of subtle differences in reaction conditions. Taken together these data indicate that the fluorescent protein is capable of forming helical filaments under standard experimental conditions, but that in our TIRFM experiments it is likely present as a ring structure similar to that reported for Dmc1 (P13, P35).

Members of the RecA-like recombinase family can form rings and filaments, but the biological function of these rings has remained elusive and it is not known what controls the ring-to-filament transition (P11, P13, P15, P33). It is clear that reaction conditions that favor filament formation also support recombination, whereas reaction conditions that favor ring formation do not support DNA recombination (P15, P33). This suggests that the ring-like recombinase structures may represent an inactive form of the protein, which must somehow be activated prior to the formation of an active helical filament. Alternatively, it has also been proposed that the ring form of the proteins may enable the recombinase to translocate or pump DNA (P13). Our data clearly demonstrate that human Rad51 exhibits unrestricted lateral movement along the helical axis of dsDNA, yet the proteins do not slide off of the free ends of the DNA molecules. This suggests that the freely diffusing proteins undergo a conformational change upon encountering the DNA ends, which causes them to become tightly bound and unable to diffuse.

Rad51, Dmc1, RecA, and RadA all form ring-like structures, and the evolutionary conservation of these recombinase rings from bacteria to humans strongly implies biological function (P11-P16, P34, P35). We have demonstrated that human Rad51 is capable of free lateral diffusion along the helical axis of dsDNA and we have shown that sliding stops at sites resembling a double-stranded break. To our knowledge, sliding of Rad51 (or any related protein) on DNA has never been experimentally detected, nor has one-dimensional diffusion of this magnitude and duration ever been directly visualized for any other DNA-bound protein. A hypothesis suggested by these observations is that lateral diffusion of the ring form of the protein may enable the recombinase to scan DNA for regions in need of repair. Alternatively, sliding may facilitate delivery of the recombinase to sites of damage with the aid of other DNA repair proteins. In either case, it is likely that the sliding rings of Rad51 must undergo a conformational change when they encounter a free DNA end mimicking a broken chromosome. This newly ascribed behavior of human Rad51 highlights the significant advantages of single-molecule fluorescence-based approaches for examining the dynamics of macromolecular complexes, and the methods described herein are applicable to the study of a wide range of proteins that move on DNA.

### EXAMPLE 3

### Visualizing Homologous Presynaptic Filaments Binding to Individual DNA Molecules

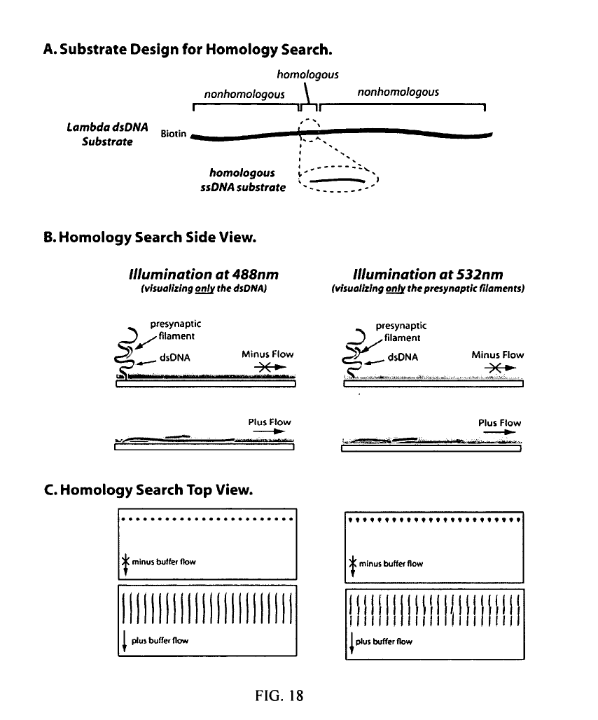

The experiment for detecting single recombination events is outlined in FIG. 18. Fluorescent Rad51 (or RecA) presynaptic filaments are assembled onto homologous 2 kb ssDNA molecules, and these presynaptic filaments are injected into a sample chamber containing tethered molecules of λ-DNA. The reactions are incubated for various times, the unbound complexes are flushed from the sample chamber; and the frequency and specificity of the resulting recombination events are determined to assess the efficiency of recombination in the TIRFM set-up. FIG. 18 illustrates the predicted final product of this reaction. When the sample is illuminated at 488 nm, the λ-DNA is detected, but the Rad51-ssDNA complexes are not detected. Conversely, when the sample is illuminated at 532 nm, the Rad51-ssDNA complexes are detected, but the k-DNA is not.

Rather than having a random distribution of complexes as observed with the nonhomologous substrates, we expect to see the fluorescent Rad51-ssDNA complexes bound to the λ-DNA array at a position corresponding to the region of homology (FIG. 18). Because ssDNA molecules that are homologous to a defined region of the λ-DNA are used, the expected location of Rad51-ssDNA complexes once the homologous sequences are aligned is known. When using the DNA array technology described herein, the outcome of the reaction is a fluorescent “line” of Rad51 filaments extending across the DNA array (FIG. 18C).

Initially these experiments are performed using conditions comparable to those used in the standard recombination assays. If the reactions are inefficient and alignment of the homologous sequences is not detected, then several experimental variables are systematically evaluated. These include the concentration of presynaptic filament, the density of surface-tethered dsDNA molecules, the size and G/C versus A/T content of the ssDNA molecules, the time allowed for the reaction to reach completion, the effect of RPA/SSB, and the buffer conditions (salt, pH, divalent metal ions, Mg²⁺ versus Ca²⁺, nucleotide cofactors, etc.). These variables are all known to influence recombination reactions performed in standard ensemble assays and conditions are optimized to accommodate for the inherent differences between these TIRFM experiments and normal recombination reactions.

### Predicted Outcomes for the Different Reaction Mechanisms

The question is how do the presynaptic filaments find the correct location on the λ-DNA? There are four possible mechanisms: (1) Random Collision, (2) Sliding, (3) Intersegmental Transfer, or (4) Hopping. We can distinguish between each of these mechanisms by using TIRFM to continuously monitor the progress of the recombination reactions in real-time. The four different proposed mechanisms for the homology search each yield a distinct result, all of which are carefully considered here.

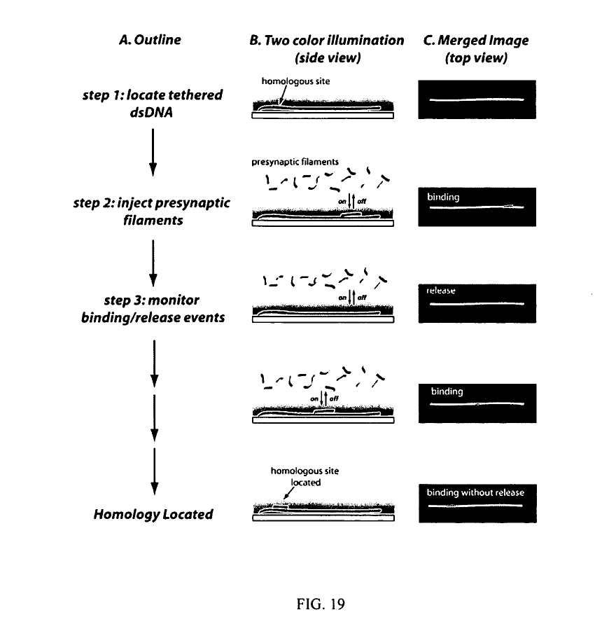

(1) Random collision involves a random search through three-dimensional space as the presynaptic filaments bind to and release the dsDNA molecule until the site of homology is located, at which point the presynaptic filament would become tightly associated with the dsDNA. If the homology search occurs though random collision, then we expect to see presynaptic filaments bind to nonhomologous regions of the k-DNA and then dissociate and diffuse out of the evanescent field. This will be revealed as the random appearance and disappearance of the fluorescent filaments as they diffuse in and out of the evanescent field and transiently bind to the λ-DNA molecules that are tethered to the sample chamber surface (FIG. 19). These cycles of association/dissociation should continue, and eventually a presynaptic filament will randomly collide with the homologous site on λ-DNA, at which point that Rad51-ssDNA filament will remain bound to the λ-DNA.

With all of these experiments, the locations of λ-DNA molecules are known, and both the λ-DNA and the presynaptic filament are simultaneously monitored. Therefore, interactions between the filaments and the tethered λ-DNA versus the transient appearance of the filaments as they randomly diffuse within the sample chamber and collide with the surface are easily distinguished.

Importantly, for this mechanism the collision frequency should be completely independent of the conformational entropy of the λ-DNA substrate. Therefore the rate of a reaction that occurred through a random collision mechanism would be the same with a λ-DNA molecule held in an extended configuration (either by buffer flow or dual biotin tags) as for a λ-DNA tethered by a single end in the absence of buffer flow. In addition, the collision frequency should be directly proportional to the concentration of free presynaptic filament within the sample chamber. At low presynaptic filament concentration the collision frequency should decrease and at higher concentrations it should increase. The importance of these distinctions will be clarified when discussing the hopping and intersegmental transfer mechanisms (see below).

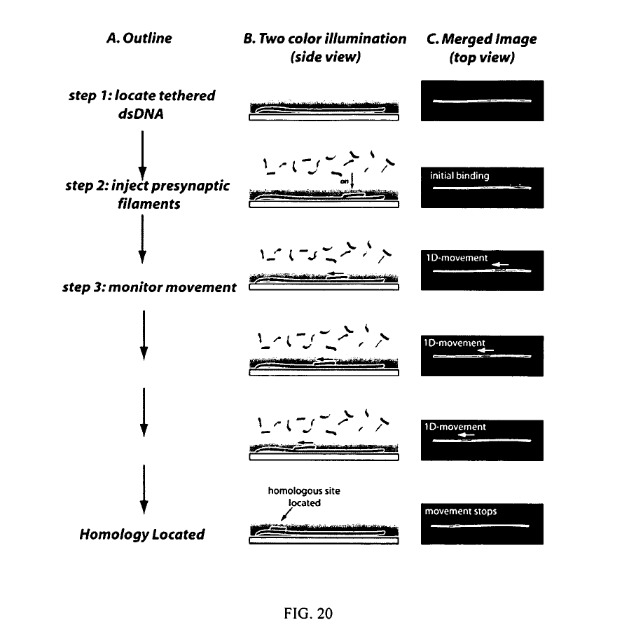

(2) Sliding differs from the other mechanisms because it involves an uninterrupted a one-dimensional search along the axis of the dsDNA molecule. This unique characteristic will allow us to readily differentiate sliding from the other three possible search mechanisms. If the homology search occurs through sliding, then we expect to see the presynaptic filament randomly associate with the tethered λ-DNA. The Rad51-ssDNA filament then will begin to move in one dimension along the λ-DNA until it encounters the region of homology, at which point the movement of the Rad51-ssDNA filament should stop (FIG. 20). As with the random collision mechanism, sliding should occur equally well with λ-DNA molecules that are tethered by either one or both ends to the sample chamber surface (i.e., the outcome should not depend on the conformational entropy of the dsDNA substrate).

One-dimensional sliding can potentially occur via two very distinct mechanisms: (1) either passive diffusion (such as with replication sliding clamps) or (2) active translocation (such as with RNA polymerases). These two mechanisms can be readily distinguished based on their biophysical characteristics. Passive diffusion (i.e., random walk) should not require energy input (i.e., ATP hydrolysis) and should also be bi-directional. The predicted bi-directional movement would occur because passive diffusion can be thought of as a series of individual and unrelated steps in which a single diffusing entity can move with equal probability in either direction (in the absence of a perturbing force) in a given step. In contrast, active translocation would require ATP hydrolysis and should only occur in one direction (with respect to the orientation of the ssDNA). These differences in behavior can be resolved by directly observing the reactions with TIRFM.

If the homology search occurs through sliding then the hydrodynamic force resulting from buffer flow could influence the behavior of the complexes. This would be most evident with passive diffusion, in which case there may be a greater propensity for the molecules to move in the direction of buffer flow. However, any influence of buffer flow on the mechanism can be revealed by performing the same reactions with λ-DNA substrates that are tethered by both ends to the sample chamber surface.

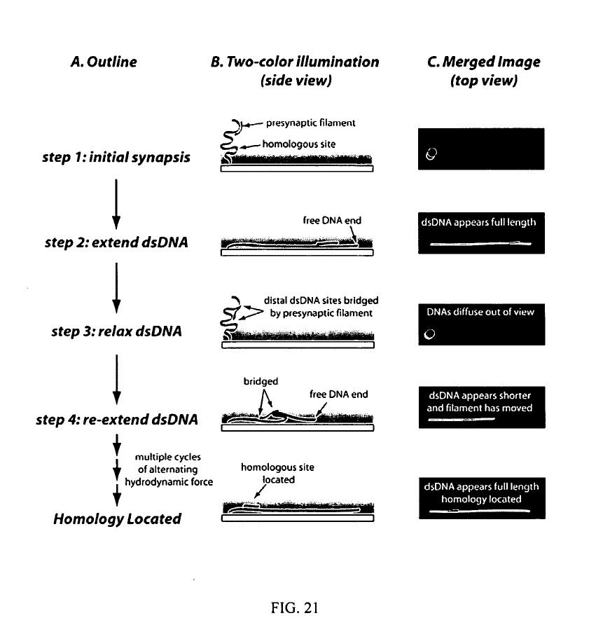

(3) Intersegmental transfer is essentially a random three-dimension search that occurs within a restricted volume defined by the λ-DNA's radius of gyration. In this case, the initial collision event is followed by partial dissociation of the Rad51-ssDNA filament, which then re-binds to a distal site on the λ-DNA. This yields a bridged intermediate with two (or more) distal sites on the dsDNA linked through interactions with the Rad51 filament. Reiterative cycles of partial release and re-binding would allow the Rad51 filament to scan the dsDNA molecule for homology without ever fully disassociating. The key aspect of this mechanism that distinguishes it from all of the other possibilities is that it requires a bridging interaction between the presynaptic filament and two (or more) distal sites on the λ-DNA (FIG. 21). An important implication of this is that the progress of the reaction will be highly dependent upon the conformational entropy of the tethered λ-DNA substrates. If the λ-DNA remains in an extended configuration (either through application of buffer flow or with dual biotin tethers) then the Rad51-ssDNA filament will be physically incapable of simultaneously interacting with two distal sites on the dsDNA, and will be unable to efficiently locate the region of homology.

The bridged reaction intermediates predicted for the intersegmental transfer mechanism can be revealed by modulating the conformational entropy of the tethered DNA molecules. To do this presynaptic filaments are injected into the sample chamber and allowed to bind to the λ-DNA. Once the Rad51-ssDNA filaments bind to the k-DNA, the unbound complexes are flushed out. This will help ensure that the same filaments are observed for the duration of the experiment (see additional discussion below). A reiterative cycle of “extending” and “relaxing” the λ-DNA by turning the buffer flow on and off is then commenced (the frequency and duration of these cycles will be determined empirically). If intersegmental transfer occurs, then we expect that the Rad51-ssDNA filament will bridge two (or more) distal sites on the λ-DNA, but this can only occur during the stage of the experiment when the buffer is not flowing and the molecules have diffused out of the evanescent field (and consequently can not be observed). This bridging effect will be revealed once the λ-DNA is re-extended with buffer flow because the λ-DNA will appear shorter, with its overall apparent length being dependent upon the distance between the bridged sites. Finally, when the reaction is complete the λ-DNA should return to its original length because the final product of the reaction no longer bridges two distal sites. None of the other homology search mechanisms will yield a similar outcome. The DNA molecules with flow can be extended to within time frames of approximately 100 milli-seconds and data collected at rates of 10-100 frames per second, detecting even transient bridging interactions.

(4) Hopping shares similarities with both the intersegmental transfer and random collision mechanisms, which must be carefully considered to experimentally distinguish it from these other possible mechanisms. Like intersegmental transfer, hopping involves a random three-dimension search within a restricted volume defined by the λ-DNA's radius of gyration. In this case, the initial random collision event is followed by cycles of complete dissociation and re-association of the same presynaptic filament at different sites on the same dsDNA molecule. As with intersegmental transfer, the ability of the Rad51-ssDNA filament to locate the region of homology via a hopping mechanism will also depend greatly upon the conformational entropy of the k-DNA. This is because the possible distance traversed in a single hop is much greater when the λ-DNA is in a more compact configuration and distal regions of the dsDNA are more likely to be in closer proximity to one another. Conversely, this distance will be greatly restricted when the λ-DNA is maintained in an extended configuration. Importantly, hopping is different from intersegmental transfer because there are no bridged intermediates along the reaction pathway. Therefore, hopping is distinguished from intersegmental transfer by alternating the extension of the λ-DNA with hydrodynamic force. If movement of the Rad51-ssDNA filament occurs through hopping then it should appear to move to different sites on the λ-DNA (i.e., hop) without the concomitant appearance of bridged intermediates, yet the rate/distance of the movement should still depend on the conformational entropy of the λ-DNA.

Hopping is also conceptually similar to the random collision mechanism in that it involves numerous binding and release events. However, random collision involves interactions between multiple different presynaptic filaments and a given dsDNA molecule, whereas hopping, by definition, entails reiterative interactions between a single presynaptic filament and a single dsDNA molecule. This difference is exploited experimentally by examining the concentration dependence of the reaction's progress after the initial collision event. For a random collision mechanism, the collision frequency between the presynaptic filaments and the tethered dsDNA will show a strong dependence upon the concentration of presynaptic filament injected into the sample chamber. For a hopping mechanism, the initial collision event will depend on the concentration of presynaptic filament, but all subsequent collisions (i.e., dissociation/association events) between the initial presynaptic filament and the λ-DNA will be independent of the concentration of free presynaptic filament. This concentration dependence is tested by varying the amount of presynaptic filament applied to the sample chamber and determining the effect on the reaction mechanism. These key differences in predicted outcomes (i.e., lack of bridged intermediates and concentration dependence) will be used to distinguish hopping from the other potential mechanisms.

### Additional Considerations

(1) DNA substrates. As described above, λ-DNA molecules can be tethered to the microfluidic sample chamber surface through either a single biotin tag or through dual biotin tags. For all of the homology search experiments, both types of DNA substrates are tested in parallel to determine the effect of conformational entropy and hydrodynamic force on the reaction mechanism.

All of the experiments described above utilize linear ssDNA molecules homologous to predefined regions of the tethered λ-DNA molecules; nonhomologous substrates will also be tested.

Estimates of the natural length of the ssDNA overhangs present in vivo after DSB formation range up to ≧1 kb for eukaryotes [Q5, Q21]. In vitro, strand pairing and exchange can occur with substrates ranging from a few tens of base pairs up to several kilo-bases in length [Q48, Q50, Q64]. It is possible that the homology search mechanism may depend upon the length of the ssDNA within the presynaptic nucleoprotein filament [Q46]. Therefore, different ssDNA lengths are tested, ranging from 0.1-10 kb to determine whether there is an effect on the reaction mechanism. The larger ssDNA substrates produce brighter filaments that can be observed for longer periods of time relative to shorter filaments, and provide a more accurate representation of the natural ssDNA overhangs present in vitro.

(2) Spatial resolution. The TIRFM system can have an optical resolution of 0.3 μm [r=0.61(λ/NA); with λ=488 nm illumination and 100×/1.3 NA objective]. However, recent technical advances have allowed greater spatial resolution of individual fluorescent particles (or molecules). This is accomplished by fitting the diffraction-limited images (i.e., point spread functions) to 2D-guassian curves. This allows the center of the fluorescent spots to be located with extremely high precision (1-10 nm) [Q76-Q78]. Experiments using single-pair fluorescence resonance energy transfer (spFRET) are used to measure even smaller scale motions (10-100 Å).

(3) Intramolecular recombination. The experiments involving changes in flow can be complicated by the fact that the reaction's progress cannot be monitored in the absence of buffer flow. Thus, there is uncertainty whether the filament bound to the λ-DNA before terminating buffer flow is the same filament that appears once buffer flow is resumed. It is formally possible that the Rad51 filament observed at the outset of the experiment is not the same filament that is seen when the DNA is re-extended. Several things will be considered to rule out (or confirm) this possibility. First, the extension/relaxation experiments are performed only after having rinsed all unbound presynaptic filaments from the sample chamber. Therefore, the only source of new presynaptic filaments is those that dissociate from another λ-DNA molecule. Once the unbound filaments are rinsed from the sample chamber, the remaining concentration of bound filaments is exceedingly low (approx. ˜10-100 femto-molar), greatly reducing the probability that a filament can dissociate and rebind to a new λ-DNA molecule. This can be further verified with experiments in which there are a limited number of Rad51 filaments associated with the dsDNA array (i.e., some of the λ-DNA will not be bound by a filament). Once the free filaments are flushed from the sample chamber no new complexes should associate with the unbound λ-DNA molecules. If dissociation/re-association events are detected, the probability with which re-association can occur are determined and these values are used to establish the likelihood that a single filament remains associated with the λ-DNA throughout the experiment.

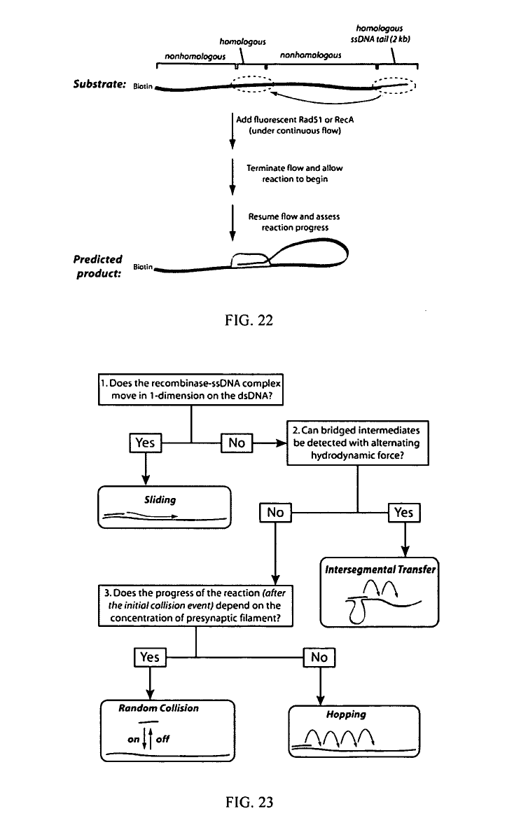

Alternatively, another experimental setup can be used that includes an intramolecular recombination reaction with a λ-DNA substrate in which a 2 kb ssDNA is linked to the end of the tethered DNA molecule (FIG. 22). These DNA molecules are tethered to the surface and Rad51 (or RecA) are applied to the sample chamber under constant buffer flow. Rad51 and RecA preferentially assemble onto ssDNA tails, and therefore bind to the ssDNA without binding to the dsDNA. Furthermore, the application of constant buffer flow prevents the homology search from beginning, and the search is initiated by stopping flow. This experimental configuration ensures that the same filament is observed for the duration of the entire experiment because it is covalently linked to the λ-DNA molecule under investigation. Another attraction of this approach is that these DNA molecules closely mimic the predicted structure for the processed end of a broken chromosome.

(4) Effect of Rad52. Once we have established conditions for doing the homology search experiments with Rad51 and RecA it will be relatively simple to assess the behavior of additional recombination proteins that are known to align DNA sequences. Of particular interest is the human protein Rad52. Rad52 has recently been shown to catalyze recombination in vitro [Q53]. Notably, this reaction is independent of ATP hydrolysis. Rad52 also promotes the recombination activity of Rad51 [Q47, Q51, Q52]. GFP-labeled Rad52 is fully functional in vivo [Q22, Q24], and we have made and purified a GFP-tagged version of Rad52 for in vitro experiments. Using our TIRFM assays we will test this protein both on its own and in combination with Rad51 to assess how it promotes homologous recombination.

### Summary of Data Interpretation

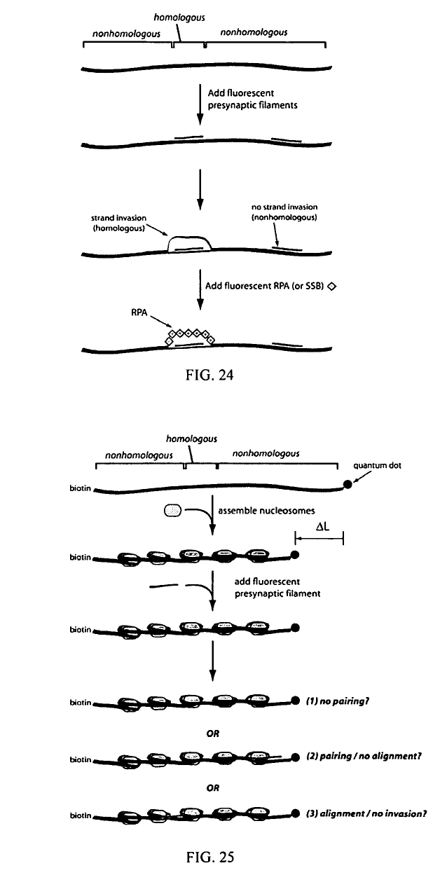

These experiments involve relatively complex manipulations of DNA molecules using non-traditional approaches and require careful consideration of many different variables in order to come to a reasonable conclusion about the homology search mechanism. To clarify how these data will be evaluated, an example of a flow chart that will be used to help guide the interpretation of the single-molecule homology search experiments described herein is shown in FIG. 23. There are three general questions that can be answered by our TIRFM experiments, which will reveal the homology search mechanisms for Rad51 and RecA. (1) First, does the recombinase-ssDNA complex move continuously in one dimension on the dsDNA? If so, the most likely mechanism is 1D-sliding. (2) Second, can we detect bridged intermediates (and does the reaction depend on the conformational entropy of the λ-DNA substrate)? Intersegmental transfer is the only mechanism that predicts the existence of bridged intermediates. (3) Third, is the progression of the reaction (after the initial collision event) dependent upon the concentration of free presynaptic filament (and, again, does the reaction depend on the conformational entropy of the λ-DNA substrate)? The rate of completely random collisions will be highly dependent upon the concentration of presynaptic filament, whereas the multiple collisions predicted to arise from hopping are not dependent on the concentration of free presynaptic filament. Many different variables are tested and the outcomes of these experiments may necessitate an alteration of the decision tree. Nevertheless, this logical progression of questions and experiments begins revealing the molecular mechanism of the homology search during DNA recombination. Regardless of the actual mechanism, the TIRFM single-molecule experiments described herein can readily distinguish between each of these four different possibilities.

### EXAMPLE 4

### Evaluating the Temporal Relationship Between DNA Alignment, Displacement of the Non-Complementary ssDNA Strand, and Extension of the dsDNA

The experiments described herein are designed to determine whether the complexes observed in the TIRFM experiments have undergone strand invasion, to determine the temporal relationship between strand alignment and strand invasion, to determine whether interactions between nonhomologous molecules produce transient intermediates with substantial single-stranded character, and to determine the relationship between DNA elongation and recombination.

Using RPA/SSB to Detect the Displaced ssDNA Strand

RPA and SSB are known proteins that play critical roles in the postsynaptic stages of recombination. [47-50] Strand invasion by a presynaptic filament results in the generation of an ssDNA loop (D-loop) corresponding to the non-complementary strand displaced from the invaded duplex DNA. Under normal conditions this ssDNA is bound by either SSB or RPA, which facilitates completion of the reaction and may protect the displaced strand from degradation by cellular nucleases. In the TIRFM assays described herein, strand invasion yields an ssDNA loop that serves as the binding substrate for fluorescent SSB or RPA. Therefore, the binding of these proteins to recombination products serves as a positive indicator that the DNA molecules have actually undergone recombination.

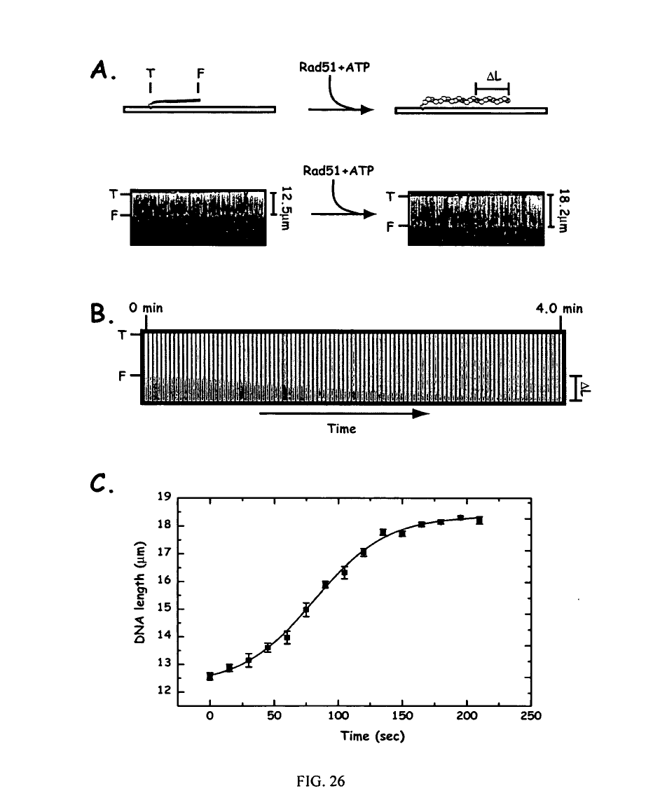

We have constructed fluorescent versions of human RPA and E. coli SSB using native chemical ligation, and these fluorescent proteins are functional in standard recombination assays. We will use our fluorescent versions of RPA and SSB to detect single-stranded regions in TIRFM experiments with fluorescent presynaptic filaments as described herein. The fluorescent Rad51 (or RecA) presynaptic filaments is injected along with fluorescent RPA (or SSB). By using RPA (or SSB) and Rad51 (or RecA) labeled with different fluorophores, we are able to simultaneously monitor strand alignment by the recombinase and the binding of RPA (or SSB) to the displaced ssDNA (FIG. 24). Homologous and nonhomologous ssDNA molecules are compared to ensure that the two different substrates are distinguished.

Several questions can be immediately addressed with this experimental design. First, have the complexes observed in our experiments undergone strand invasion? Does sequence alignment coincide with strand invasion or are these two events temporally distinct? Are regions of ssDNA generated when the presynaptic filaments interact with nonhomologous regions of dsDNA (i.e., is RPA associated with these transient intermediates)? If so, this would suggest that the filaments probe for sequence homology through intermediates that result in the generation of extensive D-loops. If not, then the presynaptic filament must probe the dsDNA though a mechanism that does not yield extensive regions of ssDNA. Finally, RPA and SSB are both critical components required for DNA replication. Therefore, as a longer-term goal these experiments with RPA and SSB will set the stage for studying the initiation of DNA replication after the completion of recombination.

### Monitoring DNA Extension During Strand Invasion

The binding of Rad51 or RecA to a single- or double-stranded DNA molecule results in the extension of the DNA molecule by approximately 50% relative to the length of λ-DNA. Similarly, when a Rad51-ssDNA filament invades a homologous duplex, the resulting double-stranded product bound by Rad51 is also expected to be in an extended conformation [Q79]. Extension of the dsDNA alters the pucker of the ribose rings and permits the bases to more readily rotate out of the helical duplex [Q80]. Base-rotation is thought to provide a mechanism allowing the Rad51 (or RecA) to probe the duplex for homologous sequences complementary to that of the ssDNA strand bound within the filament [Q81, Q82]. A hypothesis suggested by this is that the paired intermediates observed during the homology search should extend the dsDNA prior to strand invasion because the filaments would need to stretch the dsDNA to promote base-rotation when searching for homology. However, it is currently not known whether this extension of the invaded dsDNA molecules occurs before, during, or after strand invasion.

To clarify the role of DNA extension in homologous recombination the length of the λ-DNA is measured throughout the course of the reaction. With a 2 kb ssDNA substrate the resulting product is expected to increase in length by approximately 0.34 μm, which can be resolved by optical microscopy. Experiments are also conducted with ssDNA substrates of 5 or 10 kb in length, which would lengthen the λ-DNA by 0.85 and 1.7 μm, respectively. These length measurements are facilitated by attaching a fluorescent semi-conducting nanocrystal (quantum dot) to the end of the λ-DNA. The fluorescence emitted by the quantum dots appears as a very bright, diffraction-limited spot, which is highly photo-stable and is precisely monitored by single-particle tracking.

### Temporal Relationship Between Alignment, Extension and Strand Invasion

This experiment is designed to monitor multiple parameters at the level of a single recombination reaction, and incorporates aspects from all of the experiments described above. Specifically, we will attempt to concurrently monitor strand pairing and alignment by a fluorescent Rad51-ssDNA filament (or RecA), ssDNA displacement (i.e., strand invasion) and binding of fluorescent RPA (or SSB), as well as extension of the λ-DNA labeled at its free end with a quantum dot. These experiments are conducted as described above, with the fluorescent presynaptic filaments assembled in bulk and then injected into the sample chamber containing tethered molecules of λ-DNA. The precise experimental conditions and manipulations depend upon the outcome of the homology search experiments described herein; optimal conditions identified will be used for recombination in the TIRFM system. The progress of the homology search and strand invasion reactions as described above will be followed, while simultaneously monitoring the presynaptic filaments, the binding of RPA (or SSB), and the length of the λ-DNA. If strand alignment and invasion are temporally distinct, then we expect to first see the fluorescent filament align with the DNA molecule. Then, the fluorescent RPA should bind to the displaced ssDNA as strand invasion begins. Alternatively, if alignment and strand invasion are concurrent events then alignment of the DNA strands and the binding of fluorescent RPA will occur simultaneously. Similarly, these experiments would directly reveal at what point along the reaction trajectory the Rad51-ssDNA filament began extending the λ-DNA and would reveal whether this process is coupled to displacement of the ssDNA. It is likely that some extension of the dsDNA will occur as soon as the presynaptic filament pairs with the tethered λ-DNA, regardless of whether it is in contact with homologous or nonhomologous regions of the DNA. This hypothesis is based on the need for paired bases to rotate out of the duplex as the presynaptic filament probes the sequence of the dsDNA during the homology search. Once homology is located the λ-DNA should increase in length at a rate proportional to the rate of strand invasion and the final length should be proportional to the size of the Rad51-ssDNA filament.

### D2.4 Additional Considerations

(1) Fluorescent RPA and SSB. We have prepared fluorescent versions of RPA and SSB, and these proteins are functional in ensemble recombination experiments. Based on analysis using the TIRFM system, they do not interact nonspecifically with the lipid bilayer-coated surface; therefore, both proteins are suitable for the experiments described herein.

(2) DNA length measurements. If the reaction conditions for optimal recombination require the use of double-tethered DNA substrates then this method of measuring the DNA length will not be possible. However, DNAs tethered by two ends vibrate due to Brownian motion; the frequency and amplitude of these vibrations can be measured by TIRFM because their magnitude is on the order of 10's of nanometers, causing the emission intensity of fluorescently labeled DNAs fluctuate as the molecules move in and out of the evanescent field (unpublished). The magnitude of these vibrations depends on the length of the DNA (which is known) and the distance between the tethered ends (which is fixed and can easily be measured by visualizing the molecules with TIRFM). Therefore, by invoking the mathematical calculations derived from the well-established statistical mechanical treatment of DNA as a wormlike chain [Q83, Q84], TIRFM is used to measure the physical properties, such as tension and length, of the DNA molecules that are tethered by two ends. The binding of a Rad51-ssDNA filament to the double-tethered DNA results in an increase in the length of the DNA, and hence change the amplitude of the vibrations observed via TIRFM. These vibrations are measured in the x-y plane (based on the side-to-side motion of the DNA) and the z-direction (based on oscillations in the intensity of the DNA as it moves up and down within the evanescent field). As the Rad51 filament binds to and extends the dsDNA these vibrations are expected to increase in amplitude, thereby giving an alternative readout for the extension of the DNA.

(3) Summary of data interpretation. These experiments are performed essentially as described herein, with the exception that the association of RPA (or SSB) with the reaction intermediates and the length of the dsDNA is also monitored. The appearance of fluorescent signal from the RPA (or SSB) is interpreted as the production of a D-Loop coinciding with strand invasion, and the rate and extent of invasion is estimated based on the signal intensity. Similarly, extension of the dsDNA is used to estimate the extent to which the presynaptic filament is probing the dsDNA for homology via base rotation. Completion of strand invasion yields an extended dsDNA and the length increase is proportional to the size of the ssDNA used in the reaction. Homologous and nonhomologous ssDNAs are also compared.

### EXAMPLE 5

### Determining How Rad51 is Influenced by the Presence of Rad54 and Nucleosome Arrays

In vivo, recombination reactions must occur in the context of chromatin, a condensed DNA structure known to inhibit DNA recombination by Rad51 in vitro [Q55]. This inhibition can be overcome in the presence of the chromatin-remodeling protein Rad54, although the precise mechanism by which Rad54 functions is unknown [Q54, Q55, Q85]. Recombination on single DNA molecules bound by nucleosomes is examined.

### Determining the Effect of Rad54 on the Homology Search Mechanism of Human Rad51

Rad54 is a DNA-dependent ATPase that interacts with the Rad51 presynaptic filament and dramatically stimulates the rate of homologous recombination in vitro [Q59, Q70]. This protein is also a member of the SNF2-like family of chromatin remodeling enzymes and is thought to slide on DNA [Q86]. It has even been proposed that Rad54 stimulates recombination by promoting sliding of the presynaptic filament along the dsDNA [Q36]. Thus, although Rad51 is capable of aligning DNA sequences on its own, Rad54 may facilitate this process by serving as the natural motor protein that propels the Rad51 filament along the DNA [Q86].

The effect of Rad54 on the behavior of the Rad51-ssDNA filament during the homology search reaction is directly visualized. To test the influence of Rad54 on the homology search mechanism, experiments are performed with fluorescent Rad51 and unlabeled Rad54 protein. First, fluorescent Rad51 filaments is assembled on ssDNA substrates as described herein. These filaments are mixed with Rad54 and injected into the sample chamber, and the reaction mechanism is evaluated following the same criteria presented herein (FIG. 23). There are two possible outcomes: (1) Rad54 will either increase the rate at which the presynaptic filament locates the region of homology without altering the actual reaction mechanism, or (2) Rad54 will alter the mechanism with which the homology search is conducted. For example, if the Rad51 filament search occurs through an intersegmental transfer mechanism, then the mechanism may change to sliding when Rad54 is included. If Rad54 promotes the homology search mechanism by causing the Rad51 presynaptic filament to slide on DNA, then the fluorescent filaments will bind directly to the tethered dsDNA and slide rapidly along the helical axis. Once the filament encounters the region of homology it is expected to stop sliding and remain bound to the dsDNA.

The effect of Rad54 on recombination is dependent upon ATP hydrolysis. If Rad54 alters the homology search mechanism, then the effect of ATP hydrolysis on the reaction is also examined. Presynaptic complexes made with fluorescent Rad51 are mixed with unlabeled Rad54 and injected into the sample chamber, as described above. Once a presynaptic filament binds to a dsDNA molecule the sample chamber is rapidly flushed with buffer containing ADP, ATPγS, or no nucleotide, and the reaction is monitored with TIRFM. As an additional control, Rad54 with mutations in the ATPase Walker A box are also tested. These mutant proteins have been fully characterized; they do bind to DNA, but they do not hydrolyze ATP, and they do not stimulate recombination [Q70, Q86]. (FIG. 23).

### Determining how the Homology Search and Strand Invasion Mechanisms are Influenced by the Presence of Nucleosome Arrays:

Single-molecule TIRFM experiments using arrays of λ-DNA molecules that are bound by fluorescent nucleosomes are performed.

(1) Construction of fluorescent nucleosome arrays. Plasmids for the expression of H2A, H₂B, H3, and H4 were a kind gift from Dr. Karolin Luger (Colorado State University). Recombinant nucleosomes are expressed and purified from E. coli as previously described [Q71]. H2A, 2B, and H4 have no cysteines. H3 has a single surface cysteine, which we have mutated to serine as previously described [Q87]. A single normative cysteine is introduced into H2A at S113, and this is used as an attachment point for a thiol-reactive fluorescent dye. The fluorescent nucleosomes is then assembled onto dsDNA as previously described [Q88, Q89]. Other groups have reported construction, labeling, and characterization of fluorescent nucleosomes as well as methods for assembling nucleosome arrays on dsDNA [Q71, Q87-Q91].

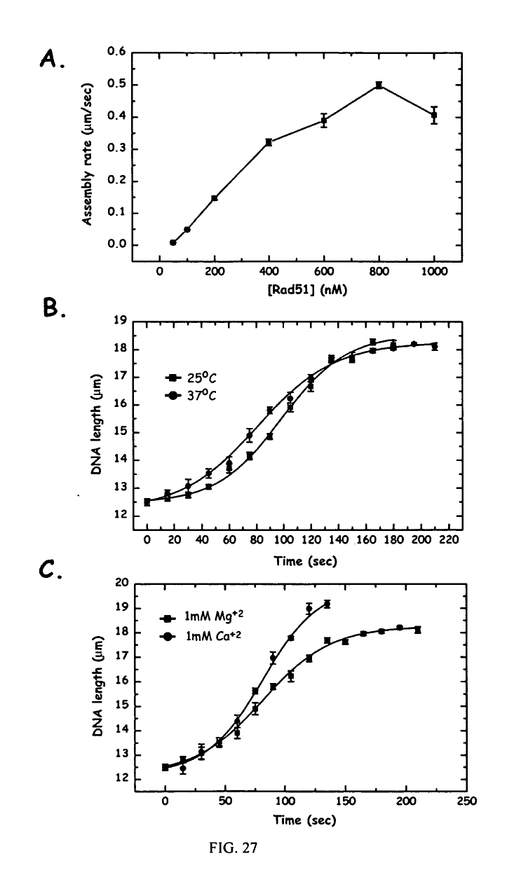

(2) Studying recombination on nucleosome-coated DNA. These experiments directly reveal which step of the recombination reaction is hindered by the presence of the nucleosome. The experiments for studying recombination in the context of nucleosome arrays is outlined in FIG. 25. Rather than labeling the DNA with YOYO1, it is labeled with the fluorescent nucleosomes. These DNA molecules are also labeled at their free end with a quantum dot to allow concurrent measurement of their contour length. Assembly of the nucleosomes results in compaction of the DNA, with the final length being proportional to the number of nucleosomes bound. Once the nucleosomes are assembled, the λ-DNA molecules are tethered in a parallel array on the surface of a microfluidic sample chamber (as described herein). Fluorescent presynaptic filaments are then injected into the sample chamber and the reaction monitored with TIRFM. Nucleosomes greatly inhibit recombination in vitro, suggesting three likely outcomes (FIG. 25). (1) First, it is possible that the nucleosomes will completely prevent the presynaptic filaments from pairing with the tethered λ-DNA substrates, in which case we will never see the Rad51-ssDNA complexes interacting with the tethered DNA molecules. We consider this possibility unlikely because there should still be a substantial amount of accessible DNA between adjacent nucleosomes that would be available for interaction with the presynaptic filament. A (2) second possibility is that the Rad51-ssDNA filaments would pair with the λ-DNA, but the nucleosomes may prevent the homology search, possible by rendering the regions bound by nucleosomes inaccessible for sampling by the filament. In this case, we would see the filaments bind to the DNA, but they would not align with the correct region. (3) Third, it is also possible that the Rad51-ssDNA filaments will be able to pair and align with the λ-DNA, but they will not be able to invade the duplex due to the bound nucleosomes.

(3) Influence of chromatin remodeling enzymes. While Rad54 is known to remodel chromatin, the definition of this function and its role in homologous recombination is poorly understood. It is possible, for example, that Rad54 completely removes nucleosomes from the double-stranded substrate, allowing recombination to proceed unhindered. Alternatively, remodeling may involve a more subtle reorganization of the nucleosomes without displacement from the DNA. This in turn may make the dsDNA accessible to the Rad51 presynaptic filament. It is these two models that we will investigate with our TIRFM experiment. If the Rad54-Rad51-ssDNA complex completely removes the nucleosomes from the λ-DNA, then we will see a concomitant loss of fluorescent signal from the nucleosomes in the region where recombination occurs, and a corresponding increase in the λ-DNA length in proportion to the size of the invading ssDNA and the number of nucleosomes displaced. Conversely, if remodeling does not involve the removal of the nucleosomes from the DNA, then these experiments will reveal colocalization of the histones and the Rad51 in the same location on the DNA.

### Additional Considerations

(1) Nonspecific surface interactions. Should the nucleosome arrays interact nonspecifically with the lipid bilayer, the use of other types of surface modifications is evaluated and whether they are suitable for our experiments is determined [Q31, Q73].

(2) Recombinant nucleosomes. These experiments utilize arrays assembled from recombinant nucleosomes that are expressed in bacteria. Prior to performing the TIRFM experiments, the assembly and structure of the nucleosome arrays is verified using micrococcal nuclease digestion and electron or atomic force microscopy; their inhibitory effect on DNA recombination is also verified in standard gel-based assays. The use of recombinant histones is necessary to allow site-specific fluorescent labeling, and labeling cannot be accomplished with nucleosomes prepared from eukaryotic nuclear extracts. Simple nucleosome arrays in which the individual nucleosomes are separated by stretched of linker DNA (so called “beads-on-a-string” [Q88]) are used. Alternatively, the assays described herein are performed with higher-order structures, such as 30 nm fibers, and how the recombination machinery interacts with these highly condensed DNA structures is examined. Additionally, the core histones expressed in bacteria are not subject to post-translational modification (acetylation, methylation, or phosphorylation). Thus, alternatively, the functional consequences of post-translational modifications are examined by using homogeneous populations of in vitro-modified histones.

These experiments will all rely on bacteriophage λ-DNA as the substrate, and although this is not eukaryotic DNA, it has nonetheless proven useful as a model system for studying chromatin assembly and disassembly and will suffice for all of the assays described herein ([Q88] and references therein). Alternatively, different DNA substrates are used, such as those that are known to contain strong nucleosome positioning sequences [Q91].

### EXAMPLE 6

### Visualization of Assembly of Rad51 Filaments on Double-Stranded DNA

Rad51 is the core component of the eukaryotic homologous recombination machinery and assembles into extended nucleoprotein filaments on DNA. To study the dynamic behavior of Rad51 we have developed a single-molecule assay that relies on a combination of hydrodynamic force and microscale diffusion barriers to align individual DNA molecules on the surface of a microfluidic sample chamber that is coated with a lipid bilayer. When visualized with total internal reflection fluorescence microscopy (TIRFM), these “molecular curtains” allow for the direct visualization of hundreds of individual DNA molecules. Using this approach, we have analyzed the binding of human Rad51 to single molecules of double-stranded DNA under a variety of different reaction conditions by monitoring the extension of the fluorescently-labeled DNA, which coincides with assembly of the nucleoprotein filament. We have also generated several mutants in conserved regions of Rad51 implicated in DNA binding, and tested them for their ability to assemble into extended filaments. We show that proteins with mutations within the DNA-binding surface located on the N-terminal domain still retain the ability to form extended nucleoprotein filaments. Mutations in the L1 loop, which projects towards the central axis of the filament, completely abolish assembly of extended filaments. In contrast, most mutations within or near the L2 DNA-binding loop, which is also located near the central axis of the filament, do not affect the ability of the protein to assemble into extended filaments on dsDNA. Taken together, these results demonstrate that the L1-loop plays a crucial role in the assembly of extended nucleoprotein filaments on dsDNA, but the N-terminal domain and the L2 DNA-binding loop have significantly less impact on this process. The results presented here also provide an important initial framework for beginning to study the biochemical behaviors of Rad51 nucleoprotein filaments using our novel experimental system.

### Introduction.

The recognition and repair of damaged DNA is essential for maintaining genome integrity, and cells have developed several different mechanisms for efficiently locating and correcting various types of lesions^{J1;J2}. Double-stranded DNA breaks (DSBs) are a particularly dangerous form of damage, and a single DSB can lead to catastrophic consequences for the cell if left unrepaired or repaired incorrectly. Homologous recombination is considered an error-free pathway to repair DSBs and the core protein components of this pathway are conserved throughout biology^{J2;J3}. In eukaryotes, Rad51 catalyzes the key steps of DNA pairing and strand invasion during homologous recombination. The importance of Rad51 was demonstrated by the finding that homozygous null Rad51 mutations in mice are embryonic lethal^{J4}. In addition, some forms of hereditary cancer in humans are linked to defects in homologous recombination, and the protein BRCA2 (Breast Cancer Associated Gene 2) is thought to direct the assembly of Rad51 at sites in need of repair^{J5;J6;J7;J8}.

Rad51 belongs the RecA/Rad51/Dmc1/RadA superfamily of DNA recombinases, all of which perform similar functions during homologous DNA recombination^{J3;J9}. Some well-studied members of this family include UvsX from bacteriophage T4, RecA from E. coli, archeal RadA, and Rad51 from humans and S. cerevisiae³. Rad51, like the other recombinases, assembles into extended nucleoprotein filaments on the ends of damaged chromosomes and these filaments promote pairing of the broken end with homologous sequence present elsewhere in the genome^{J10;J11}. Once paired, Rad51 catalyzes a strand invasion reaction wherein the broken chromosome end invades the homologous duplex, resulting in the displacement of the noncomplementary strand from the homologous double-stranded DNA (dsDNA). These interlinked intermediates are processed further by the recombination machinery to eventually yield a repaired product in which missing DNA sequence has been replaced using genetic information derived from the homologous template^{J1;J2;J11}.

Rad51 is also a member of the RAD52 epistasis group of genes, which were initially identified in S. cerevisiae as mutants susceptible to DNA-damaging agents. Included among this group of genes are RAD50, RAD52, RAD54, RDH54/TID1, RAD55, RAD57, RAD59, MRE11, DMC1, and XRS2^{J12;J13}. In higher eukaryotes there are several Rad51 homologs (Rad5B, Rad51C, Rad51D, Xrcc2, and Xrcc3), but none of these can substitute for Rad51 in cell survival, emphasizing the key role that the protein plays in vertebrate cells^{J14;J15;J16}. Although the functions that many of these proteins play in homologous recombination remain unknown, in several cases they are thought to facilitate the assembly of the Rad51 filament and/or regulate its biochemical properties.

Human Rad51 is a DNA-dependent ATPase comprised of 339 amino acids and contains Walker A and Walker B nucleotide-binding motifs, which together form the ATPase active site^{J10;J17;J18}. The ATP-binding core of Rad51 is homologous to that found in bacterial RecA with nearly 30% sequence identity across this region of the protein^{J3;J10}. The higher order structures of the nucleoprotein filaments formed by human Rad51, E. coli RecA and several related proteins have been studied extensively by electron microscopy and crystallography^{J99;J20;J21;J22;J23;J24;J25;J26}. A common trait of these recombinase filaments is that they form right-handed helical structures and the DNA within the center of the protein filament is extended by as much as 50% relative to the length of B-DNA. The DNA is also untwisted from ˜10 to ˜19 base pairs per turn, and stretched from a 3.4 Å rise to ˜5.1 Å rise per base pair in the nucleoprotein filament^{J27}. These parameters are somewhat variable, and the pitch of the filament can change in response to different ligands or reaction conditions and can even vary within the same nucleoprotein filament. In general, filaments that are inactive for DNA strand exchange have lower pitches than active filaments (˜65-85 Å for the inactive form versus ˜90-130 Å per turn for the active form). In addition to filaments, many RecA-like proteins can also form ring-like structures comprised of 6-8 subunits, which contain a central pore large enough (internal diameter of ˜30 nm) to allow passage of a dsDNA molecule^{J16;J21;J25;J28}. Although the function of the rings and compressed filaments remains unknown, they are evolutionarily conserved, strongly implying biological importance^{J21;J25;J28}.

Despite this wealth of biochemical and structural information, many aspects of recombination remain poorly understood. For example it is still unclear precisely where the DNA molecules reside within the nucleoprotein filaments. It also remains unclear what regulates the transition between the different structural forms of the protein, whether these different forms are mechanistically relevant, or how these filaments function during recombination to locate and align homologous sequences and promote subsequent strand exchange.

To study the dynamic behavior of Rad51 we have developed a total internal reflection fluorescence microscopy (TIRFM) assay that relies upon fluorescently-labeled DNA molecules organized into defined patterns on the lipid bilayer-coated surface of a microfluidic sample chamber^{J29;J30}. This assay allows us to directly visualize hundreds of individual DNA molecules, in real-time, within a single experiment. We have taken advantage of this assay to monitor the assembly of the recombinase filaments on dsDNA molecules that are labeled with the fluorescent intercalating dye YOYO1^{J33;J34}. Using this approach we have probed the assembly of the Rad51 nucleoprotein filaments under a variety of different reaction conditions. We have also prepared proteins with single point mutations and examined the influence of these mutations on the assembly of the nucleoprotein filaments. Point mutations within the N-terminus, which has been proposed to interact with dsDNA, do not prevent filament formation. However, these N-terminal mutations do reduce the efficiency of in vitro DNA strand exchange reactions. Mutations in the L1 DNA-binding loop completely disrupt formation of extended nucleoprotein filaments on dsDNA and also eliminate strand exchange activity. In contrast, mutations in L2 have little effect on filament extension and result in only a modest decline in strand exchange efficiency.

### Results.

### TIRFM Assay for Monitoring the Assembly of Rad51 Filaments.

For our assay, microscale mechanical barriers to lipid diffusion were etched into the surface of a fused silica slide, which was then coated with a lipid bilayer comprised of DOPC and 0.5% biotin-DOPE^{J29;J31}. Neutravidin was injected into the sample chamber, where it bound to the biotinylated lipid head groups within the bilayer. After a short incubation, the excess neutravidin was washed away and biotinylated k-DNA (48,502 base pairs) was injected into the sample chamber where it could bind to the tetravalent neutravidin tethered to the bilayer. The individual lipids that make up the bilayer are free to diffuse within the two-dimensional plane of the membrane, but they can not cross the microscale diffusion barriers^{J31}. Therefore, the DNA molecules moved in the direction of buffer flow with their tethered ends dragging along within the bilayer, but they stopped moving when they encountered the diffusion barriers. This procedure yielded a “molecular curtain” comprised of aligned DNA molecules located at predefined positions on the sample chamber surface^{J29}.

With TIRFM, a laser beam is reflected off the interface formed between two transparent media with differing refractive indexes (i.e. a fused silica slide and an aqueous buffer). This generates a standing wave referred to as an evanescent field, which penetrates approximately 150 nanometers (nm) into the aqueous solution^{J32}. The flow force used to align the DNA also extends the molecules parallel to the surface and confines them within the excitation volume defined by the penetration depth of the evanescent field.

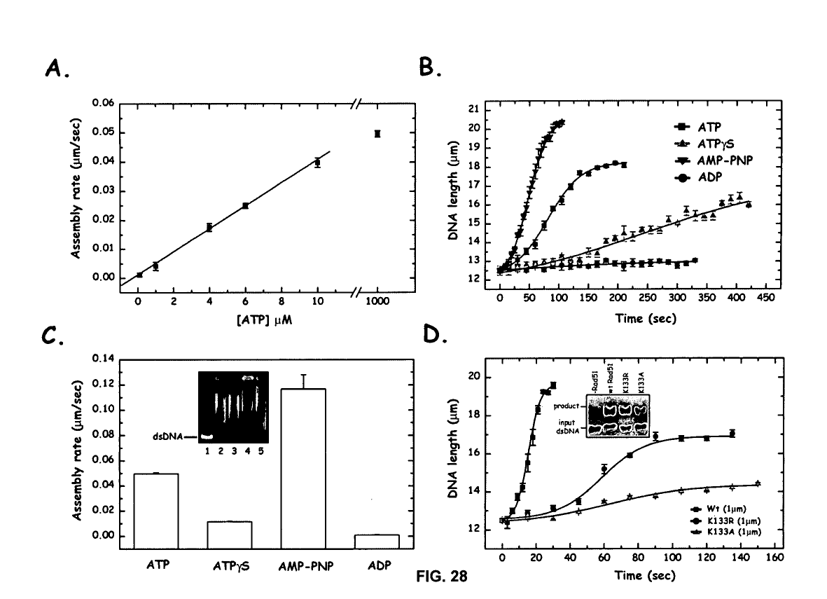

FIG. 26A illustrates how the assembly of Rad51 filaments was monitored. Rad51 and ATP were injected into the sample chamber at a constant flow rate using a syringe pump system and switch valve, and data capture was initiated just before the protein entered the flowcell. Two effects were immediately apparent: First, the DNA molecules increased in length, indicating that the protein assembled into extended filaments (FIGS. 26A and 26B). Second, the extension of the DNA was accompanied by a concomitant decrease in the intensity of the YOYO1 signal (FIG. 26B). This decreased signal from the fluorophore was consistent with previous work, which has demonstrated that Rad51 and other RecA-like proteins can eject intercalating dyes such as ethidium bromide and DAPI from double-stranded DNA^{J35}. We compensated for the decreased signal by including a small amount of free YOYO1 (0.5 nM) in the reaction buffer, which was sufficient to visualize the DNA under most reaction conditions. These low concentrations of YOYO1 did not interfere with an in vitro DNA strand exchange assay using plasmid-sized substrates (φX174), indicating that the presence of the dye was unlikely to adversely affect the behavior of the protein. However, at the highest concentrations of Rad51 tested (1 μM) the signal from the fluorescent dye completely disappeared and we were unable to compensate for this loss of signal by the inclusion of additional dye. This loss of signal compromised our ability to monitor the DNA molecules when they were completely coated with Rad51 (see below).

### Influence of Reaction Conditions on the Assembly of Human Rad51 Nucleoprotein Filaments.

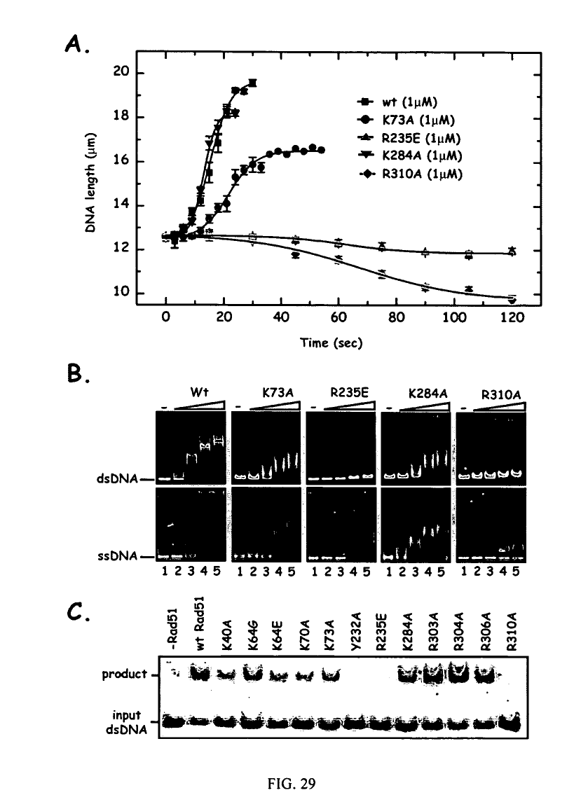

To begin probing the assembly mechanism, we compared the rates at which the DNA molecules were lengthened under a variety of different reaction conditions. FIG. 26C shows the length of the DNA plotted as a function of time after the injection of Rad51. At 100 nM Rad51, it took approximately 3 minutes for the reaction to reach completion. The overall shape of the assembly curves was sigmoidal, but there was no extensive lag between the time that the protein entered the sample chamber and the time that the DNA began to lengthen. If nucleation was rate limiting and continued polymerization was highly cooperative, as is the case for binding of bacterial RecA to dsDNA^{J36}, then it would be expected that some of the DNA molecules would begin to extend before others. However, all of the individual DNA molecules began to lengthen in unison. These observations suggested that nucleation events were not rate limiting and assembly was weakly cooperative. To approximate rates we used least squares regression to fit the central portions of the extension curves to a linear equation. As indicated in FIG. 27A, under these reaction conditions the assembly rates ranged from 0.008 em/sec at 50 nM Rad51, up to 0.50 μm/sec at 800 nM Rad51. These apparent assembly rates were comprised of two parameters, the rate of nucleation and the rate of oligomerization; however, our current experimental set up did not allow us to directly measure these parameters independently.

With 100 nM Rad51 and 1 mM ATP the assembly reactions reached a plateau when the DNA had gone from a length of 12.5 μm up to 18.2 μm, which corresponds to an apparent increase of 46% in length. With 1 μM Rad51 we observed an apparent increase of 57%, which is somewhat longer than the expected increase of 50%. This larger than expected increase in contour length can be explained by considering the behavior of surface-tethered polymers^{J37;J38}. The DNA molecules are subject to (a) Brownian motion, (b) shear flow in a laminar system^{J3;J38}, and (c) an increase in persistence length that occurs as the protein filaments assembled onto the DNA^{J33;J39}. All of these effects influence the observed lengths of the DNA molecules in a given TIRFM experiment. Due to the combination these influences, the DNA is only stretched to 12.5 μm in the absence of protein (i.e., ˜80% of its full contour length). As Rad51 binds the DNA, it becomes easier to stretch the DNA-protein complexes out to their full lengths at a constant flow velocity due to the increased persistence length that accompanies filament assembly. Therefore, the increased length of the DNA was consistent with the formation of an extended Rad51 filament.

To determine the effect of temperature on nucleoprotein filament assembly, reactions were performed under identical buffer conditions at 25° C. and 37° C. As shown in FIG. 27B, Rad51 could assemble into an extended filament at either 25° C. or 37° C., although there was a reproducible, albeit very small, increase in the assembly rate at 37° C. Therefore, all subsequent experiments were performed at 37° C. We also observed a slight increase in both the rate of filament formation and the final length of the filaments formed in the presence of Ca²⁺ (FIG. 27C). In fact, assembly in the presence of Ca²⁺ was so efficient that the YOYO1 signal was rapidly lost as the DNA stretched beyond ˜19 μm. Previous studies have shown that DNA recombination by human Rad51 is dramatically stimulated in the presence of calcium^{J40;J41}. This stimulatory effect is thought to result from a reduced k_{cat} for ATP hydrolysis in the presence of Ca²⁺, the effect of which is to maintain the Rad51 filament in an activated, ATP-bound state^{J40}. Rad51 filaments observed with AFM in the presence of Mg²⁺ were highly irregular and did not resemble the more stable structures formed in the presence of ATP and calcium^{J41}.

### The Influence of Nucleotide Cofactors and ATPase Mutations on the Assembly of the Extended Rad51 Filament.

To examine the role of the ATPase activity in DNA binding and nucleoprotein filament assembly, we visualized DNA extension using wt Rad51 in the presence of various nucleotides and nonhydrolyzable nucleotide analogs. With wild-type Rad51 we saw efficient filament assembly in the presence of 100 nM protein and 1 mM ATP, and we relied on this set of conditions as a reference to evaluate the effects of changing other reaction parameters.

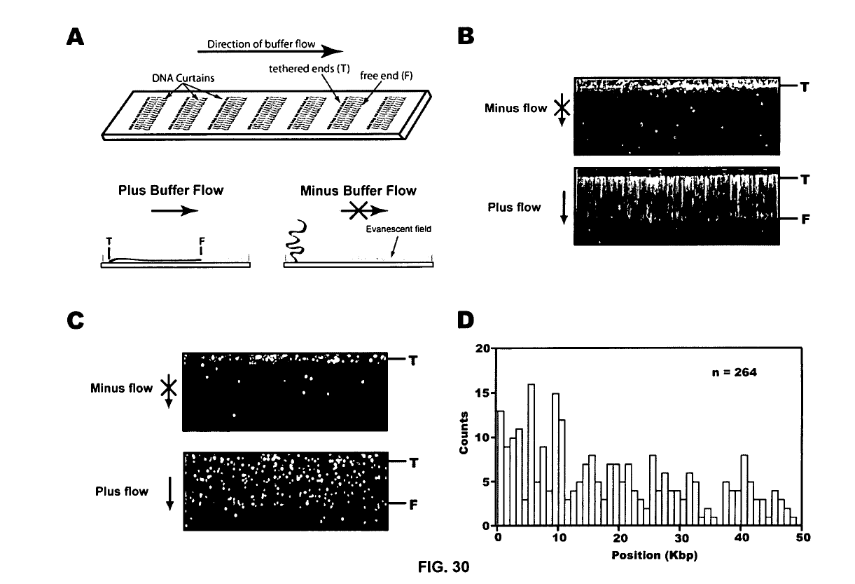

We began by testing the ATP-concentration dependence of the assembly reaction. Similar assembly rates were observed with as little as 10 μM ATP, but the extension rate declined rapidly below this concentration (FIG. 28A). We next tested whether ADP could support assembly of the extended nucleoprotein filament^{J42}. When ADP was the only nucleotide cofactor present in the reaction buffer no DNA extension was observed (FIGS. 28B and 28C). We considered the possibility that with ADP, the concentration of Rad51 may have been too low, however, even at a 10-fold higher protein concentration we did not detect any DNA extension in the presence of ADP. Despite the absence of DNA extension, it was likely that the protein was bound to the DNA. This conclusion was supported by gel-shift experiments, which revealed that Rad51 displayed DNA-binding activity in the presence of ADP comparable to that observed with ATP, as had previously been reported (FIG. 28C, inset)^{J42}.

Nonhydrolyzable or slowly hydrolyzed nucleotide analogs such as AMP-PNP and ATPγS, are often used to probe the role of ATP binding and hydrolysis by RecA-like proteins or to lock the proteins in a specific structural context^{J20;J43;J44;J45;J46}. With our TIRFM assay, extension of the DNA was observed when either ATPγS or AMP-PNP was used as the nucleotide cofactor (FIGS. 28B and 28C). At 100 nM Rad51, the final lengths of the nucleoprotein filaments were 18.2 μm and 20.5 μm with ATP and AMP-PNP, respectively. The apparent rate of assembly with ATPγS was reduced about 5-fold compared to that observed with ATP, and these reactions failed to plateau even after 7 minutes (FIG. 28B). In contrast, the assembly rate with AMP-PNP was actually 2.4-fold greater than that observed with ATP, and 12-fold greater than the assembly rates observed with ATPγS (FIGS. 28B and 28C). These results were consistent with previous studies and confirmed that Rad51 displayed normal behavior in the TIRFM assay.

ATPase deficient mutants of human Rad51 were also tested for filament assembly. The K133R mutation within the Walker A motif of human Rad51 yields a protein that binds ATP, but its hydrolysis activity is significantly reduced^{J43}. This protein binds DNA in vitro and can also promote DNA strand exchange^{J43}. In fact, recent studies have shown that Rad51-K133R produces more products than the wild-type protein in an in vitro strand exchange reaction^{J43}. We confirmed this finding for Rad51-K133R using an oligonucleotide-based strand exchange assay (FIG. 28D, inset)^{J47}. To determine whether Rad51-K133R could assemble into filaments, the mutant protein was injected into a sample chamber, and the length of the tethered DNA molecules was monitored over time. As illustrated in FIG. 28D, Rad51-K133R was able to assemble into an extended nucleoprotein filament on the dsDNA, however the extension rate was reduced relative to wild-type Rad51 (181 nm/sec versus 407 nm/sec) and the extension stopped earlier than was observed for the wild-type protein (17.0 μm versus 19.6 μm). These data would suggest that the K133R mutant either forms a filament with reduced helical pitch or that it does not cover the DNA to the same extent as wt Rad51 under these buffer conditions.

We also tested the DNA extension activity of Rad51-K133A (FIG. 28D). Previous work demonstrated that this mutant protein does bind to DNA, but it is defective for recombination^{J43}. We saw some DNA extension in the TIRFM assay at 1 μM Rad51-K133A, but the assembly reactions with K133A reached a plateau well short of that observed for wt Rad51 (14.4 μm for K133A versus 19.6 μm for wt Rad51). Moreover, previous reports have shown that Rad51 K133A can bind to dsDNA with a similar affinity as observed for wt Rad51. As expected, the Rad51-K133A mutant was compromised for in vitro strand exchange (FIG. 28D, inset). These data, taken together with previous reports, indicated that Rad51-K133A was unable to efficiently form a fully extended helical filament on dsDNA.

Mutations in the N-Terminal dsDNA-Binding Domain do not Prevent Nucleoprotein Filament Assembly

The N-terminal domain of Rad51 is conserved between the eukaryotic Rad51 and archeal RadA, however its precise function has remained enigmatic. The NMR structure and chemical shift perturbation experiments of the isolated N-terminal domain from human Rad51 have implicated that the positively charged region of this surface was important for dsDNA-binding^{J48}. This domain resembles a lobe that protrudes along the helical groove formed by the extended nucleoprotein filament^{J20}. This groove wraps around the outside of the filament and most likely forms the entry site for incoming molecules of dsDNA during DNA strand exchange.

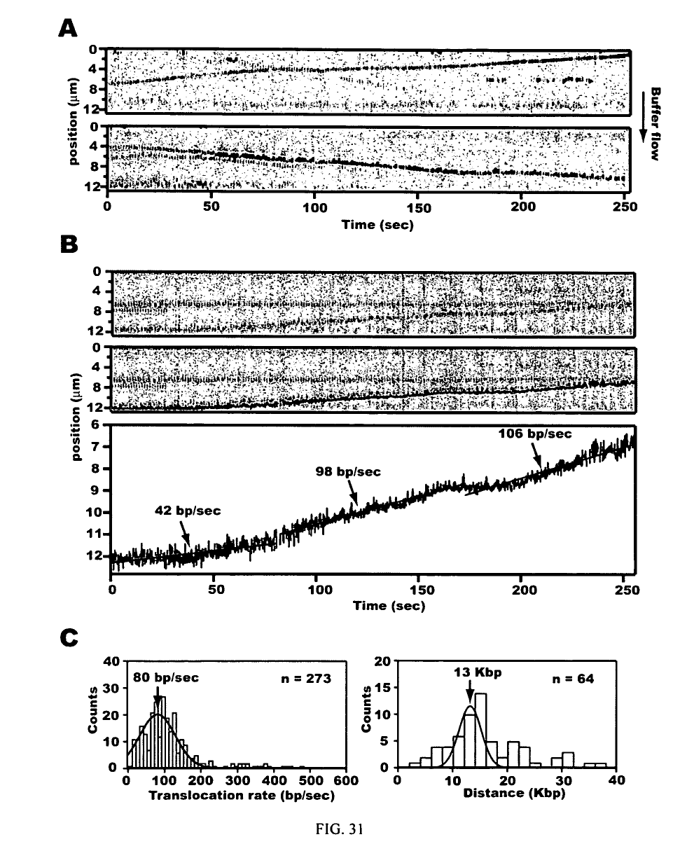

We tested several mutations designed to disrupt the putative DNA-binding surface within the N-terminal domain (Tables 1 and 2). Amino acids K40, K64, K70, and K73 form a contiguous patch of positive electrostatic potential on the exposed surface of the N-terminal domain. At 100 nM protein, each of these mutant proteins showed a reduction in the rate and end-point of DNA extension compared to wt Rad51. Yet, when the concentration of protein was increased to 1 μM, each of the mutants was able to stretch the DNA (Table 2). Therefore, mutations in the N-terminal domain did not prevent formation of the extended nucleoprotein filament. However, each of these mutants had significantly reduced strand exchange activity (FIG. 29 and Table 2). Together these results indicated that interactions with the N-terminal DNA-binding surface were not essential for filament assembly. However, the reduced strand exchange efficiency observed for the N-terminal mutants suggests that these mutations may affect the ability of Rad51-ssDNA filaments to interact with an incoming duplex DNA strand during homologous recombination.

TABLE 1

| Mutations | Location | Function |
|---|---|---|
| K40A | N-terminus | DNA binding |
| K64G | | |
| K64E | | |
| K70A | | |
| K73A | | |
| K133A | Walker A motif | ATP binding & |
| K133R | | hydrolysis |
| Y232A | L1 loop | DNA binding |
| R235E | | |
| K284A | L2 loop | DNA binding |
| R303A | L2 region | Putative DNA |
| K304A | | binding |
| R306A | | |
| R310A | | |

TABLE 2

| | TIRFM assays^{a} | | | Bulk assays | | |
|---|---|---|---|---|---|---|
| Rad51 | Assembly rate | Final length | | dsDNA^{b} | ssDNA^{b} | % Strand exchange^{c} |
| Mutations | (nm/sec) | (μm) | % Increase | binding | binding | product |
| Wild-type | 407_{±26} | 19.6 | 57 | ++ | ++ | 40.2_{±3.1} |
| K40A | 180_{±20} | 17.8 | 42 | + | + | 19.2_{±2.8} |
| K64G | 311_{±10} | 18.6 | 49 | + | + | 26.2_{±2.8} |
| K64E | 400_{±8} | 20.9 | 67 | + | + | 13.5_{±0.7} |
| K70A | 238_{±10} | 18.7 | 50 | + | + | 7.2_{±6.5} |
| K73A | 156_{±9} | 16.8 | 34 | + | + | 21.9_{±6.7} |
| K133R | 181_{±10} | 17.0 | 36 | + | + | 48.7_{±3.5} |
| K133A | 16.4_{±0.8} | 14.4 | 15 | + | + | 18.7_{±4.3} |
| Y232A | −0.3_{±0.6} | 12.5 | 0 | + | + | 2.9_{±2.9} |
| R235E | −11.3_{±1} | 11.9 | −5 | − | + | 1.8_{±1.8} |
| K284A | 515_{±30} | 18.1 | 45 | + | + | 25.0_{±4.2} |
| R303A | 438_{±20} | 20.1 | 61 | + | + | 37.1_{±0.7} |
| K304A | 185.5_{±10} | 18.2 | 46 | + | + | 38.5_{±2.9} |
| R306A | 334_{±10} | 17.4 | 49 | + | + | 36.6_{±1.0} |
| R310A | −32_{±2} | 9.7 | −22 | − | + | 1.7_{±1.3} |

^{a}All values were obtained with 1 μM Rad51. Assembly rates and length measurements were performed as described in the materials and methods.
^{b}DNA-binding assays were performd using either linear dsDNA or circular ssDNA (φ × 174). The relative binding ability of the different proteins was based on visual inspection of gels stained with ethidium bromide (refer to FIG. 6B for representative examples).
^{c}Strand exchange assays used oligonucleotide substrates labeled with Cy3 (see materials and methods) and quantitation was performed in NIH Image J. Each reaction was performed in triplicate and reported as percent of total DNA that formed product ± standard deviation. Examples of these assays are shown in FIG. 4D and FIG. 6C.

Mutations in the Conserved L1 and L2 DNA-Binding Loops have Differential Effects on dsDNA Extension.

Amino acids within the L1 and L2 loops of the protein project towards the central axis of the helical filament and form a surface with positive electrostatic potential that is poised to interact with bound DNA molecules. However, it is unclear how these DNA-binding loops function during recombination, nor is it known which region binds to dsDNA and which binds to ssDNA. To assess the roles of the L1 and L2 loops in the assembly of extended Rad51 filaments on dsDNA we made point mutations within these conserved regions and tested the purified proteins with the TIRFM assay.

In human Rad51, Y232 is within the L1 loop and lies near the central axis of the extended nucleoprotein filament, consistent with the presumed location of the primary DNA-binding site. Experiments with Rad51-Y232A revealed that it was unable to form an extended helical filament on the dsDNA (FIG. 29A and Table 2). However, the protein did cause the DNA to become slightly more compact over time, suggesting that it was binding to the DNA in some alternative conformation. This conclusion was confirmed in gel-shift assays, which showed that the Y232A protein was able to bind both dsDNA and ssDNA, albeit at reduced levels compared to wt Rad51 (Table 2). Rad51-Y232A was also unable to promote in vitro strand exchange using oligonucleotide substrates (FIG. 29C and Table 2), providing further evidence of a severe defect in formation of active filaments.

The amino acid R235 also lies within the L1 loop near the central axis of the Rad51 nucleoprotein filament. To further evaluate the role of this amino acid we purified Rad51-R235E and tested its ability to form nucleoprotein filaments on dsDNA. This L1 mutant protein was unable to extend the dsDNA, even at Rad51 concentrations as high as 1 μM. Moreover, bulk gel-shift experiments confirmed that this protein was highly defective in dsDNA binding, yet still retained the ability to bind to ssDNA, albeit more weakly than wt Rad51. Based on the increased assembly rate and DNA extension observed with wt Rad51 and AMP-PNP, we considered the possibility that this nonhydrolyzable ATP analog might be able to promote filament assembly with the L1 mutant proteins. However, neither Y232A nor R235E were able to extend the DNA even when AMP-PNP was used as the nucleotide cofactor. Both mutant proteins were also significantly compromised in their ability to promote strand exchange with oligonucleotide substrates (Table 2 and FIG. 29). The results for Y232 and R235 indicated that interactions between the L1 loop and the dsDNA were necessary for assembly of the extended form of the nucleoprotein filament.

Like L1, the L2 loop and the adjacent L2 elbow both project into the central axis of the nucleoprotein filament. However, in contrast to the L1 mutants, the L2 mutation K284A did not disrupt DNA binding or dsDNA extension (FIG. 29B). However, this mutant did display somewhat reduced efficiency in the recombination assay (FIG. 29 and Table 2). Several basic amino acids from a β-strand immediately adjacent to the L2 loop also project into the filament axis and contribute to the positive electrostatic potential of this putative DNA-binding region. Therefore, we considered the possibility that this entire surface, and not just L2, may comprise an important DNA-binding domain; for the sake of convenience we refer to this as the L2 region. The mutations R303A, K304A, and R306A, all of which are next to the L2 elbow region (Table 1), had no effect on the ability of human Rad51 to assemble into an extended helical filament on the dsDNA and also had little or no effect on in vitro recombination (Table 2 and FIG. 29C). These results indicate that the L2 region of human Rad51 was not essential for either dsDNA binding, assembly of the extended nucleoprotein filament on dsDNA, or in vitro strand exchange.

Previous studies with human Dmc1 showed that an R311A mutation yielded a protein that was able to bind to dsDNA, but was unable to bind ssDNA^{J26}, which suggested that this mutation might provide a simple way of distinguishing different DNA binding surfaces on the protein. Therefore we made the equivalent mutation in Rad51 (R310A) and tested this mutant for the ability to assemble into an extended filament. In Rad51, R310 lies further away from the L2 loop region, but its side chain projects into the same face of the protein as the other L2 amino acids. In contrast to other mutations in the L2 region, Rad51-R310A could not extend the dsDNA (FIG. 29A). The protein also displayed virtually no dsDNA binding activity in the gel shift assays and could not promote in vitro recombination (FIGS. 29B and 29C). However, Rad51-R310A did display very weak ssDNA binding in gel shifts (FIG. 29C). These differences in dsDNA and ssDNA binding were opposite of the effects observed with the comparable mutation in Dmc1.

### Discussion.

A Single-Molecule Method for Directly Visualizing the Assembly of Hundreds of Individual Rad51 Filaments in Real Time.

In this study we probed the assembly of single Rad51 filaments using a TIRFM assay that allows us to monitor individual DNA molecules aligned into molecular curtains on a lipid bilayer-coated surface of a microfluidic sample chamber. An advantage of this assay is that we can visually monitor the formation of the Rad51 filaments by evaluating the length of the DNA molecules. One disadvantage of our current approach is the loss of YOYO1 signal that coincides with filament assembly, which prevents direct detection of the DNA when it is completely covered by Rad51. In addition, this assay currently lacks the spatial resolution offered by other visualization techniques, such as electron or atomic force microscopy. However, in contrast to other methods that can be used to study Rad51 filaments, the filaments observed with TIRFM are formed under conditions that do not perturb the biological behavior of the protein. There is no requirement for chemical cross-linking or other irreversible modification, the complexes do not have to be separated by gel electrophoresis, and the entire process can be visualized in real-time. Thus these complexes represent biologically viable forms of the protein that are not disrupted by the experimental conditions required for their detection. Because we can simultaneously monitor multiple DNA molecules, we can gather and analyze statistically relevant information from many individual assembly reactions in a single experiment. Most importantly, the nucleoprotein filaments detected by TIRFM are not destroyed during the observation and are contained within a microfluidic sample chamber, thus allowing the potential for sequential addition of different reaction components while continually probing the behavior of Rad51. This offers the possibility of eventually dissecting the various interactions between the different protein components required for homologous recombination. This initial work provides an important experimental framework that can now be exploited to begin probing many different aspects of reactions promoted by Rad51.

### ATP Hydrolysis and the Formation of Extended Rad51 Filaments.

The role of ATP hydrolysis by Rad51 and other closely related proteins has remained enigmatic. E. coli RecA, yeast Rad51, and human Rad51 can all promote in vitro recombination under conditions where nucleotide cofactor is present, but ATP hydrolysis is prevented^{J43;J46;J49}. Bacterial RecA requires ATP to promote 4-stranded recombination reactions or to bypass heterology during strand exchange, however neither of these activities has been observed for Rad51^{J46}. Both RecA and Rad51 require ATP hydrolysis to dissociate from DNA, indicating that nucleotide turnover may play a regulatory role during the last stages of genetic recombination

To test the role of ATP binding and hydrolysis by Rad51 we probed the effects that different mutations in the ATP-binding domain had on the assembly of extended nucleoprotein filaments. The K133R and K133A mutations in the Walker A nucleotide-binding motif of human Rad51 yield proteins incapable of hydrolyzing ATP^{J43}. Rad51-K133R can bind to ATP, but hydrolysis is prevented, whereas Rad51-K133A does not bind to ATP^{J43}. These same deficiencies are found in many different Walker A-containing ATPases with corresponding mutations^{J43}. Our results demonstrate that Rad51-K133R is capable of forming extended nucleoprotein filaments on dsDNA in the presence of ATP, however, these mutant filaments do not stretch to the same extent that is observed for wt Rad51. Rad51-K133A also extends DNA, but extension occurs at a greatly reduced rate and to a much lesser extent compared to both wt Rad51 or K133R. Recent biochemical studies with human Rad51 have shown that the ATPase mutants K133R and K133A can both bind ssDNA and dsDNA in the absence of nucleotide, but only K133R is capable of forming a productive filament. These same bulk studies have revealed that Rad51-K133A, which does not promote efficient recombination and can not bind ATP, shows little or no defect in DNA-binding with oligonucleotide substrates when compared to the wild-type protein. However, the complexes formed with K133A appear to be in an alternative conformation because they do not underwind the bound DNA nor are they capable of protecting the DNA from restriction enzyme digest^{J43}. These results are consistent with our observations for the K133R and K133A mutants. In addition, we conclude that the longer filaments observed with K133R are correlated with a protein that is active for recombination, whereas the much shorter filaments observed with K133A may reflect the inability of this protein to efficiently promote recombination. Alternatively, it is also possible that the K133A mutant is incapable of forming a contiguous filament and is therefore incapable of stretching the DNA to the full extent that was observed for the other proteins.

We also tested wild-type Rad51 with different nucleotide cofactors. Both ATPγS and AMP-PNP supported nucleoprotein filament assembly, although reactions with these different ATP analogs result in very different outcomes. The rate of assembly with ATPγS was greatly reduced compared to rates observed with ATP. In contrast, Rad51 filaments assemble much more rapidly with AMP-PNP, and the final lengths of these filaments is greater than the lengths of filaments formed with ATP. This indicates that AMP-PNP stabilizes Rad51 in a conformation that is highly proficient for dsDNA binding and is able to rapidly transition into an extended helical structure. Whereas ATPγS yields a filament that extends the DNA much more slowly than reactions with either ATP or AMP-PNP. With ADP we observed no extension of the DNA in the TIRFM assays, however gel-shift experiments clearly showed that the protein could bind to dsDNA under these conditions.

### Dissecting the DNA-Binding Surfaces of Rad51

Rad51, like all members of the RecA-like recombinase family, is proposed to have at least two different DNA-binding sites: (1) a primary site, which by definition is responsible for binding to the ssDNA at the outset of the recombination reaction and interacts with the newly formed dsDNA after recombination is complete, and (2) a secondary site, which interacts with the incoming duplex DNA^{J3;J50}. Based on high-resolution crystal structures, the conserved L1 and L2 loops lie near the center of the nucleoprotein filament axis, and likely function as the DNA binding sites during recombination^{J9;J22;J24}. Biochemical and structural studies have yet to reveal where the DNA molecules reside within the filament. One study suggested that L2 was the primary binding site^{J51}, whereas other reports suggested that L1 was the primary site and L2 was the secondary site^{J52;J53}. A third study suggested that L1 contributed to both the primary and secondary binding sites J. It has also been postulated that the N-terminal domain of Rad51 serves as the secondary site that interacts with dsDNA during recombination and presents this incoming duplex to the ssDNA bound within the center of the filament^{J8}. Taken together, these studies present a complex picture of the contributions of L1 and L2 to DNA binding and recombination with no clear understanding of which amino acids contribute to specific interactions with the different DNA molecules.

To help begin resolving these issues for human Rad51, we constructed a series of single point mutations in the N-terminal domain, the L1 loop, the L2 loop, and the region adjacent to L2 in human Rad51. We then tested each of these mutants for the ability to bind to and extend dsDNA using the TIRFM assay. The selected mutations were based on the structures of the ScRad51 filament, the MvRadA filament, the human Rad51 core and the isolated N-terminal domain from human Rad51, as well as on the relatively high degree of sequence conservation between the yeast and human proteins.

The residues K40, K64, K70, and K73 lie within a region of positive electrostatic potential exposed on the surface of the N-terminal domain. Our work shows that these mutations do not prevent filament assembly. However, even though these N-terminal mutants were capable of binding and extending dsDNA, all of them were compromised in strand exchange activity. This may also indicate that the basic amino acids exposed on the surface of the N-terminal domain form the secondary DNA-binding surface necessary for capturing the second DNA molecule during homologous recombination. Verification of this hypothesis awaits additional experimentation.

The L1 loop has also been implicated as an important region for DNA binding. Our studies with human Rad51 revealed that mutations in the conserved L1 loop completely abrogated the protein's ability to form extended filaments on the dsDNA and these mutants were unable to promote efficient in vitro strand exchange. Human Rad51 could not tolerate even single point mutations within the L1 loop, indicating that this conserved region of the protein was essential for binding to the dsDNA. These data strongly suggest that the dsDNA bound within the extended filaments observed in our experiments is in intimate contact with the L1 amino acids.

Most mutations in the L2 region do not disrupt filament assembly, nor do they abolish in vitro strand exchange. These results imply that the dsDNA bound within the nucleoprotein filament was not in intimate contact with the L2 amino acids. This finding is consistent with previous studies of L2 mutations in human Rad51, which also failed for find a DNA-binding defect^{J55}. The fact that point mutations in L2 and the adjacent region have little effect on DNA binding suggests two possibilities. Either this surface of the protein may interact with DNA, but it can tolerate the tested point mutations, or these amino acids do not contribute to the DNA-binding surface. Interestingly, the L2 mutant K284A did display reduced strand exchange activity, suggesting that this mutant may have been compromised in its ability to simultaneously interact with two DNA molecules. Our results with the L1 and L2 mutants have been largely corroborated by a recent study that showed mutations in L1, but not L2 disrupted DNA binding^{J56}.

In contrast to other mutations in the L2 region, R310A completely disrupted the dsDNA-binding and recombination activity of Rad51. This outcome is somewhat different than what was observed for the same mutation in Dmc1, which yielded a protein that could bind to dsDNA, but could not bind to ssDNA^{J26}. One possible explanation for this is that under the conditions used to study Dmc1, the protein was forming an octameric ring^{J26}, and the R310A mutation may have differential effects depending on the specific structural context (i.e. protein ring versus helical filament) in which it is analyzed. For example, the structure of a human Dmc1 monomer is nearly superimposable with the monomer of S. cerevisiae Rad51, with a 2.3 Å root mean square deviation (RMSD) for the Cα atoms across 228 aligned residues. Yet, the higher order structure of the octameric ring of human Dmc1 revealed that R311A is located on the outer surface of the ring, ˜43 Å from the central axis of the octamer^{J26} Whereas in the ScRad51 filament the equivalent amino acid (R368) lies only ˜23 Å from the central axis of the filament^{J22}. Thus these two different structural forms of the protein (ring versus filament) place this particular amino acid at very different distances from the presumed location of the DNA binding region.

Taken together, our results suggest that in the TIRFM assays the dsDNA bound within the extended nucleoprotein filaments resides near the L1 loop within the central axis of the filament and is not interacting extensively with either the N-terminal domain or the L2 loop. However, mutations in the N-terminal domain do affect DNA strand exchange, probably by preventing efficient binding of a second molecule of DNA. Thus the N-terminal domain is the most likely candidate for the secondary DNA binding site. Interactions with the L1 loop are essential for dsDNA binding and these interactions also appear necessary for the protein to form extended nucleoprotein filaments, leading to the conclusion that the L1 loop forms the primary DNA binding site within the nucleoprotein filament.

### Different Oligomeric States of Rad51

Rad51 and many related recombinases can form extended filaments, compressed filaments, and rings under different reaction conditions. The extended filament is clearly correlated with strand exchange activity, but the function of the compressed filaments and rings remains unknown. We have previously shown that a fluorescently tagged version of Rad51 was able to passively diffuse on DNA via a 1D-random walk mechanism. However, this tagged protein was unable to stretch the bound DNA under any reaction conditions tested, indicating that it was locked into either a compressed filament or ring-like structure and was not able to form an extended filament. In contrast to these previous experiments with fluorescent protein, the work presented here relied upon DNA that was stained with YOYO1, but the protein was not fluorescently tagged. Most of the untagged proteins we capable of stretching the DNA to a degree consistent with the assembly of an extended filament. Although we can not directly visualize the protein in this case, we consider it highly unlikely that even short patches of an extended Rad51 filament would be able to slide on the DNA largely because the binding energy required for DNA extension would likely preclude free lateral motion of the protein and DNA relative to one another. Additional work will be necessary to determine what controls the transitions between the different structural forms of Rad51 and to determine what role(s) the ring-like and compressed filaments play in recombination.

We have developed a TIRFM-based system that allows us to directly visualize the assembly of Rad51 nucleoprotein filaments on hundreds of individual DNA molecules. This assay has allowed us to visualize filament assembly and test the effects of mutations in different surfaces of the protein thought to be involved in DNA binding. We showed that mutations in the N-terminal DNA-binding domain do not prevent assembly of extended nucleoprotein filaments, but they do reduce in vitro recombination efficiency, suggesting that that the N-terminal domain forms the secondary DNA binding site necessary for interactions with the incoming duplex during strand exchange. Most mutations in the L2 region do not disrupt assembly of the extended nucleoprotein filaments, nor do they eliminate in vitro strand exchange. Mutations in the L1 loop completely disrupt assembly of the extended nucleoprotein filaments and prevent strand exchange, providing support for the hypothesis that L1 is part of the primary DNA binding site. This study validates the use of TIRFM for examining assembly of the Rad51 nucleoprotein filaments and provides an initial experimental framework in which to begin probing the behaviors of the Rad51 nucleoprotein filaments under a variety of different conditions. The assay will also allow us to begin assessing the interactions between Rad51 and other protein and or DNA components of the homologous recombination machinery. Although here we have focused on dsDNA binding and extension, this TIRFM-based experimental system can also be adapted to directly examine different stages of the recombination reaction by judicious choice of DNA substrates or reaction conditions.

### Materials and Methods.

TIRFM. The basic design of the total internal reflection fluorescence microscope used in this study has been previously described in detail^{J29;J30}. In brief, the system is built around a Nikon TE2000U inverted microscope with a custom-made illumination system and a back-illuminated EMCCD detector (Photometrics, Cascade 512B). For this study, a 488 nm, 200 mW diode-pumped solid-state laser (Coherent, Sapphire-CDHR) was used as the excitation source. The laser was attenuated with an appropriate neutral density filter, passed through a spatial filter/beam expander, collimated, and focused through a fused silica prism onto the surface of a microfluidic sample chamber (described below). The beam was defocused to cover the entire field-of-view, and the intensity at the face of the prism was typically ˜5 mW. This gave a Gaussian profile with an elliptical illuminated field of approximately 50×200 μm, which was centered over the DNA curtain by means of a remotely operated mirror (New Focus).

Flowcells, sample delivery and aligned DNA arrays. The flowcells were assembled from fused silica slides (ESCO Products) on which microscale diffusion barriers were etched using a diamond-tipped scribe. Inlet and outlet ports were made by boring through the slide with a high-speed precision drill press equipped with a diamond-tipped bit (1.4 mm O.D.; Metalliferous). The slides were cleaned extensively by successive immersion in 2% (v/v) Hellmanex, 1 M NaOH, and 100% MeOH. The slides were rinsed extensively with filtered sterile water between each wash step and stored in 100% MeOH until use. Prior to assembly of the flowcell, the slides were dried under a stream of nitrogen and baked in a vacuum oven for at least 1 hour. A sample chamber was prepared from a borosilicate glass coverslip (Fisher Scientific) and double-sided tape (˜25 μm thick, 3M). Inlet and outlet ports (Upchurch Scientific) were attached with preformed adhesive rings and cured at 120° C. under vacuum. The total volume of the sample chambers was ˜4 μl. A syringe pump (Kd Scientific) and actuated injection valve (Upchurch Scientific) were used to control sample delivery and buffer flow rate. The flowcell and prism were mounted within a custom-built heater with computer-controlled feedback regulation that could be used to control the temperature of the sample from between 25-37° C. (±0.1° C.).

DNA arrays were constructed essentially as described^{J29}. All lipids were purchased from Avanti Polar Lipids and liposomes were prepared as previously described. In brief, a mixture of DOPC (1,2-dioleoyl-sn-glycero-phosphocholine) and 0.5% biotinylated-DOPE (1,2-diacyl-sn-glycero-3-phosphoethanolamine) liposomes were applied to the sample chamber for 1 hour. Excess liposomes were flushed away with buffer containing 10 mM Tris-HCl (pH 7.8) and 100 mM NaCl. The flowcell was then rinsed with buffer A (40 mM Tris-HCl (pH 7.8), 1 mM DTT, 1 mM MgCl₂ plus 0.2 mg/ml BSA. Neutravidin (330 nM) in buffer A was then injected into the sample chamber and incubated for 30 minutes. After rinsing thoroughly with additional buffer A, biotinylated λ-DNA (˜5 μM) pre-stained with YOYO1 was injected into the sample chamber, incubated for 30 minutes, and unbound DNA was removed by flushing with buffer. Application of buffer flow also caused the lipid-tethered DNA molecules to align along the leading edges of the diffusion barriers.

Proteins. Human Rad51 was overexpressed in E. coli HMS174(DE3)pLysS and purified as previously described using a combination of ammonium sulfate precipitation and Ni-chelating chromatography^{J30}. In brief, cells were harvested by centrifugation, resuspended into buffer containing 10% glycerol, 25 mM Tris-HCl (pH 8), 500 mM NaCl, 0.1% NP40, 5 mM β-mercaptoethanol, and 1 mM PMSF, and the cells were lysed by sonication. The lysate was clarified by centrifugation at 36,000 rpm in a Ti45 rotor (Beckman) at 4° C. Ammonium sulfate was added to the lysate to a final concentration of 0.34 g/ml with constant stirring on ice. The proteins were precipitated by centrifugation at 36,000 rpm for 1 hour in a Ti45 rotor (Beckman). The protein pellet was dissolved into buffer containing 10% glycerol, 25 mM Tris (pH 8), 500 mM NaCl, 0.1% NP40, 1 mM PMSF, 50 mM imidazole, and 5 mM β-mercaptoethanol. The resuspended proteins were centrifuged for an additional 20 minutes at 20,000 rpm and then loaded onto a 1 ml HiTrap Chelating column (GE HealthCare). After washing with at least 30 ml of buffer, Rad51 was slowly eluted in buffer containing 500 mM imidazole. This was followed by extensive dialysis into storage buffer, containing 20% glycerol, 25 mM Tris-HCl (pH 8.0), 0.5 M NaCl, 1 mM EDTA, and 1 mM DTT. The proteins purified using this protocol were judged ˜95% pure based on SDS-PAGE and coomassie staining. Protein concentrations were determined by UV absorbance using a molar extinction coefficient of 12,800 M⁻¹ cm⁻¹ and confirmed by SDS-PAGE.

Rad51 point mutants were made using QuikChange site-directed mutagenesis (Stratagene) as per the manufacturer's recommendations, and all mutations were confirmed by DNA sequencing. All mutant proteins were expressed and purified as described for wild-type Rad51. All mutants reported here displayed chromatographic properties very similar to the wild-type protein.

TIRFM reaction conditions and data analysis. For assembly experiments the flowcells were coupled to a switch valve (Upchurch Scientific) and syringe pump (KD Scientific), which were used to control application of the protein-containing samples to the DNA arrays within the flowcells. All buffers were comprised of 40 mM Tris-Cl (pH 7.8), 1 mM MgCl₂, 1 mM DTT, and 0.2 mg/ml BSA, unless otherwise indicated. Buffers also contained an oxygen scavenging system comprised of 0.8% glucose, 1% β-mercaptoethanol, glucose oxidase (33.3 units/ml) and catalase (520 units/ml). This oxygen scavenging system was also tested in bulk assays with wild-type Rad51 and had no effect on the protein's recombination activity with either plasmid sized or oligonucleotide substrates, nor did it alter the ATPase activity of the protein. For the DNA extension experiments, flow was initiated using buffer that lacked Rad51 and nucleotide cofactor. The protein was then injected along with the appropriate nucleotide cofactor (as indicated in the figure legends) and data collection was initiated.

Data collection and analysis were performed using Metamorph software (Universal Imaging). All DNA length measurements were made by measuring the positions of the tethered and free ends of the DNA molecules in the molecular curtains. The difference in these y-coordinates was then calculated and converted from pixels to micrometers to determine the lengths of the DNA molecules (each CCD pixel was 16×16 μM; 1 pixel corresponds to 0.16 μm at 100× magnification). All experiments had between ˜50-125 DNA molecules per field of view and most were done in triplicate to verify the results.

Bulk Biochemical Assays. Gel shift assays contained 40 mM Tris-HCl (pH 7.8), 2 mM ATP, 10 mM MgCl2, 1 mM DTT, 30 μM φX174 (either dsDNA digested with ApaL1 or ssDNA virion; concentration in nucleotides), and varying amounts of Rad51. Reaction mixes were assembled on ice, incubated for 10 minutes at 37° C., and then resolved on 0.8% agarose gels. The DNA bands were detected by staining with ethidium bromide.

Recombination assays were adapted from A. Mazin, et al.^{J47}, but used Cy3 tagged oligonucleotide substrates rather than radiolabeled oligonucleotides. Reaction mixes contained 33 mM HEPES (pH 7), 2 mM DTT, 2 mM ATP, 1.22 mM MgOAc, 0.2 μM duplex oligonucleotide with a 5′ ssDNA overhang. Reactions were initiated with the addition of 4 μM Rad51 and incubated for 5 minutes at 37° C. After the incubation, additional MgOAc was added to yield a final concentration of 20 mM. This was followed by another 5-minute incubation at 37° C., after which a fluorescently tagged duplex oligonucleotide (0.2 μM) complementary to the ssDNA overhang was added to the reaction, and the reactions were incubated at 37° C. for an additional hour. Reactions were then stopped by the addition of 2 μl 0.5 M EDTA, 2 μl 10% SDS, and 0.5 μl proteinase K (20 mg/ml), and incubated for an additional 15 minutes at 37° C. The DNA products were resolved on 10% acrylamide gels and visualized with a Molecular Dynamics FluorImager 595.

### EXAMPLE 7

### Visualization of Rdh54 on Nucleic Acid Arrays

We have used total internal reflection fluorescence microscopy (TIRFM) to investigate the behavior of the yeast Snf2-releated homologous recombination factor Rdh54 at the single-molecule level. Our results demonstrate that Rdh54 is a molecular machine that extrudes loops of DNA in a reaction coupled to ATP hydrolysis-dependent DNA translocation. The loops generated by individual Rdh54 complexes encompassed an average of six kilobases and the proteins often abruptly released the extruded DNA. The Rdh54 motor proteins also displayed a variety of different behaviors, including variations in translocation rate and distance, pauses, reversals, and collisions between different proteins traveling on the same DNA. These complex patterns of activity imply that each Rdh54 complex has two distinct DNA-binding sites, one of which enables translocation while the other remains anchored to a single location on the DNA. Our work, together with other recent studies, suggests that translocation-coupled DNA loop extrusion may be a common mechanistic feature conserved throughout the Snf2-family of chromatin-remodeling proteins.

Rdh54 belongs to the Snf2-family of chromatin-remodeling proteins and is required for meiotic DNA recombination (M19; M40). The Snf2-family of proteins is comprised of members with similarities to the Saccharomyces cerevisiae chromatin-remodeling protein Snf2. These proteins are characterized by the presence of seven conserved helicase motifs labeled I, Ia, Ib, II, III, IV and V (M11, M36). Motifs I and II are the Walker A and B nucleotide-binding motifs commonly found in ATP hydrolyzing enzymes. These proteins are ubiquitous in eukaryotes and are required for virtually all aspects of DNA metabolism, including chromatin remodeling, DNA replication, transcription, translation, and DNA repair (M10). A recent analysis of public databases by Owen-Hughes and colleagues has revealed that the Snf2 proteins can be subdivided into at least 24 distinct subfamilies with ˜1300 known members (M10). Some of the more commonly known Snf2 proteins include the ATPase subunits of complexes such as Swi/Snf, ISWI, RSC, NURF, ACF, CHRAC, INO80.com, Swr1, NURD, and the DNA repair protein Rad54. S. cerevisiae alone has 17 known Snf2 proteins that play important roles in broad range of biological processes (M10). Although originally labeled as DNA helicases, many of these proteins are actually ATP-dependent DNA translocases that can move along duplex DNA (M29, M30, M43). Their ability to translocate along duplex DNA appears to be the key mechanism by which these proteins function, presumably by disrupting any DNA-bound proteins that they encounter and by modifying superhelical torsion as they travel along the duplex.

Rad54 is the defining member of one Snf2 subgroup (the Rad54-like subfamily) and is among the most well-characterized proteins of the Snf2-family (M15, M41). Rad54 was originally identified in S. cerevisiae as a member of the RAD52 epistasis group of genes, which are required for the repair of double-strand DNA breaks (DSBs) via homologous recombination, and mutations in Rad54 lead to increased sensitivity to DNA damaging agents (M40). The crystal structure of zebrafish Rad54 revealed that the protein has a pair of tandemly repeated RecA-like folds, which contain the seven conserved helicase motifs (M42). Very similar domains are found in the SF1 DNA helicases PcrA, UvrD, and Rep, and the SF2 proteins RecG, UvrB, eIF4A, and NS3 (M40). It is these conserved RecA-like domains that mediate ATP-hydrolysis and DNA translocation. The RecA-like domains in Rad54 are flanked by additional regions that are conserved only within the Snf2-subfamily and most likely serve to confer functional specificity. Rad54 interacts directly with Rad51, a RecA homolog that is the core component of the eukaryotic recombination machinery (M8, M17, M22, M27). This interaction seems to promote formation of the Rad51-ssDNA presynaptic filament, which is a key intermediate in the recombination reaction. Rad54 promotes synapsis of the Rad51 filament with homologous duplex DNA and subsequent strand invasion (M23, M26, M35). Rad54 also remodels nucleosomes in vitro and promotes strand invasion on chromatinized templates (M2, M3, M16). In addition, Rad54 is thought to actively remove Rad51 from DNA after strand invasion (M38), a function that may be necessary to allow downstream repair proteins to gain access to the recombination intermediates. Based on these activities, it has been suggested that Rad54 can function as a molecular “wire-stripper”, which clears DNA of stationary proteins allowing repair to proceed unhindered by any potential obstructions (M18). Finally, Rad54 also promotes branch migration in vitro, and may perform the same function at the end stages of recombination in living cells (M6). Early work with Rad54 had suggested that the protein was a DNA translocase (M28, M43) and this prediction was confirmed in a recent single-molecule study, which demonstrated that Rad54 does translocate rapidly on double-stranded DNA in an ATP-dependent manner (M4).

Rdh54 (Rad homolog 54) is a member of the Rad54-like subfamily of Snf2 proteins and was identified based on sequence homology with Rad54, and independently identified as Tid1 in 2-hybrid screens for proteins that interact with the meiosis specific recombinase Dmc1 (M9, M19, M34). The role of Rdh54 in homologous recombination was verified by genetic analyses, which revealed that null mutants were highly defective in meiotic recombination and crossover interference, thus placing Rdh54 within the RAD52 epistasis group (M9, M19, M33, M34). Rdh54 and Rad54 are closely related (37% sequence identity and 55% similarity) and appear to be somewhat functionally redundant. Cells can survive in the absence of one of the two proteins, however, rad54 rdh54 double-mutants exhibit growth defects and are more sensitive to DNA damaging agents than either individual mutation. During normal cell growth, Rdh54 is found at kinetochores and may facilitate communication between the DNA damage and spindle checkpoints (M21). Exposure of cells to γ-irradiation causes Rdh54 to partially redistribute to DNA repair centers, which appear as foci comprised of many different DNA repair and checkpoint proteins (M21). In vitro experiments have revealed that Rdh54 is a robust ATPase that modifies the topology of DNA, suggesting that the protein could translocate on duplex DNA (M25). Moreover, Rdh54 promotes Rad51-catalyzed strand invasion of duplex DNA (M25), removes Rad51 and Dmc1 from DNA (M7), remodels chromatin in vitro, and may help establish the accessibility of DNA templates during homologous recombination.

To begin probing the functions of Snf2 proteins in DNA repair we sought to develop a system for visualizing the interactions between Rdh54 and duplex DNA substrates at the single-molecule level. Here we used TIRFM (M5) and microscale engineered DNA curtains (M12) to directly observe the behaviors of quantum-dot labeled Rdh54 complexes as they interacted with individual molecules of DNA. We show that Rdh54 exhibits several modes of interaction with DNA including, stationary binding, ATP hydrolysis-driven translocation, changes in velocity, transient pauses, one-dimensional sliding, and changes in direction. We also visualized molecular collisions between two different complexes of Rdh54 traveling in opposite directions on the same DNA molecule. These proteins displayed intriguingly complex patterns of movement along the DNA, but they were unable to bypass one another and neither of the colliding partners was displaced as a consequence of the molecular collision. Rdh54 also promoted the extrusion of large DNA loops in a reversible reaction that was coupled to DNA translocation. The DNA loops could be released in an abrupt event consistent with the sudden loss of a single protein-DNA contact. Loop release could also occur via a slower process that appeared to arise from backtracking or reversal of the Rdh54. The formation and release of these DNA loops implies a molecular architecture for Rdh54 that must include at least two different DNA-binding sites with distinct biochemical activities to accommodate both stationary DNA binding as well as active translocation. The cumulative outcome of these activities was to cause dramatic structural changes in the DNA that were manifested as large contractions and expansions of the DNA contour length. This work suggests that translocation-coupled DNA loop extrusion may be a common mechanism by which Rdh54 and other Snf2 chromatin-remodeling proteins alter DNA topology to influence the outcomes of various DNA transactions.

### Results

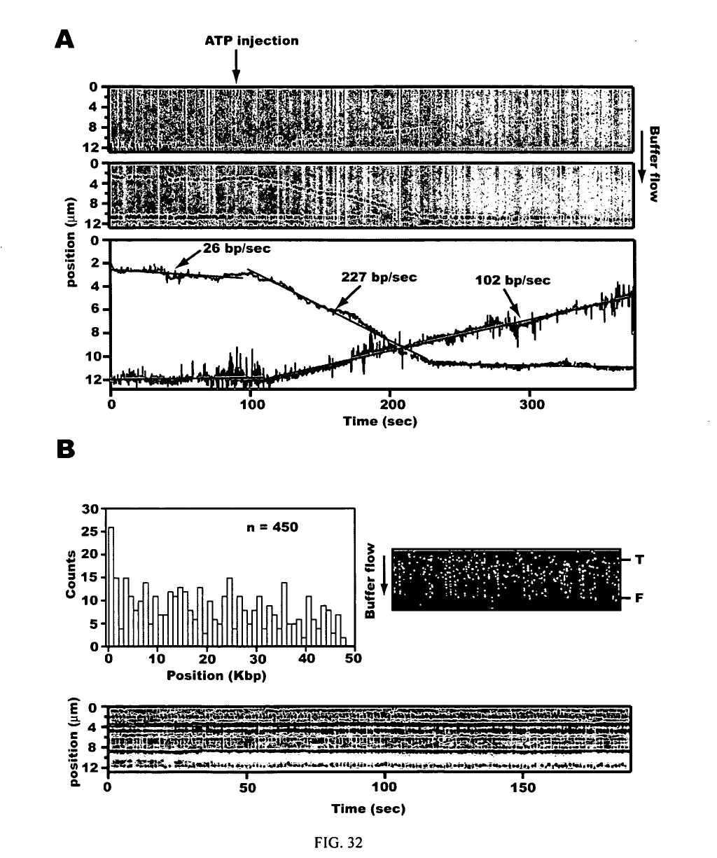

Single-molecule assay for viewing Rdh54. We have recently developed a new technology that allows us to assemble “DNA curtains” at defined positions on the surface of a fused silica microfluidic sample chamber (FIG. 30A) (M12). In brief, a fluid lipid bilayer is deposited onto the surface of the sample chamber and DNA molecules are tethered directly to the bilayer via a biotin-neutravidin linkage. The tethered DNA molecules are free to move in two dimensions, and they can be organized along the leading edges of microscale diffusion barriers by the application of a hydrodynamic force (FIG. 30A). The hydrodynamic force also extends the DNA molecules parallel to the surface of the sample chamber and confines them within the detection volume defined by the penetration depth of the evanescent field. This approach allows us to simultaneously visualize up to hundreds of physically aligned DNA molecules in real time within a single field-of-view using TIRFM (FIG. 30B). These DNA molecules are suspended above the inert lipid bilayer and can serve as the binding substrates for any protein that is injected into the sample chamber.

To visualize the behavior of Rdh54, the protein was labeled with an antibody-coupled fluorescent semi-conducting nanocrystal (quantum dot). Quantum dots are an ideal fluorophore for single-molecule imaging because they are extremely bright and they do not photo-bleach on timescales relevant for biological measurements. ATPase assays revealed that Rdh54 was fully active even in the presence of a 10-fold excess of antibody, indicating that its bulk biochemical properties were not modified by the labeling procedure (see Material and Methods). The intercalating dye YOYO1 is commonly used to label DNA in single-molecule fluorescence assays, but when illuminated, YOYO1 reacts with molecular oxygen to generate free radical species that rapidly cleave DNA (M1). This undesirable outcome is normally inhibited by the inclusion of an oxygen scavenging system comprised of glucose oxidase, catalase, glucose and β-mercaptoethanol. However, preliminary assays revealed that the ATPase activity of Rdh54 was completely abolished in the presence of this oxygen scavenging system. To overcome this problem we used YOYO1 to first stain and locate the DNA curtains (FIG. 30B). The dye was then completely removed by briefly flushing the sample chamber with 0.5 M NaCl. This was followed by re-equilibration of the sample chamber with reaction buffer that lacked the oxygen scavenging system.

After locating the DNA curtains, the labeled Rdh54 (2.5-5 nM) was injected into the sample chamber. As shown in FIG. 30C, Rdh54 bound the DNA molecules within the curtain and could be identified as isolated fluorescent signals. In this example there were a total of 264 individual Rdh54 complexes within the field-of-view and the locations of the proteins on the DNA was random, indicating that there were no preferred binding sequences (FIGS. 30C and 30D). Buffer flow was then transiently paused causing the DNA molecules and bound proteins to briefly diffuse out of the excitation volume. This procedure was used as a standard control in all of our TIRFM experiments to verify that the Rdh54 was bound to the DNA and to identify any proteins within the field-of-view that were nonspecifically adsorbed to the surface so that they could be omitted from further analysis (FIGS. 30B and 30C).

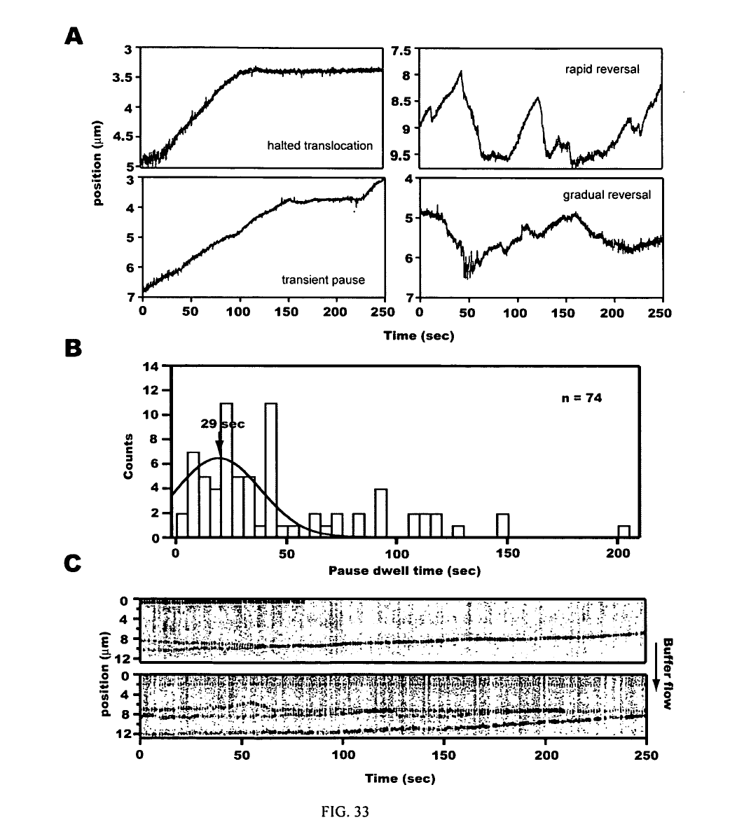

ATP hydrolysis-dependent DNA translocation by Rdh54. Recent studies have shown that the Snf2 proteins Rad54 and RSC can translocate on DNA, suggesting that this is a common attribute shared among the family members (M14, M20, M29). To determine whether Rdh54 could indeed translocate along the DNA, the protein was injected into the sample chamber along with 1 mM ATP and the behavior of the bound proteins was monitored over time by capturing videos at 8.3 frames per second. Approximately 50% of the Rdh54 complexes moved along the DNA, while the rest appeared to remain stationary during the course of the observation (see below). We assumed that the stationary proteins were inactive during this period, although it is also possible that they moved over distances shorter than our spatial resolution (˜300 bps). The kymograms in FIG. 31A illustrate the spatial and temporal behavior of Rdh54. These images were generated by excising a excising a 3×80 (W×H) pixel region-of-interest (ROI) that corresponded to one molecule from within the DNA curtain and plotting this excised image as a function of time over a 250-second interval. As shown in FIG. 31A, Rdh54 was able to translocate rapidly along the DNA when ATP was present in the reaction mixture. For those proteins that displayed translocation activity, the movement could occur either against the direction of buffer flow (FIG. 31A, top panel) or with the flow (FIG. 31A, bottom panel), strongly suggesting that it was bona fide DNA translocation.

We used single-particle tracking to further analyze the movement of Rdh54 on DNA, and a detailed example of this analysis is presented in FIG. 31B (M13). This example illustrates the movement of a single Rdh54 complex against the direction of buffer flow. The center panel shows the data generated from the particle-tracking algorithm superimposed on the image of the translocating protein. The bottom panel shows the graph of the protein's movement; the translocation rates were determined from the slopes of linear fits to the tracking data. As illustrated in this figure, the movement of the proteins was heterogeneous and the same Rdh54 could display a variety of translocation rates during the course of a single observation. Based on detailed analysis of 64 translocating proteins, from experiments performed in 1 mM ATP, the average Rdh54 complex translocated at a rate of 80 bp/sec (FIG. 31C), and changed translocation rates at a frequency of 0.017 sec⁻¹. Rdh54 could translocate at least 13 kilobases during the 250-second observations, indicating that the enzyme was highly processive (FIG. 31C). Neither the translocation rates nor the processivity were influenced by which direction the proteins were moving with respect to the buffer flow. The majority of the proteins did not dissociate from the DNA during the course of the observations and many of the Rdh54 complexes continued moving even after extended periods of time (≧45 minutes). Interestingly, although we observed several instances where Rdh54 translocated to the free ends of the DNA, we have never observed the protein dissociate as a consequence of reaching the end of the molecules.

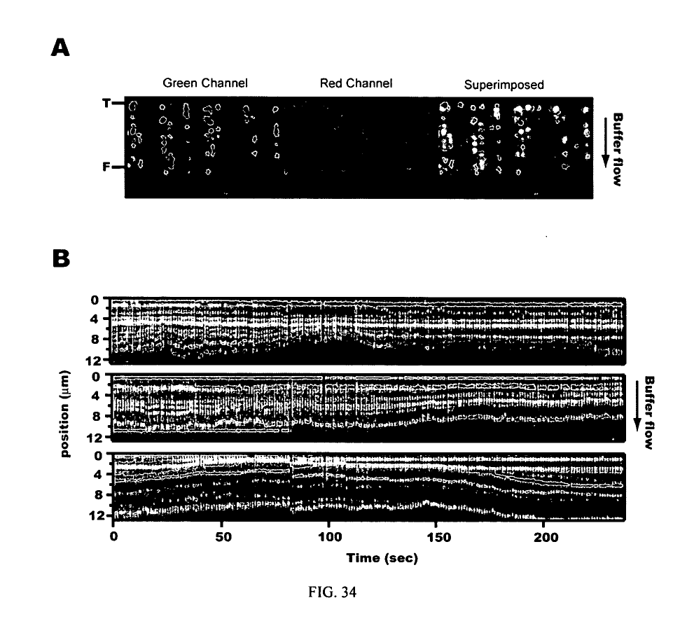

As expected, translocation did not occur in the absence of ATP (FIG. 32A), or in the presence of ADP or ATPγS, indicating that nucleotide hydrolysis was required for movement. Rdh54 bound to the DNA in the absence of ATP and there was no discernable difference in either its affinity for the DNA or in the binding distribution when the nucleotide cofactor was omitted (FIG. 32A). However, in the absence of nucleotide cofactor, most of the complexes remained stationary or moved only in the direction of buffer flow (FIG. 32A). We attribute this type of movement to one-dimensional sliding of the protein along the DNA, which was biased in the direction of flow due to the hydrodynamic force exerted by the buffer. We next tested whether the stationary Rdh54 bound to DNA in the absence of nucleotide cofactor could resume its motor function upon addition of ATP. As shown in FIG. 32A, when ATP was injected into the sample chamber the stationary Rdh54 complexes began rapidly moving along the DNA. This translocation activity was indistinguishable from that observed when ATP was present throughout the reaction indicating that the stationary complexes were bound in a stalled configuration that was poised for action upon the addition of an appropriate fuel.

As indicated above, nucleotide hydrolysis was required for translocation by Rdh54. To confirm this observation we also assayed a version of Rdh54 harboring a point mutation in the Walker A nucleotide binding domain (K352R) that renders it defective for ATP hydrolysis (FIG. 32B) (M7). This protein bound to the DNA molecules (FIG. 32B, top panels), however, very few of the proteins were observed moving, even in the presence of ATP (FIG. 32B, bottom panel). Those that did move did so slowly and moved in the direction of flow, suggesting that they were pushed along the DNA with the force exerted by the buffer. Occasionally, some of the proteins were observed slowly oscillating over short distances between two stationary proteins (see FIG. 32B, lower panel for an example). This type of oscillatory motion was consistent with a one-dimensional diffusion mechanism (M13).

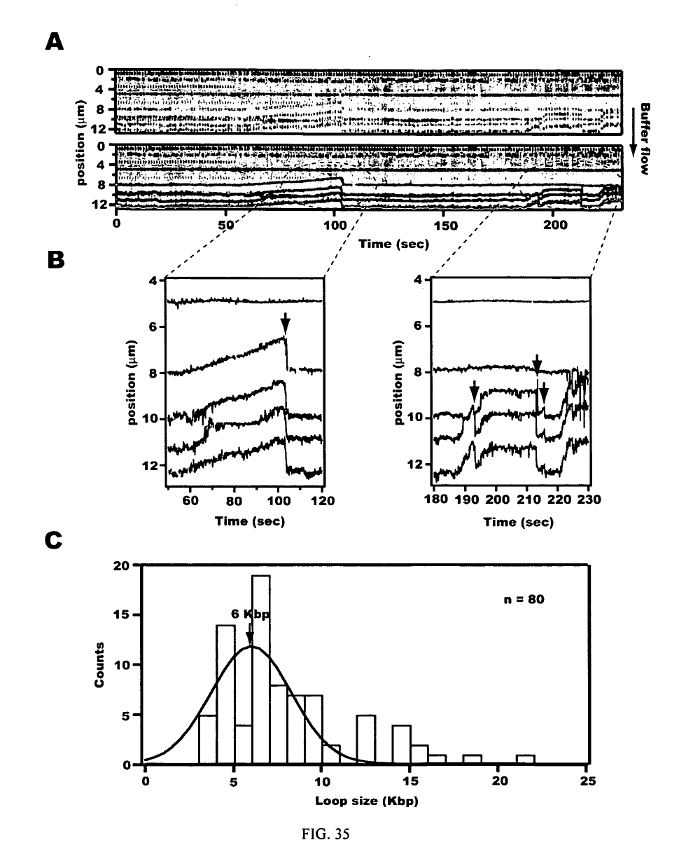

A variety of heterogeneous behaviors are observed during translocation. Analysis of yeast Rad54 has revealed that the protein displays remarkably uniform translocation kinetics with the 80% of proteins moving monotonically in one direction (M4). In contrast, the vast majority of Rdh54 complexes displayed heterogeneous translocation behaviors and variations in kinetics. The most common behaviors included halted translocation, transient pauses for varying durations, forward translocation followed by rapid reversals, and forward translocation followed by more gradual reversals (FIG. 33A). The motor proteins could also undergo repetitive cycles of forward and reverse translocation events and during these cycles they often appeared to return to their original locations (FIG. 33A, upper right panel, and see below). Interestingly, many of the Rdh54 complexes paused for long periods of time, with an average dwell time of ˜29 seconds, but then resumed translocation during the course of the experiment (FIG. 33B). This provided further support for the hypothesis that the protein could reversibly enter a stalled state that was inactive for translocation yet remained stably bound to the DNA and capable of resuming movement.

We also observed collisions between different Rdh54 complexes traveling in opposite directions along the same DNA molecule (FIG. 33C). Some of these collision events appeared to result in the merger of two independent complexes, which could then travel together along the DNA (FIG. 33C, upper panel). Whereas other colliding proteins either reversed direction or stopped moving (FIG. 33C, lower panel). Although these Rdh54 complexes were all labeled with the same color fluorophore it never appeared as though two colliding entities could bypass one another while translocating on the DNA (see below), nor did either of the colliding partners dissociate from the DNA, suggesting that they were tightly associated with the duplex.

Oligomeric state of Rdh54 complexes bound to DNA. The oligomeric state of Rad54 has been subject to investigation by several different methods, and an emerging picture indicates that the protein functions as a multimer when bound to DNA (M18, M28). The nature of this multimeric species remains unknown, although estimates have ranged from a trimer or hexamer, all the way up to dodecamer. To investigate the multimeric state of Rdh54 we analyzed the fluorescence signal from complexes that were labeled with a mixture comprised of equal amounts of green (λₑₘ=565 nm) and red (λₑₘ=705 nm) quantum dots. If Rdh54 behaved as a monomer, then we predict that we should only detect green or red proteins bound to the DNA, but no yellow complexes should be observed. In contrast, if Rdh54 behaved as a dimer, then ⅓ of the complexes should be red, ⅓ should be green, and ⅓ should be a mixture of the two (i.e., yellow). Furthermore, for a trimeric Rdh54 complex ¼ will appear red, ¼ will appear green, and ½ should be yellow. Using a similar progression of logic we can predict that as the oligomeric state of the protein increases in complexity (e.g., tetramer, hexamer, dodecamer, etc.), so to does the probability that individual complexes will appear yellow.

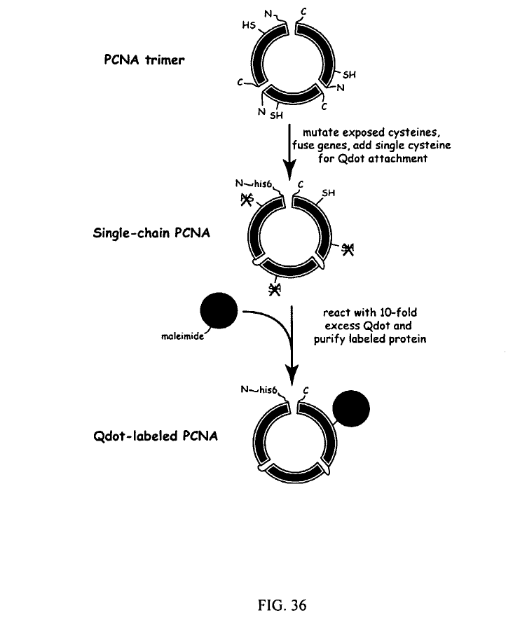

FIG. 34A shows sections of a DNA curtain bound by Rdh54 that was labeled with an equimolar mixture of green and red quantum dots. The differing emission spectra were separated by a dichroic mirror and simultaneously imaged on separate halves of the EMCCD chip. The left panel shows the signal from the green quantum dots, the center panel shows the red quantum dots, and the superimposed images are presented at the right (FIG. 34A). As shown in these images, we could detect green, red, and yellow Rdh54 complexes. Based on the analysis of 251 individual complexes we found 59 red and 73 green Rdh54 complexes. The slightly greater number of green quantum dots is likely due to minor error in measuring the stock concentrations of the purified quantum dot-antibody conjugates. We also detected 119 Rdh54 complexes that appeared yellow. These findings argue against the possibility that the protein behaves as either a monomer or as a very large complex (i.e., dodecamer or nonspecific aggregate), and the observed ratio of ˜1:1:2 (red:green:yellow) was most consistent with a small oligomer (possibly a trimer) of Rdh54. One caveat of this argument is our assumption that Rdh54 behaves as a homogenous population with respect to its multimeric state rather than a heterogeneous population of different multimers.

Collisions between different motor proteins on the same DNA. In many instances we observed what appeared to be collision events between different molecules of Rdh54 bound to the same strand of DNA (FIG. 33C). However, because the proteins were all labeled with the same colored quantum dot we were unable to verify that their relative positions along the DNA did not change over time. Therefore we performed a dual-color labeling experiment where Rdh54 was tagged with either red quantum dots or green quantum dots, as described above and monitored the translocation of the proteins over time. These experiments were performed at slightly higher concentrations of protein (determined empirically) to ensure that multiple Rdh54 complexes would be bound to the DNA.

As shown in FIG. 34B, the differentially labeled protein complexes displayed highly complex patterns of behavior as they interacted with the DNA. Different complexes of Rdh54 often appeared to collide with one another, or moved apart and traveled in different directions or at different velocities. Despite the large extent of apparent Rdh54 movement, the overall color patterns remained largely unaltered during the course of the observations, indicating that the different Rdh54 complexes did not bypass one another while moving along the DNA. The few changes in color pattern that were observed could be easily attributed to either the occasional dissociation of a protein or the apparent merging of two different colored complexes as they as they approached one another on the DNA. Surprisingly, under these conditions it often appeared as though the proteins bound to the same DNA molecule traveled in synchronous patterns, even though they were separated from one another by distances that could span thousands of base pairs (FIG. 34B and see below). The experiments presented below provide an explanation for this unexpected behavior.

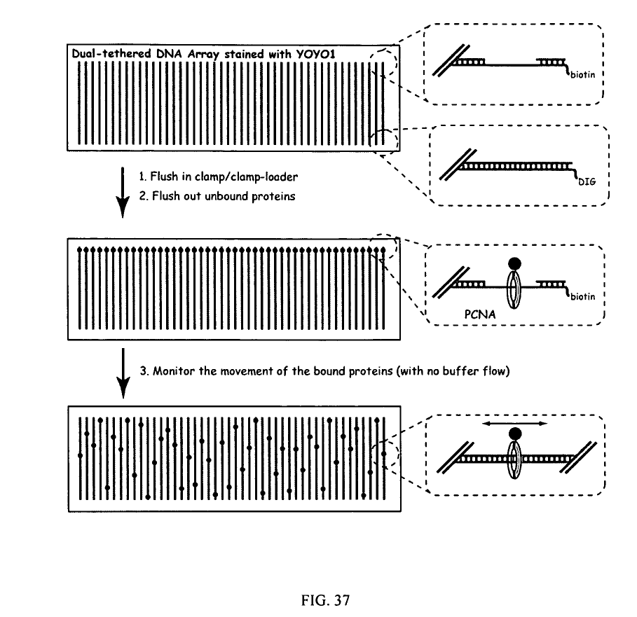

Rdh54 forms large DNA loops during translocation. As indicated above, many of the Rdh54 molecules underwent repetitive cycles of forward and reverse movement (FIG. 33A) and it often appeared as though multiple Rdh54 complexes traveled in unison while bound to distal positions on the same molecule of DNA (FIG. 34B). To explore these behaviors further we used particle-tracking to analyze the movement of Rdh54 complexes bound under conditions where there were multiple proteins per DNA molecule (FIG. 35). These results confirmed that many of the proteins traveled in unison, in fact, this type of synchronous movement was detected for at least 80% of the individual translocating Rdh54 complexes examined. In these cases, the protein complexes often abruptly and simultaneously returned to their original positions relative to the tethered ends of the DNA molecules (FIGS. 35A and 35B). For example, in FIG. 35A, the four different Rdh54 complexes closest to the free end of the DNA molecules all begin moving in unison towards the tethered end of the DNA, while the remaining complexes bound nearest the tethered end remained stationary. Just after the 100-second time point the moving complexes abruptly returned to their original locations; several similar events occurred on this same DNA molecule (FIGS. 35A and 35B). These abrupt reversals occurred too quickly to be accounted for by an ATP-dependent translocation mechanism (FIG. 35B). Rather, the data were more consistent with the disruption of a single protein-DNA contact, which may have been driven in part by the force exerted from the buffer flow. We also observed many examples where the synchronous reversal occurred gradually and more closely resembled DNA translocation rather than sudden release (FIG. 34B).

The most reasonable explanation for these correlated movements is that one or more of the Rdh54 complexes translocated along the helical axis while extruding a large loop of DNA. This would in turn cause all of the stationary “downstream” proteins to move in concert with the translocating protein as it extruded the DNA loop. The abrupt return of the proteins to their original locations would suggest that the DNA loop was suddenly released by the translocating complex. The loop release events never coincided with dissociation of a fluorescent protein from the DNA (FIG. 35A), indicating that even though the loops were disrupted the proteins remained stably bound through additional contacts with the DNA and were capable of reiterative catalytic cycles. In cases where the DNA loops were release more gradually the driving mechanism may have been reverse translocation or backtracking of the Rdh54 motor. Analysis of 80 different looping events revealed that the size of the loops averaged ˜6 kilobases, and occasional events were observed in which loops larger than 15-20 kilobases were generated (FIG. 35C). The hydrodynamic force experienced by the tethered DNA molecules in the sample chamber was on the order of 0.5 pN (M12), indicating that the Rdh54 motor was capable of generating large DNA loops even against this moderate opposing force. Based on these observations we could not determine which of the Rdh54 complexes was responsible for the observed movement. It could in principle be due to either a mobile protein that generated a loop as it translocated towards the tethered end of the DNA or it could also be caused by a stationary complex that pulled the free end of the DNA towards itself. Distinguishing between these two different mechanisms will require further investigation. Taken together, these experiments revealed that Rdh54 displays highly dynamic translocation behavior while at the same time remaining tightly bound to fixed positions on the DNA. The culmination of these activities resulted in extrusion of large DNA loops and caused drastic changes in the overall structure of the bound DNA.

### Discussion

Our approach to single-molecule biochemistry combines the use of TIRFM with novel surface engineering procedures that allow us to directly visualize up to hundreds of individual reactions in a single experiment. Here we have applied these techniques to the study of the Snf2-related motor protein Rdh54. These assays allowed us to directly visualize Rdh54 as it bound to and translocated along double-stranded DNA molecules and revealed a variety of heterogeneous behaviors including unidirectional translocation, pauses and reversals during translocation, one-dimensional sliding, and reversible DNA loop formation.

Rdh54 is a multimeric, ATP-dependent DNA translocase that displays heterogeneous kinetic behaviors. We have demonstrated that Rdh54 can actively translocate along double-stranded DNA by directly visualizing single protein complexes as they move along the helical axis. The translocation activity was rapid, displaying an average velocity of 80 bp/sec at 1 mM ATP, and the proteins were highly processive, traveling an average distance of 13,000 base pairs during the course of the observations. It is likely that the actual processivity may be much higher than this value because the proteins did not dissociate from the DNA and may have continued to translocate beyond the end of our measurements.

Previous reports have suggested that Rad54 behaves as a multimeric complex comprised of at least 3-6 subunits (M28), and a recent electron microscopy study revealed heterogeneous particles that ranged in size from ˜15 to 100 nanometers in diameter (M18). In contrast, the crystal structure of Rad54 revealed a monomeric protein and this conclusion was supported by ultracentrifugation experiments (M42). Our work suggested that the translocation complexes of Rdh54 are neither monomeric nor are they large multimers (or aggregates). Rather, our data revealed a distribution of red, green and yellow Rdh54 complexes indicating that the protein behaved as a small oligomer that was most consistent with a trimer of Rdh54 functioning as the active unit for DNA translocation, although we can not rule out the existence of other small oligomers.

The translocation of Rdh54 is reminiscent of that reported for Rad54 (M4), yet despite their high degree of sequence and functional homology there do appear to be many important differences in their activities. For instance, the majority of Rad54 molecules (80%) exhibited monotonic translocation in a single direction, and few of the proteins showed either changes in velocity or direction (M4). In contrast, with Rdh54 variations in translocation behavior appear to be the rule rather than the exception. In fact, virtually 100% of the translocating Rdh54 complexes displayed some deviation from monotonic translocation kinetics, and at least 80% of the proteins generated DNA loop structures, 60% of which reversed during the course of the observation. DNA loops have also been reported for static Rad54 particles imaged by scanning force microscopy (M28). More recently it was suggested that Rad54 could form DNA loops during translocation, although direct evidence for this has yet to be presented (M4).

Although we can not directly measure the topology of the DNA molecules in our experiments it seems likely that the DNA loops generated during Rdh54 translocation are supercoiled, which would be consistent with the known activities of the protein (M7, M25). The extrusion of DNA loops during translocation offers a very simple mechanistic explanation for how Rdh54 other related Snf2 proteins modify the topology of DNA in bulk assays.

Mechanisms of DNA loop extrusion. The formation of DNA loops can only occur if individual Rdh54 complexes contain at least two different DNA binding domains that can simultaneously interact with the same DNA molecule. There are several possible ways that this can be achieved: (1) either the protein itself has two distinct DNA binding sites within a single polypeptide chain, one domain to anchor it in place and a separate motor domain used for translocation; or (2) the protein has a single DNA binding site, but multiple points of contact can be made with the DNA due to the multimeric nature of the DNA-bound complex. For example, a trimeric complex could, in principle, make three distinct contacts with the DNA. This configuration would support loop formation if only one of the motors translocated and the others just remained bound to a fixed position on the DNA. (3) Finally, it is also possible that loop extrusion could occur via a mechanism similar to that of the type 1 restriction endonucleases, in which two motors translocate in opposite directions even though they are part of the same protein complex (M31). However, with our experimental setup such a configuration would cause the proteins to always move towards the tethered end of the DNA and the tethered end of the DNA (or any stationary downstream proteins) would appear to move twice as fast as the translocating motor. We have observed no evidence to suggest that either of these is true. Therefore it is possible that the translocating complexes operate using a single motor in any given instance (rather than two motors that concurrently opposed one another), and at least one point of contact must be maintained at a defined position on the DNA.

DNA loops have also been reported for the chromatin-remodeling complex RSC (Lia et al., 2006). RSC is a ˜1 MDa complex comprised of 15 different polypeptides and sequence analysis of its ATPase subunit (Sth1) places it within the Snf2-like subfamily of Snf2 proteins (M29, M10). Magnetic tweezers were used to show that RSC could travel along the DNA at a rate of 200 bps/sec and also induced the formation of transient DNA loops. (M20). In this case the average loop size was ˜420 base pairs, and the size of the loops was inversely related to the tension applied to the DNA molecules, dropping to ≦200 base pairs above 0.5 pN (equivalent to the approximate force experienced by the molecules in our experiments) (M12). This particular assay could only detect translocation of RSC if it was coupled to loop formation, so it remains unclear whether this protein was able to move without loop formation or whether it could remain stably bound to the DNA after loop release. It is not apparent why the loops observed for RSC were so much smaller than those detected here with Rdh54, but this may reflect differences in the specific biological functions of the two enzymes. For example, RSC may only need to move a single nucleosome for relatively short distance to allow RNA polymerase to gain access to a promoter region. In contrast, Rdh54 may need to clear proteins from a much larger region of DNA to allow a long (˜1 kilobase) Rad51:ssDNA presynaptic filament to invade a homologous duplex. Similarly, after strand invasion is complete Rdh54 may need to strip a relatively long Rad51 protein filament from the heteroduplex product of the reaction. Taken together these results show that Rdh54 and RSC both form DNA loops, despite the fact that they are assigned to different Snf2 subgroups, have different biological functions, and have obvious differences in subunit composition. Thus our results confirm that translocation-coupled DNA loop extrusion is a conserved mechanism used by the different Snf2-family of chromatin-remodeling motor proteins and may play an integral role in their biological functions.

DNA translocation, loop extrusion and the biological function of Rdh54. Rdh54 performs a variety of functions during homologous DNA recombination and is likely to act at several different stages of the reaction (M7, M15, M41). The challenge now is to understand how translocation and loop extrusion functions are integrated into the requirements of the DNA repair machinery and used to control chromosome structure and/or modify protein-DNA interactions during homologous recombination. It is possible that different aspects of Rad54 activity may play different roles at the presynaptic, synaptic, and postsynaptic stages of the recombination reaction (M14).

Rdh54 is required for meiotic DNA recombination and interacts with both the Rad51 and Dmc1 recombinases (M7, M9, M24, M32, M33). One proposed function of Rdh54 (and Rad54) has been as a molecular “stripase” whose function is to remove or remodel stationary proteins from DNA to allow the repair machinery to have unhindered access to its substrates (M2, M7, M38). At the early stages of the reaction this would entail removing nucleosomes from chromatin (M2, M3, M16). At later stages the stripase activity would ensure that the DNA was cleared of recombinase and made accessible to additional repair factors necessary for downstream steps in the pathway (M7, M18, M38). As shown here, Rdh54 translocates and concomitantly generates DNA loops, but it is not clear which of these activities would be most essential for disrupting stationary proteins. One model posits that translocation generates torsional stress that may disrupt protein-DNA complexes (M30). A second model proposes that the translocating protein may function like a locomotive's “cowcatcher” by colliding with sufficient force that any stationary proteins are simply displaced from the DNA (M38). A third possibility is that specific protein-protein interactions are necessary between the translocase and the stationary roadblock to specifically trigger dissociation of the bound protein (M7, M38). These models are not mutually exclusive and all three mechanisms may play a role during the disassembly of recombinase filaments or during disruption of nucleosomes. Importantly, none of these mechanisms would have an absolute requirement for either loop formation or extensive changes in DNA topology. This suggests that loop formation may play an alternative role in homologous recombination.

It is possible that DNA loop extrusion plays a direct role in the strand invasion step of homologous recombination. Rdh54 and Rad54 are also involved in earlier steps of homologous recombination and the proteins greatly enhance the invasion of a homologous double-stranded DNA molecule by the Rad51/Dmc1 recombinase presynaptic filament (M24, M25, M26, M37). In this mode, it is thought that the translocase associates with the recombinase filament and together they search the duplex DNA for regions of homology and align the two strands of DNA. The function of the translocase in these reactions may be two-fold: (1) it may serve as a molecular motor enabling the presynaptic filament to rapidly translocate along the duplex DNA (M39), and (2) it may extrude supercoiled loops from the duplex DNA which would in turn serve as more favorable substrates for strand invasion because of their reduced melting temperature (M24, M28, M43). DNA supercoiling is a requirement for eukaryotic DNA recombinases in the Rad51-family, therefore the formation of extruded supercoiled loops would be of clear benefit to these reactions. Moreover, the sizes of the loops observed with Rdh54 are comparable in magnitude to the known length of the ssDNA overhangs generated at the processed ends of double-stranded breaks.

Finally, Rad54 can promote DNA branch migration, a process that occurs late in recombination and requires an enzyme capable of translocating on DNA (M6). Based on their similarities, it seems reasonable to believe that Rdh54 may also play a role in branch migration. However, it is unlikely that loop extrusion would be beneficial for this reaction. In this case the configuration of the enzyme could be different when bound to a Holliday junction and loops may not be produced when translocating on these substrates.

Many questions can now be addressed regarding the activity of Rdh54. Is loop formation obligatorily coupled to translocation or can proteins translocate without concomitant loop extrusion? Are loops necessary for all of Rdh54s activities or can unidirectional translocation suffice for some functions? What happens when Rdh54 collides with a stationary protein or an unusual DNA structure? Are the behaviors of Rdh54 modified to accommodate the different stages of recombination? Our approaches will allow us to probe many new questions that can not be tested with traditional biochemical methods.

Experimental Procedures

Recombinant proteins. Rdh54 and Rdh54 K352R proteins were overexpressed in E. coli and purified as previously described (M7).

Flowcells, DNA substrates and DNA curtains. The flowcells were assembled from fused silica slides (G. Finkenbeiner, Inc.) on which microscale diffusion barriers were etched using a diamond-tipped scribe (M12). Inlet and outlet ports were made by boring through the slide with a high-speed precision drill press equipped with a diamond-tipped bit (1.4 mm O.D.; Kassoy). The slides were cleaned by successive immersion in 2% (v/v) Hellmanex, 1 M NaOH, and 100% MeOH. The slides were rinsed with filtered sterile water between each wash step and stored in 100% MeOH until use. Prior to assembly of the flowcell, the slides were dried under a stream of nitrogen and baked in a vacuum oven for at least 1 hour. A sample chamber was prepared from a borosilicate glass coverslip (Fisher Scientific) and double-sided tape (˜25 μm thick, 3M). Inlet and outlet ports (Upchurch Scientific) were attached with adhesive rings and cured at 120° C. under vacuum. The total volume of the sample chambers was ˜4 μl. A syringe pump (Kd Scientific) and actuated injection valves (Upchurch Scientific) were used to control sample delivery, buffer selection and flow rate. The flowcell and prism were mounted within a custom-built heater with computer-controlled feedback regulation that could be used to control the temperature of the sample from between 25-37° C. (±0.1° C.).

DNA curtains were constructed essentially as described (M12). All lipids were purchased from Avanti Polar Lipids and liposomes were prepared as previously described (M12). In brief, a mixture of DOPC (1,2-dioleoyl-sn-glycero-phosphocholine), 0.5% biotinylated-DPPE (1,2-dipalmitoyl-sn-glycero-3-phosphoethanolamine-N-(cap biotinyl)), and 8-10% mPEG 2000-PE (1,2-dioleoyl-sn-glycero-3-phosphoethanolamine-N-[methoxy(polyethylene glycol)-2000]). Liposomes were applied to the sample chamber for 1 hour. Excess liposomes were flushed away with buffer containing 10 mM Tris-HCl (pH 7.8) and 100 mM NaCl. The flowcell was then rinsed with buffer A (40 mM Tris-HCl (pH 7.8), 1 mM DTT, 1 mM MgCl₂ plus 0.2 mg/ml BSA. Neutravidin (330 nM) in buffer A was then injected into the sample chamber and incubated for 30 minutes. After rinsing thoroughly with additional buffer A, biotinylated λ-DNA (10 pM) pre-stained with 1-2 nM YOYO1 was injected into the sample chamber, incubated for 30 minutes, and unbound DNA was removed by flushing with buffer. Application of buffer flow caused the lipid-tethered DNA molecules to align along the leading edges of the diffusion barriers. Once the DNA curtains were located, 50 μl of 0.5 M NaCl was injected into the sample chamber at a flow rate of 0.1 ml/min to remove all detectable traces of YOYO1.

TIRFM. The basic design of the microscope used in this study has been previously described (M13). In brief the system is built around a Nikon TE2000U inverted microscope with a custom-made illumination system. For this study, a 488 nm, 200 mW diode-pumped solid-state laser (Coherent, Sapphire-CDHR) was used as the excitation source. The laser was attenuated with an appropriate neutral density filter, passed through a spatial filter/beam expander, collimated, and focused through a fused silica prism onto the surface of a microfluidic sample chamber (described below). This gave a Gaussian profile with an elliptical illuminated field of approximately 50×200 μm, which was centered over the DNA curtain by means of a remotely operated mirror (New Focus) and the intensity at the face of the prism was typically ˜5 mW. Images were detected with a back-illuminated EMCCD detector (Photometrics, Cascade 512B). For experiments that required multi-color detection the different emission spectra were separated by a dichroic mirror (630 DCXR, Chroma Technologies) with a Dual-View image-splitting device (Optical Insights).

Data collection and analysis. Data collection was done by acquiring steams comprised of 2000-10,000 frames at 8.3 frames per second using a 100 milli-second integration time. All data were collected using Metamorph software (Universal Imaging) or NIS-Elements (Nikon) and converted to 8-bit tiff files in NIH Image J. Particle tracking was then done using an algorithm written in Igor Pro, which automatically fit the signals from individual quantum dots to a 2D Gaussian function (M13).

Quantum dots, Protein Labeling and TIRFM Reaction Conditions. Quantum dots (Invitrogen) coated with short-chain polyethylene glycol with exposed free amines were labeled with affinity purified, reduced anti-thioredoxin (Immunology Consultants Laboratory, Inc.) using SMCC (succinimidyl 4-[N-maleimidomethyl]cyclohexane-1-carboxylate). The resulting conjugates were then purified over a Superdex 200 10/300 GL gel filtration column (GE Healthcare), which yielded a monodisperse peak, and were stored in PBS (pH 7.4) plus 0.1 mg/ml acetylated BSA at 4° C.

To optimize conditions for the TIRFM experiments the ATPase activity of Rdh54 was assayed at varying NaCl, MgCl₂ and KCl concentrations in the presence of 30 mM Tris-Cl pH 7.5, 1 mM DTT, 50 μg/ml BSA, 15 μM (base pairs) linear φX174 replicative form 1, 1.5 mM ATP, 1.2 μM [α-³²P]ATP at varying salt concentrations and in the presence or absence of an oxygen scavenging system (glucose/oxidase enzyme, β-mercaptoethanol, glucose) and YOYO1. Reactions were incubated, quenched and analyzed as described above. The hydrolysis reaction was initiated with either 40 or 400 nM Rdh54 and incubated at either 25° C., 30° C. or 37° C. for 30 minutes. The reactions were quenched with 2.5 μl of 0.5M EDTA and analyzed by polyethyleneimine-cellulose thin layer chromatography in 0.7M potassium phosphate buffer. These experiments revealed that the oxygen scavenging system completely abolished the ATPase activity.

ATPase assays were also performed in the presence of anti-thioredoxin antibody or anti-HA tag antibody (ICL Labs) to determine whether antibody binding affected the activity of Rdh54. Reactions were set up in 30 mM Tris-Cl pH 7.5, 1 mM DTT, 50 μg/ml BSA, 2 mM MgCl₂, 15 μM base pairs cut φX174 replicative form I, 1.5 mM ATP, 0.6 μM [α-³²P]ATP and at varying amounts of anti-thioredoxin and anti-HA antibody in 0.6×PBS. The reactions were initiated with either 40 or 400 nM Rdh54 and incubated, quenched and analyzed as described above. These experiments showed no evidence that the ATPase activity of Rdh54 was altered in the presence of the anti-thioredoxin antibody.

For TIRFM experiments, Rdh54 (10-20 nM) was mixed with an equimolar amount of anti-thioredoxin quantum dot in reaction buffer containing 40 mM Tris-Cl (pH 7.8), 1 mM MgCl₂, 1 mM DTT, and 0.2 mg/ml BSA, in a total volume of 25 μl, and reactions were incubated for 15-20 minutes on ice. The reactions were then diluted to a final volume of 100 μl immediately prior to injecting the protein into the sample chamber. All TIRFM experiments were done using 40 mM Tris-Cl pH 7.8, 1 mM MgCl2, 1 mM DTT, 0.2 mg/ml BSA with or without ATP, as indicated.

### EXAMPLE 8

### Visualization of PCNA and Msh2-Msh6 on Nucleic Acid Arrays

We will directly visualize the behaviors of PCNA (proliferating cell nuclear antigen) and Msh2-Msh6 (MutS homologs), which together form a core component of the post-replicative mismatch repair machinery. We believe that PCNA links Msh2-Msh6 to DNA, allowing it to processively scan for mismatches via a one-dimensional random walk. Once a mismatch is located Msh2-Msh6 will release PCNA and begin actively translocating on the DNA, setting the stage for downstream events in the repair pathway. To test this, we will visualize the movement of the proteins on DNA, determine how they interact with and influence one another, and determine how these interactions correlate with their putative roles in the repair of mispaired bases.

Characterizing the movement of PCNA on DNA. Analysis of mismatch recognition is done by characterizing the 1D-diffusion of PCNA in the absence of other proteins. PCNA forms a homotrimer with a central pore large enough to accommodate one strand of duplex DNA, allowing the protein to remain tightly bound but capable of sliding freely along the bound DNA and it displays a lifetime of ≧20 minutes when bound to DNA [N17, N18]. Although most commonly known as a processivity factor required for DNA synthesis, PCNA also interacts with many other proteins, including several that are involved in DNA repair [N18-N20].

PCNA is tagged at a single exposed cysteine using a fluorescent semi-conducting nanocrystal (quantum dot or Qdot). Qdots are relatively small (2-10 nm diameter), extremely photo-stable, display broad excitation spectra, narrow emission peaks, large Stokes shifts, large absorbance cross-sections, and very high quantum yields [21-23]. Individual Qdots are readily visualized at data collection rates of 100 frames per second with signal to noise ratios of ≧10:1, and the Qdots do not bleach even after prolonged illumination [N21, N22].

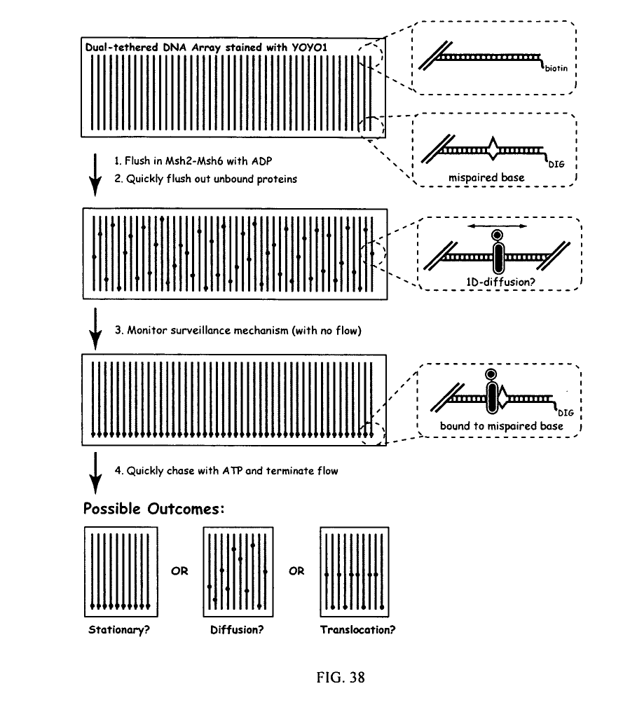

To facilitate uniform labeling (and avoid the attachment of more than 1 Qdot per protein ring) an engineered version of PCNA is used in which the homodimer subunits are expressed as a single polypeptide chain with an N-terminal hexa-histidine tag (FIG. 36; the exposed cysteines (C22, and C30) will be mutated to alanine. The genes for the PCNA trimer will be fused and expressed as a single polypeptide. This will allow the introduction of a single surface exposed cysteine (L130C), which can then be chemically linked to a Qdot. Reacting the protein with an excess of Qdot ensures one PCNA per Qdot). The N- and C-termini of the adjacent PCNA monomers are closely juxtaposed in space, suggesting it will be functional when expressed as a single peptide. Furthermore, the E. coli β-clamp (whose 3D structure can be superimposed on PCNA [N24]) is fully functional when fused and expressed as a single polypeptide. Using the crystal structure of PCNA as a guide, a mutant version is generated that has a single exposed cysteine near the C-terminus of the polypeptide. This site is not close to any regions of the protein required for either protein-protein or protein-DNA interactions; thus covalent modifications at this position should not affect its biochemical properties. To ensure that behaviors observed in the TIRFM experiments described below are due to the effects of one sliding clamp, the protein is mixed with a 10-fold molar excess of maleimide-Qdot to favor a 1:1 protein to Qdot ratio. The unreacted Qdots are removed by passing the mixture over a Ni-affinity column, which binds to the hexa-histidine tag on PCNA, but will not bind the unreacted Qdots. These fluorescent proteins are then tested in ensemble biochemical assays for the ability to load onto DNA and support replication.

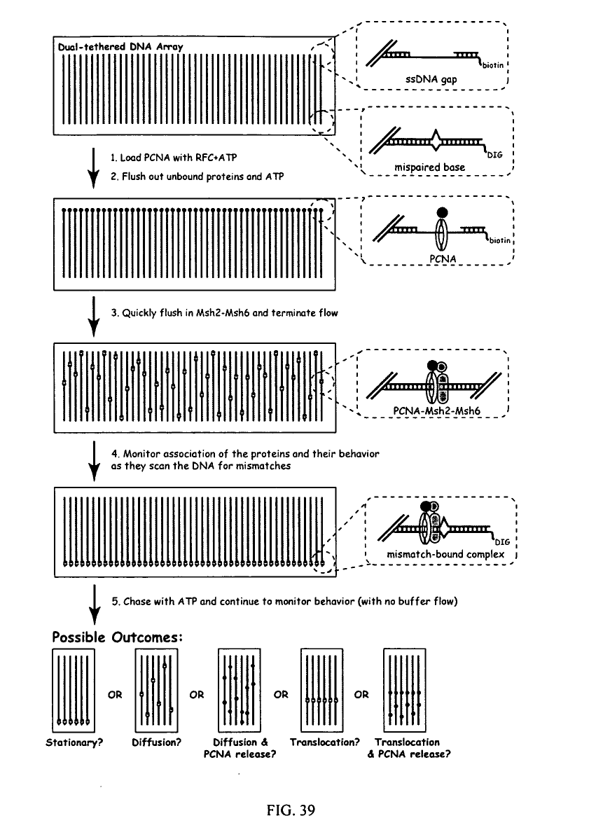

Monitoring 1D-diffusion of PCNA on DNA is illustrated in FIG. 37. First, a dual-tethered array of DNA molecules is assembled onto the surface of a microfluidic sample chamber as described herein. These will consist of molecules with a 30 nt ssDNA gap at one end, where PCNA can be loaded by the clamp-loader RFC (Replication Factor C) in an ATP-dependent reaction [N25]. At the outset of the experiment, all of the fluorescent PCNA are loaded at the same end of the DNA array. As PCNA is stochastically released by RFC it starts to diffuse along the DNA molecules at a velocity reflective of its 1D-diffusion coefficient, which is calculated based on the frame-to-frame linear displacement of the individual proteins. PCNA dissociates very slowly from DNA; the Qdots are continuously illuminated without photobleaching; and up to 100 DNA molecules in an array are monitored without sacrificing resolution between individual sliding clamps on adjacent DNA molecules. Therefore, the 1D-diffusion of PCNA is characterized over long periods of time, and these experiments will immediately set the stage for assessing the interactions between PCNA and Msh2-Msh6.

Interactions between PCNA and Msh2-Msh6 during the repair of damaged DNA. Msh2-Msh6 is a key component of the mismatch repair (MMR) machinery and is responsible for locating mispaired bases and initiating the repair pathway [N9, N26, N27]. As with PCNA, Msh2-Msh6 are labeled using Qdots. Active, HA-tagged Msh2-Msh6 are expressed and purified from S. cerevisiae, and this affinity tag is used as the attachment point for an anti-HA coated Qdot. First, maleimide-coated Qdots are reacted with anti-HA Fab fragments. The Fab-Qdot conjugates are purified by gel filtration, and then mixed with the HA-tagged Msh2-Msh6. As with PCNA, an excess of Qdot is used to ensure a 1:1 ratio of Qdot to Msh2-Msh6.

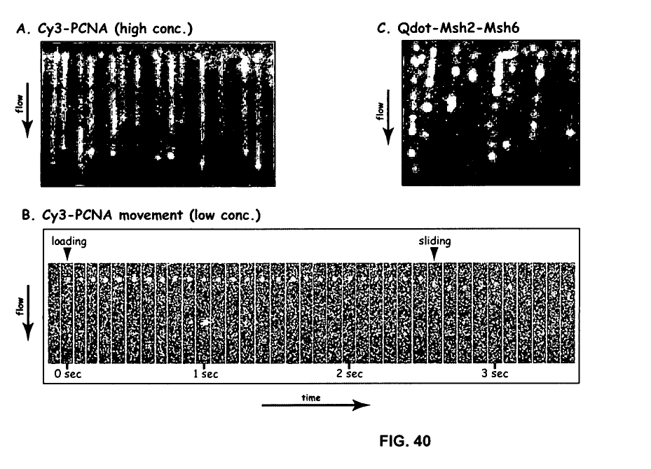

Msh2-Msh6 does not require the presence of PCNA to locate and bind to mispaired bases in vitro [N26], and how Msh2-Msh6 locates and responds to mispaired bases in the absence of PCNA (FIG. 38). The fluorescently labeled Msh2-Msh6 is bound, in the presence of ADP, to a DNA array containing a mispaired base at a defined position (prepared by annealing appropriate oligos to the end of λ-DNA). Qdot labeled Msh2-Msh6 is then flushed into the sample chamber with ADP, and allowed to bind to the DNA. ATP is then rapidly flushed into the chamber (˜10 sec dead time), flow terminated, and the behavior of the bound complexes monitored over time. Initial binding to the DNA occurs at random positions throughout the array. There are two likely mechanisms by which the Msh2-Msh6 complexes can locate the mispaired bases: either by 1D-diffusion along the DNA, or by a 3D-random collision mechanism. We can directly distinguish between these two possibilities by continually monitoring the protein complexes as they survey the DNA for the mispaired base. Over time, the Msh2-Msh6 locates and binds stably to the mismatches, yielding a “line” of fluorescent complexes extending across the DNA array marking the position of the mispaired base. ATP is then quickly flushed into the sample chamber and the flow terminated. Once Msh2-Msh6 has located a mismatch, it must hydrolyze ATP in order to trigger downstream events in the repair pathway; however, it remains completely unclear what happens at this point in the reaction. There are three controversial models in the literature describing how Msh2-Msh6 should respond once ATP is added to the reaction. It could either (1) remain stationary [N28, N29], or (2) it could passively diffuse away from the mismatch [N30-N33], or (3) it could actively translocate away from the mispaired base [N34, N35]. Our TIRFM approach will readily differentiate between these conflicting mechanisms. If the stationary model is correct, then the complexes will not move on the DNA once ATP is added. If the diffusion model is correct, then the complexes will begin to move on the DNA and this movement will be comprised of short-distance, bidirectional oscillations characteristic of a random walk. Finally, if the translocation model is correct the Msh2-Msh6 complexes should display unidirectional movement along the DNA. (The direction of the movement should depend on the orientation of each protein complex, and assuming that the original binding event is random, then 50% of the complexes should go in one direction and 50% should go in the other direction).

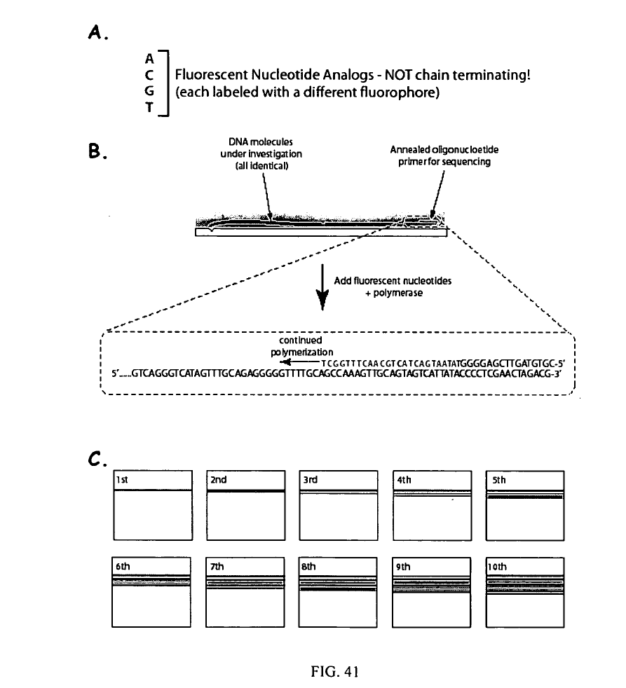

Recent studies have shown that the function of Msh2-Msh6 is linked to its ability to interact with PCNA [N36-N39]. Therefore, once the behaviors of PCNA and Msh2-Msh6 are characterized on their own, how these proteins interact with and influence one another is determined. One hypothesis is that PCNA links Msh2-Msh6 to the DNA and enables highly processive scanning for mispaired bases [N27, N37-N39]. PCNA also stimulates ATP hydrolysis by Msh2-Msh6 when a mispair is encountered. This is thought to result in the release of Msh2-Msh6 from PCNA, allowing the initiation of downstream steps in the repair pathway [N38]. To clarify the behavior of the PCNA-Msh2-Msh6 complexes the Qdot-labeled PCNA sliding clamps are bound to an array of dual-tethered DNA molecules, the unbound proteins are flushed out, and the Qdot-labeled Msh2-Msh6 complex is quickly flushed in (FIG. 39). For these experiments Qdots with different emission spectra (for example orange and red) are used so that the sliding clamps and the Msh2-Msh6 proteins are distinguished. This experiment uses arrays with a PCNA loading site at one end and a single mismatch at the other end. PCNA is loaded onto the DNA first, then the RFC and ATP is removed with a brief rinse. Msh2-Msh6 plus ADP is flushed into the sample chamber and its interactions with the DNA and the bound PCNA is monitored. Based on ensemble studies, PCNA and Msh2-Msh6 colocalize on the DNA (observing this process in real-time allows us to determine precisely how the proteins find one another). The PCNA-Msh2-Msh6 complexes then start scanning the DNA for a mispaired base. This process most likely occurs via passive diffusion, because it does not require ATP hydrolysis [N39]; thus we expect to see behavior consistent with a 1D-random walk mechanism. Finally, once the mispaired base is located, ATP is added, and the Msh2-Msh6 proteins are expected to release PCNA and either actively translocate or diffuse away from the mismatch.

This set of experiments highlights the advantages of our approach: TIRFM allows the monitoring of the reactions at the single-molecule level; the dual-tethered DNA arrays enables us to simultaneously monitor hundreds of individual reactions in the absence of any perturbing hydrodynamic force; protein complexes bound at the same site are aligned with one another, and the Qdot labels allow for the monitoring of both proteins for long periods of time without loss of signal intensity. Taken together these experimental tools allow the full dissection of the interactions between PCNA, Msh2-Msh6, and their DNA substrates, and the determination of how these interactions facilitate the repair of damaged DNA.

Additional Considerations. All of the fluorescent proteins are tested at the ensemble level using well-established methods to ensure that attachment of the fluorescent labels does not alter the function of the proteins. For example, the Qdot-PCNA is tested in DNA loading and replication assays and Qdot-Msh proteins are tested for mismatch recognition using standard gel-shift and ATPase assays [N17, N26]. Should any of the labeled proteins prove to be deficient then we will explore alternative attachment points or labeling procedures.

Visualizing PCNA on DNA

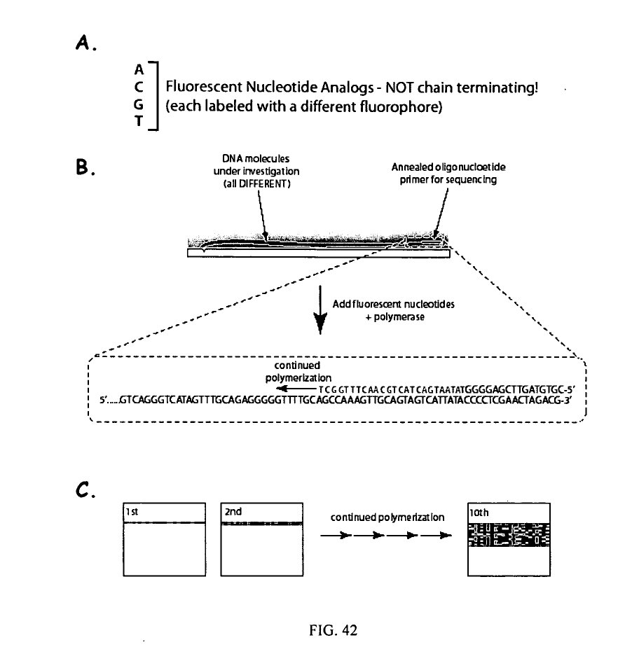

As an alternative strategy we have already constructed a version of PCNA that is labeled with Cy3 (labeled at L130C; three fluorophores per PCNA trimer). This fluorescent protein is functional in standard loading and DNA replication assays, and we can detect RFC/ATP-dependent loading on single molecules of DNA using TIRFM and an aligned DNA array (FIGS. 40A and 40B). Cy3-PCNA (50 nM) was loaded onto a DNA array comprised of molecules with an ssDNA gap at their tethered ends. At high concentrations of Cy3-PCNA the DNA molecules become coated with the fluorescent protein, but at lower concentrations we can detect individual loading events. Loading was dependent on both ATP and RFC, and in the absence of either component no PCNA was observed on the DNA. In these cases the PCNA loads on the DNA, remains briefly at the loading site, and then slides rapidly along the DNA in the direction of buffer flow (FIG. 40B; reactions were performed with 1 nM Cy3-PCNA plus ATP and RFC, and images were collected at 10 frames per second.). We are now optimizing these trial experiments with dual-tethered DNA substrates, which are expected to trap the sliding PCNA between the two tethered ends. The drawbacks of Cy3 (and other organic fluorophores) are that its low photobleaching threshold reduces the duration over which we can make our observations, and Cy3 also has much lower signal intensity relative to the Qdots, which will result in lower signal to noise ratios. Nevertheless, if difficulties are encountered with the Qdot attachment, Cy3 is a viable alternative strategy.

Visualizing Msh2-Msh6 on DNA

We have also conjugated Msh2-Msh6 to the anti-HA coated Qdots, and these conjugates bind dsDNA in our single-molecule system (FIG. 40C). Control experiments showed that the DNA binding only occurred with Qdots that were conjugated to Msh2-Msh6; the anti-HA Qdots themselves do not bind to the DNA. In addition, we do not see appreciable nonspecific binding of the proteins (PCNA or Msh2-Msh6) or the corresponding protein-DNA complexes to the lipid bilayer surfaces. This shows the ability to detect the binding of Qdots coated with Msh2-Msh6 (˜10 proteins per Qdot) to single molecules of DNA. Furthermore, HA-tagged Msh2-Msh6 retains its biochemical functions when bound by an anti-HA antibody; suggesting that the Qdot conjugates will not adversely affect the biochemical activity of Msh2-Msh6, implying that the Qdot-labeled Msh2-Msh6 are suitable for the single-molecule experiments.

PCNA loading and post-recognition events promoted by Msh2-Msh6 are dependent on the hydrolysis of ATP. Therefore all ensemble and single-molecule experiments are performed with ADP, ATP and ATPγS to ensure that the proteins respond appropriately. A variety of different DNA substrates are tested to ensure that events attributed to PCNA loading and/or mismatch recognition are correlated with the presence of a loading site and/or mispaired base. There are mutant versions of Msh2-Msh6 available that are defective in ATP binding, ATP hydrolysis, interactions with PCNA, and mismatch recognition [N40, N41]. These and other mutant proteins are utilized to fully dissect the interactions between PCNA, Msh2-Msh6, and the mismatched DNA substrates.

Beyond the broader biological questions described herein, an inherent aspect of these single-molecule experiments is the characterization of the detailed biophysical properties of the proteins bound to the DNA molecules. All of the data is processed by fitting the images (point-spread functions) to 2D-guassian curves, which are used to localize the positions of the Qdots with extremely high precision (˜1.5 nm resolution when used with a calibrated nano-positioning stage [N42]), and a single-particle tracking algorithm is used to quantify the movements of the individual protein complexes on the DNA molecules [N6, N7, N43]. The 1D-diffusion coefficients (D) for PCNA are determined (under a variety of different buffer conditions) by measuring the mean square displacement, <x²>, for the diffusing entities as a function of time [N6, N7, N44]. The diffusion coefficients are calculated using the equation: <x²> =2Dt; where t is the time interval for each successive step, and x is the lateral displacement of the protein at each step [N7, N44, N45]. Furthermore, using the Einstein-Stokes relation: D=kT/f (where k is Boltzmann's constant, and T is temperature), f, the viscous drag coefficient, is calculated for the diffusing protein or protein complex [N44]. These parameters from PCNA alone are then compared to those obtained for the PCNA/Msh2-Msh6 to determine how the interaction alters the movement of the proteins on the DNA. The processivity, stability, and/or translocation rates (if Msh2-Msh6 promotes active movement on the DNA) are also determined and compared to the different protein complexes to further evaluate how the interactions between PCNA and Msh2-Msh6 influences their behavior on the DNA.

In some embodiments, the rotational dynamics of diffusing PCNA (or other protein complexes) are measured by monitoring oscillations in the emission intensity of the Qdots as they move around the DNA and change position within the (exponentially decaying) evanescent field and/or by using a polarized evanescent field to monitor changes in their transition dipoles as they rotate around the DNA. Such measurements yield very precise details of how the protein molecules interact with and track along the DNA.

In some embodiments, individual replication forks and their associated proteins are visualized using a high-throughput single-molecule approach.

### EXAMPLE 9

### Sequencing DNA Molecules Using Nucleic Acid Arrays

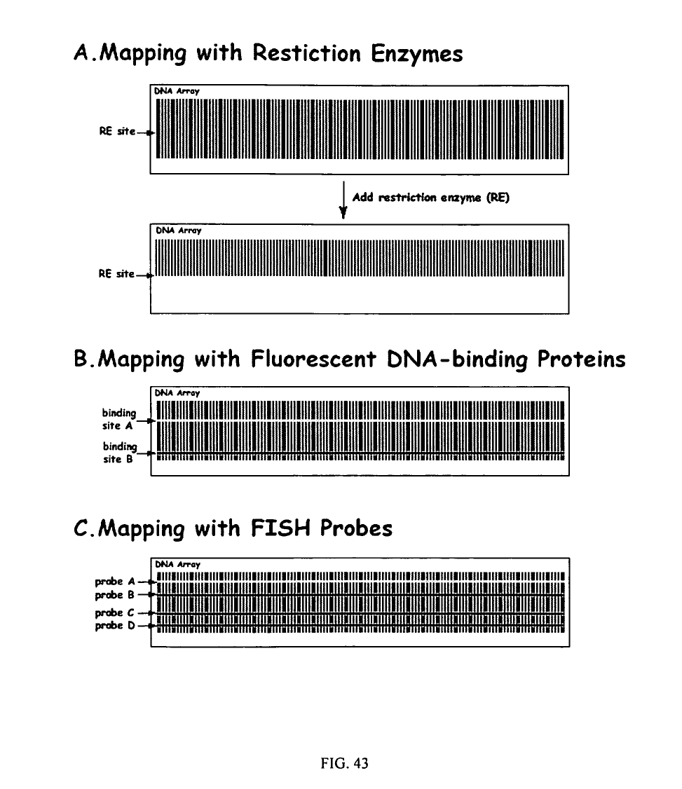

The arrays described herein can be used to determine the sequence of DNA molecules. When sequencing identical DNA molecules, fluorescent nucleotide analogs that do not terminate extension of the DNA strand are used (see FIG. 41A). An oligonucleotide primer is annealed to the DNA molecules under investigation (see FIG. 41B). Annealing is done before tethering the DNA molecules to the surface because the lipid bilayer would be disrupted by the elevated temperature. Polymerase is then added along with the fluorescent dNTP mix. The color of the nucleotide incorporated into the growing chain reveals the sequence of the DNA molecules. If all of the DNA molecules within the array are identical, then the incorporation of the first nucleotide during polymerization will yield a fluorescent line extending horizontally across the array (see FIG. 41C). Subsequent nucleotide addition will also yield horizontal lines and the color of each line will correspond the DNA sequence.

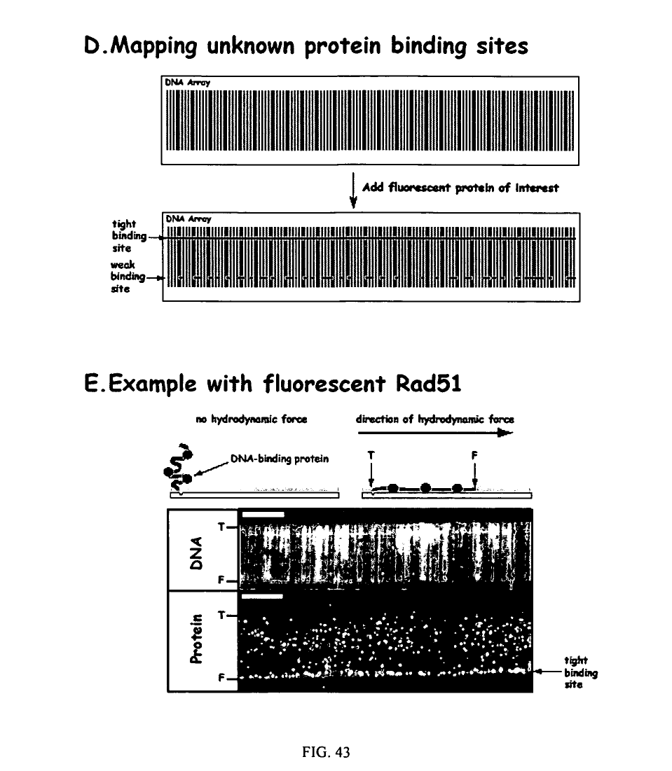

When sequencing different DNA molecules, fluorescent nucleotide analogs that do not terminate extension of the DNA strand are used (see FIG. 42A). An oligonucleotide primer is annealed to the DNA molecules under investigation (see FIG. 42B). Annealing is done before tethering the DNA molecules to the surface. Polymerase is then added along with the fluorescent dNTP mix. During sequencing, the differences in DNA sequences are revealed as the incorporation of different fluorescent nucleotides across the array (see FIG. 42C), rather than the lines of identical color seen in FIG. 41.

### EXAMPLE 10

### Mapping DNA Molecules Using Nucleic Acid Arrays

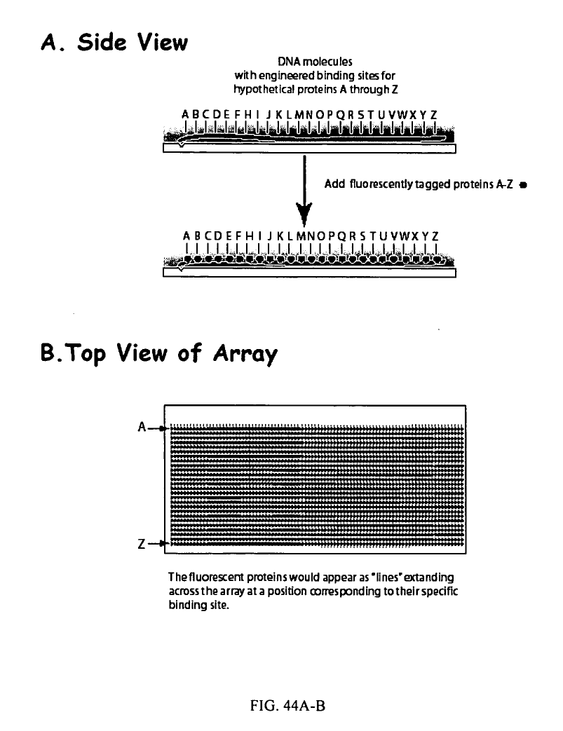

In the simplest case, the DNA molecules within the array are digested with a restriction enzyme (RE), which releases the free end of the DNA molecules, shortening their length and revealing the cutting site for that RE. (FIG. 43A) This can also be done sequentially with different REs and/or with arrays comprised of different DNA molecules. The array can also be mapped with fluorescently tagged site-specific DNA binding proteins. (FIG. 43B) In this example using two different proteins, one labeled with a yellow fluorophore and one labeled with a red fluorophore, the binding sites for the proteins are revealed as fluorescent lines extending horizontally across the array corresponding to the binding site for that particular protein (s). A similar approach can be taken using fluorescence in situ hybridization (FISH) where fluorescently tagged DNA probes are annealed to the array. (FIG. 43C) With arrays comprised of identical DNA molecules, this yields fluorescent lines across the array corresponding the location of each probe. Unknown binding sites can also be identified for a protein of interest by labeling that protein with a fluorescent tag and applying it to the array. (FIG. 43D) High affinity (tight) binding sites are revealed as fluorescent lines extending across the array, whereas lower affinity (weak) sites are revealed as partial lines, whose occupancy are determined by that binding affinity of the protein of interest for that particular site. An example of this with fluorescent Rad51 is depicted in FIG. 43E. In this case the protein bound very tightly to the ends of the DNA molecules and yielded a line extending across the array. The remaining protein was randomly distributed on the DNA because it binds to these regions with much lower specificity. This can be applied to virtually any DNA binding protein or protein complex.

### EXAMPLE 11

### High-Throughput Screening of Compounds Using Nucleic Acid Arrays

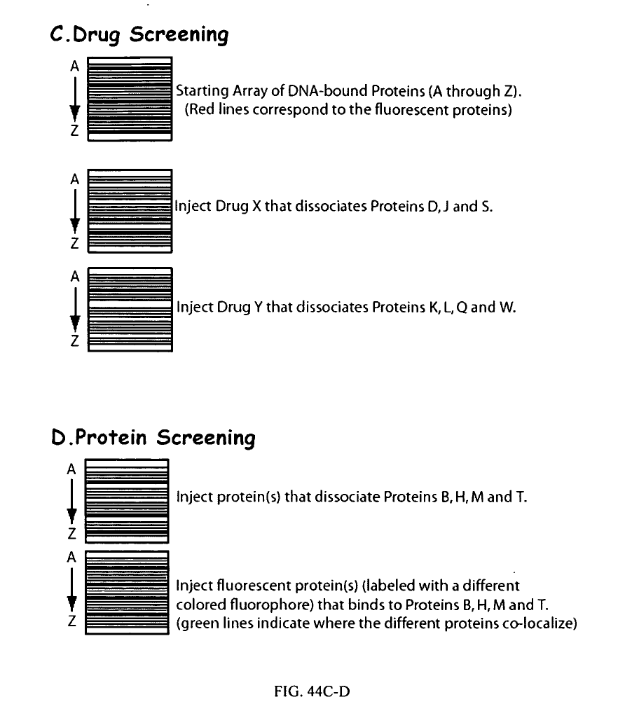

The arrays described herein can be used in high-throughput screening. For example, FIG. 44A shows a side view of a hypothetical DNA molecule that has been engineered to contain specific binding sites for the 26 hypothetical proteins A through Z. Proteins A-Z would then be tagged with a fluorescent marker. All could be labeled with the same color fluorophore because their location in the array is known a priori. Application of these proteins to the array would then yield 26 fluorescent lines extending across the array at positions corresponding the engineered binding sites. (See FIG. 44B)

To screen for drugs that influenced the binding behaviors of the proteins one would simply inject the drug(s) of interest and monitor the fate of the DNA bound proteins. (FIG. 44C) If a particular protein dissociates due to the influence of the drug, then this will be revealed as the loss of a fluorescent “line” corresponding to that particular protein. This would also reveal the specificity of the interaction, as a Drug designed to target Protein A (for example) should not affect proteins B through Z. It would also be possible to test proteins (or protein libraries) to look for either dissociation and/or colocalization. (FIG. 44D) First, the array would be prepared with its 26 DNA binding proteins (as described above), then the protein under investigation would be injected into the sample chamber. If the new proteins causes any of the DNA array bound proteins to dissociate, then non-fluorescent lines will appear across the array corresponding to the protein that was affected. Alternatively, if fluorescent test proteins (labeled with a different color than the array bound proteins) are injected into the sample chamber and interact with one or more of the array bound proteins, then this will be revealed as the colocalization of the different colored proteins on the DNA.

### EXAMPLE 12

### Visualization of Individual DNA Molecules Labeled with Single Quantum Dots

We present methods that allow for detection of individual DNA molecules that are organized into “DNA curtains” and are labeled at one end with a single quantum dot (Z4-Z6). This approach relies on the use of hydrodynamic force to organize thousands of lipid-tethered, fluorescently labeled DNA molecules along the leading edge of a microscale diffusion barrier (Z7). These molecules can then be visualized by total internal reflection fluorescence microscopy (TIRFM), and potentially hundreds of aligned DNA molecules can span the field-of-view. This method will allow for a high-throughput analysis of protein-DNA interactions at the single-molecule level.

The development of new single-molecule technologies over the past several years have allowed for experiments that can probe the chemical and physical properties of individual biological molecules in real time under near physiological conditions (Z8, Z9). One of the earliest accomplishments of this research was to allow physical analysis of the mechanical properties of DNA and the subsequent verification of mathematical models describing the behavior of individual polymers in solution (Z8, Z10, Z11). Similarly, several studies have now probed the behavior of individual DNA-binding proteins or protein complexes, and have lead to new insights into the mechanisms of many different biochemical processes related to DNA metabolism (Z12-Z17).

Studies have recently shown that fluorescent semi-conducting nanocrystals (quantum dots) can be used as labeling reagents for tagging single DNA molecules (Z20). Quantum dots are highly fluorescent, they do not photo-bleach and are virtually indestructible under the conditions used for most biochemical experiments, they have very broad excitation spectra and narrow emission peaks, and they are now commercially available with a variety of different coupling chemistries (Z4-Z6).

One limitation of many single-molecule techniques is that it is often extremely difficult to gather statistically relevant information from experiments designed to probe individual reactions. This problem can be greatly exacerbated with long or complex DNA substrates, and/or when the specific biochemical event under investigation occurs rather infrequently. In addition, many single-molecule methods require that the molecules under investigation be tethered to a surface. For example, with TIRFM the detection volume defined by the penetration depth of the evanescent field is restricted to within ˜100-200 nanometers of the surface at the interface between two transparent media of differing refractive indexes (i.e., a slide glass and an aqueous buffer) (Z21). To follow individual reaction trajectories with TIRFM, the reactions should be confined within this small volume. This can be accomplished by tethering the molecules to the surface via specific coupling methods (e.g., biotin-streptavidin). However, nonspecific interactions between any protein or DNA molecules and the surface should be eliminated or minimized, otherwise it is difficult to decipher the fluorescent signals that arise from the biologically active molecules as opposed to those that may be inactivated by their association with the unnatural surface environment. To help overcome these problems, we have developed a new technology that uses hydrodynamic force to organize arrays comprised of hundreds of individual, lipid-tethered DNA molecules along the leading edge of a microscale-mechanical barrier to lipid diffusion, as described herein and in (Z7). These “DNA curtains” allow for the direct visual detection of up to hundreds of aligned DNA molecules in a single field-of-view, all of which are suspended above a fused silica surface coated with a “bio-friendly” lipid bilayer. Because the DNA molecules are physically aligned with one another, a hypothetical line drawn across the curtain, perpendicular to the direction of flow force will cross the exact same region on each individual DNA molecule. Similarly, application of a fluorescently labeled sequence-specific DNA-binding protein or other site-specific marker is expected to yield a fluorescent line extending across the field-of-view marking the location of that specific site (Z7, Z22).

Here we present an approach that combines the advantages of quantum dots as fluorescent labels, with the benefits of our high-throughput single-molecule DNA curtains. For this we have constructed DNA curtains using PCR derived substrates that are labeled at one end with a single biotin tag and at the other end with single digoxigenin. The biotin allows the DNA to be tethered to appropriately modified head groups within the lipid bilayer and subsequently organized into a defined pattern along the leading edge of a microscale diffusion barrier by the application of a hydrodynamic force. The digoxigenin at the opposite end of the DNA is used to label each individual molecule in the curtain with a single antibody-coated fluorescent quantum dot, which can then readily be detected using total internal reflection fluorescent microscopy (TIRFM). This strategy allows for direct visual detection under intense laser illumination without damaging the DNA. Furthermore, the emission intensity of the quantum dots is not affected under physiological solution conditions and can also be used at higher salt concentrations, which enables detection of the DNA under a wide range of conditions. This approach will facilitate single-molecule research of protein-DNA interactions by ensuring the rapid acquisition of large amounts of data in an experimental context closely mimicking the natural environment encountered by most DNA-binding proteins.

### Materials and Methods

### Total Internal Reflection Fluorescence Microscope (TIRFM)

The TIRFM system was custom-designed and built around a Nikon TE2000U inverted microscope (Z7, Z22). A 488 nm solid-state laser (Coherent Inc.) provided illumination and was focused through a pinhole (10 μm) using an achromatic objective lens (25×; Melles Griot), then collimated with another achromatic lens (f=200 mm). The beam was directed to a focusing lens (f=500 mm) and passed through a custom-made fused silica prism (J.R. Cumberland, Inc) placed on top of the flowcell to generate the evanescent field with a calculated penetration depth of 150 nm. Fluorescence images were collected through an objective lens (100× Plan Apo, NA 1.4, Nikon), passed through a notch filter (Semrock), and captured with a back-thinned EMCCD (Cascade 512B, Photometrics, Tucson, Ariz.). Image acquisition was controlled using Metamorph software (Universal Imaging Corp.).

### DNA and Quantum Dot Preparation

Quantum dots (Qdot 705; Invitrogen) coated with primary amines were labeled with polyclonal sheep anti-digoxigenin (anti-DIG) Fab fragments (Roche Applied Sciences). Labeling was performed essentially as described in the manufactures protocol, with a few modifications. The quantum dots (125 μl at 4 μM) were activated by addition of 1 mM SMCC (4-(maleimidomethyl)-1-cyclohexanecarboxylic acid N-hydroxysuccinimide ester) and allowed to react for 1 hour at room temperature. The lyophilized antibodies were resuspended to a final concentration of 1 mg/ml in 300 μl of PBS, reduced by the addition of DTT to a final concentration of 20 mM, and then incubated for 30 minutes at room temperature. Both the activated quantum dots and the reduced antibodies were then purified on a NAP-5 desalting column (GE Healthcare) to remove unreacted SMCC and excess DTT, respectively. The activated quantum dots and reduced antibodies were then mixed, allowed to incubate to an additional hour at room temperature, and finally quenched with the addition of 10 mM β-mercaptoethanol. The antibody-labeled quantum dots were then concentrated to a final volume of 200 μl by ultrafiltration and purified on a Superose 6 or Superdex 200 10/300 GL column (GE Healthcare) equilibrated in PBS. The purified quantum dot conjugates were quantitated by measuring the absorbance at 550 nm and using an extinction coefficient of 1,700,000 M⁻¹ cm⁻¹, as suggested by the manufacturer. The antibody-labeled quantum dots were then stored in PBS plus 0.1 mg/ml acetylated BSA at 4° C., and no decrease in performance was observed when they stored for 2-4 months under these conditions.

The DNA substrates were prepared by PCR amplification of a 23 kilobase segment of the human β-globin locus using the Expand 20 kbPLUS PCR system and human genomic DNA (Roche Applied Sciences). PCR was performed according to the manufacturer's recommendation using the following primers: 5′-biotin-TEG-CACAAGGGCTACTGGTTGCCGATT-3′ (forward primer; SEQ ID NO: 3) and 5′-digoxigenin-AGCTTCCCAACGTGATCGCCTTTCTCCCAT-3′ (reverse primer; SEQ ID NO: 4). Primers were obtained from Operon and gel purified before use. To remove unreacted primers, the resulting PCR products were purified over a MicroSpina S-400 HR column (GE Healthcare) pre-equilibrated in TE. Typical yield from this protocol was ≈50 μl at a final concentration of 1 nM 23 kb DNA substrate.

Two different procedures were used for coupling the anti-DIG quantum dots to the DNA molecules, with equivalent outcomes. In the first method, 10 μl of the 1 nM purified PCR product was diluted to 1 ml in buffer A (see below) and slowly injected into the sample chamber. This allowed the DNA to bind to the bilayer and move to the leading edge of the diffusion barrier. After assembly of the array, 100 μl of anti-DIG quantum dots (1 nM) were injected into the sample chamber at a low flow rate (20-200 μl/min) to allow binding to the DNA molecules. In the second procedure, the DNA molecules (5 μM, final concentration) were pre-incubated with the anti-DIG quantum dots (1 nM) and then injected into the sample chamber where they were allowed to bind and assembled into an array as described above.

### Lipid Vesicles, Microfluidic Flowcells and DNA Curtains

Small unilamellar vesicles were prepared by mixing chloroform solutions (Avanti Polar Lipids) containing DOPC (1,2-dioleoyl-sn-glycero-3-phosphocholine), biotinylated-DPPE (1,2-dipalmitoyl-sn-glycero-3-phosphoethanolamine-N-Cap Biotinyl)), and mPEG 550-PE (1,2-distearoyl-sn-glycero-3-phosphoethanolamine-N-[methoxy(polyethylene glycol)-550) in a glass vial. The solution was dried under a stream of nitrogen until a dried film of lipids was present on the sides of the vial. This sample was dried further by placing under vacuum for ˜1 hour to remove any residual traces of chloroform. The dried lipids were then hydrated for ≧2 hours with an appropriate volume of lipid buffer [10 mM Tris-HCl (pH 7.8) and 100 mM NaCl] to yield a final concentration of 10 mg/ml DOPC with 0.5% (wt/wt) biotinylated-DPPE, and 8% (wt/wt) mPEG 550-PE. The hydrated lipids were mixed thoroughly by vortexing and sonicated with three 1.5-minute pulses at 2-minute intervals at 10-15% power output. After sonication, the liposomes were passed through 0.2 μm filters and stored at 4° C.

Microfluidic flowcells were constructed from 76.2×25.4×1 mm fused silica slides (ESCO Products), which had port holes made by drilling through the slide with a diamond-coated bit (1.4 mm o.d.; Eurotool). Micro-scale diffusion barriers were made by mechanically etching the surface of the fused silica with a diamond-tipped scribe (Eurotool) as previously described. Slides were then cleaned in 2% Hellmanex (Hellma), washed with Milli-Q H20, washed in 1M NaOH, rinsed thoroughly with Milli-Q H₂0 and dried under vacuum for at least 1 hour. The sample chamber was then made using a borosilicate glass coverslip (Fisher Scientific) and double-sided tape (3M). Inlet and outlet ports were attached using adhesive rings (Upchurch Scientific) and cured for 2 hours under vacuum at 120° C. The final volume of the sample chambers was ˜4 μl, and a syringe pump (Kd Scientific) was used to control buffer flow through the chamber.

Bilayers were prepared by injecting liposomes into the flowcell and incubated for 1 hour. Excess liposomes were then rinsed with buffer A, which contained 40 mM Tris-HCl (pH 7.8), 1 mM DTT, 1 mM MgCl2, and 0.2 mg/ml BSA. The surface was then incubated for 30 minutes with the buffer A plus 330 nM Neutravidin (Pierce), and finally rinsed thoroughly with buffer A to remove the excess Neutravidin. The biotinylated 23 kb PCR product was then injected into the sample chamber, incubated for 10 minutes to allow binding, and finally rinsed with buffer to remove excess DNA and align the tethered molecules along the edge of the diffusion barrier.

### Data Analysis

Analysis was performed on images that were captured at 8.3 frames per second and the “red” (quantum dots) and “green” photons (YOYO1) were physically separated onto each half of the CCD by a dichroic mirror. Post-acquisition processing was accomplished by pseudo-coloring each half of the images and then recombining the pseudo-colored images into a single file using Metamorph software. All DNA length measurements were performed on the raw data by using a single-particle tracking algorithm written in Igor Pro (Wavemetrics).

### Results

### Strategy and Substrate Construction

We have previously reported the development of a new technique that allows the construction of parallel arrays of DNA molecules tethered to fluid lipid bilayers and organized into patterns defined by the placement of micro-scale mechanical barriers to lipid diffusion on the surface of a microfluidic sample chamber (Z7, Z22). When combined with TIRFM, these “DNA curtains” can allow the simultaneous detection of hundreds of individual molecules in a single field-of-view, and there are on the order of tens of thousands of molecules to choose from in any given experiment (Z7, Z22). This approach greatly increases the potential throughput capacity of single-molecule experiments designed to study protein-DNA interactions because a large number of individual reaction trajectories can be monitored in parallel (Z22). Furthermore, data analysis is simplified because all of the DNA molecules in a field-of-view are physically aligned with respect to one another. Thus a hypothetical line drawn across the curtain, perpendicular to the direction of buffer flow, would cross the same sequence on each individual DNA molecule (Z7, Z22). In our previous reports the tethered DNA molecules were stained with the interchelating dye YOYO1, which could not be used in the presence of physiologically relevant concentrations of salts or divalent metal ions (see below). For example, we were unable to detect any YOYO1 signal from the DNA molecules in the presence of ≧100 mM NaCl or 5 mM MgCl₂. YOYO1 also caused extensive DNA damage when used in the absence of an oxygen scavenging system or when illuminated for long periods of time (≧5-10 minutes).

Quantum dots provide an ideal fluorophore for many applications in single-molecule bioscience (Z4-Z6). The combination of very large excitation cross-sections, high quantum yields, small size, and crystalline structure results in an extremely bright fluorophore that does not photo-bleach and is compatible with many biological applications. An additional benefit of quantum dots is that they have very broad excitation spectra while at the same time displaying very narrow emission peaks. This provides the potential for the simultaneous detection of multiple different colors without the need for different illumination wavelengths. Furthermore, quantum dots are now commercially available and can be obtained with a variety of surface modifications to enable easy coupling to biological molecules (Z5, Z6). Previous studies have reported the use of quantum dots as reagents for labeling individual DNA molecules, which could then be detected by epi-fluorescence microscopy (Z20). However, these experiments required the attachment of multiple quantum dots per DNA (up to ˜75 attachment points per DNA), only achieved a 60% success rate for end labeling, and utilized DNA combing as a method for anchoring the DNA to a hydrophobic glass surface (Z20). This anchoring method yields DNA molecules stretched well beyond their normal length, with their long axes pointing in the “combing direction”, but otherwise randomly arranged on the surface (Z23). These conditions may be unsuitable for studying many types of protein-DNA interactions, because the DNA is mechanically deformed and resides within a highly hydrophobic environment, which is likely to lead to nonspecific adsorption of many types of proteins. These problems are completely eliminated with the use of our DNA curtain technology because the molecules are linked to the surface via a single biotin-Neutravidin interaction and they are suspended above an inert lipid bilayer (Z7).

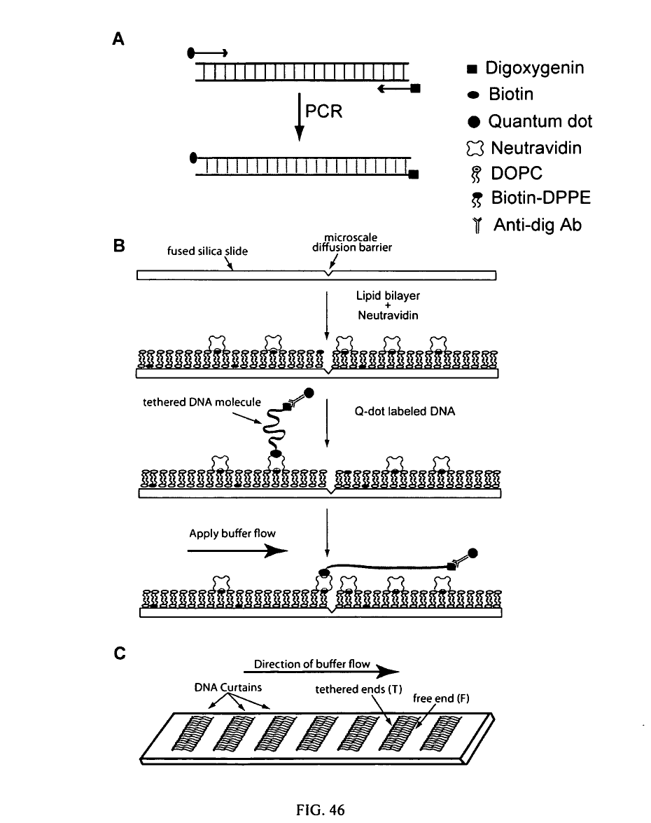

The strategy for preparing quantum dot-labeled DNA curtains is outlined in FIG. 46. First, we used PCR to prepare a DNA substrate that could be tethered by one end to the lipid surface and then labeled at its free end with a single quantum dot. For this, a forward primer was synthesized with a 5′ biotin and the reverse primer contained a 5′ digoxigenin (FIG. 46A). This yields a differentially labeled PCR product that could be coupled to the surface via a biotin-Neutravidin interaction, and then organized along the leading edge of a microscale diffusion barrier by the application of hydrodynamic force, as previously described (FIG. 46B) (Z7). The free end the DNA could be labeled with anti-digoxigenin coated quantum dots. This end-specific labeling strategy would also allow verification that all of the individual DNA molecules within the curtain were aligned with one another in the same orientation.

### Visualizing Quantum Dot-Labeled DNA Curtains

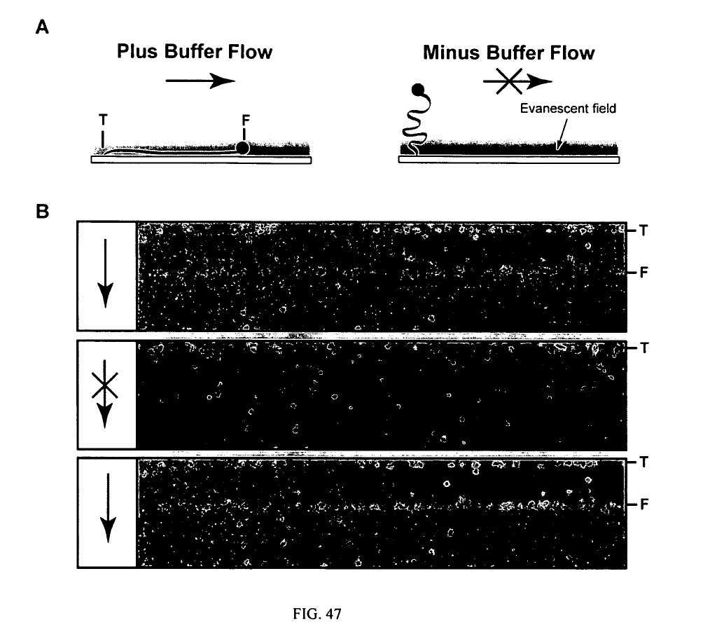

To observe the curtains, the tethered DNA molecules were stained with YOYO1 and also labeled with anti-DIG labeled quantum dots (FIG. 47). Labeling with the anti-DIG quantum dots was done either before or after the DNA molecules were tethered to the surface, with equivalent outcomes (see Materials and Methods). The tethered DNA molecules within the curtain were then imaged using TIRFM, and the longer wavelength fluorescence emission from the quantum dots was separated from the shorter wavelength emission of YOYO1 by using an image splitting device (Optical Insights), which contained a dichroic mirror (630 DCXR) and each separate image was focused onto a different half of the same CCD chip. This allowed for simultaneous detection of two colors without loss of temporal resolution, and the two halves of the frame were then digitally superimposed into to a single image. The fluorescent signal YOYO1 stained DNA molecules was colored green and the signal from the quantum dots was colored red. As expected, the quantum dots formed a fluorescent “line” that extended across the entire field-of-view in a direction perpendicular to the flow of buffer. This line of red quantum dots demarks the location of the free end of the DNA molecules and further illustrates that all of the DNA molecules within the curtain are physically aligned with respect to one another and arranged in the same orientation.

Nearly every DNA molecule with this curtain was labeled with a quantum dot, indicating that the labeling efficiency was extremely high (≧95%) even though the DNA molecules only contained a single digoxigenin. In addition, control experiments using either DNA substrates that were not labeled with digoxigenin or experiments that used quantum dots that were not coupled to anti-DIG did not reveal any binding to the DNA. This confirmed that the labeling strategy was highly specific and occurred solely through the digoxigenin-Anti-DIG interaction. Similar results were obtained using bacteriophage λ-DNA made by annealing biotin or digoxigenin labeled primers complimentary to the 12-nt ssDNA overhangs present at either end of the DNA (data not shown). This indicated that the antibody-based quantum dot labeling procedure was highly efficient and could be reliably used to track the location of each individual DNA molecule within the curtain even in the absence of YOYO1 signal.

It should be noted that several reports have demonstrated that quantum dots “blink” rapidly when they are illuminated, and this blinking behavior has the potential to reduce detection efficiency (Z20, Z24, Z25). However, it has also been shown that the inclusion of thiol-containing reducing agents completely eliminates the on/off fluorescence emission behavior (Z26). Subsequently, all of the buffers used here contained at least 1 mM β-mercaptoethanol, which prevented any detectable blinking by the quantum dots. This also allowed us to collect data from individual quantum dots at very rapid rates (10-100 frames per second) without a significant decrease in either signal intensity or image quality. An oxygen scavenging system was also included in experiments with YOYO1 (see Materials & Methods).

As indicated above, the application of a hydrodynamic force was necessary to confine the labeled DNA molecules within the detection volume defined by the penetration depth of the evanescent field (approximately 100 nanometers). We have previously shown that in the absence of flow, the free ends of the DNA molecules rapidly diffused away from the sample chamber surface due to an increase in their conformational entropy and could no longer be visualized by TIRFM, as illustrated in FIG. 47B (Z7). We used this dependence on flow force to verify that the fluorescently labeled DNA molecules were only linked to the surface via the biotin-neutravidin interaction. In FIG. 47B, buffer flow was transiently halted and then quickly resumed. As expected, the DNA molecules and their associated quantum dots diffused out of the evanescent field when flow was terminated, but they quickly reappeared when flow was resumed. This indicated that the tethered molecules were only linked to the surface via the biotin-neutravidin interaction and that neither the DNA nor the quantum dots interacted nonspecifically with the lipid bilayer that coated the fused silica surface of the sample chamber. This same procedure could be used to identify any quantum dots that are stuck to the surface, because they do not disappear from the field-of-view when buffer flow is transiently halted.

The DNA molecules remained tethered by just their biotinylated ends, whereas the quantum dot-labeled ends did not interact nonspecifically with the bilayer-coated surface. This highlights another advantage of the lipid-tethered DNA curtains over other methods, such as DNA combing, in which the molecules are directly linked to glass or fused silica surfaces. Specifically, the DNA molecules within the curtains are maintained in a microenvironment compatible with a wide range of biological molecules. With DNA combing, the DNAs are linked via ssDNA tails to a hydrophobic surface, which is unlikely to be optimal for maintaining the biochemical integrity of many types of proteins. Moreover, DNA combing yields often molecules that are stretched 50% beyond the normal length for B-DNA (Z23), thus rendering them unsuitable as substrates for many biochemical experiments. In contrast, the DNA molecules within our molecular curtains are not distorted by the tethering scheme, and they require only ˜0.5-1 pN (pico-Newton) of force to maintain them in a near fully extended configuration (Z7). Importantly, the low level of nonspecific adsorption was achieved by including a small fraction of PEGylated lipid (8% wt/wt) within the bilayer (Z27), which was necessary to prevent the quantum dots from sticking to the bilayer. Initial control experiments performed with bilayers comprised of DOPC showed significant nonspecific binding of the quantum dots to the surface (data not shown). This nonspecific binding was also observed with bilayers comprised of DOPC and Biotin-DPPE (0.5%). However, inclusion of the PEGylated lipids eliminated most of the nonspecific adsorption by the quantum dots. Bilayers containing low concentrations of PEGylated lipids have previously been shown to retain normal fluidity (Z27), and the fact that the tethered DNA molecules could be organized along the leading edge of the diffusion barriers confirms that the fluid bilayers were not perturbed by the inclusion of the PEGylated lipids.

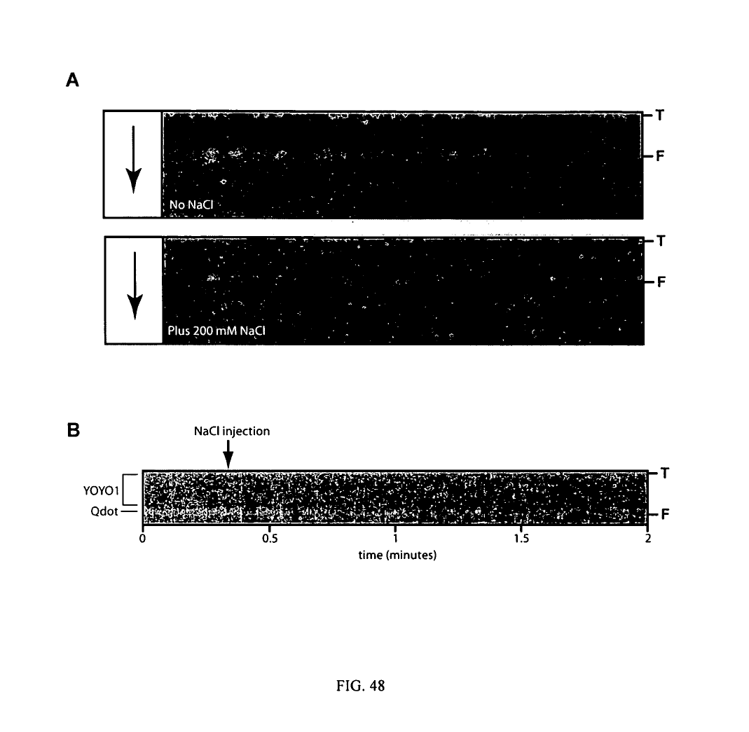

One important advantage of quantum dots over YOYO1 is that they are compatible with a much wider range of solution conditions. This is clearly demonstrated in FIGS. 48A and 48B, where 200 mM NaCl was injected into a sample chamber containing a DNA curtain stained with YOYO1 and labeled with quantum dots. As expected, the signal from the YOYO1 rapidly disappeared as the NaCl passed through the chamber (FIG. 48A, lower panel and FIG. 48B). However, the quantum dot signal remained visible with no change in signal intensity. This result clearly showed that the quantum dot-labeled DNA molecules could still be readily observed under solution conditions that were not compatible with YOYO1.

### Tracking Changes in DNA Length

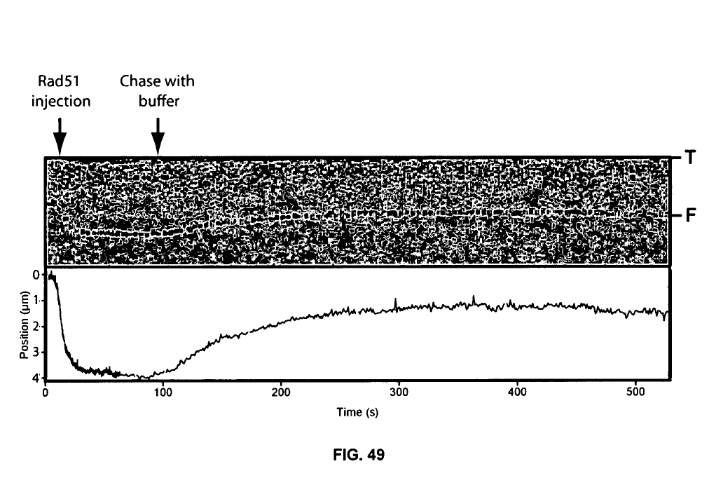

Another advantage of this labeling method is that the single quantum dots appear as individual, diffraction-limited spots that demark the position of the free end of the DNA molecules. These fluorescent signals can be precisely located and automatically tracked over time by fitting the images to a two-dimensional Gaussian function using single-particle tracking (Z28). This is of particular benefit when probing the behaviors of DNA-binding proteins that cause changes in the length of the DNA upon binding. An example of this is illustrated with the homologous recombination protein Rad51 (FIG. 49) (Z29, Z30). This protein binds to DNA and forms extended nucleoprotein filaments that have a right-handed helical structure, which represents the active form of the recombinase (Z31). The DNA within these extended helical filaments has unusual structural parameters in that the distance between adjacent bases increases from 3.4 Å in B-form DNA to 5.1 Å, and the number of base pairs per turn increases from 10.6 bp per turn (B-DNA) to ≈18.6 bp per turn. This leads to a 50% increase in the length of a DNA molecule bound by Rad51 when compared to naked B-DNA. We have previously used TIRFM to analyze the binding of human Rad51 to single-molecules of YOYO1-stained DNA by following the change in DNA length (Z32). However, at high concentrations of protein, Rad51 rapidly ejected the YOYO1 from the DNA, making it impossible to visualize the DNA molecules that were completely coated with the protein filament (Z32).

To further demonstrate the potential benefits of the quantum dot-labeled DNA curtains over YOYO1, we monitored the binding of Rad51 to the DNA and quantitated filament assembly and disassembly by using single-particle tracking to monitor the position of the fluorescent tag at the free ends of the DNA molecules within the array. As illustrated in FIG. 49, when Rad51 was injected into the sample chamber the fluorescent quantum dots moved down the field-of-view, corresponding to an increase in the length of the DNA as the nucleoprotein filament was assembled. Similarly, when Rad51 was removed from the injection buffer the quantum dot began to retreat towards its original location, corresponding to disassembly of the nucleoprotein filament and concomitant shortening of the DNA. As indicated above, Rad51 ejects YOYO1 from DNA upon binding, so the signal from this fluorophore decreases substantially as the nucleoprotein filaments are assembled (Z32). In contrast, the quantum dots remained fully visible, allowing us to continually observe the length of the DNA for the full duration of the reaction cycle. This also demonstrates that protein-induced changes in the overall structure of the DNA that are manifested as changes in the contour length of the molecules can be readily monitored because the end of the DNA molecules can be precisely located and tracked over time (FIG. 49). Furthermore, because the DNA curtains contain thousands of DNA molecules and particle-tracking is done by a computer algorithm, it is feasible to develop fully automated methods for analyzing the behaviors of large numbers of DNA molecules simultaneously.

### Discussion

The methods described here provide the ability to monitor many individual, aligned DNA molecules in real time by TIRFM without the need for an interchelating dye. These DNA molecules are maintained in a bio-friendly microenvironment that is compatible with a wide range of proteins and therefore has significant potential as an experimental tool for studying protein-nucleic acid interactions at the single-molecule level. Most previous studies of individual DNA molecules have relied on the interchelating dye YOYO1, which suffers from several inherent limitations, including the propensity to cause substantial damage to the stained DNA upon illumination. Here we have used quantum dots to label the DNA molecules. The advantages of this strategy are that (a) each DNA has a single label at a well-defined position, which is unlikely to interfere with protein-DNA interactions, (b) quantum dots do not damage the DNA when illuminated, (c) quantum dots are highly stable and can be viewed for very long periods of time without photo-bleaching, (d) quantum dots appear as single diffraction-limited spots that can be precisely located by single particle tracking, and (e) quantum dots are commercially available with a variety of different emission spectra. These advantages over more commonly used interchelating dyes make quantum dots the ideal DNA-labeling fluorophore for single-molecule experiments.

The use of TIRFM with the quantum dot labeled DNA curtains provides a relatively simple experimental set-up, that allows simultaneous observations of up to hundreds of individual DNA molecule all aligned in the exact same orientation, and can potentially allow the parallel analysis of thousands of individual reaction trajectories. Even though the DNA molecules must remain in very close proximity to the sample chamber surface, this surface is comprised of a fluid lipid bilayer that is largely inert and closely mimics the natural environment that most proteins are expected to encounter within the cellular milieu. Therefore we expect that these approaches can be readily applied to a variety of biochemical systems involving the interactions between proteins and DNA molecules.

### EXAMPLE 13

### DNA Curtains and Cr Barriers

To help establish methods for high-throughput single molecule imaging, “DNA curtains” have been developed, which when used in combination with total internal reflection fluorescence microscopy (TIRFM) allow for simultaneous imaging of hundreds of individual molecules anchored to a surface rendered inert through the deposition of a lipid bilayer. The DNA curtains are assembled by anchoring one end of a biotinylated DNA molecule to the lipid bilayer. The bilayers permit two-dimensional motion of the lipid-tethered DNA molecules, and this mobility is utilized by using hydrodynamic force to organize the DNA molecules along the leading edge of microscale diffusion barriers, which are manually etched into the surface of the flowcell perpendicular to the direction of buffer flow. These DNA curtains are highly advantageous for single-molecule experiments due to the inert surface provided by the lipid bilayer and the large number of DNA molecules that can be simultaneously imaged. However, the reliance on a manual etching procedure greatly limits user control over the dimensions and locations of the barriers, and limits control over the spacing between adjacent barriers. The resulting rough barrier surfaces also lead to problems such as light scattering, uneven alignment of DNA molecules, nonspecific binding, and inefficient coverage of the flowcell surface, all of which undermine the true utility of DNA curtains for single-molecule research.

Here, these problems are overcome by assembling DNA curtains at diffusion barriers with nanometer (nm) scale features generated by photolithography. Chrome barriers 100-nm in width and 70-nm tall are shown to be used to align DNA molecules that are anchored to a lipid bilayer when used in combination with hydrodynamic force. These precisely controlled diffusion barriers do not interfere with signal detection, and can be applied at readily defined locations on the flowcell surface. The shape of the barriers can be used as a tool to direct the organization of the DNA molecules thereby ensuring even coverage of the surface and maximizing the total number of individual protein-DNA interactions that can be concurrently visualized. These now allow us to observed thousands of DNA molecules and thousands of individual protein-DNA interactions within a single field of view.

A protocol has been established for preparing DNA curtains with chrome (Cr) barriers deposited by photolithography. The benefits of the new procedure are (i) the location of the Cr barriers can be readily and precisely controlled, (ii) up to ˜1000 fluorescently labeled DNAs can be viewed per field of view, (iii) the Cr barriers are just 100 nm×70 nm (W×H), with an edge roughness of ±9 nm, and these dimensions can be readily controlled, (iv) the Cr barriers do not scatter light, they do not bind Qdots, they are easy to use and highly reproducible. These new curtains increase data collection capabilities by over an order of magnitude.

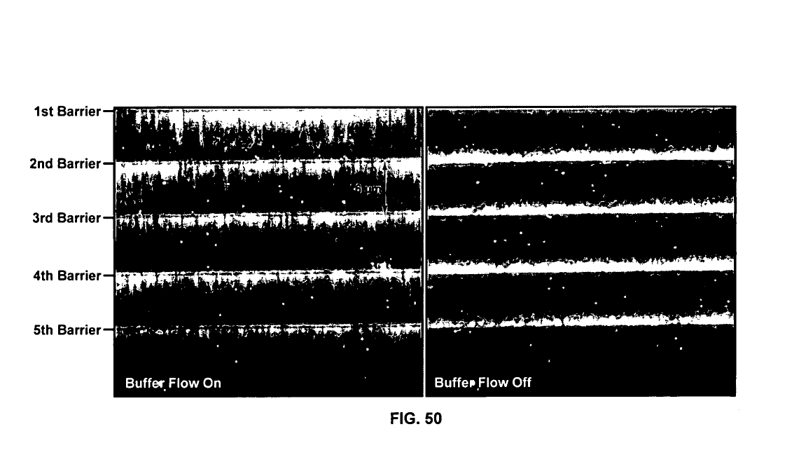

FIG. 50 shows an example of YOYO1 stained DNA assembled into DNA curtains at the nanoscale diffusion barriers in the presence (left panel) and absence (right panel) for buffer flow.

### EXAMPLE 140

### DNA Curtains and Nanoscale Curtain Rods

### High-Throughput Tools for Single Molecule Imaging

Real time visualization of individual protein-DNA complexes can reveal previously inaccessible details of biochemical reaction mechanisms and macromolecular dynamics. However, these techniques are often limited by the inherent difficulty of collecting statistically relevant information from experiments explicitly designed to look at single molecules. New approaches that increase throughput capacity of single-molecule methods have the potential for making these techniques more applicable to a variety of biological questions involving different types of DNA transactions. Here a simple method for organizing DNA molecules into curtains along the leading edges of nanofabricated chromium barriers is presented, which are located at strategic positions on a fused silica slide otherwise coated with a supported lipid bilayer. The individual molecules that make up the DNA curtains can be visualized by total internal reflection fluorescence (TIRFM) and can simultaneously image thousands of perfectly aligned molecules in a single field-of-view. These DNA curtains present a robust and powerful experimental platform portending massively parallel data acquisition of individual protein-DNA interactions in real time and are ideally suited for high-throughput single molecule imaging.

Single-molecule techniques have revealed many new insights into previously inaccessible aspects of biology and this field is now poised to profoundly impact the way that virtually all biological macromolecules can be studied. However, many single-molecule methods suffer from disadvantages that limit their broader application, and meeting the oncoming challenges will require the development of more robust, user-friendly, high-throughput experimental platforms that can be readily applied to any biochemical system of interest.

For example, one common, but often unappreciated problem of single molecule techniques is the requirement that the macromolecules under investigation be anchored to a solid support surface, which is often unlike anything they would ever encounter within a cellular environment. It absolutely is essential to minimize any nonspecific interactions with the surface that may perturb their biological properties. Traditional approaches for passivating surfaces have included nonspecific blocking agents (e.g. BSA or casien) or covalent modification with polyethylene glycol (PEG) (S1, S2).

Nonspecific blocking proteins often do not work well enough to prevent surface absorption of other molecules (S3). PEGylated surfaces are very good at preventing nonspecific interactions between proteins or nucleic acids and the underlying surface, but PEG alone may not be sufficient in all cases. More recently, vesicle encapsulated reactions have been used in single molecule analysis (S4, S5). Vesicle encapsulation is a very promising approach that makes use of the native environment provided by lipid membranes, but it has limited potential for some types of biochemical experiments, especially those requiring long DNA molecules.

Single molecule techniques also suffer from the fact that is that it is inherently difficult to collect statistically relevant information using procedures designed to image just one or at best a few molecules at any given time. This can be especially problematic when the reactions under investigation require the use of long DNA substrates. Procedures for anchoring numerous, long DNA molecules to surfaces are present in the literature, and each has great potential for specific situations, but they also suffer from specific drawbacks with respect to biochemical applications. For example Bensimon et al., developed “DNA combing” (S6), which has evolved into a powerful tool for molecular biologists (reviewed in (S7)). Combed DNA is anchored to a hydrophobic glass slide, and aligned with a receding air-water meniscus, yielding molecules adhered by multiple contact points and stretched ˜150 percent beyond the length of normal B-DNA. The hydrophobic surfaces required for combing and the resulting distortion of the DNA may not be compatible with many proteins. In addition, while the combed DNA molecules are aligned along a common direction their ends are not aligned relative to one another nor is the orientation of the DNA defined with respect to its sequence.

In another elegant approach, Kabata and colleagues reported that “belts” of k-DNA could be stretched between two aluminum electrodes by dielectrophoresis, which they used to visualize the motion of RNAP and EcoRI by fluorescence microscopy (S8, S9). However the molecules in these belts are not oriented in the same direction with respect their sequence, it remains unclear how the DNA links to the aluminum, and broader use of this technique has not been realized (S110). Recently, Guan and Lee have demonstrated that highly ordered arrays of DNA molecules can be stamped onto PDMS (polydimethyl siloxane) with an intriguing method based on molecular combing (S11). This technology is promising, but protein adsorption to unmodified PDMS may present a limitation for biochemical applications. Prentiss and colleagues have used an approach in which magnetic beads were linked to the free ends of DNA molecules anchored to a glass surface (S12). Kim et al., reported a similar approach, in which they anchored molecules of λ-DNA to PEGylated surface and stretched the DNA with buffer flow (S13). In each of these examples they were able to concurrently detect on the order of 100-200 molecules, but required 10× magnification to expand the field-of-view, thus the overall density of the anchored DNA remained quite low (S113). Finally, Schwartz and co-workers have pioneered single DNA molecule optical mapping techniques (S14, S15), but again, these approaches may not be applicable for real time biochemical analysis.

As a practical solution to these problems “DNA curtains” have been developed, which allow simultaneous imaging of on the order of one hundred individual DNA molecules within a single field-of-view at 100× magnification (S16). Curtains are assembled by anchoring one end of a biotinylated DNA molecule to a lipid bilayer, which provides an inert environment compatible with a range of biological molecules (S17). The bilayers also permit long-range two-dimensional motion of the lipid-tethered DNA molecules wherein the advantage of this mobility is taken by using hydrodynamic force to organize the DNA molecules at microscale diffusion barriers, which are manually etched into the surface of the flowcell and oriented perpendicular to the direction of buffer flow. Lipids within the bilayer can not traverse the etched barrier (S18), therefore the lipid-tethered DNA molecules accumulate along the leading edges of these barriers (S16). One drawback of this approach is that manual etching greatly limits user control over the dimensions and locations of the microscale diffusion barriers. The resulting rough barriers also compromise the quality of the optical surface, leading to problems such as light scattering, uneven alignment of DNA, nonspecific protein adsorption, and inefficient coverage of the viewing area. Taken together these problems can undermine the use of DNA curtains for single-molecule biological research, and further perfection of this technology is warranted to realize its full potential.

Here, electron-beam lithography is used to engineer chromium diffusion barriers to lipid diffusion with nanometer (nm) scale features that can be used to make molecular curtains of DNA where all of the molecules are suspended above an inert lipid bilayer. The shape of the barriers and the fluidity of the bilayer are used are used as tools to direct the organization of the DNA into well-defined patterns in which all of the molecules are arranged in the exact same orientation and aligned perfectly with respect to one another. These chromium barriers (nano-scale curtain rods) are simple and robust, they are small enough that they do not interfere with optical imaging of the fluorescent molecules, and they can be precisely constructed at predefined locations on the surface of a microfluidic sample chamber. Using these nanoscale barriers it has been demonstrated that several hundred and even several thousand DNA molecules in a single field-of-view can be concurrently imaged. These highly uniform patterns of DNA provide a unique and powerful experimental platform enabling massively parallel data acquisition from individual molecules and offer a myriad of potential applications.

### Materials and Methods

Barrier construction by E-beam lithography. Fused silica slides were cleaned in NanoStrip solution (CyanTek Corp, Fremont, Calif.) for 20 minutes, then rinsed with acetone and isopropanol and dried with N₂. The slides were spin-coated with a bilayer of polymethylmethacrylate (PMMA), molecular weight 25K and 495K, 3% in anisole (MicroChem, Newton, Mass.). Each layer was spun at 4000 rpm for 45 seconds using a ramp rate of 300 rpm/s. Patterns were written by E-beam lithography using an FEI Sirion scanning electron microscope equipped with a pattern generator and lithography control system (J. C. Nabity, Inc., Bozeman, Mont.). Resist was developed using a 3:1 solution of isopropanol to methyl isobutyl ketone (MIBK) for 2 minutes with ultrasonic agitation at 5° C. The substrate was then rinsed in isopropanol and dried with N₂. A thin layer of chromium was deposited using a Semicore electron beam evaporator. To effect lift-off, the coated substrate was submerged in a 75° C. acetone bath for 30 minutes, and then gently sonicated. Following lift-off, samples were rinsed with acetone to remove stray chromium flakes and dried with N₂. Barriers were imaged using a Hitachi 4700 scanning electron microscope and a PSIA XE-100 Scanning Probe Microscope in noncontact mode. Optical images of the barriers were taken with a Nikon Eclipse ME600 at either 10× or 20× magnification (as indicated).

Barrier construction by nanoimprint Lithography. The nanoimprint master was patterned in chromium on a silicon dioxide wafer by liftoff. This pattern was used as a mask as the silicon dioxide was etched 100 nm by a C₄F₈:O₂ 45:5 plasma for 72 seconds at a forward power of 25 W. Chromium was stripped using CR-7S etchant (Cyantek Corp, Fremont, Calif.), leaving a pattern in relief made entirely of silicon dioxide. The master was then fluorinated using C₄F₈ gas at a forward power of 100 W. Etching and fluorination steps were performed in an Oxford Plasmalab 80 Plus Inductively-Coupled Plasma (Oxford Instruments, Oxfordshire, UK). A bilayer of PMGI and PMMA25kA3 resists (Microchem, Newton, Mass.) was spun on silica slides for nanoimprint lithography using a Nanonex NX-B200. (Monmouth Junction, N.J.) Samples were imprinted for 5 minutes at 480×Pa and 180° C. Residual PMMA was cleaned from the imprinted area using an O₂ plasma etch for 60 seconds at 20 W ICP power. PMGI was developed using Microposit MF-CD26 developer at room temperature for 3 minutes (Rohm & Haas Electronic Materials LLC, Marlborough, Mass.). As in direct-write electron-beam lithography, samples were metallized in a Semicore electron beam evaporator and lifted off in a hot acetone bath. After lift-off, PMGI was stripped completely using MF-CD26.

Lipid bilayers and DNA curtains. The flowcells were assembled from fused silica slides (G. Finkenbeiner, Inc.) with chromium nanoscale diffusion barriers. Inlet and outlet ports were made by boring through the slide with a high-speed precision drill press equipped with a diamond-tipped bit (1.4 mm O.D.; Kassoy). The slides were cleaned by successive immersion in 2% (v/v) Hellmanex, 1 M NaOH, and 100% MeOH. The slides were rinsed with filtered sterile water between each wash and stored in 100% MeOH until use. Prior to assembly, the slides were dried under a stream of nitrogen and baked in a vacuum oven for at least 1 hour. A sample chamber was prepared from a borosilicate glass coverslip (Fisher Scientific) and double-sided tape (˜25 μm thick, 3M). Inlet and outlet ports (Upchurch Scientific) were attached with hot-melt adhesive (SureBonder glue sticks, FPC Corporation). The total volume of the sample chambers was ˜4 μl. A syringe pump (Kd Scientific) and actuated injection valves (Upchurch Scientific) were used to control sample delivery, buffer selection and flow rate. The flowcell and prism were mounted in a custom-built heater with computer-controlled feedback regulation that to control the temperature of the sample from between 25-37° C. (±0.1° C.), as necessary.

DNA curtains were constructed as described (S16). All lipids were purchased from Avanti Polar Lipids and liposomes were prepared as previously described. In brief, a mixture of DOPC (1,2-dioleoyl-sn-glycero-phosphocholine), 0.5% biotinylated-DPPE (1,2-dipalmitoyl-sn-glycero-3-phosphoethanolamine-N-(cap biotinyl)), and 8% mpEG 550-DOPE (1,2-dioleoyl-sn-glycero-3-phosphoethanolamine-N-[methoxy(polyethylene glycol)-550]). Liposomes were applied to the sample chamber for 30 minutes. Excess liposomes were flushed away with buffer containing 10 mM Tris-HCl (pH 7.8) and 100 mM NaCl. The flowcell was then rinsed with buffer A (40 mM Tris-HCl (pH 7.8), 1 mM DTT, 1 mM MgCl₂, and 0.2 mg/ml BSA) and incubated for 15 minutes. Neutravidin (660 nM) in buffer A was then injected into the sample chamber and incubated for 10 minutes. After rinsing thoroughly with additional buffer A, biotinylated λ-DNA (˜10 pM) pre-stained with YOYO1 (1 dye per 600 base pairs) was injected into the sample chamber, incubated for 10 minutes, and unbound DNA was removed by flushing with buffer at 0.1 ml/min. For imaging, the buffers also contained 100 pM YOYO1 along with an oxygen scavenging system comprised of 1% (w/v) glucose, 60 mM β-mercaptoethanol, glucose oxidase (100 units/ml) and catalase (1,560 units/ml). Application of buffer flow caused the lipid-tethered DNA molecules to align along the leading edges of the diffusion barriers. The flow was stopped for 5 minutes allowing the DNA to diffuse towards the center of the barriers. The flow was started at 0.1 ml/min for 30 seconds and the flow on-off cycle was repeated 3-5 times until DNA curtains of even density formed along the diffusion barriers.

TIRFM Imaging. The basic design of the microscope used in this study has been previously described (S19). In brief, the system is built around a Nikon TE2000U inverted microscope with a custom-made illumination system. For this study, a 488 nm, 200 mW diode-pumped solid-state laser (Coherent, Sapphire-CDHR) was used as the excitation source. The laser was attenuated as necessary with a neutral density filter and centered over the DNA curtain by means of a remotely operated mirror (New Focus). The beam intensity at the face of the prism was typically ˜10-15 mW. Images were detected with a back-illuminated EMCCD detector (Photometrics, Cascade 512B). TIRFM images were collected using a 60× water immersion objective lens (Nikon, 1.2 NA, Plan Apo) or a 10× objective (Nikon, 0.45 NA, Plan Apo), as indicated. For dual color experiments, the different emission spectra were separated by a dichoric mirror (630 DCXR, Chroma Technologies) housed within a Dual-View image splitting device (Optical Insights).

Restriction Enzymes. To map restriction sites in the DNA curtains 700 μl of 100 U/ml EcoRI (NEB) in reaction buffer A (40 mM Tris-HCl (pH 7.8), 1 mM MgCl₂, 1 mM DTT, and 0.2 mg/ml BSA) plus 50 mM NaCl, 10 mM MgCl₂ and the oxygen scavenging system was injected at 0.4 ml/min. Images were collected before the restriction enzyme injection and after all of the enzyme solution had flown through.

To make fluorescently tagged EcORI_{E111Q} the sequence was amplified from pET14b-EcoRI_{E111Q} (PCR primers: Forward primer: 5′-CGG CAT CAG GCC ATG GAT TAC AAA GAT GAC GAC GAT AAG GCT GAA GCA ATG TCT AAT AAA AAA CAG TC [SEQ ID NO: 5] and Reverse primer: 5′-TTT ATA GCT CTT CCG CAC TTA GAT GTA AGC TG [SEQ ID NO: 6]). The amplified FLAG-EcoRI_{E111Q} sequence was cloned into pTXB3 (NEB) using NdeI and NcoI restriction sites. The pTXb3-FLAG-EcoRI_{E111Q} was transformed into Rosetta cells and 2 L of culture LB/Amp/Cam was grown to OD₆₀₀=0.6 at 37C. The cells were induced with 0.4 mM IPTG and grown for 4 h at 37° C. and pelleted at 4° C. The pellets were resuspended in 50 ml of Buffer C 20 mM HEPES (pH 8), 0.5 M NaCl and frozen. The cells were then thawed, lysed by sonication at 30% for 2 minutes on ice and cell debris pelleted by centrifugation at 25,000 g. The FLAG tagged protein was purified over a chitin column (NEB; 20 ml/L of culture) equilibrated with 10 volumes of Buffer C. The supernatant was manually loaded onto the column and the column was washed with 3 volumes of Buffer C. 50 ml of Cleavage Buffer (20 mM Hepes (pH 8), 0.5 M NaCl, 30 mM DTT) was applied to the column and incubated overnight. 10×5 ml fractions were eluted and checked for protein content on 10% SDS-PAGE. The fractions containing FLAG-EcoRI_{E111Q} were combined and dialyzed overnight against 1 L of 300 mM NaCl, 10 mM β-ME, 0.1 mM EDTA, 200 ug/ml BSA, 50% glycerol, 0.15% TritonX-100 and stored at −20° C.

### Results

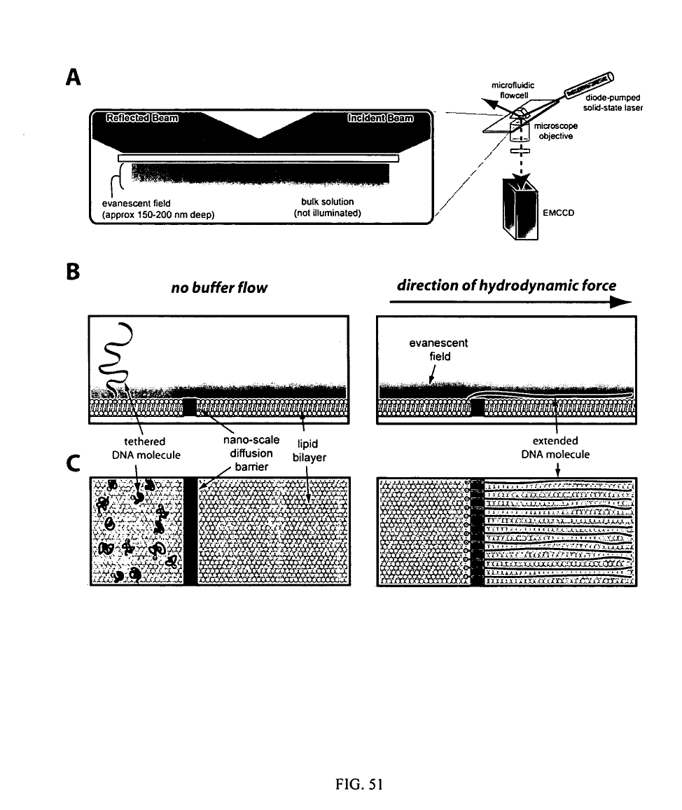

Nano-scale barriers to lipid diffusion. Mechanical barriers to lipid diffusion are shown in these studies to organize DNA molecules into curtains at defined locations on a fused silica surface (S16). These studies also show that these curtains serve as a highly effective experimental platform for the study protein-DNA interactions at the single molecule level (S23-S25). The general principles behind this approach are outlined in FIG. 51. To make the curtains, DNA is first anchored by one end to a supported lipid bilayer coating the surface of the sample chamber (FIG. 51B and FIG. 51C). In the absence of a hydrodynamic force the molecules are randomly distributed on the surface, but lie outside of the detection volume defined by the penetration depth of the evanescent field (˜150-200 nm) (S26). Application of buffer flow (or a tangentially applied electric field) pushes the DNA through the sample chamber with one end anchored to the bilayer. The diffusion barriers are oriented perpendicular to the direction of flow at strategic locations in the path of the DNA (FIG. 51B and FIG. 51C); this halts the forward movement of the molecules causing them to accumulate at the edges of the barriers where they are extended into the evanescent field (S16).

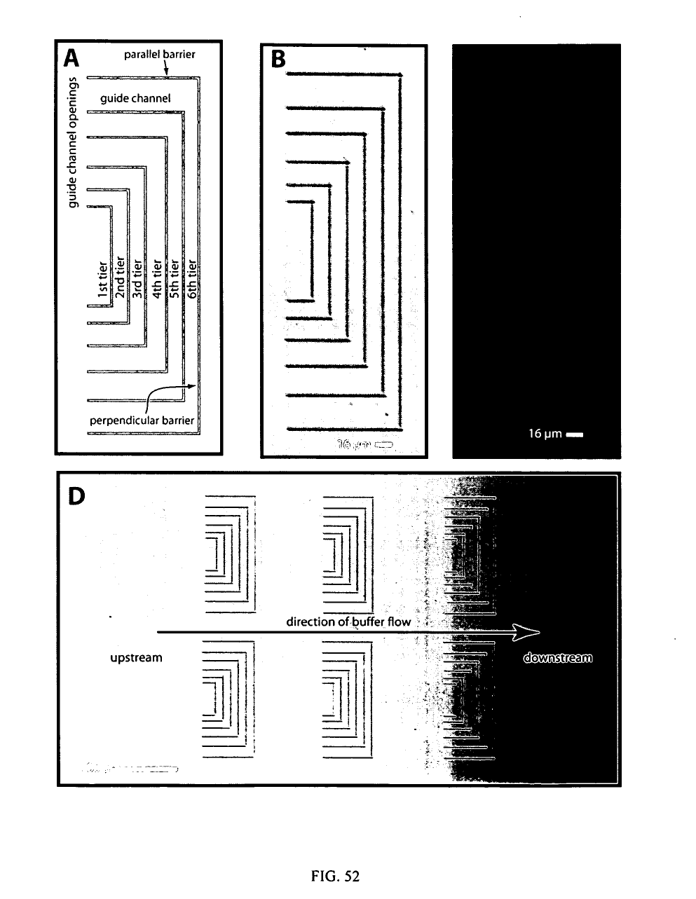

Micrometer-scale diffusion barriers have been prepared by manually scoring the surface with a diamond-tipped scribe (S16, S19, S23-25). Manual etching is simple, yet inherently problematic because it is very difficult to control. This prevents precise placement of the DNA molecules, yields barriers with highly variable dimensions, makes it practically impossible to align adjacent barriers with respect to one another, and undermines the quality of the optical surface. In fact, the manually etched barriers are often as wide or wider than the length of the DNA molecules making up the curtains (see below). Barrier materials can be made of any material or structure that disrupts either the continuity or fluidity of the lipid bilayer (S18, S20, S21). Therefore, as an alternative to the etching procedure lithographic techniques were applied for generating precisely patterned barriers with nanoscale features that could be used to organize DNA molecules into arrayed curtains making the most efficient use of the available surface area. FIG. 52A, shows a cartoon representation of a desired surface pattern comprised of an interlocking series of bracket-shaped barriers, and the important features of the design are indicated. Guide channels oriented parallel to the direction of flow ensure efficient capture of approaching DNA molecules tethered to the bilayer. Perpendicular barriers form the curtain rods against which the DNA molecules are aligned. The parallel barriers prevent the molecules from sliding off the edges of the perpendicular barriers when buffer flow is transiently paused (see below). Collectively, these features are expected to organize the tethered DNA molecules into curtains wherein all of the constituent molecules are aligned in the exact same orientation.

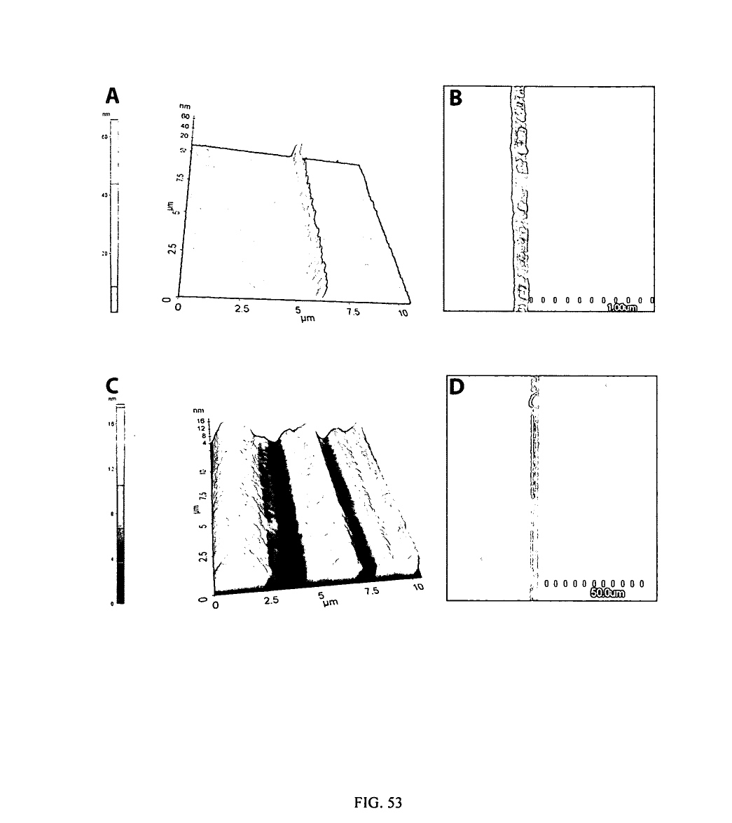

An optical image of a chromium barrier pattern prepared by direct-write electron beam (E-beam) lithography is shown in FIG. 52B. FIG. 52C shows a composite image of the same type of barrier after deposition of a supported bilayer containing fluorescent lipids (0.5% rhodamine-DHPE), confirming that the lipids coat the fused silica, but that they do not cover the chromium barriers, as expected from previous studies (S21). The image in FIG. 52D shows a section of fused silica surface with an example of a 2×3 series of chromium barrier sets, and the total number of barriers patterned onto the slide is limited only by the final dimensions of the sample chamber. The height of the barriers is dictated by the amount of chromium evaporated onto the surface and can be arbitrarily controlled as required for specific experimental needs. FIG. 53A shows an AFM image illustrating a representative single barrier that is 31 nm tall, and functional patterns have also been made with barriers as tall as 173 nm. FIG. 53B shows an SEM image of a chromium barrier revealing a width 100±9 nm. FIG. 53C and FIG. 53D show AFM and SEM images of manually etched barriers for comparison. In contrast to the highly uniform chromium barriers, the width of the etched barriers can be on the order of ˜5-10 μm and they also have highly irregular topology, as previously reported (S18).

Assembly of DNA curtains at nanoscale curtain rods. To assemble DNA curtains at the nano-scale barriers, biotinylated λ-DNA is tethered to the bilayer through tetravalent neutravidin that is in turn attached to a subset of lipids that have biotinylated head groups (0.5% biotinylated-DPPE). The DNA molecules are then pushed in the direction of the diffusion barriers through the application of a constant flow force, and the molecules are directed to the perpendicular diffusion barriers (curtain rods) via the guide channel openings. The initial application of buffer flow pushes the DNA into the barrier patterns where they accumulate at the ends of the guide channels. Once all of the molecules have accumulated within the barriers, flow is briefly terminated (for ˜5 minutes), allowing the lipid-tethered DNA molecules to diffuse freely within the bilayer. This step permits the DNA molecules to diffuse laterally within the bilayer so that they become evenly distributed along each of the parallel barriers. The DNA molecules themselves are retained within the barrier set because flow is not stopped long enough to allow them to diffuse out of the guide channel openings. Flow can then be resumed to assess the distribution of the DNA, and if necessary this process is repeated at short intervals to achieve even disbursement of the DNA along the barrier edges (see Materials and Methods).

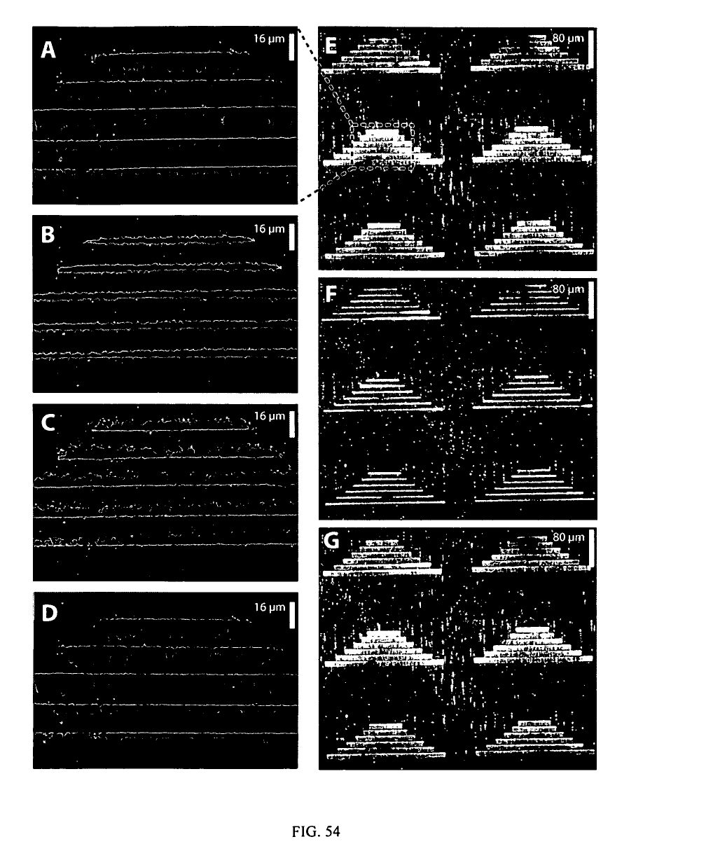

FIG. 54A shows an image with YOYO1 stained λ-DNA (48,502 bp, ˜16.5 μm when fully extended) organized into curtains at the nano-scale barriers within a five-tiered barrier set. There are approximately 805 individual, full-length molecules of k-DNA in this field-of-view imaged at 60× magnification, illustrating the high-throughput potential of this approach to single molecule imaging. Buffer flow is then transiently terminated, allowing the DNA molecules diffuse up away from the surface and out of the evanescent field (FIG. 54B). This is a necessary control performed in all of these experiments to verify that the DNA molecules are anchored by only one end to the sample chamber surface and to confirm that they are not nonspecifically absorbed to the bilayer. When flow is stopped for longer than a few seconds the anchored DNA molecules also begin to move away from the barrier edges, showing that they are not irreversibly anchored to the strips of chromium or otherwise immobilized to the surface (FIG. 54C). When flow is resumed the DNA molecules are pushed back into the diffusion barriers (FIG. 54D). If continuous buffer flow is maintained the λ-DNA molecules do not diffuse laterally, but rather remain in a single location along the barrier edge. This ensures that individual molecules can be readily tracked over time. However, shorter DNA fragments did exhibit lateral diffusion when pushed against the barriers under the same flow conditions used for λ-DNA, but rougher barrier edges can be used to keep smaller DNA molecules in place.

FIGS. 54E-G shows a 2×3 array of nanoscale barrier patterns containing λ-DNA curtains viewed at 10× magnification. There are at least 1,000 of these 48.5 kb DNA molecules per barrier set and 6 sets of barriers, corresponding to a total content of ˜6,000 individual DNA molecules and roughly 291 million base pairs (291 Mb) of genetic information in this single field-of-view. Importantly, the amount of DNA applied to the surface, the fraction of biotinylated lipid, the spacing between barrier sets, the number of barriers, and the width of the guide channel openings all dictate the total amount of DNA aligned at any given barrier. Any one of these variables can be altered to adjust the number of aligned DNA molecules as needed. Finally, these flowcells are reusable; the bilayers can be repeatedly removed with cleaning agents without compromising the quality of the surface or harming the chromium barriers (see Materials and Methods). New lipids and DNA curtains can be reapplied and imaged with no noticeable loss of optical quality, even after multiple uses.

Preparation of barriers by nanoimprint lithography. The results shown above illustrate that nanoscale barriers to lipid diffusion can be prepared by E-beam lithography, and that these barriers can subsequently be used to assemble curtains comprised of thousands of DNA molecules. This process involves spin-coating the fused silica with photo-resist, etching the desired pattern into the photo-resist with an electron beam, evaporating chromium onto the surface, and finally removing the residual photoresist. One disadvantage of this approach is that it is time consuming to pattern the surfaces. As an alternative, nanoimprint lithography was used to scale up production of the patterns (S27). This involves preparation of a master with the desired barrier pattern made by standard E-beam lithography, and this master is then used to make replicate surfaces simply by using it as a stamp to generate negative barrier patterns in slides coated with photo-resist. Chromium is then deposited on the exposed surface by an electron beam evaporator and the remaining photo-resist is removed in an acetone bath, leaving behind the desired barrier pattern. The advantage of this procedure is that a single master can be used to rapidly generate large numbers of patterned slides containing nanometer-scale barrier features. The barriers generated by nanoimprint lithography can also work for making DNA curtains.

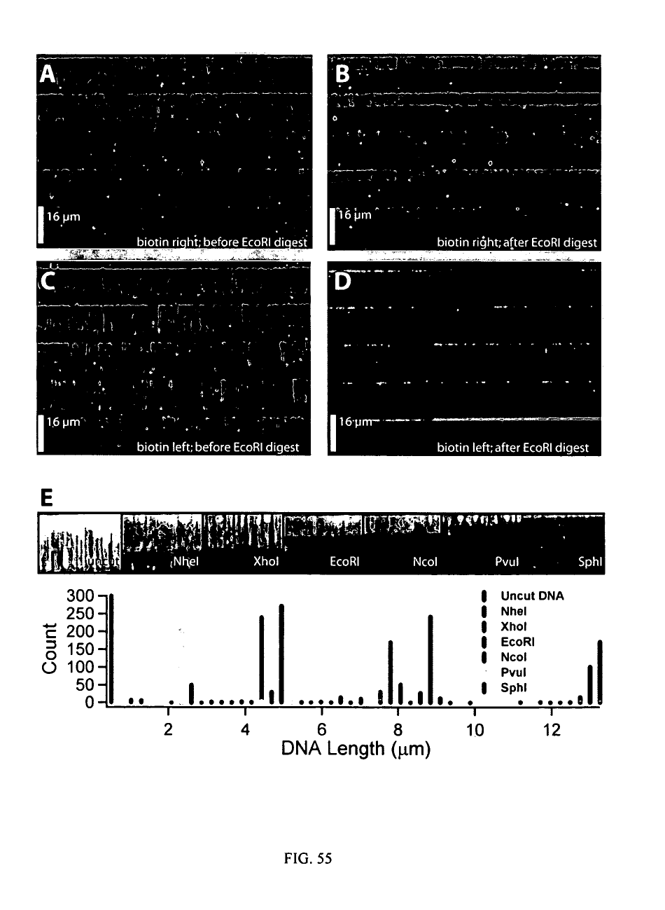

Optical restriction mapping of DNA curtains. The design of the curtains is expected to yield DNA molecules all aligned with the same sequence orientation based upon the location of the biotin tag. λ-DNA has five EcoRI restriction sites located 21,226 bp, 26,106 bp, 31,747 bp, 39,168 bp and 44,972 bp from the left end of the molecules. If the molecules are in the expected orientation, then complete EcoRI digestion of λ-DNA anchored by its left end will yield a tethered fragment of approximately 21 kb, and all of the downstream fragments are washed from the sample chamber. Similarly, an EcoRI digestion of a curtain comprised of λ-DNA biotinylated at the right end should yield a much smaller fragments corresponding to a final length of 3.5 kb. FIGS. 55A-D confirm these predictions, thereby demonstrating that all of the DNA molecules making up the curtain are tethered in orientation specified by the location of the biotin tag. In addition, as shown in FIG. 55E, different combinations of single restriction sites can also be easily mapped within the DNA curtain by successive introduction of the desired enzymes into the flowcell. In this particular example, the DNA curtain was sequentially cut with NheI, XhoI, EcoRI, NcoI, PvuI, and SphI, and the observed lengths (μm) of the resulting DNA fragments were measured and plotted as a histogram.

Because all of the DNA molecules are uniformly aligned with respect to one another a hypothetical line drawn across the curtains perpendicular to the direction of flow force will cross the same sequence on each individual DNA. This fact is proven by the restriction digests presented above. Similarly, if a fluorescently-tagged site-specific DNA binding protein is bound to the DNA curtains, then that protein should form fluorescent “lines” spanning the width of the curtain demarking the location of its cognant binding site. To illustrate this principle, a mutant version of EcoRI with a Gln substitution for Glu111 (EcORI_{E111Q}) was expressed. This mutant protein is incapable of cutting DNA, but binds to its cognant site with an affinity of 10¹³ M⁻¹ at physiological salt concentrations (S28). For this work, EcoRI_{E111Q} was fused at its N-terminus to a FLAG epitope, which in turn was used to label the purified recombinant protein with anti-FLAG-conjugated quantum dots (Qdots). Without wishing to be bound by theory, EcoRI_{E111Q} can bind to the DNA and the binding sites would be demarked as lines across the curtain corresponding the cognant site of the restriction enzyme. DNA curtains bound by the Qdot-tagged EcORI_{E111Q} can also be protected from cleavage by wt EcoRI, and thus it can be verified that the mutant, Qdot-tagged protein remained fully functional and bound to the correct locations. This binding assay can allow one to map all of the EcoRI sites throughout the entire λ phage genome without actually cutting the DNA. For example, a total of 24 barriers sets, loaded with DNA molecules and fluorescently tagged molecules of EcoRI_{E111Q} can be counted that would bind to the DNA curtains on this single flow chamber. Their locations relative to the nano-scale diffusion barriers can then be mapped, providing an illustration of the potential for massive parallel data acquisition of protein-DNA complexes using this technology.

### Discussion

Here, lithography has been applied to engineer arrays of nanoscale diffusion barriers, which in turn are used to organize curtains of DNA molecules on a fused silica surface coated with a supported phospholipid bilayer. With these novel tools in hand, thousands of individual, perfectly aligned DNA molecules, all arranged in the exact same orientation, can now be visualized in real time using total internal reflection fluorescence microscopy. These nanofabricated DNA curtains offer numerous advantages that help overcome some of the current limitations of single molecule imaging. The method is simple and robust, the flowcells are reusable, the barriers themselves are highly uniform, and they do not compromise the optical quality of the fused silica or interfere with signal detection. In addition, the lipid bilayer provides an inert microenvironment closely resembling a cell membrane and is compatible with many biological macromolecules (S17, S21). This ensures that the DNA curtains can be used for imaging a wide range of biochemical systems, as has been begun to be demonstrated (S19, S23-25). Our earlier studies relied on DNA curtains assembled at manually etched microscale barriers, and the development of these new nanoscale chromium barriers will make future work with DNA-binding proteins even more reasonable.

The nanoscale diffusion barriers can be made using two different lithography methods. Direct-write electron-beam lithography for nanofabricating barrier patterns offers tremendous reproducibility, accuracy, and design flexibility, and is particularly advantageous for prototyping devices. While nanoimprint lithography, which is a compression molding based approach, enables more rapid production scale throughput at relatively low cost. With either of these methods, the key elements of the barrier design (barrier height, barrier width, barrier material, separation distance between adjacent barriers, guide channel shape or width, etc.) can all be adjusted to accommodate any desired substrate and/or experimental need with virtually no limitations on the overall pattern other than those spatial constraints imposed by the use of lithographic techniques. The shapes and dimensions of the barriers presented here were specifically constructed for visualizing 48 kb λ-DNA molecules. For example, the parallel barriers within these sets are separated from one another by a distance of 16 μm to allow maximal surface coverage with the λ-DNA. However, the design flexibility conferred by the use of lithography beckons the development of even more complex barrier elements.

The primary intent is to generate new tools that facilitate massively parallel data collection for single molecule analysis of protein-DNA interactions, yet it is also apparent that these DNA curtains have a myriad of other potential applications. For example, they enable rapid generation of physical maps of long DNA molecules, which have been demonstrated in these studies with a series of optical mapping assays based on restriction endonuclease cleavage. Because these reactions are performed within a microfluidic sample chamber, collection of the cleaved fragments in sufficient quantities for cloning and further analysis should prove straightforward. These curtains can also be used to generate maps of DNA binding sites for any site-specific DNA binding protein of interest as long as it can be tagged with a fluorescent label. This application can also be demonstrated with a catalytically inactive mutant of EcoRI that was labeled with a quantum dot. Although EcORI_{E111Q} is chosen for a simple proof-of-principle, this DNA curtain-binding assay can be used to rapidly assess and map both the distribution and site occupancy of virtually any DNA binding protein. Moreover, this strategy of using FLAG tagged proteins in combination with antibody-conjugated quantum dots eliminates the need for chemical derivatization and should prove generally applicable to any protein that is epitope tagged and remains biologically active when coupled to an antibody-quantum dot conjugate. Finally, the perfect alignment of the DNA molecules within the curtains greatly facilitates data evaluation, and also offers the future potential for applying machine vision techniques for automated image analysis.

In summary, single-molecule studies can reveal aspects of biological molecules and reactions that are inaccessible to ensemble approaches. However, this potential can be impaired by technical challenges in data acquisition. This especially true for multi-component biochemical reactions involving complex molecular transactions and long DNA molecules. To help overcome these challenges, new tools are being established to organize DNA molecules on inert surfaces. Here, “DNA curtains” organized at nano-scale diffusion barriers have been shown to offer the ability to simultaneously view thousands of DNA molecules and thousands of individual protein-DNA interactions in real time at the single molecule level.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

### REFERENCES

J1. Kanaar, R., Hoeijmakers, J. H. J. & van Gent, D.C. (1998). Molecular mechanisms of DNA double-strand break repair. Trends in Cell Biology 8, 483-489.
J2. Cromie, G. A., Connelly, J. C. & Leach, D. R. F. (2001). Recombination at double-strand breaks and DNA ends: conserved mechanisms from phage to humans. Molecular Cell 8, 1163-1174.
J3. Bianco, P. R., Tracy, R. B. & Kowalczykowski, S. C. (1998). DNA strand exchange proteins: a biochemical and physical comparison. Frontiers in Bioscience 3, d530-603.
J4. Tsuzuki, T., Fujii, Y., Sakumi, K., Tominaga, Y., Nakao, K., Sekiguchi, M., Yoshimura, Y. & Morita, T. (1996). Targeted disruption of the Rad51 gene leads to lethality in embryonic mice. Proceedings of the National Academy of Sciences (USA) 93, 6236-6240.
J5. Davies, A., Masson, J., McIlwraith, M., Stasiak, A., Stasiak, A., Venkitaraman, A. & West, S. (2001 February). Role of BRCA2 in control of the RAD51 recombination and DNA repair protein. Molecular Cell 7, 273-82.
J6. King, M.-C., Marks, J. H. & Mandell, J. B. (2003). Breast and Ovarian cancer risks due to inherited mutations in BRCA1 and BRCA2. Science 302, 643-646.
J7. Powell, S., Willers, H. & Xia, F. (2002 December). BRCA2 keeps Rad51 in line. High-fidelity homologous recombination prevents breast and ovarian cancer? Molecular Cell 10, 1262-3.
J8. Shin, D. S., Pellegrini, L., Daniels, D. S., Yelent, B., Craig, L., Bates, D., Yu, D. S., Shivji, M. K., Hitomi, C., Arvai, A. S., Volkmann, N., Tsuruta, H., Blundell, T. L., Venkitaraman, A. R. & Tainer, J. A. (2003). Full-length archaeal Rad51 structure and mutants: mechanisms for Rad51 assembly and control by BRCA2. The EMBO Journal 22, 4566-4576.
J9. Wu, Y., He, Y., Moya, I. A., Qian, X. & Luo, Y. (2004). Crystal structure of archaeal recombinase RadA: a snapshot of its extended conformation. Molecular Cell 15, 423-435.
J10. Baumann, P. & West, S. C. (1998). Role of the human Rad51 protein in homologous recombination and double-stranded-break repair. Trends in Biochemical Sciences 23, 247-251.
J11. West, S. C. (2003). Molecular views of recombination proteins and their control. Nature Reviews 4, 1-11.
J12. Symington, L. S. (2002). Role of RAD52 Epistasis group of genes in homologous recombination and double-strand break repair. Microbiology and Molecular Biology Reviews 66, 630-670.
J13. Sung, P., Krejci, L., Van Komen, S. & Sehorn, M. G. (2003). Rad51 recombinase and recombination mediators. The Journal of Biological Chemistry 278, 42729-42732.
J14. Masson, J.-Y., Stasiak, A. Z., Stasiak, A., Benson, F. E. & West, S. C. (2001). Complex formation by the human Rad51C and XRCC3 recombination repair proteins. Proceedings of the National Academy of Sciences (USA) 98, 8440-8446.
J15. Masson, J.-Y., Tarsounas, M. C., Stasiak, A. Z., Stasiak, A., Shah, R., McIlwraith, M. J., Benson, F. E. & West, S. C. (2001). Identification and purification of two distinct complexes containing the five RAD51 paralogs. Genes & Development 15, 3296-3307.
J16. Sehorn, M. S., Sigurdsson, S., Bussen, W., Unger, V. M. & Sung, P. (2004). Human meiotic recombinase Dmc1 promotes ATP-dependent homologous DNA strand exchange. Nature 429, 433-437.
J17. Gupta, R. C., Bazemore, L. R., Golub, E. I. & Radding, C. M. (1997). Activities of human recombination protein Rad51. Proceedings of the National Academy of Sciences (USA) 94, 46-468.
J18. Baumann, P., Benson, F. E. & West, S. C. (1996). Human Rad51 protein promotes ATP-dependent homologous pairing and strand transfer reactions in vitro. Cell 87, 757-766.
J19. Benson, F. E., Stasiak, A. & West, S. C. (1994). Purification and characterization of the human Rad51 protein, an analogue of E. coli RecA. The EMBO Journal 13, 5764-5771.
J20. Yu, X., Jacobs, S. A., West, S. C., Ogawa, T. & Egelman, E. H. (2001). Domain structure and dynamics in the helical filaments formed by RecA and Rad51 on DNA. Proceedings of the National Academy of Sciences (USA) 98, 8419-8424.
J21. Yang, S., Yu, X., Seitz, E. M., Kowalczykowski, S. C. & Egelman, E. H. (2001). Archeal RadA protein binds DNA as both helical filaments and octomeric rings. Journal of Molecular Biology 314, 1077-1085.
J22. Conway, A. B., Lynch, T. W., Zhang, Y., Fortin, G. S., Fung, C. W., Symington, L. S. & Rice, P. (2004). Crystal Structure of a Rad51 filament. Nature Structural and Molecular Biology 11, 791-796.
J23. Pellegrini, L., Yu, D. S., Lo, T., Anand, S., Lee, M., Blundell, T. L. & Venkitaramani, A. R. (2002). Insights into DNA recombination from the structure of a RAD51-BRCA2 complex. Nature 420, 287-293.
J24. Story, R. M., Weber, I. T. & Steitz, T. A. (1992). The structure of the E. coli recA protein monomer and polymer. Nature 355, 318-325.
J25. Yu, X. & Egelman, E. H. (1997). The RecA hexamer is a structural homologue of ring helicases. Nature Structural Biology 4, 101-104.
J26. Kinebuchi, T., Kagawa, W., Enomoto, R., Tanaka, K., Miyagawa, K., Shibata, T., Kurumizaka, H. & Yokoyama, S. (2004). Structural basis for octomeric ring formation and DNA interaction of the human homologous-pairing protein Dmc1. Molecular Cell 14, 363-374.
J27. Egelman, E. H. (2001). Does a stretch DNA structure dictate the helical geometry of RecA-like filaments. Journal of Molecular Biology 309, 539-542.
J28. Passy, S. I., Yu, X., Li, Z., Radding, C. M., Masson, J.-Y., West, S. C. & Egelman, E. H. (1999). Human Dmc1 protein binds DNA as an octomeric ring. Proceedings of the National Academy of Sciences (USA) 96, 10684-10688.
J29. Graneli, A., Yeykal, C. C., Prasad, T. K. & Greene, E. C. (2006). Organized arrays of individual DNA molecules tethered to supported lipid bilayers. Langmuir 22, 292-299.
J30. Graneli, A., Yeykal, C. C., Robertson, R. B. & Greene, E. C. (2006). Long-distance lateral diffusion of human Rad51 on double-stranded DNA. Proceedings of the National Academy of Sciences (USA) 103, 1221-1226.
J31. Groves, J. & Boxer, S. (2002 March). Micropattern formation in supported lipid membranes. Acc Chem Res 35, 149-57.
J32. Axelrod, D. (1989). Total internal reflection fluorescence microscopy. Methods Cell Biol 30, 245-70.
J33. Bennink, M. L., Scharer, O. D., Kanaar, R., Sakata-Sogawa, K., Schins, J. M., Kanger, J. S., de Grooth, B. G. & Greve, J. (1999). Single-molecule manipulation of double-stranded DNA using optical tweezers: interaction studies of DNA with RecA and YOYO1. Cytometry 36, 200-208.
J34. Gurrieri, S., Wells, K. S., Johnson, I. D. & Bustamante, C. (1997). Direct visualization of individual DNA molecules by fluorescence microscopy: characterization of the factors affecting signal/background and optimization of imaging conditions using YOYO. Analytical Biochemistry 249, 44-53.
J35. Zaitseva, E. M., Zaitsev, E. N. & Kowalczykowski, S. C. (1999). The DNA binding properties of Saccharomyces cerevisiae Rad51 protein. The Journal of Biological Chemistry 274, 2907-2915.
J36. Pugh, B. F. & Cox, M. M. (1988). General mechanism for RecA protein binding to duplex DNA. Journal of Molecular Biology 203, 479-493.
J37. Doyle, P. S., Ladoux, B. & Viovy, J.-L. (2000). Dynamics of a tethered polymer in shear flow. Physical Review Letters 84, 4769-4772.
J38. Ladoux, B. & Doyle, P. S. (2000). Stretching tethered DNA chains in shear flow. Europhysics Letters 52, 511-517.
J39. Hegner, M., Smith, S. B. & Bustamante, C. (1999). Polymerization and mechanical properties of single RecA-DNA filaments. Proceedings of the National Academy of Sciences (USA) 96, 10109-10114.
J40. Bugreev, D. V. & Mazin, A. V. (2004). Ca²⁺ activates human homologous recombination protein Rad51 by modulating its ATPase activity. Proceedings of the National Academy of Sciences (USA) 101, 9988-9993.
J41. Ristic, D., Modesti, M., van der Heijden, T., van Noort, J., Dekker, C., Kanaar, R. & Wyman, C. (2005). Human Rad51 filaments on double- and single-stranded DNA: correlating regular and irregular forms with recombination function. Nucleic Acids Research 33, 3292-3302.
J42. Tombline, G., Heinen, C. D., Shim, K.-S. & Fishel, R. (2002). Biochemical characterization of the human Rad51 protein: III. Modulation of DNA binding by adenosine nucleotides. The Journal of Biological Chemistry 277, 14434-14442.
J43. Chi, P., Van Komen, S., Sehorn, M. G., Sigurdsson, S. & Sung, P. (2006). Roles of ATP binding and ATP hydrolysis in human Rad51 recombinase function. DNA Repair 5, 381-391.
J44. VanLoock, M. S., Yu, X., Yang, S., Lai, A. L., Low, C., Campbell, M. J. & Egelman, E. H. (2003). ATP-mediated conformational changes in the RecA filament. Structure 11, 187-196.
J45. Wu, Y., Qian, X., He, Y., Moya, I. A. & Luo, Y. (2005). Crystal structure of an ATPase-active form of Rad51 homolog from Methanococcus voltae. The Journal of Biological Chemistry 280, 722-728.
J46. Rice, K. P., Eggler, A. L., Sung, P. & Cox, M. M. (2001). DNA pairing and strand exchange by the Escherichia coli RecA and yeast Rad51 proteins without ATP hydrolysis. The Journal of Biological Chemistry 276, 38570-38581.
J47. Mazin, A., Zaitseva, E., Sung, P. & Kowalczykowski, S. (2000 Mar. 1). Tailed duplex DNA is the preferred substrate for Rad51 protein-mediated homologous pairing. The EMBO Journal 19, 1148-56.
J48. Aihara, H., Ito, Y., Kurumizaka, H., Yokoyama, S. & Shibata, T. (1999). The N-terminal domain of the human Rad51 protein binds DNA: structure and a DNA binding surface as revealed by NMR. Journal of Molecular Biology 290, 495-505.
J49. Morrison, C., Shinohara, A., Sonoda, E., Yamaguchi-Iwai, Y., Takata, M., Weichselbaum, R. R. & Takeda, S. (1999). The essential functions of human Rad51 are independent of ATP hydrolysis. Molecular and Cellular Biology 19, 6891-6897.
J50. Howard-Flanders, P., West, S. C., Rusche, J. R. & Egelman, E. H. (1984). Molecular mechanisms of genetic recombination: the DNA-binding sites of RecA protein. Cold Spring Harbor Symp. Quant. Biol. 49, 571-580.
J51. Morimatsu, K. & Horii, T. (1995). DNA-binding surface of RecA protein photochemical crosslinking of the first DNA binding site on the RecA filament. Eur. J. Biochem. 234, 695-705.
J52. Wang, Y. & Adzuma, K. (1996). Differential proximity probing of two DNA binding sites in the Escherichia coli recA protein using photo-cross-linking methods. Biochemistry 35, 3563-3571.
J53. Cazaux, C., Blanchet, J.-S., Dupuis, D., Villani, G., Defias, M. & Johnson, N. P. (1998). Investigation of the secondary DNA-binding site of the bacterial recombinase RecA. The Journal of Biological Chemistry 273, 28799-28804.
J54. Mirshad, J. K. & Kowalczykowski, S. C. (2003). Biochemical characterization of a mutant RecA protein altered in DNA-binding loop 1. Biochemistry 42, 5945-5954.
J55. Kurumizaka, H., Aihara, H., Kagawa, W., Shibata, T. & Yokoyama, S. (1999). Human Rad51 amino acid residues required for Rad52 binding. Journal of Molecular Biology 291, 537-548.
J56. Matsuo, Y. Sakane, I., Takizawa, Y., Takahashi, M., and Kurumizaka, H. (2006). Roles of the human Rad51 L1 and L2 loops in DNA binding. The FEBS Journal 273, 3148-3159.
L1. ernandez, J. M.; L1, H., Science 2004, 303, (5664), 1674-8.
L2. mith, S. B.; Cui, Y.; Bustamante, C., Science 1996, 271, (5250), 795-9.
L3. a, T., Biochemistry 2004, 43, (14), 4055-63.
L4. Bianco, P. R.; Brewer, L. R.; Corzett, M.; Balhorn, R.; Yeh, Y.; Kowalczykowski, S. C.; Baskin, R. J., Nature 2001, 409, (6818), 374-8.
L5. Greene, E. C.; Mizuuchi, K., J Biol Chem 2004, 279, (16), 16736-43.
L6. Greene, E. C.; Mizuuchi, K., Embo J 2002, 21, (6), 1477-86.
L7. Rasnik, I.; Myong, S.; Cheng, W.; Lohman, T. M.; Ha, T., J Mol Biol 2004, 336, (2), 395-408.
L8. Schuler, B., Chemphyschem 2005, 6, (7), 1206-1220.
L9. Axelrod, D., Methods Cell Biol 1989, 30, 245-70.
L10. Greene, E. C.; Mizuuchi, K., Mol Cell 2002, 9, (5), 1079-89.
L11. Ha, T.; Rasnik, I.; Cheng, W.; Babcock, H. P.; Gauss, G. H.; Lohman, T. M.; Chu, S., Nature 2002, 419, (6907), 638-41.
L12. Sackman, E., Science 1996, 271, 43-48.
L13. Keller, C.; Glasmastar, K.; Zhdanov, V.; Kasemo, B., Phys Rev Lett 2000 Jun. 5, 84, (23), 5443-6.
L14. Glasmastar, K.; Larsson, C.; Höök, F.; Kasemo, B., Journal of Colloid and Interface Science 2002, (246), 40-47.
L15. Yoshina-Ishii, C.; Boxer, S. G., J Am Chem Soc 2003, 125, (13), 3696-7.
L16. Stevens, B. C.; Ha, T., Journal of Chemical Physics 2004, 120, 3030-3039.
L17. Greene, E. C.; Mizuuchi, K., Molecular Cell 2002, 10, (6), 1367-1378.
L18. Berg, H. C., Random walks in biology. Princeton University Press: Princeton, N.J., 1993.
L19. Bustamante, C.; Bryant, Z.; Smith, S. B., Nature 2003, 421, (6921), 423-7.
L20. Harada, Y.; Funatsu, T.; Murakami, K.; Nonoyama, Y.; Ishihama, A.; Yanagida, T., Biophysical Journal 1999, 76, 709-715.
L21. Kam, L.; Boxer, S. G., J Biomed Mater Res 2001, 55, (4), 487-95.
L22. Bensimon, A.; Simon, A.; Chiffaudel, A.; Croquette, V.; Heslot, F.; Bensimon, D., Science 1994, 265, 2096-2098.
L23. Bensimon, D.; Simon, A. J.; Croquette, V.; Bensimon, A., Physical Review Letters 1995, 74, 4754-4757.
L24. Crut, A.; Lasne, D.; Allemand, J.-F.; Dahan, M.; Desbiolles, P., Physical Review E 2003, 67, 051910 1-6.
L25. Gueroui, Z.; Place, C.; Freyssingeas, E.; Berge, B., Proc Natl Acad Sci USA 2002, 99, 6005-6010.
L2.6 Bouchiat, C.; Wang, M. D.; Allemand, J.-F.; Strick, T.; Block, S. M.; Croquette, V., Biophysical Journal 1999, 76, 409-413.
L27. Bustamante, C.; Marko, J. F.; Siggia, E. D.; Smith, S., Science 1994, 265, 1599-1600.
L28. Groves, J. T.; Boxer, S. G., Acc. Chem. Res. 2002, 35, (3), 149-157.
L29. Cremer, P. S.; Boxer, S. G., J. Phys. Chem. B 1999, 103, 2554-2559.
L30. Salafsky, J.; Groves, J. T.; Boxer, S. G., Biochemistry 1996, 35, 14773-14781.
M1. Åkerman, B., and Tuite, E. (1996). Single- and double-strand photocleavage of DNA by YO, YOYO, and TOTO. Nucleic Acids Research 24, 1080-1090.
M2. Alexeev, A. A., Mazin, A. V., and Kowalczykowski, S. C. (2003). Rad54 protein possesses chromatin-remodeling activity stimulated by the Rad51-ssDNA nucleoprotein filament. Nature Structural and Molecular Biology 10, 182-186.
M3. Alexiadis, V., and Kadonaga, J. T. (2002). Strand pairing by Rad54 and Rad51 is enhanced by chromatin. Genes & Development 16, 2767-2771.
M4. Amitani, I., Baskin, R. J., and Kowalczykowski, S. C. (2006). Visualization of Rad54, a chromatin remodeling protein, translocating on single DNA molecules. Molecular Cell 23, 143-148.
M5. Axelrod, D. (1989). Total internal reflection fluorescence microscopy. Methods in Cell Biology 30, 245-270.
M6. Bugreev, D. V., Mazina, O. M., and Mazin, A. V. (2006). Rad54 protein promotes branch migration of Holliday junctions. Nature 442.
M7. Chi, P., Kwon, Y., Seong, C., Epshtein, A., Lam, I., Sung, P., and Klein, H. L. (2006). Yeast recombination factor Rdh54 functionally interacts with the Rad51 recombinase and catalyzes Rad51 removal from DNA. The Journal of Biological Chemistry 281, 26268-26279.
M8. Clever, B., Interthal, H., Schmuckli-Maurer, J., King, J., Sigrist, M., and Heyer, W.-D. (1997). Recombinational repair in yeast: functional interactions between Rad51 and Rad54 proteins. The EMBO Journal 16, 2535-2544.
M9. Dresser, M., Ewing, D., Conrad, M., Dominguez, A., Barstead, R., Jiang, H., and Kodadek, T. (1997). DMC1 functions in a Saccharomyces cerevisiae meiotic pathway that is largely independent of the RAD51 pathway. Genetics 147, 533-544.
M10. Flaus, A., Martin, D. M. A., Barton, G. J., and Owen-Hughes, T. (2006). Identification of multiple distinct Snf2 subfamilies with conserved structural motifs. Nucleic Acids Research 34, 2887-2905.
M11. Gorbalenya, A. E., Koonin, E. V., Donchenko, A. P., and Blinov, V. M. (1988). A novel superfamily of nucleotide triphosphate-binding motif containing proteins which are probably involved in duplex unwinding in DNA and RNA replication and recombination. FEBS Letters 235, 16-24.
M12. Graneli, A., Yeykal, C. C., Prasad, T. K., and Greene, E. C. (2006a). Organized arrays of individual DNA molecules tethered to supported lipid bilayers. Langmuir 22, 292-299.
M13. Graneli, A., Yeykal, C. C., Robertson, R. B., and Greene, E. C. (2006b). Long-distance lateral diffusion of human Rad51 on double-stranded DNA. Proceedings of the National Academy of Sciences (USA) 103, 1221-1226.
M14. Heyer, W., Li, X., Rolfsmeier, M., and Zhang, X. (2006). Rad54: the Swiss Army knife of homologous recombination? Nucleic Acids Research.
M15. Heyer, W., Li, X., Rolfsmeier, M., and Zhang, X. (2006 Aug. 25). Rad54: the Swiss Army knife of homologous recombination? Nucleic Acids Research.
M16. Jaskelioff, M., Van Komen, S., Krebs, J. E., Sung, P., and Peterson, C. L. (2003). Rad54p is a chromatin remodeling enzyme required for heteroduplex DNA joint formation with chromatin. The Journal of Biological Chemistry 278, 9212-9218.
M17. Jiang, H., Xie, Y., Houston, P., Stemke-Hale, K., Mortensen, U. H., Rothstein, R., and Kodadek, T. (1996). Direct association between yeast Rad51 and Rad54 recombination proteins. The Journal of Biological Chemistry 271, 33181-33186.
M18. Kiianitsa, K., Solinger, J. A., and Heyer, W.-D. (2006). Terminal association of Rad54 protein with the Rad51-dsDNA filament. Proceedings of the National Academy of Sciences (USA) 103, 9767-9772.
M19. Klein, H. L. (1997). RDH54, a RAD54 homologue in Saccharomyces cerevisiae, is required for mitotic diploid-specific recombination and repair for meiosis. Genetics 147, 1533-1543.
M20. Lia, G., Praly, E., Ferreira, H., Stockdale, C., Tse-Dinh, Y. C., Dunlap, D., Croquette, V., Bensimon, D., and Owen-Hughes, T. (2006). Direct observation of DNA distortion by the RSC complex. Molecular Cell 21, 417-425.
M21. Lisby, M., Barlow, J. H., Burgess, R. C., and Rothstein, R. (2004). Choreography of the DNA damage response: spatiotemporal relationships among checkpoint and repair proteins. Cell 118, 699-713.
M22. Mazin, A., Alexeev, A., and Kowalczykowski, S. (2003). A novel function of Rad54 protein. Stabilization of the Rad51 nucleoprotein filament. The Journal of Biological Chemistry 278, 14029-14036.
M23. Mazin, A. V., Bomarth, C. J., Solinger, J. A., Heyer, W.-D., and Kowalczykowski, S. C. (2000). Rad54 protein is targeted to pairing loci by the Rad51 nucleoprotein filament. Molecular Cell 6.
M24. Petukhova, G., Stratton, S., and Sung, P. (1998). Catalysis of homologous DNA pairing by yeast Rad51 and Rad54 proteins. Nature 393, 91-94.
M25. Petukhova, G., Sung, P., and Klein, H. (2000). Promotion of Rad51-dependent D-loop formation by yeast recombination factor Rdh54/Tid1. Genes & Development 14, 2206-2215.
M26. Petukhova, G., Van Komen, S., Vergano, S., Klein, H., and Sung, P. (1999). Yeast Rad54 promotes Rad51-dependent homologous DNA pairing via ATP hydrolysis-driven change in DNA double helix conformation. The Journal of Biological Chemistry 274, 29453-29462.
M27. Raschle, M., Van Komen, S., Chi, P., Ellenberger, T., and Sung, P. (2004). Multiple interactions with the Rad51 recombinase govern the homologous recombination function of Rad54. The Journal of Biological Chemistry 279, 51973-51980.
M28. Ristic, D., Wyman, C., Paulusma, C., and Kanaar, R. (2001). The architecture of the human Rad54-DNA complex provides evidence for protein translocation along DNA. Proceedings of the National Academy of Sciences (USA) 98, 8454-8460.
M29. Saha, A., Wittmeyer, J., and Cairns, B. R. (2002). Chromatin remodeling by RSC involves ATP-dependent DNA translocation. Genes & Development 16, 2120-2134.
M30. Saha, A., Wittmeyer, J., and Cairns, B. R. (2006). Chromatin remodeling: the industrial revolution of DNA around nucleosomes. Nature Reviews Molecular Cell Biology 7, 437-447.
M31. Seidel, R., van Noort, J., van der Scheer, C., Bloom, J. G. P., Dekker, N. H., Dutta, C. F., Blundell, A., Robinson, T., Firman, K., and Dekker, C. (2004). Real-time observation of DNA translocation by the type I restriction modification enzyme EcoR1241. Nature Structural and Molecular Biology 11, 838-843.
M32. Shinohara, M., Gasior, S. L., Bishop, D. K., and Shinohara, A. (2000). Tid1/Rdh54 promotes colocalization of Rad51 and Dmc1 during meiotic recombination. Proceedings of the National Academy of Sciences (USA) 97, 10814-10819.
M33. Shinohara, M., Sakai, K., Shinohara, A., and Bishop, D. K. (2003). Crossover interference in Saccharomyces cerevisiae requires a TID1/RDH54 and DMC1-dependent pathway. Genetics 163, 1273-1286.
M34. Shinohara, M., Shita-Yamaguchi, E., Buerstedde, J.-M., Shinagawa, H., Ogawa, H., and Shinhara, A. (1997). Characterization of the roles of the Saccharomyces cerevisiae RAD54 gene and homologue of RAD54, RDH54/TID1, in mitosis and meiosis. Genetics 147, 1545-1556.
M35. Sigurdsson, S., Van Komen, S., Petukhova, G., and Sung, P. (2002). Homologous DNA pairing by human recombination factors Rad51 and Rad54. The Journal of Biological Chemistry 277, 42790-42794.
M36. Singleton, M. R., and Wigley, D. B. (2002). Modularity and Specialization in Superfamily 1 and 2 helicases. The Journal of Bacteriology 184, 1819-1826.
M37. olinger, J. A., and Heyer, W.-D. (2001). Rad54 protein stimulates the postsynaptic phase of Rad51 protein-mediated DNA strand exchange. Proceedings of the National Academy of Sciences (USA) 98, 8447-8453.
M38. Solinger, J. A., Kiianitsa, K., and Heyer, W.-D. (2002). Rad54, the Swi/Snf-like recombinational repair protein, disassembles Rad51:dsDNA filaments. Molecular Cell 10, 1175-1188.
M39. Sung, P., Krejci, L., Van Komen, S., and Sehom, M. G. (2003). Rad51 recombinase and recombination mediators. The Journal of Biological Chemistry 278, 42729-42732.
M40. Symington, L. S. (2002). Role of RAD52 epistasis group genes in homologous recombination and double-strand break repair. Microbiology and Molecular Biology Reviews 66, 630-670.
M41. Tan, T. L. R., Kanaar, R., and Wyman, C. (2003). Rad54, a jack of all trades in homologous recombination. DNA Repair 2, 787-794.
M42. Thoma, N. H., Czyzewski, B. K., Alexeev, A. A., Mazin, A. V., Kowalczykowski, S. C., and Pavletich, N. P. (2005). Structure of the SWI2/SNF2 chromatin-remodeling domain of eukaryotic Rad54. Nature Structural and Molecular Biology 12, 350-356.
M43. Van Komen, S., Petukhova, G., Sigurdsson, S., Stratton, S., and Sung, P. (2000). Superhelicity-driven homologous DNA pairing by yeast recombination factors Rad51 and Rad54. Molecular Cell 6, 563-572.
N1. Weiss, S., 1999. Fluorescene Spectroscopy of Single Biomolecules. Science. 283: p. 1676-1683.
N2. Axelrod, D., 1989. Total internal reflection fluorescence microscopy. Methods Cell Biol. 30: p. 245-70.
N3. Forkey, J. N., M. E. Quinlan, and Y. E. Goldman, 2000. Protein structural dynamics by single-molecule fluorescence polarization. Progress in Biophysics & Molecular Biology. 74: p. 1-35.
N4. Sackmann, E., 1996. Supported Membranes. Science. 271: p. 43-48.
N5. Greene, E. C. and K. Mizuuchi, 2002. Target immunity during Mu DNA transposition: transpososome assembly and DNA looping enhance MuA-mediated disassembly of the MuB target complex. Molecular Cell. 10: p. 1367-1378.
N6. Saxton, M. J. and K. Jacobson, 1997. Single-particle tracking: applications to membrane dynamics. Annual Reviews in Biophysics and Biomolecular Structure. 26: p. 373-399.
N7. Qian, H., M. P. Sheetz, and E. L. Elson, 1991. Single particle tracking: analysis of diffusion and flow in two-dimensional systems. Biophysical Journal. 60: p. 910-921.
N8. Groves, J. and S. Boxer, 2002 Mar. Micropattern formation in supported lipid membranes. Acc Chem. Res. 35(3): p. 149-57.
N9. Hsieh, P., 2001. Molecular mechanisms of DNA mismatch repair. Mutation Research. 486: p. 71-87.
N10. Groves, J. T., N. Ulman, P. S. Cremer, and S. G. Boxer, 1998. Substrate-membrane interactions: mechanisms for imposing patterns on a fluid bilayer membrane. Langmuir. 14: p. 3347-3350.
N11. Whitesides, G. M., E. Ostuni, S. Takayama, X. Jiang, and D. E. Ingber, 2001. Soft Lithography in Biology and Biochemistry. Annual Reviews in Biomedical Engineering. 3: p. 335-373.
N12. Kung, L. A., L. Kam, J. S. Hovis, and S. G. Boxer, 2000. Patterning Hybrid Surfaces of Proteins and Supported Lipid Bilayers. Langmuir. 16: p. 6773-6776.
N13. St. John, P. M., R. Davis, N. Cady, J. Czajka, C. A. Batt, and H. G. Craighead, 1998. Diffraction-Based Cell Detection Using a Microcontact Printed Antibody Grating. Analytical Chemistry. 70: p. 1108-1111.
N14. Strick, T., V. Croquette, and D. Bensimon, 2000 Apr. 20. Single-molecule analysis of DNA uncoiling by a type II topoisomerase. Nature. 404(6780): p. 901-4.
N15. Crisona, N., T. Strick, D. Bensimon, V. Croquette, and N. Cozzarelli, 2000 Nov. 15. Preferential relaxation of positively supercoiled DNA by E. coli topoisomerase IV in single-molecule and ensemble measurements. Genes Dev. 14(22): p. 2881-92.
N16. Sung, N. S., J. I. Gordon, G. D. Rose, E. D. Getzoff, S. J. Kron, D. Mumford, J. N. Onuchic, N. F. Scherer, D. L. Sumners, and N. J. Kopell, 2003. Educating future scientists. Science. 301: p. 1485.
N17. Yao, N., J. Turner, Z. Kelman, P. T. Stukenburg, F. Dean, D. Shechter, Z.-Q. Pan, J. Hurwitz, and M. O'Donnell, 1996. Clamp loading, unloading and intrinsic stability of PCNA, beta and gp45 sliding clamps of human, E. coli, and T4 replicases. Genes to Cells. 1: p. 101-113.
N18. Kelman, Z., 1997. PCNA: structure, functions and interactions. Oncogene. 14: p. 629-640.
N19. Kelman, Z. and J. Hurwitz, 1998. Protein-PCNA interactions: a DNA-scanning mechanism? Trends in Biochemical Sciences. 23: p. 236-238.
N20. Vivona, J. B. and Z. Kelman, 2003. The diverse spectrum of sliding clamp interacting proteins. FEBS Letters. 546: p. 167-172.
N21. Medintz, I., H. T. Uyeda, E. R. Goldman, and H. Mattoussi, 2005. Quantum dot bioconjugates for imaging, labeling and sensing. Nature Materials. 4: p. 435-446.
N22. Michalet, X., F. F. Pinaud, L. A. Bentolila, J. M. Tsay, S. Doose, J. J. Li, G. Sundaresan, A. M. Wu, S. S. Gambhir, and S. Weiss, 2005. Quantum dots for live cells, in vivo imaging, and diagnostics. Science. 307: p. 538-544.
N23. Empedocles, S. A., R. Neuhauser, K. Shimizu, and M. G. Bawendi, 1999. Photoluminescence from single semiconductor nanostructures. Advanced materials. 11(15): p. 1243-1256.
N24. Kelman, Z. and M. O'Donnell, 1995. Structural and functional similarities of prokaryotic and eukaryotic DNA polymerase sliding clamps. Nucleic Acids Research. 23(18): p. 3613-3620.
N25. Jeruzalmi, D., M. O'Donnell, and J. Kuriyan, 2002. Clamp loaders and sliding clamps. Current Opinion in Structural Biology. 12: p. 217-224.
N26. Alani, E., 1996. The Saccharomyces cerevisiae Msh2 and Msh6 proteins form a complex that specifically binds to duplex oligonucleotides containing mismatched DNA base pairs. Molecular and Cellular Biology. 16(10): p. 5604-5615.
N27. Kolodner, R. D. and G. T. Marsischky, 1999. Eukaryotic mismatch repair. Current Opinion in Genetics and Development. 9: p. 89-96.
N28. Obmolova, G., C. Ban, and W. Yang, 2000. Crystal structures of mismatch repair protein MutS and its complex with a substrate DNA. Nature. 407: p. 703-710.
N29. Junop, M. S., G. Obmolova, K. Rausch, P. Hsieh, and W. Yang, 2001. Composite active site of an ABC ATPase: MutS uses ATP to verify mismatch recognition and authorize DNA repair. Mol. Cell. 7: p. 1-12.
N30. Gradia, S., S. Acharya, and R. Fishel, 1997. The human mismatch recognition complex hMSH2-hMSH6 functions as a novel molecular switch. Cell. 91: p. 995-1005.
N31. Gradia, S., D. Subramanian, T. Wilson, S. Acharya, A. Makhov, J. Griffith, and R. Fishel, 1999. hMSH2-hMSH6 forms a hydrolysis-independent sliding clamp on mismatched DNA. Molecular Cell. 3: p. 255-261.
N32. Gradia, S., S. Acharya, and R. Fishel, 2000. The role of mismatched nucleotides in activating the hMSH2-hMSH6 molecular switch. The Journal of Biological Chemistry. 275(6): p. 3922-3930.
N33. Acharya, S., P. L. Foster, P. Brooks, and R. Fishel, 2003. The coordinated functions of the E. coli MutS and MutL proteins in mismatch repair. Mol. Cell. 12: p. 233-246.
N34. Allen, D. J., A. Makhov, M. Grilley, J. Taylor, R. Thresher, P. Modrich, and J. Griffith, 1997. MutS mediates heteroduplex loop formation by a translocation mechanism. The EMBO Journal. 16(14): p. 4467-4476.
N35. Blackwell, L. J., D. Martik, K. P. Bjornson, E. S. Bjornson, and P. Modrich, 1998. Nucleotide promoted release of hMuts-alpha from heteroduplex DNA is consistent with an ATP-dependent translocation mechanism. The Journal of Biological Chemistry. 273(48): p. 32055-32062.
N36. Bowers, J., P. T. Tran, A. Joshi, R. M. Liskay, and E. Alani, 2001. MSH-MLH complexes formed at a DNA mismatch are disrupted by the PCNA sliding clamp. Journal of Molecular Biology. 306: p. 957-968.
N37. Mendillo, M. L., D. J. Mazur, and R. D. Kolodner, 2005. Analysis of the interaction between the Saccharomyces cerevisiae MSH2-MSH6 and MLH1-PMS1 complexes with DNA using a reversible DNA end-blocking system. Journal of Biological Chemistry. 280: p. 22245-22257.
N38. Lau, P. J. and R. D. Kolodner, 2003. Transfer of the MSH2-MSH6 complex from proliferating cell nuclear antigen to mispaired bases in DNA. Journal of Biological Chemistry. 278: p. 14-17.
N39. Flores-Rozas, H., D. Clarck, and R. D. Kolodner, 2000. Proliferating cell nuclear antigen and Msh2p-Msh6p interact to form an active mispair recognition complex. Nature Genetics. 26: p. 375-378.
N40. Bowers, J., T. Sokolsky, T. Quach, and E. Alani, 1999. A mutation in the MSH6 subunit of the Saccharomyces cerevisiae MSH2-MSH6 complex disrupts mismatch recognition. The Journal of Biological Chemistry. 274: p. 16115-16125.
N41. Kijas, A. W., B. Studamire, and E. Alani, 2003. msh2 separation of function mutations confer defects in the initiation steps of mismatch repair. Journal of Molecular Biology. 331: p. 123-138.
N42. Yildiz, A., J. N. Forkey, S. A. Mckinney, T. Ha, Y. E. Goldman, and P. R. Selvin, 2003. Myosin V walks hand-over-hand: single fluorophore imaging with 1.5-nm localization. Science. 300: p. 2061-2065.
N43. Cheezum, M. K., W. F. Walker, and W. H. Guilford, 2001. Quantitative comparison of algorithms for tracking single fluorescent particles. Biophysical Journal. 81: p. 2378-2388.
N44. Berg, H., Random Walks in Biology. 1993: Princeton University Press.
N45. Guthhold, M., X. Zhu, C. Rivetti, G. Yang, N. H. Thomson, S. Kasas, H. G. Hansma, B. Smith, P. K. Hansma, and C. Bustamante, 1999. Direct observation of one-dimensional diffusion and transcription by Escherichia coli RNA polymerase. Biophys J. 77: p. 2284-2294.
N46. Naryzhny, S. N., H. Zhao, and H. Lee, 2005. Proliferating cell nuclear antigen (PCNA) may function as a double homotrimer complex in the mammalian cell. Journal of Biological Chemistry. 280(14): p. 13888-13894.
N47. Allewell, N. and V. Bloomfield, 1992. Teaching molecular biophysics at the graduate level. Biophysical Journal. 63: p. 1446-1449.
N48. Gozalez, C., 2001. Undergraduate research, graduate mentoring, and the University's mission. Science. 293: p. 1624-1626.
N49. Wells, M. A., C. Bender, and S. Ward, 1994. Improving undergraduate biology education in a large research university. Molecular Biology of the Cell. 5: p. 129-134.
N50. Orelli, B. and D. Bishop, 2001. BRCA2 and homologous recombination. Breast Cancer Res. 3(5): p. 294-8.
N51. Chopin, S. F., 2002. Undergraduate research experiences: the translation of science education from reading to doing. The Anatomical Record. 269: p. 3-10.
N52. Lopatto, D., 2004. Survey of undergraduate research experiences (SURE): first findings. Cell Biology Education. 3: p. 270-277.
P1. Sung, P., Krejci, L., Van Komen, S. & Sehorn, M. G. (2003) The Journal of Biological Chemistry 278, 42729-42732.
P2. Cromie, G. A., Connelly, J. C. & Leach, D. R. F. (2001) Molecular Cell 8, 1163-1174.
P3. Symington, L. S. (2002) Microbiology and molecular biology reviews 66, 630-670.
P4. Tsuzuki, T., Fujii, Y., Sakumi, K., Tominaga, Y., Nakao, K., Sekiguchi, M., Yoshimura, Y. & Morita, T. (1996) Proceedings of the National Academy of Sciences (USA) 93, 6236-6240.
P5. Khanna, K. K. & Jackson, S. P. (2001) Nature Gentics 27, 247-254.
P6. Venkitaraman, A. R. (2002) Cell 108, 171-182.
P7. Baumann, P. & West, S. C. (1998) Trends in Biochemical Sciences 23, 247-251.
P8. Bianco, P. R., Tracy, R. B. & Kowalczykowski, S. C. (1998) Frontiers in Bioscience 3, d530-603.
P9. Yu, X., Jacobs, S. A., West, S. C., Ogawa, T. & Egelman, E. H. (2001) Proceedings of the National Academy of Sciences 98, 8419-8424.
P10. Sigurdsson, S., Trujillo, K., Song, B. W., Stratton, S. & Sung, P. (2001) The Journal of Biological Chemistry 276, 8798-8806.
P11. McIlwraith, M. J., Hall, D. R., Stasiak, A. Z., Stasiak, A., Wigley, D. B. & West, S. C. (2001) Nucleic Acids Research 29, 4509-4517.
P12. Egelman, E. H. (2000) Trends in Biochemical Sciences 25, 183-184.
P13. Passy, S. I., Yu, X., Li, Z., Radding, C. M., Masson, J.-Y., West, S. C. & Egelman, E. H. (1999) Proceedings of the National Academy of Sciences 96, 10684-10688.
P14. Shin, D. S., Pellegrini, L., Daniels, D. S., Yelent, B., Craig, L., Bates, D., Yu, D. S., Shivji, M. K., Hitomi, C., Arvai, A. S., Volkmann, N., Tsuruta, H., Blundell, T. L., Venkitaraman, A. R. & Tainer, J. A. (2003) The EMBO Journal 22, 4566-4576.
P15. Yang, S., Yu, X., Seitz, E. M., Kowalczykowski, S. C. & Engelman, E. H. (2001) Journal of Molecular Biology 314, 1077-1085.
P16. Baumann, P., Benson, F. E., Hajibagheri, N. & West, S. C. (1997) Mutat. Res. 384, 65-72.
P17. Passy, S. I., Yu, X., Li, Z., Radding, C. M., Masson, J.-Y., West, S. C. & Egelman, E. H. (1999) Proceedings of the National Academy of Sciences (USA) 96, 10684-10688.
P18. Bauman, P., Benson, F. E. & West, S. C. (1996) Cell 87, 757-766.
P19. Pellegrini, L., Yu, D. S., Lo, T., Anand, S., Lee, M., Blundell, T. L. & Venkitaraman, A. R. (2002) Nature 420, 287-293.
P20. Aihara, H., Ito, Y., Kurumizaka, H., Yokoyama, S. & Shibata, T. (1999) The Journal of Molecular Biology 290, 495-504.
P21. Conway, A. B., Lynch, T. W., Zhang, Y., Fortin, G. S., Fung, C. W., Symington, L. S. & Rice, P. A. (2004) Nature structural & molecular biology 11, 791-796.
P22. Benson, F. E., Stasiak, A. & West, S. (1994) EMBO J. 13, 5764-5771.
P23. Greene, E. C. & Mizuuchi, K. (2002) Molecular Cell 9, 1079-1089.
P24. Graneli, A., Yeykal, C. & Greene, E. C. (2005) Submitted to Langmuir.
P25. Qian, H., Sheetz, M. P. & Elson, E. L. (1991) Biophysical Journal 60, 910-921.
P26. Wang, Z. & Sheetz, M. P. (1999) Cell Structure and Function 24, 373-383.
P27. Berg, H. C. (1993) Random walks in biology (Princeton University Press, Princeton).
P28. Cheezum, M. K., Walker, W. F. & Guilford, W. H. (2001) Biophysical Journal 81, 2378-2388.
P29. Weiss, S. (1999 Mar. 12) Science 283, 1676-83.
P30. Bustamante, C., Bryant, Z. & Smith, S. (2003 Jan. 23) Nature 421, 423-7.
P31. Bianco, P. R., Brewer, L. R., Corzett, M., Balhorn, R., Yeh, Y., Kowalczykowski, S. C. & Baskin, R. J. (2001) Nature 409, 374-378.
P32. Mazin, A. V., Zaitseva, E., Sung, P. & Kowalczykowski, S. C. (2000) The EMBO Journal 19, 1148-1156.
P33. Sehom, M. G., Sigurdsson, S., Bussen, W., Unger, V. M. & Sung, P. (2004) Nature 429, 433-437.
P34. Yu, X. & Egelman, E. H. (1997) Nature Structural Biology 4, 101-104.
P35. Kinebuchi, T., Kagawa, W., Enomoto, R., Tanaka, K., Miyagawa, K., Shibata, T., Kurumizaka, H. & Yokoyama, S. (2004) Molecular Cell 14, 363-374.
P36. Sackmann, E. (1996) Science 271, 43-48.
P37. Greene, E. C. & Mizuuchi, K. (2002) Molecular Cell 10, 1367-1378.
P38. Wei, Q.-H., Bechinger, C. & Leiderer, P. (2000) Science 287, 625-627.
P39. Saxton, M. J. & Jacobson, K. (1997) Annual Reviews in Biomolecular Structure 26, 373-399.
P40. Guthhold, M., Zhu, X., Rivetti, C., Yang, G., Thomson, N. H., Kasas, S., Hansma, H. G., Smith, B., Hansma, P. K. & Bustamante, C. (1999) Biophysical Journal 77, 2284-2294.
P41. Shimamoto, N. (1999) The Journal of Biological Chemistry 274, 15293-15296.
P42. Halford, S. E. & Marko, J. F. (2004) Nucleic Acids Research 32, 3040-3052.
P43. Harada, Y., Funatsu, T., Murakami, K., Nonoyama, Y., Ishihama, A. & Yanagida, T. (1999) Biophysical Journal 76, 709-715.
Q1. Wood, R. D., M. Mitchel, J. Sgouros, and T. Lindahl, 2001. Human DNA repair genes. Science. 291: p. 1284-1289.
Q2. Khanna, K. K. and S. P. Jackson, 2001. DNA double-strand breaks: signaling, repair and the cancer connection. Nature Gentics. 27: p. 247-254.
Q3. Modesti, M. and R. Kanaar, 2001. Homologous recombination: from model organism to human disease. Genome Biology. 2(5): p. 1014.1-1014.5.
Q4. Kanaar, R., J. H. J. Hoeijmakers, and D. C. van Gent, 1998. Molecular mechanisms of DNA double-strand break repair. Trends in Cell Biology. 8: p. 483-489.
Q5. Cromie, G. A., J. C. Connelly, and D. R. F. Leach, 2001. Recombination at double-strand breaks and DNA ends: conserved mechanisms from phage to humans. Molecular Cell. 8: p. 1163-1174.
Q6. Baumann, P. and S. C. West, 1998. Role of the human Rad51 protein in homologous recombination and double-stranded-break repair. Trends in Biochemical Sciences. 23: p. 247-251.
Q7. West, S. C., 2003. Molecular views of recombination proteins and their control. Nature reviews. 4: p. 1-11.
Q8. Kowalczykowski, S., 2000. Some assembly required. Nature Stuctural Biology. 7(12): p. 1087-1089.
Q9. Bianco, P. R., R. B. Tracy, and S. C. Kowalczykowski, 1998. DNA strand exchange proteins: a biochemical and physical comparison. Frontiers in Bioscience. 3: p. d530-603.
Q10. Tsuzuki, T., Y. Fujii, K. Sakumi, Y. Tominaga, K. Nakao, M. Sekiguchi, Y. Yoshimura, and T. Morita, 1996. Targeted disruption of the Rad51 gene leads to lethality in embryonic mice. Proceedings of the National Academy of Sciences (USA). 93: p. 6236-6240.
Q11. Kato, M., K. Yano, F. Matsuo, H. Saito, T. Katagiri, H. Kurumizaka, M. Yoshimoto, F. Kasumi, F. Akiyama, G. Sakamoto, H. Nagawa, Y. Nakamura, and Y. Miki, 2000. Identification of Rad51 alteration in patients with bilateral breast cancer. Journal of Human Genetics. 45: p. 133-137.
Q12. Venkitaraman, A., 2002. Cancer susceptibility and the functions of BRCA1 and BRCA2. Cell. 108: p. 171-182.
Q13. Powell, S. N., H. Willers, and F. Xia, 2002. BRCA2 keeps Rad51 in line: high-fidelity homologous recombination prevents breast and ovarian cancer? Molecular Cell. 10: p. 1262-1263.
Q14. Davies, A. A., J.-Y. Masson, M. J. McIlwraith, A. Z. Stasiak, A. Stasiak, A. R. Venkitaraman, and S. C. West, 2001. Role of BRCA2 in control of the RAD51 recombination and DNA repair protein. Molecular Cell. 7: p. 273-282.
Q15. Kowalczykowski, S. C., 2002. Molecular mimicry connects BRCA2 to Rad51 and recombinational DNA repair. Nature Structural Biology. 9(12): p. 897-899.
Q16. Galkin, V. E., F. Esashi, X. Yu, S. Yang, S. C. West, and E. H. Egelman, 2005. BRCA2 BRC motifs bind Rad51-DNA filaments. Proc Natl Acad Sci USA. 102(24): p. 8537-8542.
Q17. Sturzbecher, H., B. Donzelmann, W. Henning, U. Knippschild, and S. Buchhop, 1996 Apr. 15. p53 is linked directly to homologous recombination processes via RAD51/RecA protein interaction. EMBO J. 15(8): p. 1992-2002.
Q18. Yoon, D., Y. Wang, K. Stapleford, L. Wiesm,ller, and J. Chen, 2004 Feb. 20.
P53 inhibits strand exchange and replication fork regression promoted by human Rad51. J Mol. Biol. 336(3): p. 639-54.
Q19. Buchhop, S., M. Gibson, X. Wang, P. Wagner, H. Strzbecher, and C. Harris, 1997 Oct. 1. Interaction of p53 with the human Rad51 protein. Nucleic Acids Res. 25(19): p. 3868-74.
Q20. Symington, L. S., 2002. Role of RAD52 Epistasis group of genes in homologous recombination and double-strand break repair. Microbiology and Molecular Biology Reviews. 66(4): p. 630-670.
Q21. Paques, F. and J. E. Haber, 1999. Multiple pathways of recombination induced by double-strand breaks in Saccharomyces cerevisiae. Microbiology and Molecular Biology Reviews. 63(2): p. 349-404.
Q22. Essers, J., A. B. Houtsmuller, L. van Veelen, C. Paulusma, A. L. Nigg, A. Pastink, W. Vermeulen, J. H. J. Hoeijmakers, and R. Kanaar, 2002. Nuclear dynamics of Rad52 group homologous recombination proteins in response to DNA damage. The EMBO Journal. 21(8): p. 2030-2037.
Q23. Lisby, M. and R. Rothstein, 2004 Jun. DNA damage checkpoint and repair centers. Curr Opin Cell Biol. 16(3): p. 328-34.
Q24. Lisby, M., U. Mortensen, and R. Rothstein, 2003 Jun. Colocalization of multiple DNA double-strand breaks at a single Rad52 repair centre. Nat Cell Biol. 5(6): p. 572-7.
Q25. Cox, M. M., 2003. The bacterial RecA protein as a motor protein. Annual Review of Microbiology. 57: p. 551-577.
Q26. Conway, A. B., T. W. Lynch, Y. Zhang, G. S. Fortin, C. W. Fung, L. S. Symington, and P. Rice, 2004. Crystal Structure of a Rad51 filament. Nature Structural and Molecular Biology. 11(8): p. 791-796.
Q27. Shin, D. S., L. Pellegrini, D. S. Daniels, B. Yelent, L. Craig, D. Bates, D. S. Yu, M. K. Shivji, C. Hitomi, A. S. Arvai, N. Volkmann, H. Tsuruta, T. L. Blundell, A. R. Venkitaraman, and J. A. Tainer, 2003. Full-length archaeal Rad51 structure and mutants: mechanisms for Rad51 assembly and control by BRCA2. The EMBO Journal. 22(17): p. 4566-4576.
Q28. Pellegrini, L., D. S. Yu, T. Lo, S. Anand, M. Lee, T. L. Blundell, and A. R. Venkitaraman, 2002. Insights into DNA recombination from the structure of a Rad5′-BRCA2 complex. Nature. 420: p. 287-293.
Q29. Weiss, S., 1999. Fluorescence spectroscopy of single biomolecules. Science. 283: p. 676-168.
Q30. Forkey, J. N., M. E. Quinlan, and Y. E. Goldman, 2000. Protein structural dynamics by single-molecule fluorescence polarization. Progress in Biophysics and Molecular Biology. 74: p. 1-35.
Q31. Greene, E. C. and K. Mizuuchi, 2002. Direct observation of single MuB polymers: evidence for a DNA-dependent conformational change for generating an active target complex. Molecular Cell. 9: p. 1079-1089.
Q32. Tokunaga, M., K. Kitamura, K. Saito, A. H. Jwane, and T. Tanagida, 1997. Single molecule imaging of fluorophores and enzymatic reactions achieved by objective-type total internal reflection fluorescence microscopy. Biochemical and biophysical research communications. 235: p. 47-53.
Q33. Axelrod, D., 1989. Total internal reflection fluorescence microscopy. Methods Cell Biol. 30: p. 245-70.
Q34. Cox, M. M., 2001. Historical overview: searching for replication help in all the rec places. Proc Natl Acad Sci USA. 98: p. 8173-8180.
Q35. Shinohara, A., H. Ogawa, Y. Matsuda, N. Ushio, K. Ikeo, and T. Ogawa, 1993. Cloning of human, mouse and fission yeast recombination genes homologous to RAD51 and recA. Nature Genetics. 4: p. 239-243.
Q36. Sung, P., L. Krejci, S. van Komen, and M. S. Sehom, 2003. Rad51 recombinase and recombination mediators. The Journal of Biological Chemistry. 278(44): p. 42729-42732.
Q37. Halford, S, and J. Marko, 2004. How do site-specific DNA-binding proteins find their targets? Nucleic Acids Res. 32(10): p. 3040-52.
Q38. von Hippel, P. H. and O. G. Berg, 1989. Facilitated target location in biological systems. The Journal of Biological Chemistry. 264(2): p. 675-678.
Q39. Berg, O. G., R. B. Winter, and P. H. von Hippel, 1981. Diffusion-driven mechanisms of protein translocation on nucleic acids. 1. Models and Theory. Biochemistry. 20: p. 6929-6948.
Q40. Winter, R. B. and P. H. von Hippel, 1981. Diffusion-driven mechanisms of protein translocation on nucleic acids. 2. The Escherichia coli repressor-operator interaction: equilibrium measurements. Biochemistry. 20: p. 6948-6960.
Q41. Winter, R. B., O. G. Berg, and P. H. von Hippel, 1981. Diffusion-driven mechanisms of protein translocation on nucleic acids. 3. The Escherichia coli repressor-operator interaction: kinetic measurements and conclusions. Biochemistry. 20: p. 6961-6977.
Q42. Stanford, N. P., M. D. Szczelkun, J. F. Marko, and S. E. Halford, 2000. One- and three-dimensional pathways for proteins to reach specific DNA sites. The EMBO Journal. 19(23): p. 6546-6557.
Q43. Gonda, D. K. and C. M. Radding, 1983. By searching processively RecA protein pairs DNA molecules that share a limited stretch of homology. Cell. 34: p. 647-654.
Q44. Tsang, S. S., S. A. Chow, and C. M. Radding, 1985. Networks of DNA and RecA protein are intermediates in homologous pairing. Biochemistry. 24: p. 3226-3232.
Q45. Liu, Y., A. Z. Stasiak, J.-Y. Masson, M. J. McIlwraith, A. Stasiak, and S. C. West, 2004. Conformational changes modulate the activity of human Rad51 protein. Journal of Molecular Biology. 337: p. 817-827.
Q46. Adzuma, K., 1998. No sliding during homology search by RecA protein. The Journal of Biological Chemistry. 273(47): p. 31565-31573.
Q47. McIlwraith, M. J., E. Van Dyck, J.-Y. Masson, A. Z. Stasiak, A. Stasiak, and S. C. West, 2000. Reconstitution of the strand invasion step of double-strand break repair using human Rad51, Rad52 and RPA proteins. Journal of Molecular Biology. 304: p. 151-164.
Q48. Sigurdsson, S., K. Trujillo, B. W. Song, S. Stratton, and P. Sung, 2001. Basis for avid homologous DNA strand exchange by human Rad51 and RPA. The Journal of Biological Chemistry. 276(12): p. 8798-8806.
Q49. Sugiyama, T., E. M. Zaitseva, and S. C. Kowalczykowski, 1997. A single-stranded DNA-binding protein is needed for efficient presynaptic complex formation by the Saccharomyces cerevisiae Rad51 protein. The Journal of Biological Chemistry. 272(12): p. 7940-7945.
Q50. Eggler, A., R. Inman, and M. Cox, 2002 Oct. 18. The Rad51-dependent pairing of long DNA substrates is stabilized by replication protein A. J Biol. Chem. 277(42): p. 39280-8.
Q51. New, J. H., T. Sugiyama, E. Zaitseva, and S. C. Kowalczykowski, 1998. Rad52 protein stimulates DNA strand exchange by Rad51 and replication protein A. Nature. 391:p. 407-410.
Q52. Benson, F. E., P. Baumann, and S. C. West, 1998. Synergistic actions of Rad51 and Rad52 in recombination and DNA repair. Nature. 391: p. 401-404.
Q53. Bi, B., N. Rybalchenko, E. I. Golub, and C. M. Radding, 2004. Human and yeast Rad52 proteins promote DNA strand exchange. Proc Natl Acad Sci USA. 101: p. 9568-9572.
Q54. Alexeev, A., A. Mazin, and S. C. Kowalczykowski, 2003. Rad54 protein possesses chromatin remodeling activity stimulated by the Rad51-ssDNA nucleoprotein filament. Nature Structural Biology. 10(3): p. 182-186.
Q55. Alexiadis, V. and J. T. Kadonaga, 2002. Strand pairing by Rad54 and Rad51 is enhanced by chromatin. Genes & Development. 16: p. 2767-2771.
Q56. Mazin, A., C. J. Bornarth, J. A. Solinger, W. D. Heyer, and S. C. Kowalczykowski, 2000. Rad54 protein is targeted to pairing loci by the Rad51 nucleoprotein filament. Molecular Cell. 6: p. 583-592.
Q57. Petukhova, G., S. Stratton, and P. Sung, 1998. Catalysis of homologous DNA pairing by yeast Rad51 and Rad54 proteins. Nature. 1998: p. 91-94.
Q58. Petukhova, G., S. van Komen, S. Vergano, H. Klein, and P. Sung, 1999. Yeast Rad54 promotes Rad51-dependent homologous DNA pairing via ATP hydrolysis-driven change in DNA double helix conformation. The Journal of Biological Chemistry. 274(41): p. 29453-29462.
Q59. Solinger, J. A., G. Lutz, T. Sugiyama, S. C. Kowalczykowski, and W. D. Heyer, 2001. Rad54 protein stimulates hteroduplex DNA formation in the synaptic phase of DNA strand exchange via specific interactions with the presynaptic Rad51 nucleoprotein filament. Journal of Molecular Biology. 307: p. 1207-1221.
Q60. Solinger, J. A., K. Kiianitsa, and W. D. Heyer, 2002. Rad54, a Swi2/Snf2-like recombinational repair protein, disassembles Rad51:dsDNA filaments. Molecular Cell. 10: p. 1175-1188.
Q61. Swagemakers, S. M. A., J. Essers, J. de Wit, J. H. J. Hoeijmakers, and R. Kanaar, 1998. The human Rad54 recombinational DNA repair protein is a double-stranded DNA dependent ATPase. The Journal of Biological Chemistry. 273(43): p. 28292-28297.
Q62. Muir, T. W., D. Sondhi, and P. A. Cole, 1998. Expressed protein ligation: a general method for protein engineering. Proceedings of the National Academy of Sciences. 95: p. 6705-6710.
Q63. Singleton, S., R. Simonette, N. Sharma, and A. Roca, 2002 Dec. Intein-mediated affinity-fusion purification of the Escherichia coli RecA protein. Protein Expr Purif. 26(3): p. 476-88.
Q64. Mazin, A., E. Zaitseva, P. Sung, and S. Kowalczykowski, 2000 Mar. 1. Tailed duplex DNA is the preferred substrate for Rad51 protein-mediated homologous pairing. EMBO J. 19(5): p. 1148-56.
Q65. Shan, Q., M. Cox, and R. Inman, 1996 Mar. 8. DNA strand exchange promoted by RecA K72R. Two reaction phases with different Mg2+ requirements. J Biol. Chem. 271(10):p. 5712-24.
Q66. Yang, S., X. Yu, E. M. Seitz, S. C. Kowalczykowski, and E. H. Egelman, 2001. Archaeal RadA protein binds DNA as both helical filaments and octameric rings. Journal of Molecular Biology. 314: p. 1007-1085.
Q67. Passy, S. I., X. Yu, Z. Li, C. M. Radding, J.-Y. Masson, S. C. West, and E. H. Egelman, 1999. Human Dmc1 protein binds DNA as an octameric ring. Proceedings of the National Academy of Sciences (USA). 96: p. 10684-10688.
Q68. Vanloock, M. S., X. Yu, S. Yang, A. L. Lai, C. Low, M. J. Campbell, and E. H. Egelman, 2003. ATP-mediated conformational changes in the RecA filament. Structure. 11: p. 187-196.
Q69. Henricksen, L. A., C. B. Umbricht, and M. S. Wold, 1994. Recombinant replication protein A: expression, complex formation, and functional characterization. The Journal of Biological Chemistry. 269(15): p. 11121-11132.
Q70. Sigurdsson, S., S. van Komen, G. Petukhova, and P. Sung, 2002. Homologous DNA pairing by human recombination factors Rad51 and Rad54. The Journal of Biological Chemistry. 277(45): p. 42790-42794.
Q71. Luger, K., T. J. Rechsteiner, A. J. Flaus, M. M. Y. Waye, and T. J. Richmond, 1997. Characterization of nucleosome core particles containing histone proteins made in bacteria. The Journal of Molecular Biology. 272: p. 301-311.
Q72. Greene, E. C. and K. Mizuuchi, 2002. Target immunity during Mu DNA transposition: transpososome assembly and DNA looping enhance efficient MuA-mediated disassembly of the MuB target complex. Molecular Cell. 10(6): p. 1367-1378.
Q73. Ha, T., 2001. Single-molecule fluorescence resonance energy transfer. Methods. 25: p. 78-86.
Q74. Greene, E. C. and K. Mizuuchi, 2002. Dynamics of a protein polymer: the assembly and disassembly pathways of the MuB target complex. The EMBO Journal.
Q75. Sackmann, E., 1996. Supported Membranes. Science. 271: p. 43-48.
Q76. Gelles, J., M. K. Cheezum, W. F. Walker, and W. H. Guilford, 2001. Qualitative comparison of algorithms for tracking single fluorescent particles. Biophysical Journal. 81: p. 2378-2388.
Q77. Thompson, R. E., D. R. Larson, and W. W. Webb, 2002. Precise nanometer localization analysis for individual fluorescent probes. Biophysical Journal. 82: p. 2775-2783.
Q78. Yildiz, A., J. N. Forkey, S. A. Mckinney, T. Ha, Y. E. Goldman, and P. R. Selvin, 2003. Myosin V walks hand-over-hand: single fluorophore imaging with 1.5-nm localization. Science. 300: p. 2061-2065.
Q79. Xiao, J. and S. F. Singleton, 2002. Elucidating a key intermediate in homologous DNA strand exchange: structural characterization of the RecA-triple-stranded DNA complex using fluorescence resonance energy transfer. Journal of Molecular Biology. 320: p. 529-558.
Q80. Nishinaka, T., A. Shinohara, Y. Ito, H. Yokoyama, and T. Shibata, 1998. Base pair switching by interconversion of sugar puckers in DNA extended by proteins of RecA-family: A model for homology search in homologous genetic recombination. Proc Natl Acad Sci USA. 95: p. 11071-11076.
Q81. Gupta, R. C., E. Folta-Stogniew, S. O'Malley, M. Takahashi, and C. M. Radding, 1999. Rapid exchange of A:T base pairs is essential for recognition of DNA homology by human Rad51 recombination protein. Molecular Cell. 4: p. 705-714.
Q82. Folta-Stogniew, E., S. O'Malley, R. C. Gupta, K. S. Anderson, and C. M. Radding, 2004. Exchange of DNA base pairs that coincides with recognition of homology promoted by E. coli RecA protein. Molecular Cell. 15: p. 965-975.
Q83. Bustamante, C., S. B. Smith, J. Liphardt, and D. Smith, 2000. Single-molecule studies of DNA mechanics. Current Opinion in Structural Biology. 10: p. 279-285.
Q84. Marko, F. and E. D. Siggia, 1995. Stretching DNA. Macromolecules. 28: p. 8759-8770.
Q85. Aalfs, J. D. and R. E. Kingston, 2000. What does “Chromatin Remodeling” mean? TIBS. 25: p. 548-555.
Q86. Ristic, D., C. Wyman, C. Paulusma, and R. Kanaar, 2001. The architecture of the human Rad54-DNA complex provides evidence for protein translocation along DNA. Proceedings of the National Academy of Sciences (USA). 98(15): p. 8454-8460.
Q87. Bruno, M., A. Flaus, C. Stockdale, C. Rencurel, H. Ferreira, and T. Owen-Hughes, 2003. Histone H2A/H₂B dimer exchange by ATP-dependent chromatin remodeling activities. Molecular Cell. 12: p. 1599-1606.
Q88. Leuba, S. H., M. A. Karymov, M. Tomschik, R. Ramjit, P. Smith, and J. Zlatanova, 2003. Assembly of single chromatin fibers depends on the tension in the DNA molecule: magnetic tweezers study. Proceedings of the National Academy of Sciences. 100: p. 495-500.
Q89. Fyodorov, D. V. and J. T. Kadonaga, 2003. Chromatin assembly in vitro with purified recombinant ACF and NAP-1. Methods in Enzymology. 371:p. 499-515.
Q90. Cirillo, L. A. and K. S. Zaret, 2004. Preparation of defined mononucleosomes, dinucleosomes, and nucleosome arrays in vitro and analysis of transcription factor binding. Methods in Enzymology. 375: p. 131-158.
Q91. Dorigo, B., T. Schalch, K. Bystricky, and T. J. Richmond, 2003. Chromatin fiber folding: requirement for the histone H₄ N-terminal tail. The Journal of Molecular Biology. 327: p. 85-96.
R1. Modesti, M. and R. Kanaar, 2001. Homologous recombination: from model organism to human disease. Genome Biology. 2(5): p. 1014.1-1014.5.
R2. Greene, E. C. and K. Mizuuchi, 2002. Direct observation of single MuB polymers: evidence for a DNA-dependent conformational change for generating an active target complex. Molecular Cell. 9: p. 1079-1089.
R3. Weiss, S., 1999. Fluorescene Spectroscopy of Single Biomolecules. Science. 283: p. 1676-1683.
R4. Forkey, J. N., M. E. Quinlan, and Y. E. Goldman, 2000. Protein structural dynamics by single-molecule fluorescence polarization. Progress in Biophysics & Molecular Biology. 74: p. 1-35.
R5. Greene, E. C. and K. Mizuuchi, 2002. Target immunity during Mu DNA transposition: transpososome assembly and DNA looping enhance MuA-mediated disassembly of the MuB target complex. Molecular Cell. 10: p. 1367-1378.
R6. Greene, E. C. and K. Mizuuchi, 2004. Visualizing the assembly and disassembly mechanisms of the MuB transposition targeting complex. The Journal of Biological Chemistry. 279: p. 16736-16743.
R7. Greene, E. C. and K. Mizuuchi, 2002. Dynamics of a protein polymer: the assembly and disassembly pathways of the MuB transposition target complex. The EMBO Journal. 21: p. 1477-1486.
R8. Rasnik, I., et al., 2004 Feb. 13. DNA-binding orientation and domain conformation of the E. coli rep helicase monomer bound to a partial duplex junction: single-molecule studies of fluorescently labeled enzymes. J Mol. Biol. 336(2): p. 395-408.
R9. Sackmann, E., 1996. Supported Membranes. Science. 271: p. 43-48.
R10. Kung, L. A., et al., 2000. Patterning Hybrid Surfaces of Proteins and Supported Lipid Bilayers. Langmuir. 16: p. 6773-6776.
R11. Groves, J. and S. Boxer, 2002 Mar. Micropattern formation in supported lipid membranes. Acc Chem. Res. 35(3): p. 149-57.
R12. Cremer, P. S., et al., 1999. Writing and Erasing Barriers to Lateral Mobility onto Fluid Phospholipid Bilayers. Langmuir. 15: p. 3893-3896.
R13. Groves, J. T., et al., 1998. Substrate-membrane interactions: mechanisms for imposing patterns on a fluid bilayer membrane. Langmuir. 14: p. 3347-3350.
R14. Whitesides, G. M., et al., 2001. Soft Lithography in Biology and Biochemistry. Annual Reviews in Biomedical Engineering. 3: p. 335-373.
R15. Sung, N. S., et al., 2003. Educating future scientists. Science. 301: p. 1485.
R16. St. John, P. M., et al., 1998. Diffraction-Based Cell Detection Using a Microcontact Printed Antibody Grating. Analytical Chemistry. 70: p. 1108-1111.
R17. Marko, F. and E. D. Siggia, 1995. Stretching DNA. Macromolecules. 28: p. 8759-8770.
R18. Bustamante, C., et al., 2000. Single-molecule studies of DNA mechanics. Current Opinion in Structural Biology. 10: p. 279-285.
R19. Strick, T., V. Croquette, and D. Bensimon, 2000 Apr. 20. Single-molecule analysis of DNA uncoiling by a type II topoisomerase. Nature. 404(6780): p. 901-4.
R20. Crisona, N., et al., 2000 Nov. 15. Preferential relaxation of positively supercoiled DNA by E. coli topoisomerase IV in single-molecule and ensemble measurements. Genes Dev. 14(22): p. 2881-92.
R21. Odom, T. W., et al., 2002. Generation of 30-50 nm Structures Using Easily Fabricated, Composite PDMS Masks. Journal of the American Chemical Society. 124: p. 12112-12113.
R22. Odom, T. W., et al., 2002. Improved Pattern Transfer in Soft Lithography Using Composite Stamps. Langmuir. 18: p. 5314-5320.
S1. Ha, T., Rasnik, I., Cheng, W., Babcock, H. P., Gauss, G. H., Lohman, T. M., & Chu, S. (2002) Nature 419, 638-641.
S2. Heyes, C. D., Groll, J., Möller, M., & Neienhaus, G. U. (2007) Molecular Biosystems 3, 419-430.
S3. Rasnik, I., Myong, S., Cheng, W., Lohman, T. M., & Ha, T. (2004) J Mol Biol 336, 395-408.
S4. Rhoades, E., Gussakovsky, E., & Haran, G. (2003) Proc Natl Acad Sci USA 100, 3197-3202.
S5. Cisse, I., Okumus, B., Joo, C., & Ha, T. (2007) Proc Natl Acad Sci USA 104, 12646-12650.
S6. Bensimon, A., Simon, A., Chiffaudel, A., Croquette, V., Heslot, F., & Bensimon, D. (1994) Science 265, 2096-2098.
S7. Lebofsky, R. & Bensimon, A. (2003) Briefings in functional genomics and proteomics 1, 385-396.
S8. Kabata, H., Kurosawa, O., Arai, I., Washizu, M., Margarson, S. A., Glass, R. E., & Shimamoto, N. (1993) Science 262, 1561-1563.
S9. Kabata, H., Okada, W., & Washizu, M. (2000) Jpn. J. Appl. Phys. 39, 7164-7171.
S10. Washizu, M., Kurosawa, O., Arai, I., Suzuki, S., & Shimamoto, N. (1995) IEEE Trans. Ind. Appl. 31, 447-456.
S11. Guan, J. & Lee, L. J. (2005) Proceedings of the National Academy of Sciences, USA 102, 18321-18325.
S12. Assi, F., Jenks, R., Yang, J., Love, C., & Prentiss, M. (2002) Journal of Applied Physics 92, 5584-5586.
S13. Kim, S., Blainey, P. C., Schroeder, C. M., & Xie, S. X. (2007) Nature methods 4, 397-399.
S14. Dimalanta, E. T., Lim, A., Runnheim, R., Lamers, C., Churas, C., Forrest, D. K., de Pablo, J. J., Graham, M. D., Coppersmith, S, N., Goldstein, S., et al. (2004) Analytical Chemistry 76, 5293-5301.
S15. Lin, J., Qi, R., Aston, C., Jing, J., Anantharaman, T. S., Mishra, B., White, O., Daly, M. J., Minton, K. W., Venter, J. C., et al. (1999) Science 285, 1558-1562.
S16. Granéli, A., Yeykal, C., Prasad, T. K., & Greene, E. C. (2006) Langmuir 22, 292-299.
S17. Sackmann, E. (1996) Science 271, 43-48.
S18. Cremer, P. S. & Boxer, S. G. (1999) J. Phys. Chem. B 103, 2554-2559.
S19. Granéli, A., Yeykal, C., Robertson, R. B., & Greene, E. C. (2006) Proceedings of the National Academy of Sciences, USA 103, 1221-1226.
S20. Boxer, S. G. (2000) Curr Opin Chem Biol 4, 704-709.
S21. Groves, J. & Boxer, S. (2002 March) Acc Chem Res 35, 149-157.
S22. Tanaka, M., Hermann, J., Haase, I., Fischer, M., & Boxer, S. G. (2007) Langmuir 23, 5638-5644.
S23. Gorman, J., Chowdhury, A., Surtees, J. A., Shimada, J., Reichman, D. R., Alani, E., & Greene, E. C. (2007) Mol Cell 28, 359-370.
S24. Prasad, T. K., Robertson, R. B., Visnapuu, M. L., Chi, P., Sung, P., & Greene, E. C. (2007) J Mol Biol 369, 940-953.
S25. Prasad, T. K., Yeykal, C., & Greene, E. C. (2006) Journal of Molecular Biology 363, 713-728.
S26. Axelrod, D. (1989) Methods Cell Biol 30, 245-270.
S27. Chou, S. Y., Krauss, P. R., & Renstrom, P. J. (1996) Science 272, 85-87.
S28. Pluciennik, A. & Modrich, P. (2007) Proceedings of the National Academy of Sciences USA 104, 12709-12713.
Z1. Gurrieri, S., Wells, K. S., Johnson, I. D. and Bustamante, C. (1997) Direct visualization of individual DNA molecules by fluorescence microscopy: characterization of the factors affecting signal/background and optimization of imaging conditions using YOYO. Analytical Biochemistry, 249, 44-53.
Z2. Akerman, B. and Tuite, E. (1996) Single- and double-strand photocleavage of DNA by YO, YOYO and TOTO. Nucleic Acids Res, 24, 1080-1090.
Z3. Yoshikawa, Y., Hizume, K., Oda, Y., Takeyasu, K., Araki, S, and Yoshikawa, K. (2005) Protective effect of vitamin C against double-strand breaks in reconstituted chromatin visualized by single-molecule observation. Biophysical Journal.
Z4. Chan, W. C. W. and Nie, S. (1998) Quantum dot bioconjugates for ultrasensitive nonisotopic detection. Science, 281, 2016-2018.
Z5. Pinaud, F., Michalet, X., Bentolila, L. A., Tsay, J. M., Doose, S., Li, J. J., Iyer, G. and Weiss, S. (2006) Advances in fluorescence imaging with quantum dot bio-probes. Biomaterials, 27, 1679-1687.
Z6. Medintz, I. L., Uyeda, H. T., Goldman, E. R. and Mattoussi, H. (2005) Quantum dot bioconjugates for imaging, labeling and sensing. Nature Materials, 4, 435-446.
Z7. Granéli, A., Yeykal, C., Prasad, T. K. and Greene, E. C. (2006) Organized arrays of individual DNA molecules tethered to supported lipid bilayers. Langmuir, 22, 292-299.
Z8. Bustamante, C., Bryant, Z. and Smith, S. (2003 Jan. 23) Ten years of tension: single-molecule DNA mechanics. Nature, 421, 423-427.
Z9. Weiss, S. (1999) Fluorescence spectroscopy of single biomolecules. Science, 283, 1676-1683.
Z10. Quake, S. R., Babcock, H. P. and Chu, S. (151) The dynamics of partially extended single molecules of DNA. Nature, 388, 151-154.
Z11. Smith, D. E., Babcock, H. P. and Chu, S. (1999) Single-polymer dynamics in steady shear flow. Science, 283, 724-727.
Z12. Bianco, P. R., Brewer, L. R., Corzett, M., Balhorn, R., Yeh, Y., Kowalczyowski, S. C. and Baskin, R. J. (2001) Processive translocation and DNA unwinding by individual RecBCD enzyme molecules. Nature, 409, 374-378.
Z13. Spies, M., Bianco, P. R., Dillingham, M. S., Handa, N., Baskin, R. J. and Kowalczyowski, S. C. (2003) A molecular throttle: the recombination hotspot χ controls DNA translocation by the RecBCD helicase. Cell, 114, 647-654.
Z14. Neuman, K. C., Abbondanzieri, E. A., Landick, R., Gelles, J. and Block, S. M. (2003) Ubiquitous transcriptional pausing is independent of RNA polymerase backtracking. Cell, 115, 437-447.
Z15. Wang, M. D., Schnitzer, M. J., Yin, H., Landick, R., Gelles, J. and Block, S. M. (1998) Force and velocity measured for single molecules of RNA polymerase. Science, 282, 902-907.
Z16. Perkins, T. T., Dalal, R. V., Mitsis, P. G. and Block, S. M. (2003) Sequece-dependent pausing of single lambda exonuclease molecules. Science, 301, 1914-1918.
Z17. Ladoux, B., Quivy, J. P., Doyle, P., du Roure, O., Almouzni, G. and Viovy, J. L. (2000) Fast kinetics of chromatin assembly revealed by single-molecule videomicroscopy and scanning force microscopy. Proceedings of the National Academy of Sciences, USA, 97, 14251-14256.
Z18. Brewer, L. R., Corzett, M. and Balhorn, R. (1999) Protamine-induced condensation and decondensation of the same DNA molecule. Science, 286, 120-123.
Z19. Bennink, M. L., Scharer, O. D., Kanaar, R., Sakata-Sogawa, K., Schins, J. M., Kanger, J. S., de Grooth, B. G. and Greve, J. (1999) Single-molecule manipulation of double-stranded DNA using optical tweezers: interaction studies of DNA with RecA and YOYO-1. Cytometry, 36, 200-208.
Z20. Crut, A., Géron-Landre, B., Bonnet, I., Bonneau, S., Desbiolles, P. and Escudé, C. (2005) Detection of single DNA molecules by multicolor quantum-dot end-labeling. Nucleic Acids Research, 33, e98.
Z21. Axelrod, D. (1989) Total internal reflection fluorescence microscopy. Methods Cell Biol, 30, 245-270.
Z22. Granéli, A., Yeykal, C., Robertson, R. B. and Greene, E. C. (2006) Long-distance lateral diffusion of human Rad51 on double-stranded DNA. Proceedings of the National Academy of Sciences, USA, 103, 1221-1226.
Z23. Bensimon, A., Simon, A., Chiffaudel, A., Croquette, V., Heslot, F. and Bensimon, D. (1994) Alignment and sensitive detection of DNA by a moving interface. Science, 265, 2096-2098.
Z24. Nirmal, M., Dabbousi, B. O., Bawendi, M. G., Macklin, J. J., Trautman, J. K., Harris, T. D. and Brus, L. E. (1996) Fluorescence intermittency in single cadmium selenide nanocrystals. Nature, 383, 802-804.
Z25. Banin, U., Bruchez, M., Alivisatos, A. P., Ha, T., Weiss, S, and Chemla, D. S. (1999) Evidence for a thermal contribution to emission intermittency in single CdSe/CdS core/shell nanocrystals. Journal of Chemical Physics, 110, 1195-1201.
Z26. Hohng, S, and Ha, T. (2004) Near-complete suppression of quantum dot blinking in ambient conditions. Journal of the American Chemical Society, 126, 1324-1325.
Z27. Albertorio, F., Diaz, A. J., Yang, T., Chapa, V. A., Kataoka, S., Castellana, E. T. and Cremer, P. S. (2005) Fluid and air-stable lipopolymer membranes for biosensor applications. Langmuir, 21, 7476-7482.
Z28. Cheezum, M. K., Walker, W. F. and Guilford, W. H. (2001) Quantitative comparison of algorithms for tracking single fluorescent particles. Biophysical Journal, 81, 2378-2388.
Z29. Cromie, G. A., Connelly, J. C. and Leach, D. R. F. (2001) Recombination at double-strand breaks and DNA ends: conserved mechanisms from phage to humans. Molecular Cell, 8, 1163-1174.
Z30. Sung, P., Krejci, L., Van Komen, S, and Sehom, M. G. (2003) Rad51 recombinase and recombination mediators. The Journal of Biological Chemistry, 278, 42729-42732.
Z31. Yu, X., Jacobs, S. A., West, S. C., Ogawa, T. and Egelman, E. H. (2001) Domain structure and dynamics in the helical filaments formed by RecA and Rad51 on DNA. Proceedings of the National Academy of Sciences, USA, 98, 8419-8424.
Z32. Prasad, T. K., Yeykal, C. and Greene, E. C. (2006) Visualizing the assembly of human Rad51 filaments on double-stranded DNA. Journal of Molecular Biology, In Press.

What is claimed is:

1. An array comprising:
a) a solid support;
b) a fluid lipid bilayer disposed on the solid support;
c) at least one nucleic acid molecule; and
d) a linkage for attaching the nucleic acid molecule to the solid support.

2. An array comprising:
a) a solid support, wherein the solid support comprises a barrier;
b) a fluid lipid bilayer disposed on the solid support;
c) at least one nucleic acid molecule; and
d) a linkage for attaching the nucleic acid molecule to the lipid bilayer.

3. The array of claim 2, wherein the barrier is a mechanical barrier.

4. The array of claim 3, wherein the mechanical barrier is a scratch on the solid support.

5. The array of claim 2, wherein the barrier is a chemical barrier.

6. The array of claim 5, wherein the chemical barrier comprises a metal, a metal oxide, or a combination thereof.

7. The array of claim 6, wherein the metal comprises chromium, aluminum, gold, or titanium.

8. The array of claim 6, wherein the metal oxide comprises chromium oxide, aluminum oxide, or titanium oxide.

9. The array of claim 2, wherein the barrier is a protein barrier.

10. An array comprising:
a) a solid support, wherein the solid support comprises a protein barrier;
b) a fluid lipid bilayer disposed on the solid support;
c) at least one nucleic acid molecule; and
d) a linkage for attaching the nucleic acid molecule to the protein barrier on the solid support.

11. The array of claim 1, 2 or 10, wherein the linkage is formed between neutravidin and biotin.

12. The array of claim 1, 2 or 10, wherein the nucleic acid molecule is aligned in a desired orientation through the application of a hydrodynamic force.

13. The array of claim 1, 2 or 10, wherein one end of the nucleic acid molecule is attached by a linkage.

14. The array of claim 1, 2 or 10, wherein both ends of the nucleic acid molecule are attached by a linkage.

15. The array of claim 14, wherein the ends of the nucleic acid molecule are attached by different linkages.

16. The array of claim 1, 2 or 10 wherein the nucleic acid molecule is a DNA molecule.

17. The array of claim 16, wherein the DNA molecule comprises from about 20 to about 100,000 basepairs.

18. The array of claim 1, 2 or 10, wherein the nucleic acid molecule is coupled to a label.

19. The array of claim 18, wherein the label is a fluorescent label.

20. The array of claim 1, 2 or 10, wherein the solid support comprises SiO2.

21. The array of claim 1, 2 or 10, wherein the lipid bilayer comprises zwitterionic lipids.

22. A microfluidic flowcell comprising the array of any one of claims 1 through 10.

23. A method for analyzing an interaction between a nucleic acid and a polypeptide, the method comprising:
a) providing the array of claim 1, 2 or 10, wherein the attached nucleic acid molecule is a DNA molecule coupled to a first fluorescent label that permits visualization of the DNA molecule,
b) contacting a polypeptide to the attached DNA molecule, wherein the polypeptide is coupled to a second fluorescent label that permits visualization of the polypeptide,
c) applying a hydrodynamic force along the surface of the support to align the attached DNA molecules in a desired orientation,
d) visualizing the DNA molecule and the polypeptide, and
e) determining whether the DNA molecule interacts with the polypeptide, wherein localization of the polypeptide anywhere along the length of the DNA molecule is indicative of interaction.

24. The method of claim 23, wherein static localization of the polypeptide along the DNA molecule indicates binding between the DNA molecule and the polypeptide.

25. The method of claim 23, wherein dynamic localization of the polypeptide along the DNA molecule indicates binding and movement of the polypeptide along the DNA molecule.

26. The method of claim 23 further comprising determining whether the polypeptide binds to a specific DNA structure, wherein alignment of the polypeptide at a specific position on the DNA molecule indicates binding to a specific DNA structure.

27. A method for identifying a nucleic acid sequence that disrupts an interaction between a nucleic acid molecule and a polypeptide, the method comprising:
a) providing a first array according to any one of claims 1, 2 or 10, wherein the first array comprises a first population of identical nucleic acid molecules, and wherein the nucleic acid molecules are coupled to a first fluorescent label;
b) providing a second array according to any one of claims 1, 2 or 10, wherein the second array comprises a second population of identical nucleic acid molecules, wherein the nucleic acid molecules are coupled to the first fluorescent label, and wherein the second population of nucleic acid molecules differ from the first population of nucleic acid molecules by at least one nucleotide;
c) contacting a polypeptide to the arrays, wherein the polypeptide is coupled to a second fluorescent label that permits visualization of the polypeptide; and
d) determining whether the first population of nucleic acid molecules and the second population of nucleic acid molecules interact with the polypeptide, wherein localization of the polypeptide anywhere along the length of the first population of nucleic acid molecules is indicative of an interaction between the first population and the polypeptide, and wherein an absence of localization of the polypeptide along the length of the second population of nucleic acid molecules is indicative that the second population comprises a nucleic acid sequence that disrupts the interaction between the first nucleic acid molecule and the polypeptide.

28. A method for identifying a polypeptide that alters the structure of a DNA molecule, the method comprising:
a) providing the array of claim 1, 2 or 10, wherein the nucleic acid is a DNA molecule coupled to a first fluorescent label that permits visualization of the DNA molecule;
b) applying a hydrodynamic force along the surface of the support to align the DNA molecule in a desired orientation;
c) visualizing the length of the DNA molecule;
d) contacting a polypeptide to the DNA molecule, wherein the polypeptide is optionally coupled to a second fluorescent label that permits visualization of the polypeptide;
e) visualizing the length of the DNA molecule and, optionally, visualizing the polypeptide; and
f) determining whether the DNA molecule changes length following the contacting step, wherein an increase or a decrease in the length of the DNA molecule is indicative of a polypeptide that alters the structure of the DNA molecule.

29. A method for identifying an agent that disrupts the interaction of a polypeptide and a nucleic acid, the method comprising:
a) providing the array of claim 1, 2 or 10, wherein the nucleic acid molecule is a DNA molecule coupled to a first fluorescent label that permits visualization of the DNA molecule;
b) contacting a polypeptide to the DNA molecule, wherein the polypeptide is capable of interacting with the DNA molecule, and wherein the polypeptide is coupled to a second fluorescent label that permits visualization of the polypeptide;
c) contacting an agent to the DNA molecule and the polypeptide;
d) applying a hydrodynamic force along the surface of the support to align the attached DNA molecules in a desired orientation;
e) visualizing the DNA molecule and the polypeptide; and
f) determining whether the agent disrupts the interaction between the DNA molecule and the polypeptide, wherein loss of localization of the polypeptide anywhere along the length of the DNA molecule is indicative of an agent that disrupts the interaction between the DNA molecule and the polypeptide.

30. A method for sequencing a nucleic acid molecule, the method comprising:
a) providing the array of claim 1, 2 or 10, wherein the nucleic acid molecule is a single stranded DNA molecule;
b) providing a collection of nucleotide analogues, wherein each nucleotide type is coupled to a different fluorescent label;
c) providing DNA polymerase;
d) visualizing a fluorescent signal from the DNA molecule, wherein the signal is indicative of the identity of the nucleotide added by the polymerase; and
e) optionally repeating step d).

31. The method of claim 29, wherein the array comprises a plurality of identical DNA molecules.

32. The method of claim 29, wherein the array comprises a plurality of different DNA molecules.

33. A method for mapping a nucleic acid molecule, the method comprising:
a) providing the array of claim 1, 2 or 10, wherein the nucleic acid molecule is a DNA molecule coupled to a fluorescent label that permits visualization of the DNA molecule;
b) applying a hydrodynamic force along the surface of the support to align the DNA molecule in a desired orientation;
c) visualizing the length of the DNA molecule;
d) contacting a restriction enzyme to the DNA molecule; and
e) determining the changes in the length of the DNA molecule following the contacting step.

34. A method for mapping a nucleic acid molecule, the method comprising:
a) providing the array of claim 1, 2 or 10, wherein the array comprises a plurality of identical nucleic acid molecules, wherein the nucleic acid molecules are DNA molecules coupled to a first fluorescent label that permits visualization of the DNA molecules;
b) contacting different types of polypeptides to the DNA molecules, wherein each type of population is coupled to a fluorescent label that is not the first fluorescent label;
c) applying a hydrodynamic force along the surface of the support to align the DNA molecule in a desired orientation; and
d) visualizing the locations of binding of the polypeptides, thereby mapping the nucleic acid molecule.

35. A method for mapping a nucleic acid molecule, the method comprising:
a) providing the array of claim 1, 2 or 10, wherein the array comprises a plurality of identical nucleic acid molecules, wherein the nucleic acid molecules are DNA molecules coupled to a first fluorescent label that permits visualization of the DNA molecules;
b) contacting a plurality of DNA probes to the DNA molecules, wherein each DNA probe is coupled to a fluorescent label that is not the first fluorescent label;
c) applying a hydrodynamic force along the surface of the support to align the DNA molecule in a desired orientation; and
d) visualizing the locations of binding of the DNA probes, thereby mapping the nucleic acid molecule.

36. A method for identifying one or more agents that disrupt the interactions between one or more polypeptides and a nucleic acid, the method comprising:
a) providing the array of claim 1, 2 or 10, wherein the array comprises a plurality of identical nucleic acid molecules, wherein the nucleic acid molecules are DNA molecules coupled to a first fluorescent label that permits visualization of the DNA molecules;
b) contacting one or more polypeptides to the DNA molecules, wherein the one or more polypeptides are each capable of interacting with the DNA molecules at different known locations, and wherein the one or more polypeptide are coupled to a second fluorescent label that permits visualization of the polypeptides;
c) applying a hydrodynamic force along the surface of the support to align the attached DNA molecules in a desired orientation and visualizing the DNA molecules and the polypeptides;
d) contacting a first agent to the array;
e) visualizing the DNA molecules and the polypeptides;
f) determining whether the first agent disrupts the interaction between the DNA molecules and one or more of the polypeptides, wherein loss of localization of one or more of the polypeptides along the length of the DNA molecules is indicative of an agent that disrupts the interaction between the DNA molecules and the one or more polypeptides; and
g) optionally contacting a second agent to the array and repeating steps e) and f).

37. The method of claim 29, wherein the agents are from a library.

38. The method of claim 36, wherein the agents are from a library

39. The method of claim 23, wherein the steps are automated.

40. The method of claim 27, wherein the steps are automated.

41. The method of claim 28, wherein the steps are automated.

42. The method of claim 29, wherein the steps are automated.

43. The method of claim 30, wherein the steps are automated.

44. The method of claim 33, wherein the steps are automated.

45. The method of claim 34, wherein the steps are automated.

46. The method of claim 35, wherein the steps are automated.

47. The method of claim 36, wherein the steps are automated

48. A microfluidic flowcell comprising the array of claim 11.

49. A microfluidic flowcell comprising the array of claim 12.

50. A microfluidic flowcell comprising the array of claim 13.

51. A microfluidic flowcell comprising the array of claim 14.

52. A microfluidic flowcell comprising the array of claim 15.
